(19) United States
(12) Patent Application Publication
(10) Pub. No.: US 2004/0138826 A1
(43) Pub. Date: Jul. 15, 2004

(54) Experimental design and data analytical methods for detecting and characterizing interactions and interaction thresholds on fixed ratio rays of polychemical mixtures and subsets thereof

(76) Inventors: Walter Hansbrough Carter JR., Chesterfield, VA (US); Chris Gennings, Richmond, VA (US); Adam K. Hamm, Midlothian, VA (US); Stephanie L. Meadows, Old Saybrook, CT (US); Michelle Casey, Woodbridge, VA (US)

Correspondence Address: WHITHAM, CURTIS & CHRISTOFFERSON, P.C., 11491 SUNSET HILLS ROAD, SUITE 340, RESTON, VA, 20190, US

(21) Appl. No.: 10/655,540

(22) Filed: Sep. 5, 2003

Related U.S. Application Data
(60) Provisional application No. 60/408,232, filed on Sep. 6, 2002.
(60) Provisional application No. 60/452,933, filed on Mar. 10, 2003.

(51) Int. Cl. G06F 19/00

(52) U.S. Cl. 702/27

(57) ABSTRACT

Methods are provided for the statistical analysis of interactions among agents in a combination of agents (i.e. departures from additivity), with respect to a quantifiable result of exposure to the combination of agents. Examples include the interactions among chemicals in a mixture of chemicals with respect to health disorders caused by exposure to the mixture of chemicals. The invention provides methods for determining how many of the agents in the mixture interact, whether the interaction is synergistic or antagonistic, and the interaction threshold concentration of agents at which interactions are observed. Further, the methods are especially useful for analyzing combinations of three or more agents for which classical methods of analysis would require a prohibitively large number of data points. Software programs for implementing the invention are also provided.

This invention was made using funds from grants from the Environmental Protection Agency having cooperative agreement number CR827208-01-0 and the National Institute of Environmental Health Sciences grant number T32 ES07334-01A1. The United States government may have certain rights in this invention.

### BACKGROUND OF THE INVENTION

1. Field of the Invention

The invention generally relates to the analysis of interactions among agents in a combination of agents. In particular, the invention provides statistical methods for determining how many (if any) of the agents in the mixture interact, whether the interaction is synergistic or antagonistic, and the threshold concentration of agents at which interactions are observed.

2. Related Art

Potentially noxious chemical agents (e.g. metals, manufacturing byproducts, pesticides, etc.) are widely distributed in the environment, both as a result of naturally occurring processes and as a “side effect” of advancing technology. Humans are exposed to such agents on a daily basis, and the protection of human health from the adverse effects of such exposure is crucial. Thus, effects of these agents on human health have been and continues to be the focus of intense study.

In the past, studies have typically focused on the effect of a single agent. However, it is now recognized that exposure to a single agent is the exception rather than the rule. Environmental sources of potentially harmful agents typically contain several or even hundreds of chemical substances, so that a person encounters many compounds at once. For example, mixtures of several pesticides are generally applied to agricultural cropland, and typical hazardous waste sites may contain mixtures of several hundred different compounds. Thus, it is of prime importance to detect, characterize, and predict the impact of mixtures of chemical agents on human health.

Likewise, the availability of a plethora of drugs for treating health-related disorders, while providing substantial health benefits, often also results in the prescription of multiple drugs for an individual. This is often the case with older individuals who tend to have multiple health-related issues. Unfortunately, the side effects of interactions among multiple drugs when taken together are frequently unknown and unpredictable.

In the risk assessment of mixtures of chemicals or drugs, a common default assumption is that at low doses/concentrations, outcomes that are observed are the result of the simple additive effects of the individual components of the mixture. However, it is also recognized that at higher concentrations, the toxic side effects of chemical agents may be modified by concurrent exposure to other chemical agents.

The detection of chemical interactions, and in particular, the identification of concentrations or conditions under which additivity is not observed, is of special interest. The classical method for detecting and characterizing departures from additivity between combinations of drugs or chemicals is the isobologram. The isobologram, introduced as a graphical tool, is a plot of a contour of constant response of the dose-response surface associated with the combination superimposed on a plot of the same contour under the assumption of additivity. For a two-component mixture, the analysis of an isobologram compares the observed isobol (e.g., combination ED₅₀) to the line of additivity. The line of additivity is formed by joining the ED₅₀ associated with each of the individual components calculated from the dose response data for the individual components. If the isobol is below the line of additivity, a synergism is claimed. On the other hand, if the isobol is above the line of additivity, an antagonism is claimed. However, there are shortcomings associated with the use of isobolograms. For instance, the method used in the construction of an isobologram typically does not take data variability into account. Additionally, since it is a graphical method, isobolograms effectively are limited to the study of combinations of two or three drugs or chemicals because of the practical limits involved with data generation and representation.

The interaction index, introduced by Berenbaum, provides a convenient method to determine and characterize departures from additivity for a combination of c>2 or 3 components. The interaction index, II, is defined by

$$II = \frac{{X}_{1}}{{ED}_{100 μ} ( {CHEM}_{1} )} + \frac{{X}_{2}}{{ED}_{100 μ} ( {CHEM}_{2} )} + … + \frac{{X}_{c}}{{ED}_{100 μ} ( {CHEM}_{c} )} \qquad ( 1 )$$

where c is the number of components, X₁, X₂, . . . ,X_{c} are the doses in combination associated with a desired effect, and ED_{100μ}CHEMᵢ), i=1, . . . ,c is the dose of the ith component that, when administered alone, produces the same effect. When the interaction index II, defined in equation (1), is equal to 1 the c components interact additively; when II is greater than 1 the components interact antagonistically; and when II is less than 1 the components interact synergistically. Again, it should be noted that the individual component dose-response information is required to calculate the interaction index. The interaction index is directly related to the isobologram, i.e., when II=1, the isobol is coincident with the line of additivity; when II>1, the isobol bows above the line of additivity; and when II<1, the isobol bows below the line of additivity. An advantage of using the interaction index over the isobologram is that the interaction index is not limited to combinations/mixtures of just two or three components. However, the biological variability associated with the data is not taken into account by the interaction index.

Statisticians frequently use models of the form

$$g ( μ ) = {β}_{0} + {\sum }_{i = 1}^{c} {β}_{i} {x}_{i} + {{\sum }_{i = 1}^{c} {\sum }_{j = 1}^{c}}_{i < j} {β}_{ij} {x}_{i} {x}_{j} + {{\sum }_{i = 1}^{c} {\sum }_{j = 1}^{c} {\sum }_{k = 1}^{c}}_{i < j < k} {β}_{ijk} {x}_{i} {x}_{j} {x}_{k} + … + {β}_{12 … c} {x}_{1} {x}_{2} … {x}_{c}$$

to approximate the relationship between a mean response of interest, μ, and concentrations of c chemicals (x₁,x₂, . . . ,x_{c}) where g(μ) is a user-specified link function.

Carter et al. (reference 4 of Example 6) have shown that a relationship exists between the interaction index proposed by Berenbaum and the parameter in a statistical model that is associated with the interaction of the components of the combination. Without loss of generality, consider that the combination/mixture of interest involves two chemicals and that the response is continuous. Therefore, following the logic of Carter et al., for the linear models case (which is readily extended to the generalized linear model case), the relationship between the response and the doses or concentrations of the components in combination can be expressed as

μ=β₀+β₁x₁+β₂x₂+β₁₂x₁₂, (2)

where

μ=is the mean response, E(Y),

β₀ is the unknown intercept,

β₁ is the unknown slope parameter associated with the first component,

β₂ is the unknown slope parameter associated with the second component,

β₁₂ is the unknown parameter associated with the interaction of the two components,

and x₁ and x₂ are the doses of the respective chemicals.

From the model defined in equation (2), the ED_{100μ}(CHEMᵢ) for the respective components can be derived to be

$${ED}_{100 μ} ( {CHEM}_{1} ) = \frac{μ - {β}_{0}}{{β}_{1}}$$

$${ED}_{100 μ} ( {CHEM}_{2} ) = \frac{μ - {β}_{0}}{{β}_{2}}$$

Thus, after algebraic manipulation, the model defined in equation (2) becomes

$$\frac{{β}_{1} {x}_{1}}{μ - {β}_{0}} + \frac{{β}_{2} {x}_{2}}{μ - {β}_{0}} + \frac{{β}_{12} {x}_{12}}{μ - {β}_{0}} = 1$$

$$or$$

$$1 - \frac{{β}_{12} {x}_{12}}{μ - {β}_{0}} = \frac{{x}_{1}}{\frac{( μ - {β}_{0} )}{{β}_{1}}} + \frac{{x}_{2}}{\frac{( μ - {β}_{0} )}{{β}_{2}}} .$$

Therefore, it follows that when β₁₂=0, the combination of components 1 and 2 is additive, i.e., the isobologram is coincident with the line of additivity and the interaction index equals 1. Similarly, when β₁₂>0, the combination of components 1 and 2 is synergistic, i.e., the isobologram bows below the line of additivity and the interaction index is less than 1; and when β₁₂<0, an antagonism is present, i.e., the isobologram bows above the line of additivity and the interaction index is greater than 1. This demonstrates the algebraic equivalence between the statistical model and the interaction index. Gennings et al (reference 16 of Example 6) demonstrated the experimental convergence of the statistical modeling approach and the interaction index. The number of components that can be considered in the statistical model can be generalized to c, and data variability is appropriately accounted for in the resulting inference.

The various methods used to determine and classify departures from additivity described above utilize both single-compound data as well as combination data. However, such methodology does not cover the situation in which single-compound dose-response data are not available. For example, as the number of chemicals in a mixture of interest increases, it becomes less likely that an investigator will be able to perform an experiment large enough to support the estimation of these parameters as well as those associated with the dose-response relationship so that the potential advantages cannot be realized.

Up until the present invention, the prior art has failed to provide adequate methodology to address these problems.

### SUMMARY OF THE INVENTION

The present invention provides methods for analyzing the interaction of the agents in a combination of a large number of agents. The analysis is carried out with respect to a quantifiable outcome of interest that occurs as result of exposure to the combination of agents. For example, the present invention provides methods that can determine whether synergistic, antagonistic, or no interactions occur among the chemicals in a mixture of chemicals with respect to an outcome of interest (e.g. a health disorder) that is caused by exposure to the mixture. Alternatively, the methods may be used to analyze interactions of drugs in a mixture of drugs that are administered to a patient. The methods of the invention can be used to determine: whether and how many of the agents in the mixture interact; in certain applications, which of the agents are interacting; and the threshold concentration at which the agents begin to interact. In one embodiment of the invention, the analysis methods utilize data obtained with individual agents of the mixture (e.g. “single chemical data”) in addition to the mixture data. However, in another embodiment, the analysis methods are carried out in the absence of data generated with single agents, i.e. it uses only mixture data. Both methods adequately take into account data variability.

The invention is especially useful for analyzing combinations of a large number of agents for which classical methods of analysis would require a prohibitively large number of data points. For example, using the methods of the present invention, it is possible to detect interactions in a mixture of dozens or even hundreds of chemicals with an economically feasible study.

It is an object of this invention to provide a method of detecting an interaction among agents in a group using a fixed- ratio ray design, and to determine whether subsets of the agents also interact. The method comprises the steps of a. determining an additivity model from single chemical data; b. fitting a mixture model in terms of total dose to mixture data from fixed-ratio rays; c. statistically comparing the additivity model to the mixture model, wherein a difference between the additivity model and the mixture model indicates an interaction among agents in the group; d. removing a subset of agents from the group; e. repeating steps b and c for agents remaining in the group after removal of the subset; and f. determining whether or not the remaining agents interact with the subset of agents by utilizing statistical methods based on algebraic manipulations relating full and reduced ray mixture models. The method may also include the step of carrying out steps b and c for the subset of agents. The additivity model may be graphically represented as an additivity curve and the mixture model may be graphically represented as a mixture curve in terms of total dose. Further, simultaneous confidence bands may be determined on the difference between the additivity and mixture curves, or between mixture curves on full and reduced rays.

The invention further provides a method of detecting, in a group of agents, the number of agents that interact, and determining whether subsets of the agents also interact. The method includes the steps of a. fitting a suitable polynomial to experimental data obtained with a combination of said agents; b. statistically identifying higher order terms of the polynomial that are not equal to zero, wherein the number of agents that interact in said group of agents is equal to the degree of the higher order terms that are not equal to zero; c. removing a subset of agents from the group; d. repeating steps a and b for agents remaining in the group after removal of the subset; and e. determining whether or not the remaining agents interact with the subset of agents by utilizing statistical methods based on algebraic manipulations relating full and reduced ray mixture models. The method may also include the step of carrying out steps a and b for the subset of agents. Further, single chemical data may also be utilized. The polynomial may be embedded in a generalized linear model or in a general non-linear model. The method may include a step of generating a graphical representation of the polynomial.

The invention also provides a method of determining an interaction threshold for agents in a group. The method comprises the step of generating a generalized linear model or general nonlinear model that permits estimation of the boundaries between a region of additivity of the agents and a region of interaction of the agents, in which the boundaries define the interaction threshold. In one embodiment of the method, the region of additivity and the region of interaction are determined by the steps of

a. determining an additivity model from single chemical data;

b. fitting a mixture model that incorporates an interaction threshold parameter in terms of total dose to mixture data from fixed-ratio rays; and

c. statistically comparing the additivity model to the mixture model, in which a region of difference between the additivity model and the mixture model indicates a region of interaction among the agents, and a region of coincidence between the additivity model and the mixture model indicates a region of additivity among the agents. The method may further include the steps of d. removing a subset of agents from the group; e. repeating steps b and c for agents remaining in the group after removal of the subset; and f. determining whether or not the remaining agents interact with the subset of agents by utilizing statistical methods based on algebraic manipulations relating full and reduced ray mixture models. The method may further comprise the step of carrying out steps b and c for the subset of agents.

Alternatively, in another embodiment of the invention, the region of additivity and the region of interaction are determined by the steps of

a. fitting single chemical data to an additivity model;

b. fitting mixture data in terms of total dose to a mixture model that incorporates an 25 interaction threshold parameter, in which the region of additivity is conditioned on results obtained in step a; and

c. statistically comparing the additivity model to the mixture model, wherein a region of difference between the additivity and mixture models indicates a region of interaction among the agents, and a region of coincidence between the additivity model and the mixture model indicates a region of additivity among the agents. The method may further comprise the steps of d. removing a subset of agents from the group; e. repeating steps b and c for agents remaining in said group after removal of the subset; and

f. determining whether or not the remaining agents interact with the subset of agents by utilizing statistical methods based on algebraic manipulations relating full and reduced ray mixture models. The method may also include the step of carrying out steps b and c for the subset of agents.

The region of additivity and the region of interaction may be determined by the steps of a. fitting an interaction threshold model parameterized with a polynomial function for regions of interaction to experimental data obtained with a combination of said agents, and, b. statistically testing whether the interaction threshold parameter is different from zero and identifying higher order terms of the polynomial that are not equal to zero. The method may further comprise the steps of

c. removing a subset of agents from the group;

d. repeating steps a and b for agents remaining in the group after removal of the subset; and

e. determining whether or not the remaining agents interact with the subset of agents by utilizing statistical methods based on algebraic manipulations relating full and reduced ray mixture models. Single chemical data may also be utilized in the method.

The present invention also provides a method of designing experiments that achieve a target power associated with a test of additivity. The method comprises the steps of

a. specifying the target power, a significance level, a number of mixture dose groups, and a magnitude of departure from additivity in terms of total dose;

b. setting a candidate total sample size;

c. formulating a design by expressing a design optimality criterion as a function of the target power, the significance level, the number of mixture dose groups, the magnitude of departure from additivity in terms of total dose, and the candidate total sample size, wherein optimal locations of total dose groups and optimal allocations of subjects to the total dose groups are determined using a direct search algorithm;

d. calculating a calculated power associated with the design, and

e. comparing the calculated power to the target power,

f. repeating steps a-e until the step of comparing shows that the calculated power is equal to the target power. The method may also include the step of increasing the total sample size used during the step of repeating if the step of comparing shows that the calculated power is less than the target power. Conversely, the method may comprise the step of decreasing the total sample size used during the step of repeating if the step of comparing shows that the calculated power is greater than the target power.

The present invention also provides software programs for implementing all the above-described methods. The software programs cause a computer to carry out the steps of each method.

### BRIEF DESCRIPTION OF THE DRAWINGS

FIG. 1. Observed (asterisk) and predicted threshold additivity responses (solid lines) for (a) acephate (b) diazinon (c) chlorpyrifos (d) dimethoate (e) malathion. The threshold additivity model is given in (2) and model parameters are given in Table 5 of Example 1.

FIG. 2. Observed (asterisk) and predicted (solid line) mean responses along (a) the full five-pesticide fixed-ratio ray (0.040:0.002:0.031:0.102:0.825) and (b) the reduced fixed-ratio ray where malathion was removed from the mixture and the remaining pesticides are at the same relative ratios as given in the full ray (0.2286:0.0114:0.1767:0.5833). The threshold additivity model (dotted line) fit using single chemical data is provided for reference. Parameter estimates are provided in Table 5 of Example 1. Under additivity, the point estimate for the dose threshold is estimates as

$$\frac{\hat{δ}}{{\sum }_{i = 1}^{c} {\hat{β}}_{i} {a}_{i ( full )}} = 34.69 mg \text{/} kg$$

along the full five pesticide fixed-ratio ray and as

$$\frac{\hat{δ}}{{\sum }_{i = 1}^{c} {\hat{β}}_{i} {a}_{i ( reduced )}} = 6.07 mg \text{/} kg$$

along the reduced fixed-ratio ray. (c) The adjusted fitted dose-response curve for the full ray (dashed) is superimposed with the fitted curve for the reduced ray (solid). The threshold additivity model (dotted line) is provided for reference.

FIG. 3. The difference between the fitted models for the mixture data along the ray and that predicted under the hypothesis of additivity using the single chemical data and the 95% simultaneous confidence band on the difference in the concentration effect curves for (a) the full five pesticide fixed-ratio ray and (b) the reduced ray where malathion was removed from the mixture and the remaining four pesticides are at the same relative ratios as given in the full ray.

FIG. 4. Observed (asterisk) and predicted (solid line) responses along (a) the full five-pesticide fixed-ratio ray (0.040:0.002:0.031:0.102:0.825) and (b) the reduced ray (0.2286:0.0114:0.1767:0.5833) for the generalized linear model, given in equation (4) in Example 1, fit using only mixture data. The additivity (or first order) model (dotted line) is provided for reference. Parameter estimates are provided in Table 3 of Example 1.

FIG. 5. Predicted generalized linear interaction model (dotted line) and additivity (first-order) model (solid line) fit using single chemical data and mixture data along the full five-pesticide fixed-ratio ray (0.040:0.002:0.031:0.102:0.825) where the parameter estimates are provided in Table 1 of Example 2. The asterisks represent the sample mean motor activity responses.

FIG. 6. Generalized linear model along the reduced ray (0.2268:0.0114:0.1767:0.5833) under the null hypothesis (solid line), under the assumption of additivity (dotted line), and under the alternative hypothesis (dashed line) that (a) malathion is involved in second-order interactions, (b) malathion is involved in second and third-order interactions, and (c) malathion is involved in second, third, and fourth-order interactions.- Assumed model parameters are provided in Table 2 of Example 2.

FIG. 7: Observed and predicted responses from the additivity model with estimates given in Table 1 of Example 3 for (A) ACE, (B) DIA, (C) CPF, (D) MAL, and (E) DIM.

FIG. 8: Observed (*) and predicted responses based on the SAR mixture model (solid line) and assuming additivity (dotted line) as a function of total dose (mg/kg) for the (A) full ray with all five chemicals and (B) for the reduced ray with MAL omitted. FIG. C includes the predicted response under additivity (dotted line) and based on the reduced ray mixture model (solid line) without MAL as given in B. In addition, FIG. C includes an adjusted curve (dashed line) from the full ray mixture data (including MAL).

FIG. 9: Observed (*) and predicted responses based on the SANR mixture model (solid line) and assuming additivity (dotted line) as a function of total dose (mg/kg) for the (A) full ray with all five chemicals and (B) for the reduced ray with MAL omitted. FIG. C includes the predicted response under additivity (dotted line) and based on the reduced ray mixture model (solid line) without MAL as given in B. In addition, FIG. C includes an adjusted curve (dashed line) from the full ray mixture data (including MAL).

FIG. 10. Predicted generalized linear interaction model (dotted line) fit with the log link function using single chemical data and mixture data along the full five-pesticide fixed-ratio ray (0.040:0.002:0.031:0.102:0.825) and the additivity (first-order) model (solid line) where the parameter estimates are provided in Table 1 of Example 4. The asterisks represent the sample mean motor activity responses.

FIG. 11. Generalized linear model along the reduced ray (0.2286:0.0114:0.1767:0.5833) under the null hypothesis (i.e. no interactions due to malathion) (solid line), under the assumption of additivity (dotted line), and under the alternative hypotheses (dashed line) that (a) malathion is involved in second-order interactions, (b) malathion is involved in second and third-order interactions, and (c) malathion is involved in second, third, and fourth-order interactions. Model parameters are provided in Table 2 of Example 4.

FIG. 12. Results of 5, 6, 7, and 10 point Dₛ-optimal designs for the hypothesis given in (10), where the alternative hypothesis assumes malathion is involved in two way interactions. Parameter estimates are provided in Table 2 of Example 4. Generalized linear model along the reduced ray (0.2286:0.0114:0.1767:0.5833) under the null hypothesis (solid line), under the assumption of additivity (dotted line), and under the alternative hypothesis (dashed line) are also provided.

FIG. 13: Observed versus predicted responses for the fit of the single chemical data.

FIG. 14: Observed and predicted values using the NHEK cell line for (A) arsenic, (B) chromium, (C) cadmium, and (D) lead.

FIG. 15: Predicted concentration effect curves along total concentration for the fixed ratio mixture ray for the curve under the hypothesis of additivity (solid line) and the fitted curve of the mixture data alone (dashed line). The asterisks represent the observed sample mean responses at each of the mixture points.

FIG. 16: The difference between the fitted models for the mixture data and that predicted under the hypothesis of additivity using the single chemical data (solid line) and the 95% simultaneous confidence band on the difference in the concentration effect curves.

FIG. 17: Illustrations of Isobolograms for a Combination of Two Drugs/Chemicals. The dashed line is the ‘line of additivity’; when the isobol bows below the line of additivity a ‘synergism’ is claimed; when the isobol bows above the line of additivity an ‘antagonism’ is demonstrated.

FIG. 18: Observed Responses and Fitted Curve Under the Additivity Model for the Fit of the Mixture Data Using the NHEK Cells.

FIG. 19: Observed and Predicted Responses for the Higher Order Polynomial Model for the Fit of the Mixture Data Using the NHEK Cells. ● indicate the design locations of the total dose values selected by the Λ₁-optimal design.

FIG. 20: Observed and Predicted Responses for the Higher Order Polynomial Model for the Fit of the Mixture Data Using the NHEK Cells. (Enlarged)

FIG. 21: Observed and model predicted SDH responses using a generalized linear model with power link where 1=0.5.

FIG. 22: Observed and predicted responses for the chlorination mixture along total dose for (A) SDH and (B) the transformed g(m) scale.

FIG. 23. Isobologram for the interaction of the hypnotic effects of chloral hydrate and ethanol in mice.

FIG. 24. Examples of interaction threshold boundaries in a mixture of two chemicals.

FIG. 25. The interaction threshold between ethanol and chloral hydrate (Elliptical Boundary) with number of animals responding (out of 6) st each design point.

FIG. 26. Contours of constant response (Elliptical Boundary).

FIG. 27. Observed responses from mixture data, predicted curves from the SAR interaction threshold model, and the predicted curves from the zero interaction model on the full ray (A) and the reduced ray (B)

FIG. 28. The estimated dose-response curve on the full ray projected onto the reduced ray under the hypothesis of no effect of malathion compared to the observed dose-response curve on the reduced ray using the SAR interaction threshold model.

FIG. 29. Observed responses from mixture data, and predicted curves from the SANR additivity model on the full ray (A) and the SANR interaction model on the reduced ray (B).

### DETAILED DESCRIPTION OF THE PREFERRED EMBODIMENTS OF THE INVENTION

The present invention provides statistical methods for analyzing data obtained by exposing subjects to several different concentrations of a mixture or combination of agents, and observing and quantitating a result or outcome of the exposure. The methods of the present invention allow the determination of whether or not the agents in the combination interact to produce the result or outcome, or whether the outcome is merely due to the simple additive effect of the agents in the combination. If an interaction is detected, the methods allow the determination of how many of the agents interact, whether the interaction is synergistic or antagonistic, and the threshold (minimal) concentration of the combination at which the interaction occurs. In some embodiments of the invention, the particular agents that interact are identified. In addition, the present invention provides methods for designing experiments to obtain appropriate data for analysis.

At all concentrations of a combination that is tested, the relative ratios of the agents in the combination remain constant. The design used in the methods is the ray design, which can be used to study mixtures of drugs or chemicals at a fixed mixing ratio (“fixed-ratio ray”), but in which the total dose (concentration) varies. By “total dose” we mean the total amount of combined agents per dose, concentration or exposure unit of the mixture. This approach simplifies analysis of a study by reducing the dimensionality to a set of 2-dimensional dose response curves. Further, the methods of the present invention may also incorporate data from multiple rays, i.e. data at specific concentrations at two or more fixed-ratios of the agents under consideration.

An example of suitable subject matter for the methods of the present invention is the interaction of chemicals in a mixture of chemicals of interest with respect to eliciting a health disorder in a test subject. In order to obtain data for analysis, test subjects are exposed to increasing concentrations of a mixture of chemicals of interest and some indicator that is symptomatic of the health disorder is measured at each concentration. The relative ratios of the amount of each chemical remain constant at each concentration of the mixture, and the relative ratios of chemicals that are chosen for use in the mixture should (in order to allow for the most relevant influence) have some useful basis. For example, with pesticides, the ratios chosen for the mixture might be those most commonly encountered in the environment. Another example would be the analysis of the interaction of drugs in a mixture of drugs. In this case, the ratios might be chosen to mimic typical doses that would be administered to a patient in a “cocktail”. Some very low concentrations at which the effect is not detectable should be included if possible, and the concentration should be increased until the effect is clearly present in the test subjects, or until a reasonable, useful conclusion can be drawn from the data. Appropriate control subjects should be included.

Using the methods of the present invention, the data so obtained can be analyzed in order to determine whether the symptoms/outcomes that are observed are the result of simple additive contributions of each agent (e.g. a chemical) in the mixture, or whether some of the chemicals in the mixture interact, resulting in a non-additive outcome. If an interaction is detected, the methods of the present invention can be used to determine whether or not the interaction is synergistic (i.e. two or more of the chemicals interact to bring about a stronger response to the mixture than would be predicted if a simple additive effect was being observed) or antagonistic (i.e. two or more of the chemicals interact to attenuate the response that would be predicted to occur in the absence of interactions), and how many of the chemicals interact. By acquiring additional data in which one or more of the chemicals in the fixed ray is removed from the mixture (i.e. by forming a subset and utilizing a reduced ray), it may also be possible to determine which of the chemicals in the subset participates in the interaction, or at least to narrow the possibilities. It is also possible to assay the effect of subsets of agents on other subsets by analyzing each separately and then in combination in a mixture containing all elements of each subset.

Further, multiple rays may be analyzed by testing different mixtures of the same agents in which the relative rations of the agents are varied among the different mixtures. In other words, for a given mixture, the ratio of chemicals within the mixture remains constant at each tested dose, but the ratio varies from mixture to mixture (i.e. from ray to ray).

In addition, using the methods of the present invention, the threshold or minimum concentration at which an interaction among the chemicals is observed can be identified. Determination of such a threshold can be very useful in, for example, recommending guidelines for maximal safe exposure to toxic chemicals. Or, is such an interaction threshold is discovered for a combination of drugs, it would be of benefit to develop methods directed to administering a drug in combinations either above or below the threshold, depending on the desired outcome. The methods of the present invention allow an analysis of potential interactions in these and other systems that will occur to those of skill in the art, and the present invention is intended to encompass all such systems.

The invention also provides methods of experimental design that result in the acquisition of data that is particularly useful for the present analytical methods, as described below.

A major advantage of the methods of the present invention is that, because a mixture of the agents is tested, it is not necessary to acquire data with each agent individually or in all possible combinations. Thus, it is possible to carry out a meaningful analysis of many agents (e.g. dozens or even hundreds) without the necessity of carrying out an impossibly large number of single agent experiments. The invention is especially applicable to the analysis of combinations of three or more agents for which classical methods of analysis would require a prohibitively large number of data points.

The present invention provides two general methods for analyzing data obtained as described above. One method, termed Single Agent Required (SAR), utilizes data acquired with a mixture in conjunction with similar data acquired individually with single components of the mix. The second method, the Single Agent Not Required (SANR) method, requires only data acquired with a mixture/combination.

In order to carry out both the SAR and SANR methods, a suitable system for investigation must be identified, and a database must be generated or located. With respect to generating or identifying data for analysis, those of skill in the art will recognize that many suitable test systems exist for tabulating data points regarding the effect of a mixture on a particular outcome in test subjects. For example, many cell culture and animal model systems exist for ascertaining the result of exposure to mixtures of agents. Examples include but are not limited to: the assessment of cell viability in culture after exposure to the agents, or the assessment of a particular growth characteristic of the cells (e.g. slow or rapid growth, production of a certain product such as an enzyme, induction of mRNA synthesis, transformation rate, etc); for animal models observable results include but are not limited to viability of the animal; development or recession of tumors; the development of a trait such as loss of appetite, lack of motor control, increase or decrease in activity, etc., as well as changes at the level of tissues, organs or cells (e.g. changes in mRNA synthesis, or change in appearance or functioning of tissue, deposition of substances such as cholesterol, etc.). In addition, the outcome that is detected may be less concrete, e.g. an increased or decreased perception of well-being may be observed. Those of skill in the art will recognize that experimental data suitable for analysis by the methods of the present invention may be purposefully generated for such analyses, or may already have been obtained for some other reason, e.g. in a laboratory or clinical study, during the compilation of actuarial tables, etc. Further, the “test subjects” need not be cells or experimental animals, but can be any entity of interest. Examples include but are not limited to persons (e.g. those in clinical trials or studies, or any persons for which data is available), plants, insects, and other living organisms that can be exposed to the mixture of agents, and for which a measurable outcome can be recorded.

In the practice of the present invention, the “agents” in the combination of agents that is analyzed may be of many types. For example, in some cases the agents are chemical entities and the combination is simply a mixture of the chemical entities. Examples include but are not limited to pesticides, drugs, food additives and other ingredients in food (either artificial or naturally occurring, e.g. vitamins, minerals, carbohydrates, lipids, etc.), chemical residues from water treatment, chemical byproducts from manufacturing processes, metals, etc. However, those of skill in the art will recognize that in other cases, one or more “agents” of the combination may be something other than a chemical substance. For example, an agent may be a condition, characteristic, phenomenon or activity that the individuals under study experience, engage in or are exposed to. Examples of such conditions, characteristics, phenomena and activities include but are not limited to receiving a dose or doses of radiation, exposure to sunlight, consumption (or lack thereof) of particular food groups or other food items, time spent in an activity (e.g. meditating, engaging in exercise), height, weight, income level, age, etc. Any “agent” that can be quantified or for which a “dose” can be described, may be utilized in a combination of agents analyzed by the methods of the present invention. For example, methods of the present invention may be used to analyze data in which the variable is a traditional dosage such as number of mg per day; or a description of an activity such as “swims (bikes, walks, etc.) a particular number of times per week”; or variations in income level. In sum, the methods of the present invention may be used to analyze any data type that relates a response variable to levels of an independent variable that can be placed into fixed ratios. Further, some categorical type variables which are not readily described using fixed ratios (e.g. gender, race, adult vs. juvenile, and the like), may nonetheless be analyzed by the methods of the present invention. This is accomplished by designing individual rays as described above and obtaining data for each of the variables of interest. For example, the effect of several concentrations of a mixture of chemicals could be studied in adult individuals and compared to similar date obtained with juvenile individuals.

Likewise, the outcomes of exposure to the mixtures of agents that are analyzed by the present invention can be of a wide variety. For example, the outcome that is measured may be a classical clinical manifestation, and may be generally perceived as “negative” (i.e. undesirable) or “positive” (i.e. desirable) with respect to health. Examples of a negative outcome of exposure to a mixture of agents include but are not limited to development of a disease condition (e.g. cancer, high blood pressure, and many others that will occur to those of skill in the art) or physical impairments (e.g. loss of motor control). In contrast, an outcome may be considered “positive” e.g. reduction in tumor size, increase in life span, weight loss, pain reduction, etc. Further, the outcome may be generally perceived as “neutral” or “arbitrary”, depending on the context, e.g. number of hours spent sleeping. The type of data that is analyzed by the methods of the present invention may be of any suitable type, including but not limited to categorical, count, continuous, time to response, etc.

The SAR method of the present invention may be used to analyze data such as that described above that has been obtained using several different concentrations or “doses” of a mixture/combination of agents along a fixed ratio ray. In the case of SAR, it is also necessary to obtain corresponding single chemical data (i.e. individual data for each chemical in the mixture). In order to carry out the SAR method, the single chemical data are fit to an additivity model, and the mixture data are fit to a mixture model along each ray. Fitting of the single chemical data to an additivity model provides a predicted and estimated graphical representation of the data that would be observed if increasing doses of all the chemicals were administered as a mix, and if the effect of each chemical in the mix is additive and not influenced by the presence of the other chemicals. For example, when using a generalized linear model, the mixture data associated with a fixed ratio are fit to a mixture model in terms of total dose:

g(μₘᵢₓ)=β₀+θ₁*t

where g(μₘᵢₓ) is a specified link function, β₀ is an unknown parameter associated with the overall intercept, and θ₁* is the unknown parameter associated with the slope relating g(μₘᵢₓ) to the total dose, t. By “specified link function” we mean a specified monotone and differentiable function relating the mean to total dose in a linear model. Examples of specified link functions include but are not limited to the logit link often useful for binary data, the log link for count data, and identity link for continuous data, and complementary log-log link for percentage data, etc. In order to achieve adequate fit to the mixture data, higher order terms in total dose are added as necessary. Once both fits are completed, the results are compared. A difference between the mixture data fit compared to that of the fit of the additivity data hypothetical mixture data based on the single chemical data is indicative of a departure from additivity, i.e. the chemicals/agents, when in combination, do not elicit the same additive result that is predicted to occur based on data obtained with individual chemicals/agents. Details of such an analysis are given in the Examples below, where Examples 1-4 describe both SAR and SANR methods, and Example 5 describes SANR in particular.

In addition, it may be desirable to carry out further analyses with a “reduced fixed-ratio ray”, a mixture in which one or more of the chemicals in the original mix (i.e. a subset of the original mix) is removed from the mix while the relative ratios of the retained components remain the same as in the full ray. For example, if, upon elimination of one or more components from the mix, additivity is restored, then this is evidence that the omitted chemical(s) is associated with departure from additivity of the mixture. Methods are included in the invention that allow for statistical hypothesis testing regarding the interaction of subset(s) with the remaining agents in the mixture. Such determinations are carried out using statistical methods based on algebraic manipulations relating full and reduced ray mixture models.

In contrast, for the SANR method, single chemical data are not necessary for the analysis. This is a very valuable technique for cases where single chemical data may be unavailable or unreliable and cannot be used to describe the additive “no interaction” case. The SANR method is based on the assumption of a general parametric form of the underlying response surface such that polynomial terms of degree two or greater for a model along a fixed-ratio array are associated with interactions among the chemicals in a mixture. Rather than use single chemical data, such data are “replaced” by the assumption of the parametric form of the underlying dose response surface. (However, if single chemical data are available, they can be used to support the conclusions obtained with an SANR analysis). In the case of SANR, higher degree terms, which are interpreted as being associated with interactions, are included in the model. To account for general dose-response shapes (e.g. sigmoidal, exponential, etc.) on the ray in terms of total dose caused, for instance, by plateaus, etc., it is necessary to embed the polynomial model of maximum degree c in a general nonlinear model when a generalized linear model is not appropriate. This is done to allow for the polynomial terms to account for the effects of the interaction and not the general shape (e.g. sigmoidal, exponential, etc.) of the dose-response relationship. Such models will be referred to as “suitable polynomial models”. For the case of a generalized linear model, a suitable polynomial model is a polynomial model of degree at most c. In considering the interaction for a mixture of c agents, polynomials with at least 2 and up to c-degree terms are considered, i.e. with respect to the term of the polynomial, i, i=2, . . . c. For example, in a mixture of a full ray of five agents, polynomial models with up to a fifth degree term are considered. Upon fitting the full ray data to a polynomial, the significance of the i^{th} degree term of the polynomial is interpreted as evidence of an i^{th} degree interaction. By “significance of the i^{th} degree term”, we mean that the i^{th} degree term is not equal to zero. However, the significance of the i^{th} degree interaction is not indicative of which components are interacting. In the example of a mix of five agents, ABCDE, if the 4^{th} degree term is found to be significant, then four components are deemed to be interacting. However, five 4-way interactions are possible: ABCD, ABCE, ABDE, ACDE, and BCDE. In order to determine which combination of four components interacts, it is necessary to obtain data with reduced rays for any of the possible five groups of four agents where the relative ratios between agents remains the same as in the full ray. The details of an SANR analysis are given in the Examples below, where Examples 1-4 describe both SAR and SANR methods, and Examples 6 and 7 describe SANR in particular. Further, those of skill in the art will recognize that, while no single chemical data are required for analysis using the SANR method, if such data are available it may be used in conjunction with an SANR analysis.

If, as a result of an SAR or SANR analysis, the hypothesis of additivity is rejected, it is then of interest to determine total dose regions where interactions occur. To that end, a plot of a simultaneous confidence region on the difference in the model fit along the fixed-ratio ray and the additivity model over total dose may identify such regions. Total dose levels where the simultaneous confidence band does not include zero are suggestive of locations and characterization of interaction. Through use of simultaneous confidence bands, the user is assured of at east the nominal level of confidence. The details of such an analysis are given in Example 5 below. From this example, it is clear that along a fixed ratio of the components in the mixture, there are regions of synergy, regions of antagonism, and regions of additivity.

In addition, the present invention provides a method to estimate and to test for the presence of an interaction boundary in the mixture over all possible ratios of the components, i.e. a boundary in the response surface for the combination beyond which interactions among the agents in a mixture exist. Example 8 develops methodology for estimating the boundary equation which illustrates the methodology with a two-component mixture. Once evidence of departure from additivity is obtained through the methods developed in this invention, the hypothesis of an interaction threshold is of interest. If the null hypothesis of no interaction threshold is not rejected, then the interaction may exist throughout the entire dose region. If the null hypothesis is rejected, then the interaction threshold boundary must split the dose region into areas of additivity and interaction, which can be identified. Details of such a determination are given in Example 2 below.

In addition, the present invention provides an iterative method of designing experiments that achieve a target power associated with the test of additivity through the determination of a total sample size, determining the location of data points (i.e. total dose values) and allocation of subjects to these data points. The location of data points and allocation of subjects are achieved through use of optimal experimental design methodology. In order to carry out the method, it is necessary to identify the test system and the agents to be tested. Mixtures/combinations of the agents should be designed so that the agents are present in the mixtures in a constant ratio that is somehow relevant, e.g. a ratio that is likely to occur in the environment. If c agents are in the combination, then c+1 points (at a minimum) should be placed on a ray in order to optimize the criterion of interest associated with the test of additivity. This approach can be applied to tests of the effect of a subset of chemicals on the remaining chemicals (see Example 3). Positioning of the points (i.e. dose location) is determined, for example, by Λ1-optimal design or Ds-optimal design as illustrated in the Examples. Since statistical power is related to total sample size, locations and allocations of experimental subjects to design points (i.e. total doses), the general strategy for planning a mixture study is iterative. The basic steps of the design method are:

Step 1. Specify the target power, significance level, number of mixture dose groups, and the magnitude of the departure from additivity in terms of total dose;

Step 2. Set a candidate total sample size;

Step 3. Express the design optimality criterion as a function of the values specified in steps 1 and 2, and determine the location of total dose groups and the allocation of subjects to these groups that optimize the criterion using a direct search algorithm;

Step 4. Calculate the power associated with the design determined in Step 3. If the power is below the target power, increase the candidate total sample size and repeat Step 3. If the power is above the target power, decrease the candidate total sample size and repeat Step 3. Repeat Steps 3 and 4 until the power associated with the design equals the target power. Details of such design methods are given in Example 4 below.

### EXAMPLES

The following examples are intended to illustrate various embodiments of the invention but are intended for purposes of illustration only and should not be construed so as to limit the invention in any way.

### Example 1

### Detecting Interaction(s) and Assessing the Impact of Component Subsets in a Chemical Mixture Using Fixed-Ratio Mixture Ray Designs

1. Introduction

In 1996, the U.S. government passed the Food Quality Protection Act (FQPA), which directed the EPA to consider cumulative and aggregate exposure in assessing the risk of exposure to chemicals. Due to the variety of agricultural, household, pet, and garden uses of organophosphorus (OP) pesticides, the most widely used pesticides in the United States (Aspelin, 1994), there is high potential for multiple exposures from multiple routes. Cohen (1984), DuBois (1961), McCollister et al. (1959), and others have studied pesticide mixtures. However, these studies have primarily focused on binary chemical combinations and few studies have addressed interaction among organophosphorus pesticides. Other authors (e.g., Ma et al., 2002) suggest some of these pesticides are human carcinogens. Since humans are exposed to these pesticides on a daily bases and there is evidence to suggest exposure leads to adverse human health effects, it is of interest to assess the risk of exposure to environmentally relevant combinations.

In studying relevant combinations of OP pesticides, we are interested in detecting and characterizing departure from additivity, i.e., determining if exposure to combinations of these pesticides results in an increase in the toxic effect above what would be expected under additivity. Traditionally, definitions of additivity are based on the classical isobologram (e.g., Loewe and Muischnek, 1926; Loewe, 1953). One such definition is Berenbaum's interaction index (Berenbaum, 1981), which is algebraically equivalent to the isobologram. The interaction index, II, for combinations of c chemicals, is given by

$$Π = {\sum }_{i = 1}^{c} \frac{{x}_{i}}{{ED}_{μ}^{( i )}} = \{ \begin{matrix}= 1 , & additivity \\ < 1 , & synergism \\ > 1 , & antagonism\end{matrix} \} \qquad ( 1 )$$

where xᵢ represents the dose of the i^{th} component in combination that yields the desired response (EDₘ) and ED_{μ}⁽ⁱ⁾ is the dose of the i^{th} component alone that yields the desired response. When II equals one, the chemicals are said to be additive; otherwise, departure from additivity is claimed. Gennings et al. (1997) illustrated that single chemical dose-response data are necessary and sufficient to support the estimation of an additivity model which is algebraically equivalent to the definition of additivity in (1) when II=1.

The classical design used to test for departure from additivity in a mixture of c chemicals is the factorial design which grows exponentially with c. An alternative to the factorial design is the ray design, described by Martin (1942), Mantel (1958), Finney (1964), Brunden and Vidmar (1989), and others. Ray designs allow researchers to describe the relationship among multiple compounds at fixed mixing ratios of interest. For a given ray, the mixing ratio for c chemicals is defined by [a₁: a₂: . . . :a_{c}] where

$${\sum }_{i = 1}^{c} {a}_{i} = 1.$$

Defining t as the total dose along the mixing ray, the amount of the i^{th} compound in the mixture is aᵢt. As the number of chemicals, c, in the mixture gets large, the experimental effort required to estimate the c+1-dimensional response surface becomes infeasible. Using fractional factorial designs requires the assumption that certain higher-order interactions do not exist and may result in inaccurate representation of nonlinear sigmoid-shaped dose-response relationships. Alternative to focusing on the complete response surface, when inference is directed to relevant fixed-ratios of the c chemicals, the experimental effort is reduced to include c single chemical dose-response curves and dose-response curves in terms of total dose for each fixed-ratio ray of interest.

To motivate the use of these fixed-ratio mixture ray designs consider a study which examines exposure to environmentally relevant pesticides. The OP pesticides chosen for study, based on usage patterns (i.e. pesticides used on same or similar crops) and market share (i.e. highest volume pesticides), were acephate, diazinon, chlorpyrifos, dimethoate, and malathion. Motor activity, a count of the number of passes made across a central area, was used to assess toxicity in healthy adult rats. A full five-pesticide fixed-ratio ray, given by (0.040:0.002:0.031:0.102:0.825) for (acephate:diazinon:chlorpyrifos:dimethoate:malathion), was chosen based on relative dietary exposure estimates of each chemical as projected by the U.S. EPA Dietary Exposure Evaluation Model (DEEM). Since preliminary analysis on single chemical data indicated that malathion is not dose responsive with respect to motor activity and malathion accounts for 82.5% of the total mixture, researchers considered a second fixed-ratio ray, given by (0.2286:0.0114:0.1767:0.5833) for (acephate:diazinon:chlorpyrifos:dimethoate), where malathion was removed from the mixture and the four active pesticides were at the same relative ratios as those considered in the full ray. For example, the ratio of acephate to diazinon along the full ray was 0.040:0.002 which is a 20:1 ratio. Similarly, the ratio of acephate to diazinon along the reduced ray was 0.2286:0.0114 which is also a 20:1 ratio.

In what follows, the methods proposed by Gennings et al. (2002) and Meadows et al (2002) are extended to consider departure from additivity for threshold models along multiple fixed-ratio rays simultaneously. Using the full and reduced rays, methodology is developed for assessing the impact of subsets of chemicals (e.g., malathion) on the mixture. Simultaneous confidence bands on the difference between the additivity model and the model estimated along a fixed-ratio ray, which may elucidate regions where interactions occur, are also developed. This general strategy is developed for two methods of analysis. The first approach, described in section 2, is an extension of the work by Gennings et al. (2002), which uses the single chemical data for estimation of an additivity model. This model is used to predict the dose-response relationship for a mixture of the chemicals along relevant fixed-ratio rays in terms of total dose under the hypothesis of additivity. The observed mixture data are then used to estimate a ‘mixture model’ along the ray(s) of interest. The test of additivity is equivalent to the statistical comparison of these two curves. If the mixture data support a different relationship than predicted from the additivity model estimated by the single chemical data, then departure from additivity is claimed. This first approach is termed the ‘single agents required’ (SAR) method of analysis. A second approach is also developed which extends the work of Meadows et al (2002) who demonstrated that only data along the mixture ray are necessary for detecting departure from additivity. In this ‘single agents not required’ (SANR) method, assumptions are made about the underlying relationship along the rays and the significance of higher-order terms in the polynomial model indicates departure from additivity. In section 3, these methods are extended to consider departure from additivity along multiple fixed-ratio rays simultaneously in the presence or absence of single chemical data. Tests of hypotheses for making inference about interactions due to subsets of chemicals are also developed. The methods are illustrated using a mixture of five OP pesticides in section 4.

2. Methods: Single Agents Required (SAR) Approach

2.1. Model Estimation

In evaluating the risk associated with exposure to mixtures of chemicals, it is often of interest to detect a threshold (Schwartz, 1995). Assuming a quasi-likelihood framework (e.g., Wedderburn, 1974), the threshold additivity model (e.g., Gennings et al., 1997), which relates the doses of the chemicals under study to the mean through a link function, g(m), can be expressed as

$$g ( {μ}_{add} ) = \{ \begin{matrix}\{ \begin{matrix}{β}_{0} & if {\sum }_{i = 1}^{c} {β}_{i} {x}_{i} < δ \\ {β}_{0} + {\sum }_{i = 1}^{c} {β}_{i} {x}_{i} - δ & if {\sum }_{i = 1}^{c} {β}_{i} {x}_{i} \geq δ \end{matrix} \} , if {β}_{i} \geq 0 , ∀ i \\ \{ \begin{matrix}{β}_{0} & if {\sum }_{i = 1}^{c} {β}_{i} {x}_{i} > δ \\ {β}_{0} + {\sum }_{i = 1}^{c} {β}_{i} {x}_{i} - δ & if {\sum }_{i = 1}^{c} {β}_{i} {x}_{i} \leq δ \end{matrix} \} , if {β}_{i} \leq 0 , ∀ i\end{matrix} \qquad ( 2 )$$

where:

g(μ_{add}) is the link function (see McCullagh and Nelder, 1989) of the response of interest,

xᵢ is the dose of the i^{th} single chemical,

β₀ is the unknown parameter associated with the intercept,

βᵢ is the unknown parameter associated with the slope of the i^{th} chemical,

δ is the unknown parameter associate with the threshold, and

$${δ}_{i}^{*} = \frac{δ}{{β}_{i}}$$

is the parameter associated with the dose of the threshold for the i^{th} chemical. The model in (2) is described for both an increasing additivity relationship and for a decreasing additivity relationship. An additivity model should include mixtures of chemicals that are either all nondecreasing or nonincreasing and not a combination of the two cases. If all of the dose thresholds are estimated outside of the experimental region resulting in an overparameterized model, then the corresponding generalized linear model

$$g ( {μ}_{add} ) = {β}_{0} + {\sum }_{i = 1}^{c} {β}_{i} {x}_{i}$$

is used to replace (2).

Let K be the number of fixed-ratio rays under consideration and a₍ₖ₎=[a₁₍ₖ₎, a₂₍ₖ₎, . . . ,a_{c(k)}] define the mixing ratio along the k^{th} fixed-ratio ray. Let x₍ₖ₎=[x₁₍ₖ₎, x₂₍ₖ₎, . . . ,x_{c(k)}] define a vector of doses at a given mixture point and

$$t = {\sum }_{i = 1}^{c} {x}_{i ( k )}$$

define total dose along the k^{th} ray. Following Gennings et al. (2002) and Meadows et al. (2002), when ray designs are considered, total dose is the independent variable along the mixing ray and the amount of the i^{th} compound in the mixture along the k^{th} ray is given by aᵢ₍ₖ₎t. As a result, the threshold additivity model along the k^{th} fixed-ratio ray for increasing curves becomes

$$\begin{matrix}g ( {μ}_{add ( k )} ) = \{ \begin{matrix}{β}_{0} & if {\sum }_{i = 1}^{c} {β}_{i} {a}_{i} t < δ \\ {β}_{0} + {\sum }_{i = 1}^{c} {β}_{i} {a}_{i ( k )} t - δ & if {\sum }_{i = 1}^{c} {β}_{i} {a}_{i} t \geq δ\end{matrix} \\ = \{ \begin{matrix}{β}_{0} & if {θ}_{1 ( k )} t < δ \\ {β}_{0} + {θ}_{1 ( k )} t - δ & if {θ}_{1 ( k )} t \geq δ\end{matrix}\end{matrix} \qquad ( 3 )$$

where

$${θ}_{1 ( k )} = {\sum }_{i = 1}^{c} {β}_{i} {a}_{i ( k )}$$

and the parameter associated with the threshold dose under additivity along the k^{th} ray is given by

$${δ}_{( k )}^{*} = \frac{δ}{{θ}_{1 ( k )}} .$$

Similar results hold for decreasing curves where the inequalities in (3) switch direction. If the estimated dose threshold is outside of the experimental region, then the additivity model along the kth ray is the corresponding generalized linear model given by

g(μ_{add(k)})=β₀+θ₁₍ₖ₎t.

The model, given in (3), is fit to the single chemical data. Now consider the increasing threshold model fit to the mixture data along the k^{th} fixed-ratio ray given by,

$$g ( {μ}_{mix ( k )} ) = \{ \begin{matrix}{β}_{0} & if {θ}_{1 ( k )}^{*} t < {α}_{( k )}^{*} \\ {β}_{0} + {θ}_{1 ( k )}^{*} t - {α}_{( k )}^{*} & if {θ}_{1 ( k )}^{*} t \geq {α}_{( k )}^{*}\end{matrix} \qquad ( 4 )$$

where:

g(μₘᵢₓ₍ₖ₎) is the specified link function of the response of interest (McCullagh and Nelder, 1989),

t is the total dose along the fixed-ratio ray,

β₀ is an unknown parameter associated with the intercept,

θ*₁₍ₖ₎ is the unknown parameter associated with the slope along the k^{th} fixed-ratio ray,

α*₍ₖ₎ is the unknown parameter associated with the threshold along the k^{th} fixed-ratio ray, and

$${α}_{( k )}^{**} = \frac{{α}_{( k )}^{*}}{{θ}_{1 ( k )}^{*}}$$

is the parameter associated with the threshold dose along the k^{th} ray.

In the case where δ*₍ₖ₎ or α**₍ₖ₎ are outside of the experimental region, the threshold model, given by (3) or (4), is an over parameterized model; in particular, if the dose thresholds have estimates less than zero, then there is more than one parameter to describe the intercept. Thus, the corresponding generalized linear model is fit. In the case that δ*₍ₖ₎ is within the experimental region and α**₍ₖ₎ is outside of the experimental region, the threshold additivity model is fit to single chemical data and the corresponding generalized linear model is fit to the mixture data along the k^{th} fixed-ratio ray.

A reasonable simplifying assumption is to consider a common intercept for the additivity and mixture models. If multiple control groups are experimentally evaluated the assumption of a common intercept should be verified by comparing the means of the control groups. As the derivatives of the threshold model are not continuous, linearization algorithms may not converge to solutions. Thus, a direct search algorithm (e.g., the Nelder-Mead simplex algorithm; Nelder and Mead, 1965) may be used to estimate model parameters using the method of maximum quasi-likelihood (McCullagh and Nelder, 1989).

Before testing for departure from additivity, a goodness-of-fit test is performed on the model, given in (4), to ensure that it adequately fits the mixture data. In the event of significant lack-of-fit associated with (4), higher-order terms are added until an appropriate model is determined. Graphical techniques can also be used to assess the fit of the model. Although a goodness-of-fit test may indicate that there is no significant lack-of-fit associated with the first order model, a plot may indicate that a higher-order model provides a more accurate representation of the data. Since the goal is to adequately represent the mixture data along the fixed-ratio rays with a given parametric model before testing for departure from additivity, both goodness-of-fit tests and graphical methods are considered.

2.2 Hypothesis Testing

Following the logic of Gennings et al. (2002), if the relationship between the compounds is additive, the parameters along the mixture curves will be equivalent to those predicted under additivity. Thus, the overall test for departure from additivity (assuming a common intercept and higher-order terms are not necessary to improve the fit of the model) is given by,

$${H}_{0} : {b}_{add} γ = [ \begin{matrix}{θ}_{1 ( 1 )}^{*} = {\sum }_{i = 1}^{c} {β}_{i} {a}_{i ( 1 )} \\ {α}_{( 1 )}^{*} = δ \\ ⋮ \\ {θ}_{1 ( K )}^{*} = {\sum }_{i = 1}^{c} {β}_{i} {a}_{i ( K )} \\ {α}_{( K )}^{*} = δ\end{matrix} ] , \qquad ( 5 )$$

where the px1 vector γ=[β₀, β₁, β₂, . . . , β_{c}, δ, θ*₁₍₁₎, α*₍₁₎, θ*₁₍₂₎, α*₍₂₎. . . , θ*_{1(K)}, α*_{(K)}]′ is a vector of model parameters and b_{add} is an appropriate 2Kxp contrast matrix. In a more general case where higher-order terms are required or the models allow for different intercepts, the additional parameters are added to γ and b_{add} is adjusted appropriately. Under additivity, higher-order terms are zero and the intercept under additivity is equivalent to those along the fixed-ratio rays.

A Wald-type test for testing the hypothesis given in (5), is given by

$$W = \frac{{{( b \hat{γ} )}^{′} [ b Ω {b}^{′} ]}^{- 1} ( b \hat{γ} )}{M τ} , \qquad ( 6 )$$

where τΩ is the variance-covariance matrix of \hat{γ} and b is any contrast matrix (e.g. b_{add}). Since \hat{γ} is distributed asymptotically normal (McCullagh and Nelder, 1989) with mean γ and variance τΩ, it follows that W is approximately distributed chi-square with M degrees-of-freedom (M=2K for the hypothesis given in (5)). The moment estimate for t is expressed as

$$\hat{τ} = \frac{1}{( N - p )} {\sum }_{i , j}^{} \frac{{( {y}_{ij} - {\hat{μ}}_{i} )}^{2}}{V ( {\hat{μ}}_{i} )} = \frac{{X}^{2}}{( N - p )} , \qquad ( 7 )$$

where X² is the generalized Pearson statistic (McCullagh and Nelder, 1989), which is asymptotically distributed chi-square with N−p degrees of freedom. In the quasi-likelihood framework, McCullagh (1983) defines the large sample variance-covariance matrix for \hat{γ} as τ[I(γ)]⁻¹, where I(g) is the expected quasi-information matrix. Let N be the number of observations. McCullagh (1983) expressed the expected quasi-information matrix as

$$I ( γ ) = {{D}^{′} ( V ( μ ) )}^{- 1} D \\ where \\ D = {[ \frac{\partial {μ}_{i}}{\partial {γ}_{j}^{′}} ]}_{\begin{matrix}i = 1 , 2 , … , N \\ j = 1 , 2 , … , p\end{matrix}} and V ( μ ) = [ \begin{matrix}V ( {μ}_{1} ) & 0 & ⋯ & 0 \\ 0 & V ( {μ}_{2} ) & ⋯ & 0 \\ ⋮ & ⋮ & ⋰ & 0 \\ 0 & 0 & ⋯ & V ( {μ}_{N} )\end{matrix} ] . \qquad ( 8 )$$

Replacing γ with \hat{γ} in (8), \hat{Ω}=[I(\hat{γ})]⁻¹ is a consistent estimate for W (McCullagh, 1983). Replacing τ with \hat{τ} and W with \hat{Ω} in (6), W is approximately distributed F with M numerator degrees of freedom and N−p denominator degrees of freedom, where p is the number of parameters. (Note that when higher-order terms are added along the fixed-ratio rays to improve the fit of the model or when multiple intercepts are considered, these parameters must be accounted for in the numerator and denominator degrees-of-freedom).

In the case that the simultaneous test, given in (5), is rejected, two degree-of-freedom tests can be used to detect departure from additivity along individual rays using Hochberg's correction for multiple testing, (Hochberg, 1988), which is useful in maintaining the overall significance level, α Hochberg's method is a refinement of the Bonferroni adjustment procedure. It is a sequential procedure in which all p-values are ranked from smallest to largest and the r^{th} p-value is compared to

$$\frac{α}{M - r + 1} ,$$

where M is the total number of tests. If p-value₍ᵣ₎

$$\leq \frac{α}{M - r + 1} ,$$

then the r^{th} hypothesis and all hypotheses with subsequently smaller p-values are rejected.

2.3. Simultaneous Confidence Band

If the hypothesis of additivity is rejected, it is of interest to determine total dose regions where interactions occur. A plot of a simultaneous confidence region on the difference in the model fit along the fixed-ratio ray and the additivity model over total dose may identify such regions. In order to accommodate the construction of the simultaneous confidence band, differences in the two models are considered on the ‘linearized’ g(μ) scale. Consider the simultaneous confidence band for the k^{th} fixed-ratio ray. For an increasing dose-response curve along the k^{th} fixed-ratio ray, define ρ₍ₖ₎(t)=g(μ_{add(k)})−g(μₘᵢₓ₍ₖ₎) as the difference between the transformed response model for the curve under additivity and that fit to the mixture data. Conditioning on values of the dose threshold parameters along the ray, δ*₍ₖ₎⁰ and α**₍ₖ₎⁰, the threshold models can be written as two-phase linear models

$$g ( {μ}_{add ( k )} ) = {β}_{0} + ( {\sum }_{i = 1}^{c} {β}_{i} {a}_{i ( k )} t - δ ) {I}_{( t > {δ}_{( k )}^{* 0} )}$$

g(μₘᵢₓ₍ₖ₎)=β₀+(θ*₁₍ₖ₎t−α*₍ₖ₎)I_{(t>α**}_{₍ₖ₎}_{⁰}₎,

where I_{t>δ*}_{₍ₖ₎}^{₀}₎ is an indicator function that takes on a value of one if the total dose value along the k^{th} ray is greater than the estimated threshold dose under additivity along the k^{th} ray and zero otherwise. Similarly I_{(t>α**}_{₍ₖ₎}^{₀}₎ is an indicator function that takes on a value of one if the total dose value along the k^{th} ray is greater than the estimates threshold dose from the model along the ray and zero otherwise.

Let x* correspond to the px1 vector of total dose such that

$${ρ}_{( k )} ( t ) = {x}^{{*}^{′}} γ .$$

Following Carter et al. (1986) and using the Cauchy-Schwartz inequality, it can be shown that conditional on the dose threshold parameter values,

$${sup}_{t ∈ ℜ} [ \frac{{( {x}^{{*}^{′}} ( \hat{γ} - γ ) )}^{2}}{p \hat{τ} ( {x}^{{*}^{′}} \hat{Ω} {x}^{*} )} ] \leq \frac{{( \hat{γ} - γ )}^{′} \hat{Ω} ( \hat{γ} - γ )}{p \hat{τ}} ∼ {F}_{p , N - p} .$$

This leads to the following conservative probability statement

$$P [ \frac{{( {x}^{{*}^{′}} ( \hat{γ} - γ ) )}^{2}}{p \hat{τ} ( {x}^{{*}^{′}} \hat{Ω} {x}^{*} )} \leq {F}_{p , N - p ; 1 - α} ∀ t ∈ ℜ ] \geq 1 - α$$

which can be manipulated to yield a conservative simultaneous confidence band on

$${x}^{{*}^{′}} γ$$

such that the conditional 100(1−α)% simultaneous confidence band on ρ₍ₖ₎(t) is

P[\hat{ρ}_{L}(t)≦ρ₍ₖ₎(t)≦\hat{ρ}_{U}(t) for all tε [symbol] ]≧1−α, (9)

where

$${\hat{ρ}}_{L} ( t ) = {x}^{{*}^{′}} \hat{γ} - {[ p \hat{τ} ( {x}^{{*}^{′}} \hat{Ω} {x}^{*} ) {F}_{p , N - p ; 1 - α} ]}^{\frac{1}{2}} and {\hat{ρ}}_{U} ( t ) = {x}^{{*}^{′}} \hat{γ} + {[ p \hat{τ} ( {x}^{{*}^{′}} \hat{Ω} {x}^{*} ) {F}_{1 , n - p ; 1 - α} ]}^{\frac{1}{2}} . \qquad ( 9 )$$

2.4. Assessing the Impact of Subsets of Chemicals

In addition to simultaneous confidence bands, researchers may be interested in studying the effect of particular compounds on the remaining components in a mixture. For example, consider a five chemical mixture where researchers are interested in studying the effect of the fifth chemical on the remaining components of the mixture. This requires the collection of data along an additional ray where the fifth chemical is removed from the mixture and the remaining components are at the same relative ratios as those given in the full mixture (i.e.

$$( i . e . \frac{{a}_{i ( full )}}{{a}_{j ( full )}} = \frac{{a}_{i ( reduced )}}{{a}_{j ( reduced )}} ) .$$

The subscript ‘full’ denotes values associated with the full five chemical mixture and the subscript ‘reduced’ denotes values associated with the mixture where the fifth chemical was removed.

Recall for a given dose point t_{full}=x₁+x₂+x₃+x₄+x₅ and x₅=a_{5(full)}t_{full}. Consider the following relationship

$$\begin{matrix}{t}_{reduced} = {x}_{1} + {x}_{2} + {x}_{3} + {x}_{4} \\ = {t}_{full} - {x}_{5} \\ = {t}_{full} - {a}_{5 ( full )} {t}_{full} \\ = ( 1 - {a}_{5 ( full )} ) {t}_{full} & ⇒ \frac{{t}_{reduced}}{( 1 - {a}_{5 ( full )} )} = {t}_{full} . & ( 10 ) \end{matrix}$$

Given the relationship described above in (10), we can develop hypotheses that compare model parameters along the full and reduced rays. Under the null hypothesis that the fifth chemical does not have an effect on the mixture g(μ_{(full)})=g(μ_{(reduced)}) where

$$g ( {μ}_{( full )} ) = \{ \begin{matrix}{β}_{0} & if {θ}_{1 ( full )}^{*} {t}_{full} < {α}_{( full )}^{*} \\ {β}_{0} + {θ}_{1 ( full )}^{*} {t}_{full} - {α}_{( full )}^{*} & if {θ}_{1 ( full )}^{*} {t}_{full} \geq {α}_{( full )}^{*}\end{matrix} ⇒ \\ g ( {μ}_{( full )} ) = \{ \begin{matrix}{β}_{0} & if \frac{{θ}_{1 ( full )}^{*} {t}_{reduced}}{( 1 - {a}_{5 ( full )} )} < {α}_{( full )}^{*} \\ {β}_{0} + \frac{{θ}_{1 ( full )}^{*} {t}_{reduced}}{( 1 - {a}_{5 ( full )} )} - {α}_{( full )}^{*} & if \frac{{θ}_{1 ( full )}^{*} {t}_{reduced}}{( 1 - {a}_{5 ( full )} )} \geq {α}_{( full )}^{*}\end{matrix} \\ and \\ g ( {μ}_{( reduced )} ) = \{ \begin{matrix}{β}_{0} & if {θ}_{1 ( reduced )}^{*} {t}_{reduced} < {α}_{( reduced )}^{*} \\ {β}_{0} + {θ}_{1 ( reduced )}^{*} {t}_{reduced} - {α}_{( reduced )}^{*} & if {θ}_{1 ( reduced )}^{*} {t}_{reduced} \geq {α}_{( reduced )}^{*}\end{matrix} .$$

Thus, the hypothesis that the fifth chemical does not have an effect on the mixture is given by

$${H}_{0} \text{:} {b}_{interact} γ = [ \begin{matrix}\frac{{θ}_{1 ( full )}^{*}}{( 1 - {a}_{5 ( full )} )} = {θ}_{1 ( reduced )}^{*} \\ {α}_{( full )}^{*} = {α}_{( reduced )}^{*} \end{matrix} ] \qquad ( 11 )$$

where γ=[β₀, β₁, β₂, β₃, β₄, β₅, δ, θ*_{1(full)}, α*_{(full)}, θ*_{1(reduced)}, α*_{(reduced)}]′ and

$${b}_{interact} = [ \begin{matrix}0 & 0 & 0 & 0 & 0 & 0 & 0 & \frac{1}{( 1 - {a}_{5 ( full )} )} & 0 & - 1 & 0 \\ 0 & 0 & 0 & 0 & 0 & 0 & 0 & 0 & 1 & 0 & - 1\end{matrix} ] .$$

The Wald-type test, given in (6) is used to test this hypothesis.

3. Methods: Single Agents Not Required (SANR) Approach

The general strategy of the SAR method, as specified in the name, is that single chemical dose-response data are required to estimate the additivity surface. Investigators may not have the resources to conduct single agent studies when the number of chemicals in the mixture is large (as in a complex mixture where thousands of chemicals may be present). Or, when the single chemical data and the mixture data are not conducted concurrently, there may be evidence of shifts in the dose-responsiveness of the chemicals over time. Therefore, it is of interest to develop a method for testing for departure from additivity for the case where single chemical data are not available (so that the additivity surface is not estimable). In addition, we assume the mixture data are taken on fixed-ratio rays of the mixture(s) of chemicals. Since we are generally interested in risk assessment where threshold models are useful, we develop the SANR method using threshold models.

3.1 Test of Additivity

Carter et al. (1988) demonstrated that when the model parameters associated with interactions (i.e., cross-product terms) in a generalized linear model are equal to zero the interaction index is equal to one, which implies an additive relationship. Thus, the significance of cross-product terms is associated with departure from additivity, i.e., interaction.

In the SANR method of analysis the general form of the response surface (interaction) model for a mixture of c chemicals is assumed to be given by

$$g ( {μ}_{mix} ) = {β}_{0} + {\sum }_{i = 1}^{c} {β}_{i} {x}_{i} + {{\sum }_{i = 1}^{c} {\sum }_{j = 1}^{c}}_{i < j} {β}_{ij} {x}_{i} {x}_{j} + {{\sum }_{i = 1}^{c} {\sum }_{j = 1}^{c} {\sum }_{l = 1}^{c}}_{i < j < l} {β}_{ijl} {x}_{i} {x}_{j} {x}_{l} + … + {β}_{123 … c} {x}_{1} {x}_{2} … {x}_{c}$$

for a generalized linear model. Following Schwartz et al (1995), the extension of this model, which allows for a threshold, is given by

$$g ( {μ}_{mix} ) = \{ \begin{matrix}{β}_{0} , & A ( x ) < δ \\ {β}_{0} + A ( x ) - δ , & A ( x ) \geq δ\end{matrix} \}$$

$$A ( x ) = {\sum }_{i = 1}^{c} {β}_{i} {x}_{i} + {{\sum }_{i = 1}^{c} {\sum }_{j = 1}^{c}}_{i < j} {β}_{ij} {x}_{i} {x}_{j} + {{\sum }_{i = 1}^{c} {\sum }_{j = 1}^{c} {\sum }_{l = 1}^{c}}_{i < j < l} {β}_{ijl} {x}_{i} {x}_{j} {x}_{l} + … + {β}_{123 … c} {x}_{1} {x}_{2} … {x}_{c}$$

for increasing relationships; the inequalities are switched for decreasing relationships.

When ray designs are considered, total dose is the independent variable along the mixing ray and the amount of the i^{th} compound in the mixture along the k^{th} ray is given by aᵢ₍ₖ₎t. Let K be the number of fixed-ratio rays under consideration and a₍ₖ₎=[a₁₍ₖ₎, a₂₍ₖ₎, . . . ,a_{c(k)}] define the mixing ratio along the k^{th} fixed-ratio ray. Let x₍ₖ₎=[x₁₍ₖ₎, x₂₍ₖ₎, . . . ,x_{c(k)}] define a vector of doses at a given mixture point and

$$:= {\sum }_{i = 1}^{c} {x}_{i ( k )}$$

define total dose along the k^{th} ray. As a result, x₍ₖ₎=a₍ₖ₎t and the interaction model along the k^{th} ray can be expressed as (Meadows et al., 2002)

$$g ( {μ}_{mix ( k )} ) = \{ \begin{matrix}{β}_{0} & if {θ}_{1 ( k )}^{*} t + {\sum }_{i = 2}^{{c}_{k}} {θ}_{i ( k )}^{*} {t}^{i} < {α}_{( k )}^{*} \\ {β}_{0} + {θ}_{1 ( k )}^{*} t + {\sum }_{i = 2}^{{c}_{k}} {θ}_{i ( k )}^{*} {t}^{i} - {α}_{( k )}^{*} & if {θ}_{1 ( k )}^{*} t + {\sum }_{i = 2}^{{c}_{k}} {θ}_{i ( k )}^{*} {t}^{i} \geq {α}_{( k )}^{*}\end{matrix} \} \\ where \text{:} \\ {θ}_{1 ( k )}^{*} = {\sum }_{i = 1}^{{c}_{k}} {β}_{i} {a}_{i ( k )} ; {θ}_{2 ( k )}^{*} = {{\sum }_{i = 1}^{{c}_{k}} {\sum }_{j = 1}^{{c}_{k}}}_{i < j} {β}_{ij} {a}_{i ( k )} {a}_{j ( k )} ; {θ}_{3 ( k )}^{*} = {{\sum }_{i = 1}^{{c}_{k}} {\sum }_{j = 1}^{{c}_{k}} {\sum }_{l = 1}^{{c}_{k}}}_{i < j < l} {β}_{ijl} {a}_{i ( k )} {a}_{j ( k )} {a}_{l ( k )} ; etc . , \qquad ( 12 )$$

θ*₁₍ₖ₎ is the unknown parameter associated with the first-order term,

θ*ᵢ₍ₖ₎ for i=2 . . . cₖ is the unknown parameter associated with the i^{th} way interaction, t is total dose,

cₖ is the number of chemicals under study along the k^{th} fixed-ratio ray, and

α*₍ₖ₎ is the threshold parameter..

It follows that second order terms are associated with two-way interactions, third order terms are associated with three-way interactions, etc.

The model is generally fit simultaneously to the K fixed-ratio rays assuming a common intercept. If multiple vehicle control groups are experimentally evaluated, a comparison of the control group means is necessary to verify the common intercept assumption. Notice that when single chemical data are not available, the parameters in the underlying response surface are not estimable, so that the linear parameters θ*₁₍ₖ₎ are estimated directly and not under the constraint that

$${θ}_{1 ( k )}^{*} = {\sum }_{i = 1}^{{c}_{k}} {β}_{i} {a}_{i ( k )} .$$

Parameter estimates are found by maximizing the quasi-likelihood (McCullagh and Nelder, 1989). When the threshold estimate associated with total dose along the k^{th} mixing ray is not within the experimental region, the corresponding generalized linear model is used, i.e.,

$$g ( {μ}_{mix ( k )} ) = {β}_{0} + {θ}_{1 ( k )}^{*} t + {\sum }_{i = 2}^{{c}_{k}} {θ}_{i ( k )}^{*} {t}^{i} \qquad ( 12 b )$$

Following the definition of additivity provided in Section 2 and the methods described by Meadows et al. (2002), the parameters associated with interaction along the K fixed-ratio rays, namely (θ*₂₍₁₎, θ*₂₍₁₎, . . . ,θ*_{c}_{₁}₍₁₎, θ*₂₍₂₎, θ*₃₍₂₎, . . . , θ*_{c}_{₂}₍₂₎, . . . , θ*_{2(K)}, θ*_{3(K)}, . . . , θ*_{c}_{_{K}}_{(K)}), are zero under the hypothesis of additivity. Define the px1 vector γ=[β₀, θ*₁₍₁₎, θ*₂₍₁₎, . . . , θ*_{c}_{₁}₍₁₎, . . . , θ*_{1(K)}, θ*_{2(K)}, . . . , θ*_{c}_{_{K}}_{(K)}]′ as a vector of model parameters and define b_{add} as a matrix of zeros and ones such that

b_{add} γ=[θ*₂₍₁₎, θ*₃₍₁₎, . . . , θ*_{c}_{₁}₍₁₎, . . . , θ*_{2(K)}, . . . , θ*_{c}_{ₖ}_{(K)}]′.

An overall hypothesis of additivity, based on the significance of higher-order terms, is given by

H₀:b_{add}γ=0 (13)

which can be tested using the Wald-type test described in (6) with scale parameter estimated as in (7).

3.2 Testing the Impact of Subsets of Chemicals

The methods described in Section 3.1 do not provide specific information about which of the compounds are interacting with one another. For example, consider a four chemical mixture study where all of the available data are fit to the interaction model given in (12). Let (a_{1(full)}: a_{2(full)}: a_{3(full)}: a_{4(full)}) denote the mixing ratio (subscript ‘full’ denotes the model fit to the mixture where the ratios associated with all the compounds are non zero). The model along the fixed-ratio ray is given by,

$$g ( {μ}_{( full )} ) = \{ \begin{matrix}{β}_{0} & if {θ}_{1 ( full )}^{*} t + {\sum }_{i = 2}^{4} {θ}_{i ( full )}^{*} {t}^{i} < {α}_{( full )}^{*} \\ {β}_{0} + {θ}_{i ( full )}^{*} t + {\sum }_{i = 2}^{4} {θ}_{i ( full )}^{*} {t}^{i} - {α}_{( full )}^{*} & if {θ}_{1 ( full )}^{*} t + {\sum }_{i = 2}^{{c}_{k}} {θ}_{i ( full )}^{*} {t}^{i} \geq {α}_{( full )}^{*}\end{matrix} \} \qquad ( 14 )$$

where:

θ*_{1(full)}=β₁a_{1(full)}+β₂a_{2(full)}+β₃a_{3(full)}+β₄a_{4(full)},

θ*_{2(full)}=β₁₂a_{1(full)}a_{2(full)}+β₁₃a_{1(full)}a_{3(full)}+β₁₄a_{1(full)}a_{4(full)}+β₂₃a_{2(full)}a_{3(full)}+β₂₄a_{2(full)}a_{4(full)}+β₃₄a_{3(full)}a_{4(full)},

θ*_{3(full)}=β₁₂₃a_{1(full)}a_{2(full)}a_{3(full)}+β₁₂₄a_{1(full)}a_{2(full)}a_{4(full)}+β₁₃₄a_{1(full)}a_{3(full)}a_{4(full)}+β₂₃₄a_{2(full)}a_{3(full)}a_{4(full)}, and

θ*_{4(full)}=β₁₂₃₄a_{1(full)}a_{2(full)}a_{3(full)}a_{4(full)}.

Suppose that θ*_{4(full)}=0, but θ*_{3(full)}≠0, i.e. significant third-order interactions are detected. Since θ*_{3(full)}≠0, at least one three-factor interaction exists. Unfortunately, there is not enough information on the single ray to determine which of the compounds are involved in this interaction. Meadows (2001) suggests performing

$$( \begin{matrix}4 \\ 3\end{matrix} ) = 4$$

additional experiments each with a combination of three of the compounds at the same relative ratios as those used in the original ray (i.e.

$$( i . e . \frac{{a}_{i ( full )}}{{a}_{j ( full )}} = \frac{{a}_{i ( reduced )}}{{a}_{j ( reduced )}}$$

where ‘reduced’ refers to a mixture where one of the four chemicals is removed). While these additional experiments allow one to determine which chemicals are involved in a particular interaction, the experimental effort may become infeasible as the number of chemicals under study increases.

An alternative to performing

$$( \begin{matrix}c \\ j\end{matrix} )$$

additional experiments is to consider how a particular compound or subset of compounds interacts with the remaining j components of the mixture. Consider the four chemical mixture example described above. Suppose it is of interest to determine if the fourth chemical is involved in a three-factor interaction. This can be accomplished by performing an additional experiment with the remaining three chemicals using the same relative ratios as those considered along the original ray.

Recall the model given in (14) and consider the model fit to the three chemical mixture (parameters denoted with subscript ‘reduced’) given by,

$$g ( {μ}_{( reduced )} ) = \{ \begin{matrix}{β}_{0} & if {θ}_{1 ( reduced )}^{*} t + {\sum }_{i = 2}^{3} {θ}_{i ( reduced )}^{*} {t}^{i} < {α}_{( reduced )}^{*} \\ {β}_{0} + {θ}_{1 ( reduced )}^{*} t + {\sum }_{i = 2}^{3} {θ}_{i ( reduced )}^{*} {t}^{i} - {α}_{( reduced )}^{*} & if {θ}_{1 ( reduced )}^{*} t + {\sum }_{i = 2}^{3} {θ}_{i ( reduced )}^{*} {t}^{i} \geq {α}_{( reduced )}^{*}\end{matrix} \} \qquad ( 15 )$$

where:

θ*_{1(reduced)}β₁a_{1(reduced)}+β₂a_{2(reduced)}+β₃a_{3(reduced)},

θ*_{2(reduced)}=β₁₂a_{1(reduced)}a_{2(reduced)}+β₁₃a_{1(reduced)}a_{3(reduced)}+β₂₃a_{2(reduced)}a_{3(reduced)}, and

θ*_{3(reduced)}=β₁₂₃a_{1(reduced)}a_{2(reduced)}a_{3(reduced)}.

Since the three chemical experiment is performed at the same relative ratios as those in the original ray,

$$\frac{{a}_{i ( full )}}{{a}_{j ( full )}} = \frac{{a}_{i ( reduced )}}{{a}_{j ( reduced )}} .$$

Therefore,

$${β}_{123} \frac{{a}_{1 ( full )} {a}_{2 ( full )} {a}_{3 ( full )}}{{( {a}_{1 ( full )} )}^{3}} = {β}_{123} \frac{{a}_{1 ( reduced )} {a}_{2 ( reduced )} {a}_{3 ( reduced )}}{{( {a}_{1 ( reduced )} )}^{3}} = \frac{{θ}_{3 ( reduced )}^{*}}{{( {a}_{1 ( reduced )} )}^{3}}$$

and

$$\frac{{θ}_{3 ( full )}^{*}}{{( {a}_{1 ( full )} )}^{3}}$$

from (14) becomes

$$\begin{matrix}\frac{{θ}_{3 ( full )}^{*}}{{( {a}_{1 ( full )} )}^{3}} = \frac{{θ}_{3 ( reduced )}^{*}}{{( {a}_{1 ( reduced )} )}^{3}} = {β}_{124} \frac{{a}_{1 ( full )} {a}_{2 ( full )} {a}_{4 ( full )}}{{( {a}_{1 ( full )} )}^{3}} + \\ {β}_{134} \frac{{a}_{1 ( full )} {a}_{3 ( full )} {a}_{4 ( full )}}{{( {a}_{1 ( full )} )}^{3}} + {β}_{234} \frac{{a}_{2 ( full )} {a}_{3 ( full )} {a}_{4 ( full )}}{{( {a}_{1 ( full )} )}^{3}} ⇒ \\ \frac{{θ}_{3 ( full )}^{*}}{{( {a}_{1 ( full )} )}^{3}} - \frac{{θ}_{3 ( reduced )}^{*}}{{( {a}_{1 ( reduced )} )}^{3}} = {β}_{124} \frac{{a}_{1 ( full )} {a}_{2 ( full )} {a}_{4 ( full )}}{{( {a}_{1 ( full )} )}^{3}} + \\ {β}_{134} \frac{{a}_{1 ( full )} {a}_{3 ( full )} {a}_{4 ( full )}}{{( {a}_{1 ( full )} )}^{3}} + {β}_{234} \frac{{a}_{2 ( full )} {a}_{3 ( full )} {a}_{4 ( full )}}{{( {a}_{1 ( full )} )}^{3}} .\end{matrix}$$

Now consider the hypothesis given by,

$${H}_{0} : [ \frac{{θ}_{3 ( full )}^{*}}{{( {a}_{1 ( full )} )}^{3}} - \frac{{θ}_{3 ( reduced )}^{*}}{{( {a}_{1 ( reduced )} )}^{3}} ] = 0 ⇔ {H}_{0} : [ \begin{matrix}{β}_{124} \\ {β}_{134} \\ {β}_{234}\end{matrix} ] = 0. \qquad ( 16 )$$

In the case that there is not sufficient evidence to reject this hypothesis and the study is reasonably powered, we conclude that chemical four is not involved in a three-factor interaction and the other three additional experiments suggested by Meadows (2001) are not necessary. If there is sufficient evidence to reject the hypothesis, we conclude the fourth chemical is involved in at least one three-factor interaction. However, without further experimentation we cannot determine which of the three interactions involving this chemical are significant.

As an alternative to considering the effect of chemical four on three-way interactions alone, it may be of interest to test the hypothesis that the fourth chemical is not involved in any interactions with the remaining components of the mixture. This is done by simultaneously testing the effect of chemical four on two and three-way interactions. The hypothesis that chemical four is not involved in any interactions with the remaining three chemicals is given by

$$\begin{matrix}{H}_{0} \text{:} & {b}_{interact} γ = [ \begin{matrix}\frac{{θ}_{2 ( full )}^{*}}{{( {a}_{1 ( full )} )}^{2}} - \frac{{θ}_{2 ( reduced )}^{*}}{{( {a}_{1 ( reduced )} )}^{2}} \\ \frac{{θ}_{3 ( full )}^{*}}{{( {a}_{1 ( full )} )}^{3}} - \frac{{θ}_{3 ( reduced )}^{*}}{{( {a}_{1 ( reduced )} )}^{3}}\end{matrix} ] = 0\end{matrix} \qquad ( 17 )$$

where γ=[β₀, θ*_{1(full)}, θ*_{2(full)}, θ*_{3(full)}, θ*_{1(reduced)}, θ*_{2(reduced)}, θ*_{3(reduced)}]′ and

$${b}_{interact} = [ \begin{matrix}0 & 0 & \frac{1}{{( {a}_{1 ( full )} )}^{2}} & 0 & 0 & - \frac{1}{{( {a}_{1 ( reduced )} )}^{2}} & 0 \\ 0 & 0 & 0 & \frac{1}{{( {a}_{1 ( full )} )}^{3}} & 0 & 0 & - \frac{1}{{( {a}_{1 ( reduced )} )}^{3}}\end{matrix} ] .$$

In general, consider the c-chemical mixture model given by,

g(μₘᵢₓ)=β₀+θ*₁t+θ*₂t²+θ*₃t³+θ*₄t⁴+ . . . +θ*ⱼt^{j}+θ*ⱼ₊₁t^{j+1}+ . . . +θ*_{c}t^{c}.

First, test H₀: θ*ᵢ=0 ∀i=2, . . . ,c. If there is sufficient evidence to reject this hypothesis, additional experiments with j (≧h) chemicals, at the same relative ratios as the original experiment, will provide further information about the h-factor interaction. The hypothesis of interest is given by,

$$\begin{matrix}{H}_{0} \text{:} & [ \frac{{θ}_{h ( full )}^{*}}{{( {a}_{1 ( reduced )} )}^{h}} - \frac{{θ}_{h ( reduced )}^{*}}{{( {a}_{1 ( reduced )} )}^{h}} ] = 0 & ⇒\end{matrix} \qquad ( 18 )$$

H₀: All h-chemical interactions involving chemicals j+1, j+2, . . . , or c are equal to zero.

(Note that the denominators in the hypotheses given above do not have to be (a_{1(full)})^{h} and (a_{1(reduced)})^{h}. We could have chosen (a_{2(full)})^{h} and (a_{2(reduced)})^{h}, or (a_{3(full)})^{h}, and (a_{3(reduced)})^{h}, etc). Table 1 provides a list of possible hypotheses when a subset of c chemicals is considered. The Wald-type test, given in (6) and (7), is used to test the hypotheses, developed in this section, that consider interactions due to subsets of chemicals.

TABLE 1
Possible hypothesis when an additional experiment is run with a subset of the original compounds under study.

| C Chemical Study | J Chemical Study (J < C) | Hypothesis Tested | Equivalent Hypothesis |
|---|---|---|---|
| θ_{c} = β_{12345...c} | — | H₀: θ_{c} = 0 | H₀: β_{12345...c} = 0 |
| $\begin{matrix}{θ}_{c - 1} = {\sum }_{{i}_{1} = 1}^{c} {\sum }_{{i}_{2} = 1}^{c} … {\sum }_{{i}_{j} = 1}^{c} … {\sum }_{{i}_{c - 1} = 1}^{c} {β}_{{i}_{1} {i}_{2} {i}_{3} … {i}_{c - 1}} {a}_{{i}_{1}} {a}_{{i}_{2}} {a}_{{i}_{3}} … {a}_{{i}_{c - 1}} \\ {i}_{1} < {i}_{2} < … < {i}_{j} < … < {i}_{c - 1}\end{matrix}$ | — | H₀: θ_{c-1} = 0 | H₀: All (c − 1)-chemical interactions are equal to zero |
| . | . | . | . |
| . | . | . | . |
| . | . | . | . |
| $\begin{matrix}{θ}_{j + 1} = {\sum }_{{i}_{1} = 1}^{c} {\sum }_{{i}_{2} = 1}^{c} … {\sum }_{{i}_{j = 1} = 1}^{c} {β}_{{i}_{1} {i}_{2} {i}_{3} … {i}_{j + 1}} {a}_{{i}_{1}} {a}_{{i}_{2}} {a}_{{i}_{3}} … {a}_{{i}_{j + 1}} \\ {i}_{1} < {i}_{2} < … < {i}_{j + 1}\end{matrix}$ | — | H₀: θⱼ₊₁ = 0 | H₀: All (j + 1)-chemical interactions are equal to zero |
| $\begin{matrix}{θ}_{j} = {\sum }_{{i}_{1} = 1}^{c} {\sum }_{{i}_{2} = 1}^{c} … {\sum }_{{i}_{j = 1} = 1}^{c} {β}_{{i}_{1} {i}_{2} {i}_{3} … {i}_{j + 1}} {a}_{{i}_{1}} {a}_{{i}_{2}} {a}_{{i}_{3}} … {a}_{{i}_{j + 1}} \\ {i}_{1} < {i}_{2} < … < {i}_{j}\end{matrix}$ | ${θ}_{j}^{*} = {β}_{123 … ( j - 1 ) j} {a}_{1}^{*} {a}_{2 }^{*} … {a}_{j - 1}^{*} {a}_{j}^{*}$ | ${H}_{0} \text{:} \frac{{θ}_{j}}{{( {a}_{1} )}^{j}} = \frac{{θ}_{j}^{*}}{{( {a}_{1}^{*} )}^{j}}$ | H₀: All (j)-chemical interactions involving chemicals (j + 1), (j + 2), . . ., or c are equal to zero |
| $\begin{matrix}{θ}_{4} = {\sum }_{k = 1}^{c} {\sum }_{l = 1}^{c} {\sum }_{m = 1}^{c} {\sum }_{n = 1}^{c} {β}_{klmn} {a}_{k} {a}_{l} {a}_{m} {a}_{n} \\ k < l < m < n\end{matrix}$ | $\begin{matrix}{θ}_{4}^{*} = {\sum }_{k = 1}^{j} {\sum }_{l = 1}^{j} {\sum }_{m = 1}^{j} {\sum }_{n = 1}^{j} {β}_{klmn} {a}_{k}^{*} {a}_{l}^{*} {a}_{m}^{*} {a}_{n}^{*} \\ k < l < m < n\end{matrix}$ | ${H}_{0} \text{:} \frac{{θ}_{4}}{{( {a}_{1} )}^{4}} = \frac{{θ}_{4}^{*}}{{( {a}_{1}^{*} )}^{4}}$ | ${H}_{0} \text{:} [ \begin{matrix}{β}_{123 ( j + 1 )} \\ {β}_{123 ( j + 2 )} \\ ⋮ \\ {β}_{123 c} \\ ⋮ \\ {β}_{( c - 3 ) ( c - 2 ) ( c - 1 ) c}\end{matrix} ] = 0$ (all 4-chemical interaction parameters involving chemicals (j + 1), (j + 2), . . . (c − 1), or (c) are equal to zero |
| $\begin{matrix}{θ}_{3} = {\sum }_{k = 1}^{c} {\sum }_{l = 1}^{c} {\sum }_{m = 1}^{c} {β}_{klm} {a}_{k} {a}_{l} {a}_{m} \\ k < l < m\end{matrix}$ | $\begin{matrix}{θ}_{3}^{*} = {\sum }_{k = 1}^{j} {\sum }_{l = 1}^{j} {\sum }_{m = 1}^{j} {β}_{klm} {a}_{k}^{*} {a}_{l}^{*} {a}_{m}^{*} \\ k < l < m\end{matrix}$ | ${H}_{0} \text{:} \frac{{θ}_{3}}{{( {a}_{1} )}^{3}} = \frac{{θ}_{3}^{*}}{{( {a}_{1}^{*} )}^{3}}$ | ${H}_{0} \text{:} [ \begin{matrix}{β}_{12 ( j + 1 )} \\ {β}_{12 ( j + 2 )} \\ ⋮ \\ {β}_{12 c} \\ {β}_{13 ( j + 1 )} \\ ⋮ \\ {β}_{( c - 2 ) ( c - 1 ) c}\end{matrix} ] = 0$ (all 3-chemical interaction parameters involving chemicals (j + 1), (j + 2), . . . , (c − 1), c are equal to zero) |
| $\begin{matrix}{θ}_{2} = {\sum }_{k = 1}^{c} {\sum }_{k = 1}^{c} {β}_{kl} {a}_{k} {a}_{l} \\ k < l\end{matrix}$ | $\begin{matrix}{θ}_{2}^{*} = {\sum }_{k = 1}^{j} {\sum }_{l = 1}^{j} {β}_{kl} {a}_{k}^{*} {a}_{l}^{*} \\ k < l\end{matrix}$ | ${H}_{0} \text{:} \frac{{θ}_{2}}{{( {a}_{1} )}^{2}} = \frac{{θ}_{2}^{*}}{{( {a}_{1}^{*} )}^{2}}$ | ${H}_{0} \text{:} [ \begin{matrix}{β}_{1 ( j + 1 )} \\ {β}_{1 ( j + 2 )} \\ ⋮ \\ {β}_{( c - 1 ) c}\end{matrix} ] = 0$ (all 2-chemical interactions involving chemicals (j + 1), (j + 2), . . . , (c + 1), c are equal to zero) |
| $\begin{matrix}{θ}_{1} = {β}_{1} {a}_{1} + {β}_{2} {a}_{2} + {β}_{3} {a}_{3} + … \\ {β}_{j} {a}_{j} + … + {β}_{c - 1} {a}_{c - 1} + {β}_{c} {a}_{c}\end{matrix}$ | $\begin{matrix}{θ}_{1} = {β}_{1} {a}_{1}^{*} + {β}_{2} {a}_{2}^{*} + {β}_{3} {a}_{3}^{*} + … + \\ {β}_{j - 1} {a}_{j - 1}^{*} + {β}_{j} {a}_{j}^{*}\end{matrix}$ | ${H}_{0} \text{:} \frac{{θ}_{1}}{( {a}_{1} )} = \frac{{θ}_{1}^{*}}{( {a}_{1}^{*} )}$ | ${H}_{0} \text{:} [ \begin{matrix}{β}_{j + 1} \\ {β}_{j + 2} \\ ⋮ \\ {β}_{c - 1} \\ {β}_{c}\end{matrix} ] = 0$ (parameters associated with the slop of chemicals (j + 1), (j + 2), . . . , (c − 1), and c are zero) |

Analysis of a Mixture of Five Pesticides

Summary statistics for the single chemical and mixture data are given in the Tables 2 and 2a. Single chemical data were collected approximately 18 months prior to the data along the full fixed-ration ray. The data along the reduced fixed-ratio ray were collected approximately 6 months following the full ray study. Multiple ‘positive control’ values for the single chemicals were experimentally evaluated in order to verify that the dose-response relationship did not significantly shift between the time that the single chemical data were generated and the time the mixture data were generated. Preliminary data checks were performed to successfully verify that the data across the single chemical and mixture studies were compatible.

TABLE 2
Summary statistics for motor activity response associated with
single chemical experiments.

| | | Mean Motor | | |
|---|---|---|---|---|
| | Dose | Activity | Standard | |
| Chemical | mg/kg | Response | Deviation | Sample Size |
| Acephate | 0 | 217.88 | 35.77 | 8 |
| | 3 | 200.13 | 34.13 | 8 |
| | 10 | 165.88 | 25.02 | 8 |
| | 30 | 108.75 | 62.51 | 8 |
| | 60 | 58.25 | 24.23 | 8 |
| | 120 | 33.25 | 27.41 | 8 |
| Diazinon | 0 | 206.69 | 34.77 | 16 |
| | 5 | 190.88 | 28.49 | 16 |
| | 25 | 215.56 | 24.02 | 16 |
| | 50 | 183.13 | 24.44 | 8 |
| | 75 | 165.69 | 33.05 | 16 |
| | 125 | 152.00 | 38.65 | 8 |
| | 150 | 76.50 | 35.40 | 8 |
| | 250 | 61.25 | 47.07 | 8 |
| Chlorpyrifos | 0 | 198.56 | 24.56 | 16 |
| | 1 | 213.13 | 31.42 | 8 |
| | 2 | 192.75 | 38.61 | 8 |
| | 5 | 213.37 | 31.04 | 8 |
| | 10 | 178.31 | 34.02 | 16 |
| | 20 | 157.13 | 28.31 | 8 |
| | 25 | 162.00 | 32.36 | 8 |
| | 30 | 80.13 | 34.85 | 8 |
| | 50 | 49.44 | 29.32 | 16 |
| Malathion | 0 | 195.86 | 19.06 | 7 |
| | 100 | 201.50 | 28.38 | 8 |
| | 500 | 203.75 | 28.34 | 8 |
| Dimethoate | 0 | 195.75 | 33.12 | 8 |
| | 5 | 188.25 | 24.21 | 8 |
| | 10 | 188.63 | 53.05 | 8 |
| | 25 | 107.75 | 37.23 | 8 |
| | 50 | 103.75 | 51.59 | 8 |
| | 75 | 101.50 | 59.57 | 8 |

TABLE 2a
Summary statistics for motor activity response associated with
mixture data.

| | Total | Mean Motor | | |
|---|---|---|---|---|
| | Concentration | Activity | Standard | Sample |
| Experiment | Dose (mg/kg) | Response | Deviation | Size |
| Full Ray | 0 | 199.43 | 20.77 | 14 |
| | 10 | 200.92 | 27.10 | 12 |
| | 55 | 167.92 | 37.55 | 12 |
| | 100 | 117.08 | 47.34 | 12 |
| | 200 | 95.17 | 34.03 | 12 |
| | 300 | 72.25 | 40.93 | 12 |
| | 450 | 60.08 | 46.36 | 12 |
| Reduced Ray | 0 | 206.13 | 38.24 | 8 |
| | 1.75 | 189.58 | 30.82 | 12 |
| | 9.6 | 186.92 | 26.87 | 12 |
| | 17.5 | 135.67 | 40.46 | 12 |
| | 35 | 84.42 | 25.98 | 12 |
| | 52.5 | 43.67 | 25.27 | 12 |
| | 78.8 | 48.17 | 25.80 | 12 |

4.1 SAR Method of Analysis

The threshold additivity model given in (2) and the threshold mixture model given in (4) were simultaneously fit to the single chemical data and mixture data along the two fixed-ratio rays allowing for a common intercept. The parameter associated with malathion was not included in the additivity model as it was not significant. Threshold dose estimates from each of the single chemicals were within the experimental region and the additivity threshold parameter (δ) was significant (p=0.005) (Table 3), which indicated a threshold exists under additivity. The dose threshold estimates for the two fixed-ratio rays were outside of the experimental region, which indicated that the threshold model was not necessary for the mixture data. Thus, the corresponding generalized linear model given by

g(μₘᵢₓ₍ₖ₎)=β₀₍ₖ₎+θ*₁₍ₖ₎t (19)

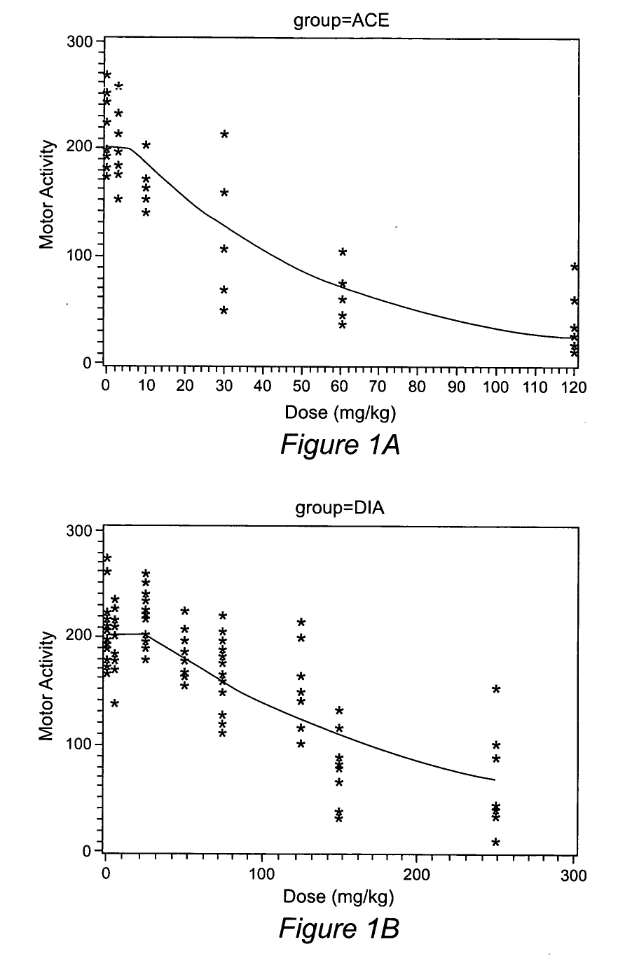

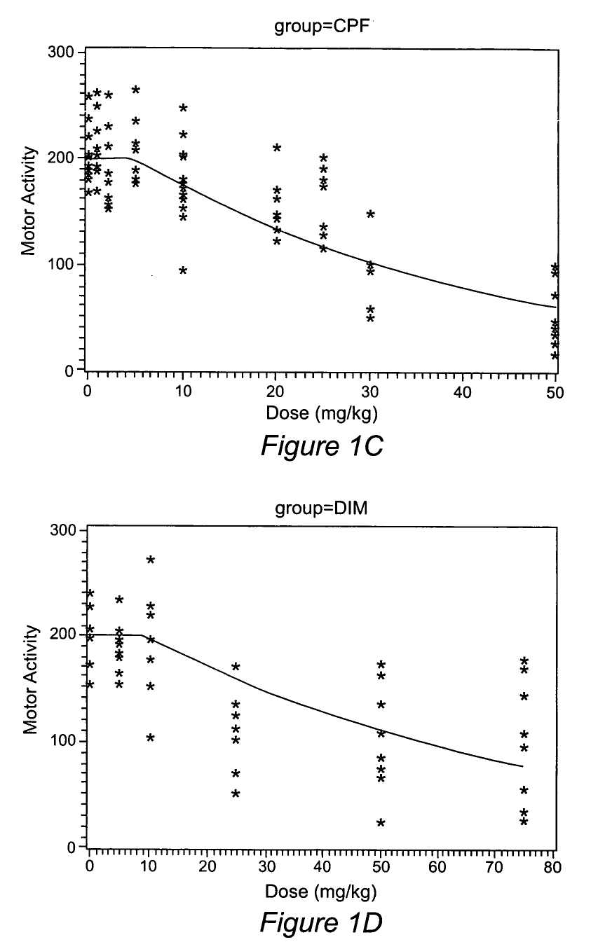

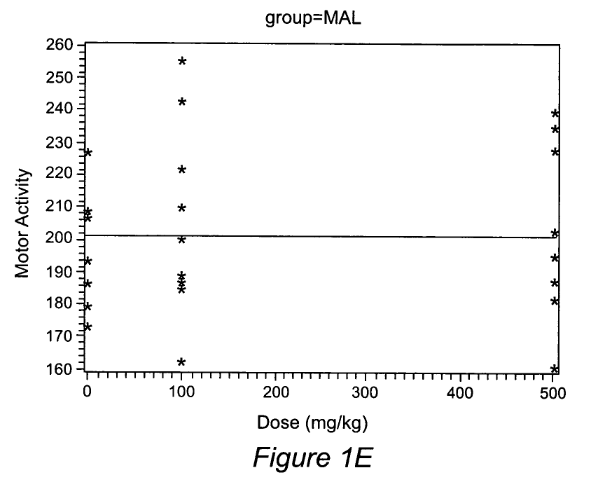

was fit to the mixture data along the two fixed-ratio rays. Tests for the adequacy of the models fit to the data were performed graphically (FIG. 1) for the single chemical data and by using the scaled deviance as a goodness-of-fit statistic for the mixture models. Plots in FIG. 1 indicated that the threshold additivity model provided a reasonable fit for the single chemical data. Similarly, a goodness-of-fit test using the scaled deviance indicated an adequate fit (p-value of 0.502).

The resulting parameter estimates and associated p-values for the additivity and mixture models are provided in Table 3. Parameters associated with the full five-pesticide fixed-ratio ray are denoted with subscript ‘full’. Similarly, parameters associated with the fixed-ratio ray where malathion was removed from the mixture are denoted with subscript ‘reduced’. The slopes associated with the four active pesticides are all negative and significant (p-value, <0.001), indicating that as the dose of these pesticides increases, the mean motor activity response decreases. Similarly, as the total dose of the mixture increases along the two fixed-ratio rays the mean motor activity response also decreases (p-values of <0.001 along both rays). Point estimates and 95% confidence intervals for the threshold doses associated with each single chemical (δ*ᵢ) are provided in Table 5. Chlorpyrifos has the smallest threshold estimate (4.69 mg/kg) and diazinon has the largest point estimate (25.0 mg/kg). All four confidence intervals on the dose threshold parameters for acephate, diazinon, chlorpyrifos, and dimethoate do not include zero, indicating significant dose thresholds for the four chemicals. Under additivity, the plane that connects these dose threshold values is termed the ‘additivity threshold surface’. All dose values below this surface are associated with background motor activity responses. Dose values above this surface are associated with motor activity responses below background.

TABLE 3
Parameter estimates and resulting p-values for the parameters given in (2) and
the corresponding generalized linear model to (4) for the five-pesticide additivity
model and the mixture models along the full and reduced fixed-ratio rays. The
estimate for the scale parameter, τ, was 12.27.

| | | | | Threshold | 95% |
|---|---|---|---|---|---|
| | | Standard | | Estimate | Confidence |
| Parameter | Estimate | Error | P-value | (mg/kg) | Interval |
| β_{0(add)} | 5.303 | 0.021 | <0.001 | | |
| β₁ (acephate) | −0.020 | 0.002 | <0.001 | 6.30 | (2.14, 10.45) |
| β₂ (diazinon) | −0.005 | 4.8E−4 | <0.001 | 25.0 | (9.54, 40.45) |
| β₃ (chlorpyrifos) | −0.026 | 0.002 | <0.001 | 4.69 | (1.72, 7.66) |
| β₄ (Dimethoate) | −0.014 | 0.002 | <0.001 | 8.72 | (3.15, 14.29) |
| δ | −0.124 | 0.044 | 0.005 | | |
| β_{0(full)} | 5.260 | 0.042 | <0.001 | | |
| ${θ}_{1 ( full )}^{*}$ | −0.00306 | 2.7E−4 | <0.001 | | |
| β_{0(reduced)} | 5.322 | 0.045 | <0.001 | | |
| ${θ}_{1 ( reduced )}^{*}$ | −0.023 | 0.002 | <0.001 | | |

NOTE:
$\begin{matrix}{\sum }_{i = 1}^{4} {β}_{i} {a}_{i ( full )} = {θ}_{1 ( full )}^{*} = - 0.00307 and \\ {\sum }_{i = 1}^{4} {β}_{i} {a}_{i ( reduced )} = {θ}_{1 ( reduced )}^{*} = - 0.0018 . \end{matrix}$
The parameter associated with malathion was removed from the model
due to lack of significance.

The hypothesis of additivity using the SAR approach, developed in Section 2, makes comparisons between the model predicted under additivity, using single chemical data, and the model fit to the data along the fixed-ratio rays. For the data considered here, the threshold additivity model, given in (2), was fit to the single chemical data and the corresponding generalized linear model, given in (19), was fit to the mixture data along the two fixed-ratio rays. Thus, the hypothesis of additivity is defined as

$$\begin{matrix}{H}_{0} \text{:} & {b}_{add} γ = [ \begin{matrix}{β}_{0 ( full )} = {β}_{0 ( add )} - δ \\ {θ}_{1 ( full )}^{*} = {\sum }_{i = 1}^{4} {β}_{i} {a}_{i ( full )} \\ {β}_{0 ( reduced )} = {β}_{0 ( add )} - δ \\ {θ}_{1 ( reduced )}^{*} = {\sum }_{i = 1}^{4} {β}_{i} {a}_{i ( reduced )}\end{matrix} ]\end{matrix} \qquad ( 20 )$$

where γ=[β_{0(add)}, β₁, β₂, β₃, β₄, δ, β_{0(full)}θ*_{1(full)}, β_{0(reduced)}, θ*_{1(reduced)}]′ and

$${b}_{add} = [ \begin{matrix}1 & 0 & 0 & 0 & 0 & - 1 & - 1 & 0 & 0 & 0 \\ 0 & 0.040 & 0.002 & 0.031 & 0.102 & 0 & 0 & - 1 & 0 & 0 \\ 1 & 0 & 0 & 0 & 0 & - 1 & 0 & 0 & - 1 & 0 \\ 0 & 0.2286 & 0.0114 & 0.1767 & 0.5833 & 0 & 0 & 0 & 0 & - 1\end{matrix} ]$$

This hypothesis was tested using the statistic given in (6) compared to an F_{4, N-10} with scale parameter given by (7).

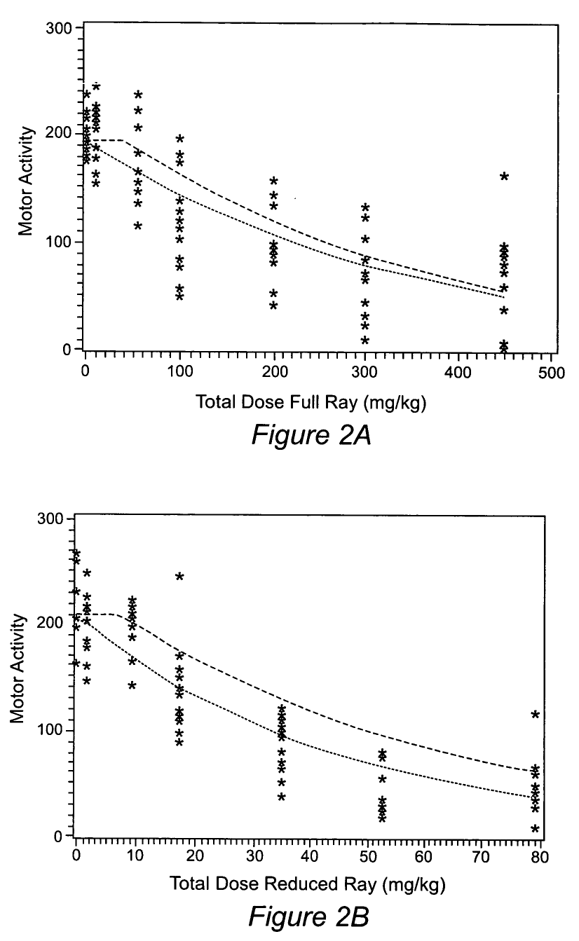

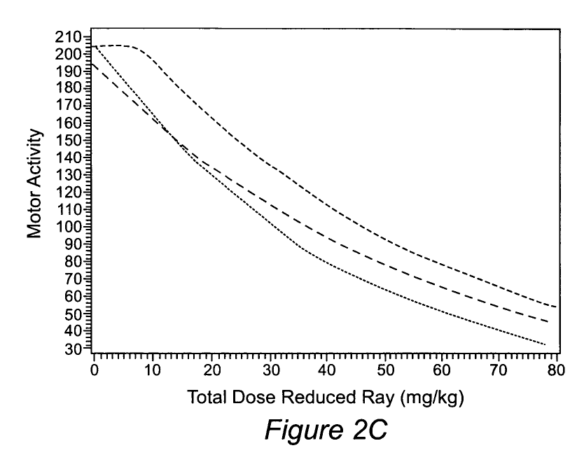

FIG. 2 provides plots of the observed and predicted responses for the mixture data and the predicted threshold additivity model along the full and reduced fixed-ratio rays respectively. The means for the mixture data at many of the dose groups along the two fixed-ratio rays fall below that predicted under additivity. Results of testing the hypothesis of additivity are provided in Table 4. With a p-value of <0.001, there was sufficient evidence to reject the overall test of additivity, given in (20), and conclude significant departure from additivity exists on at least one of the two fixed-ratio rays. Using Hochberg's correction for multiple testing, significant departure from additivity was detecting along both the full and reduced rays (p-values of <0.001 for each).

TABLE 4
Overall test of additivity and associated two degree-of-freedom
tests for significance along the individual fixed-ratio rays.

| | | |
|---|---|---|
| Statistic | Degrees-of-freedom | P-value |

Overall Test of Additivity

| | | | |
|---|---|---|---|
| Hypothesis given in (14) | 7.76 | (4, 467) | <0.001 |

Test of Additivity along Individual Rays

| | | | |
|---|---|---|---|
| Full Ray | 7.47 | (2, 467) | <0.001 |
| Change in intercept | 9.21 | (1, 467) | 0.002 |
| Change in slope | 0.001 | (1, 467) | 0.970 |
| Reduced Ray | 12.48 | (2, 467) | <0.001 |
| Change in intercept | 3.23 | (1, 467) | 0.073 |
| Change in slope | 6.22 | (1, 467) | 0.013 |

Test for the Effect of Malathion

| | | | |
|---|---|---|---|
| Hypothesis given in (11) | 2.70 | (2, 467) | 0.068 |
| for generalized linear | | | |
| model | | | |
| Change in intercept | 1.03 | (1, 467) | 0.311 |
| Change in slope | 5.13 | (1, 467) | 0.024 |

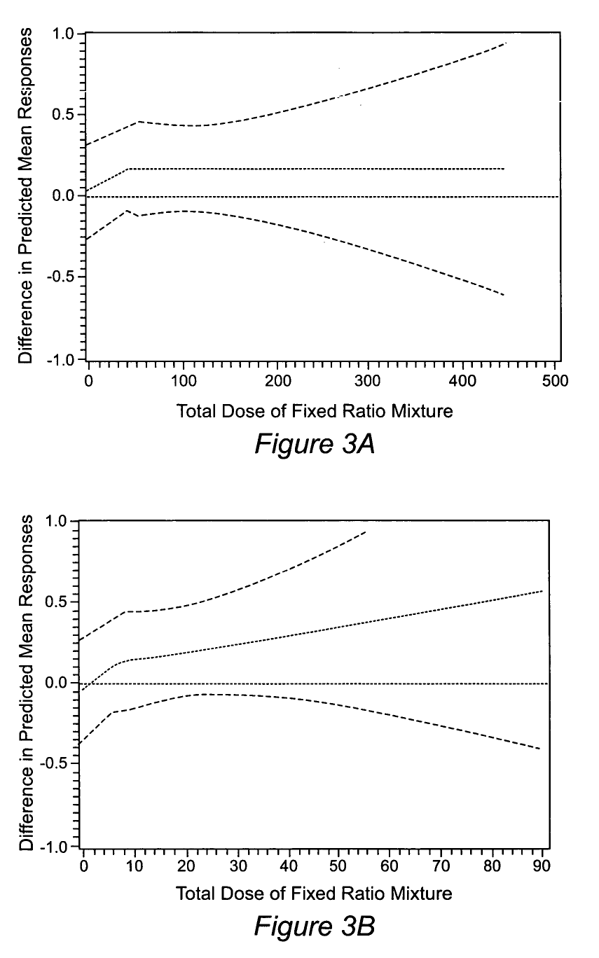

FIG. 3 provides plots of the difference between the additivity and mixture curves on the transformed response g(μ) and the corresponding 95% simultaneous confidence band for the full and reduced rays respectively. Since the curves are decreasing, the difference was taken as the additivity mean minus the mixture mean; thus, a positive value is associated with a more extreme or greater than additive response and a negative difference is associated with a less than additive response. The simultaneous bands included zero for both the full and reduced rays. Although the test for interaction was significant in both rays (Table 4), the simultaneous confidence bands were too wide to elucidate the location of the interaction.

Finally, since malathion is not dose-responsive alone and it accounts for 82.5% of the mixture researchers are interested in determining if malathion has an effect on the mixture. This can be achieved by considering differences in the models predicted along the full and reduced rays. In other words, if the model fit along the full ray is equivalent to the model fit along the reduced ray, where malathion was removed and the remaining four pesticides are at the same relative ratios as given in the full ray, and there is enough power then we can conclude malathion does not have an effect on the mixture.

The hypothesis for testing for the effect of a particular compound on the remaining components of the mixture was developed in Section 2 for the threshold model. For the mixture data considered here a threshold model was not necessary. Recall under the null hypothesis that malathion does not have an effect on the mixture g(m_{(full)})=g(m_{(reduced)}) where

$$\begin{matrix}g ( {μ}_{( full )} ) = {β}_{0 ( full )} + {θ}_{1 ( full )}^{*} {t}_{full} \\ = {β}_{0 ( full )} + \frac{{θ}_{1 ( full )}^{*} {t}_{reduced}}{( 1 - {a}_{5 ( full )} )}\end{matrix} ⇒$$

and

g(μ_{(reduced)})=β_{0(reduced)}+θ*_{1(reduced)}t_{reduced}.

Thus, the hypothesis that malathion does not have an effect on the mixture is given by

$$\begin{matrix}{H}_{0} \text{:} & {b}_{interact} γ = [ \begin{matrix}{β}_{0 ( full )} = {β}_{0 ( reduced )} \\ \frac{{θ}_{1 ( full )}^{*}}{( 1 - {a}_{5 ( full )} )} = {θ}_{1 ( reduced )}^{*}\end{matrix} ]\end{matrix} \qquad ( 21 )$$

where γ=[β_{0(add)}, β₂, β₃, β₄, δ, β_{0(full)}θ*_{1(full)}, β_{0(reduced)}, θ*_{1(reduced)}]′ and

$${b}_{interact} = [ \begin{matrix}0 & 0 & 0 & 0 & 0 & 0 & 1 & 0 & - 1 & 0 \\ 0 & 0 & 0 & 0 & 0 & 0 & 0 & \frac{1}{( a - {a}_{5 ( full )} )} & 0 & - 1\end{matrix} ] .$$

The Wald-type test, given in (6) and (7) is used to test this hypothesis. The results of testing the hypothesis of no effect due to malathion are provided in Table 4. With a p-value of 0.068, there is marginal evidence that malathion has an effect on the mixture. The lack of significance of the parameter associated with malathion in the additivity model suggests that the effect of malathion is not additive (i.e., malathion interacts with the active pesticides). FIG. 2c provides the adjusted dose-response curve fit to the five-pesticide mixture overlaid with the observed and predicted means along the reduced ray. It is evident from this figure that the effect of malathion is a higher dose phenomenon as this is where the solid lines and dashed lines are separated the most.

3.2 SANR Method of Analysis: Mixture Data Alone

Although not the case here, for illustrative purposes, suppose that significant shifts between the single chemical and mixture studies were observed. This indicates that the mixture studies are not compatible with the single chemical studies; thus, it is not appropriate to combine the data for analysis. In this case, the mixture data alone can be used to test the hypotheses of interest. Results of fitting the model, given in (12), simultaneously to the mixture data across the two rays are given in Table 5. A model building approach was used to consider the level of interaction along the rays. The fourth-order term along the reduced ray was removed and the third, fourth and fifth degree terms along the full ray were removed due to lack of significance. Recall the degree of the term in the model is associated with the degree of the interaction tern(s) in the assumed underlying response surface model. The hypothesis, given by

H₀: b_{add}γ=[θ*_{2(full)}, θ*_{2(reduced)}, θ*_{3(reduced )}]′=0

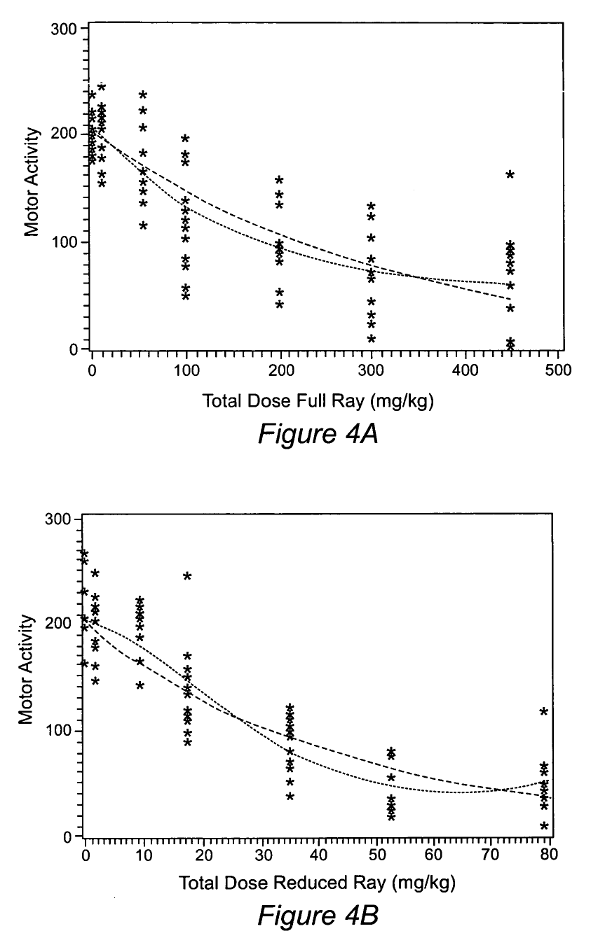

was used to test the hypothesis of additivity given in (13). Since the p value associated with additivity was <0.001 we may reject the hypothesis of additivity and conclude departure from additivity exists along at least one of the fixed-ratio rays. Using Hochberg's correction for multiple testing, significant departure from additivity was detected along the full and reduced rays (p=0.006 and p=0.002, respectively). With a p-value of <0.001, we conclude that there are significant third-order interactions along the reduced ray among the four pesticides; with a p value of 0.006, we concluded that there is at least one two-way interaction among the five pesticides together. Plots of the additivity and interaction model along each of the rays are provided in FIG. 4.

TABLE 5
Parameter estimates where data along the two fixed-ratio rays are
simultaneously fit to the corresponding generalized linear model
for (12).

| Parameter | Estimate | SE | p-value |
|---|---|---|---|
| β₀ | 5.313 | 0.0365 | <0.001 |
| θ*_{1(full)} | −0.00497 | 0.00073 | <0.001 |
| θ*_{2(full)} | 5.06E−6 | 1.84E−6 | 0.006 |
| θ*_{1(reduced)} | −0.00553 | 0.00881 | 0.530 |
| θ*_{2(reduced)} | −0.00097 | 0.000354 | 0.006 |
| θ*_{3(reduced)} | 0.000010 | 3.29E−6 | 0.002 |
| τ | 11.70 | | |

TABLE 6
Overall test of additivity and associated two degree-of-freedom
tests for significance along the individual fixed-ratio rays.

| | | |
|---|---|---|
| Statistic | Degrees-of-freedom | P-value |

Overall Test of Additivity

| | | | |
|---|---|---|---|
| Hypothesis given in (13) | 21.5 | (3, 160) | <0.001 |

Test of Additivity along Individual Rays

| | | | |
|---|---|---|---|
| Full Ray | 4.759 | (1, 160) | 0.006 |
| Reduced Ray | 13.02 | (2, 160) | 0.002 |

Test for the Effect of Malathion

| | | | |
|---|---|---|---|
| Hypothesis given in (14) | 23.2 | (3, 160) | <0.001 |

5. Discussion

The analysis method developed here, which includes the use of single chemical data to describe the dose-response relationship assumed under the zero interaction (or additivity) case, is useful when interest is restricted to making inference along specific rays. Appropriate statistical comparisons of the dose-response curve under additivity are made to the fitted dose-response curve of the mixture in total dose. Plots of the simultaneous confidence bands about the difference in the two models on the g(μ) scale may identify regions where significant departure from additivity exists. The collection of data along subset rays, where particular compounds of interest are removed from the mixture and the remaining components are studied at the same relative ratios as in the full ray, are useful in characterizing the effect of the chemicals that have been removed.

The first analytical strategy presented here has been termed the SAR method, as single agent data are required to estimate the additivity surface. By contrast, SANR method initially described by Meadows et al. (2002) and Casey (2003) requires the assumption of the parametric form of the underlying responses surface. In this case, significant higher-order terms in the model indicate departure from additivity. The degree of the largest significant term along the fixed-ratio ray indicates the order of the interaction. This method of analysis can be used with or without the single chemical data. The choice of which method to use to detect departure from additivity along fixed-ratio rays is based on assumptions the analyst is willing to make and the availability of single chemical data.

The SANR methods can be used in the presence or absence of single chemical data. As illustrated in the example, studies need to be appropriately powered (see Casey, 2003). Of particular importance is to consider the reduced power (due to a reduction in the total sample size) associated with using only mixture data. We recommend the collection of single chemical data when feasible. Considering mixture data alone is useful for studies of complex mixtures.

When single chemical data are not available, the parameters associated with the slopes of specific chemicals (β₁, β₂, . . . , β_{c}) cannot be estimated unless the number of fixed-ratio rays is greater than or equal to the number of chemicals under study. However, reduced designs, i.e., designs where the number of fixed-ratio rays is less than the number of chemicals under study, provide valuable information about interactions. For example, it may be reasonable to assume chemicals in the same class have the same slope. In addition, constraints can be made across the rays so that the parameter associated with additivity, θ*₁, is common across rays.

One scenario that can be considered for selecting the same number of rays as chemicals is to select a relevant mixing ratio and then, in a systematic order, remove single chemicals, one at a time, keeping the remaining chemicals at the same relative ratios as given in the full mixture. Such a design allows for the estimation of slope parameters and for the detection of higher-order interactions. In addition, this design allows one to consider how a particular compound interacts with the remaining components by comparing each of the rays to one another using the methods developed in Section 3.

Finally, it should be noted that the hypotheses developed here require the fit of higher-order polynomial models. The order of the polynomial follows directly from the number of chemicals under study (Meadows et al., 2002). Working with such models can cause numerical problems, particularly as the order of the polynomial increases. We are considering a dose range of 0 mg/kg to 450 mg/kg along the full ray and 0 mg/kg to 80 mg/kg along the reduced ray. Raising such dose values to powers of two or greater results in relatively large numbers; thus, parameter estimates associated with higher-order terms become smaller as the order of the polynomial term increases. In some situations, such small numbers cause numerical problems. One proposed solution to ease these numerical problems is to consider scaling the dose range. For example, we could divide the doses by 10 or 100 and work with either centigrams or decigrams instead of milligrams. Alternatively, for studies of complex mixtures, it may be reasonable to specify the level of interaction researchers are interested in detecting. For example, a researcher studying a mixture of ten chemicals may wish to use the SANR method as a screening tool to detect up to five-way interactions. Considering the methods presented here as a screening tool to detect interactions up to a certain level will ease numerical calculation problems and aid researchers in defining specific hypotheses or chemicals of interest. For example, researchers may be able to determine that some of the chemicals under study are not involved in interactions and, thus, can be removed form the mixture.

6. References

Aspelin, A. L. (1994), Pesticide Industry Sales and Usage: 1992 and 1993 Market Estimates, Office of Pesticides Programs, U.S. Environmental Protection Agency, EPA 733-L-94-001, Washington, D.C.

Berenbaum, M. C. (1981), “Criteria for Analyzing Interactions Between Biologically Active Agents,” Advances in Cancer Research, 35, 269-335.

Brunden, M. and Vidmar, T. (1989), “Optimal 3×3 Factorial and 3-Ray Designs for Drug Interaction Experiments with Dichotomous Responses,” Communications in Statistics, 18, 2835-2859.

Casey, M. (2003), Statistical methodology for Exploiting the Use of Ray Designs in Studies of Polychemical Mixtures, Unpublished Ph.D. Dissertation, Virginia Commonwealth University, Department of Biostatistics.

Carter, W. H., Jr., Chinchilli, V. M., Wilson, J. D., Campbell, E. D., Kessler, F. K., and Carchman, R. A. (1986), “An Asymptotic Confidence Region for the ED₁₀₀ₚ from the Logistic Response Surface for a Combination of Agents,” The American Statistician, 40, 2, 124-128.

Cohen, S. D. (1984), “Mechanisms of Toxicological Interactions Involving Organophosphate Insecticides,” Fundamental and Applied Toxicology, 4, 315-324.

DuBois, K. P., (1961), “Potentiation of the Toxicity of Organophosphorus Compounds,” Advances in Pest Control Research, 4, 117-151.

Finney, D. J. (1964, 1971), Probit Analysis, London: Cambridge University Press.

Gennings, C., Carter, W. H., Jr., Campain, J., Bae, D, Yang, R. (2002), “Statistical Analysis of Interactive Cytotoxcity in Human Epidermal Keratinocytes Following Exposure to a Mixture of Four Metals,” Journal of Agricultural, Biological, and Environmental Statistics, 17, 58-73.

Gennings, C., Schwartz, P., Carter, W. H., Jr., Simmons, J. E. (1997), “Detection of Departures for Additivity in Mixtures of Many Chemicals with a Threshold Model,” Journal of Agricultural, Biological, and Environmental Statistics, 5, 257-259.

Hochberg. Y. (1988), “A Sharper Bonferroni Procedure for Multiple Tests of Significance,” Biometrika, 75, 800-802.

Loewe, S. (1953), “The Problem of Synergism and Antagonism of Combined Drugs,” Arzneimittle Forshung, 3, 285-290.

Loewe, S., and Muischnek, H. (1926), “Über Kombinations-Wirkungen. 1. Mitteilung: Hilfsmittle der Fragestel-lung,” Archives of Experimental Pathology and Pharmacology, 114, 313-326.

Ma, X., Buffler, P. A., Gunier, R. B., Dahl, G., Smith, M. T., Reinier, K., and Reynolds, P. (2002), “Critical Windows of Exposure to Household Pesticides and Risk of Childhood Leukemia,” Environmental Health Perspectives, 110, 955-960.

Mantel, N. (1958), “An Experimental Design in Combination Chemotherapy,” Annals of the New York Academy of Sciences, 76, 909-914.

Martin, J. T. (1942), “The Problem of the Evaluation of Rotenone-Containing Plants. VI. The Toxicity of 1-elliptone and of Poisons Applied Jointly, with Further Observations on the Rotenone Equivalent Method of Assessing the Toxicity of Derris Root,” Annals of Applied Biology, 29, 69-81.

McCollister, D. D., Oyen, F., and Row, V. K. (1959), “Toxicological Studies of O, O-dimethyl-O-(2,4,5-trichlorophenyl) phosphorothionate (Ronnel) in Laboratory Animals,” Journal of Agricultural and Food Chemistry, 7, 689.

McCullagh, P. (1983), “Quasi-likelihood Functions,” The Annals of Statistics, 11, 59-67.

McCullagh, P., Nelder, J. A. (1989), Generalized Linear Models (2^{nd} ed), New York: Campman and Hall, 511 pp.

Meadows, S. L., Gennings, C., and Carter, W. H., Jr. (2002), “Experimental Designs for Mixtures of Chemicals along Fixed Ratio Rays,” Environmental Health Perspective, in press.

Nelder, J. A. and Mead, R. (1965), “A Simplex Method for Function Minimization,” The Computer Journal, 7, 308-313.

Schwartz, P. F., Gennings, C., and Chinchilli, V. M., (1995), “Threshold Models for Combination Data From Reproductive and Developmental Experiments,” Journal of the American Statistical Association, 90, 862-870.

Wedderburn, R. W. M. (1974), “Quasi-Likelihood Functions, Generalized Linear Models, and the Gauss-Newton Method,” Biometrika, 61, 439-447.

### Example 2

### Power and Sample Size Calculations for Determining Whether a Subset of Chemicals Interacts with the Remaining Components of a Mixture Using Fixed-Ratio Designs

1. Introduction

The EPA regulates the use of hundreds of individual pesticides based on acute, subchronic, and chronic toxicity assessments conducted in healthy animals (EPA 1999). Realistically, however, many pesticides are used in combination or in a pattern that results in exposure to multiple pesticides. These pesticides may interact with one another in such a way that results in unexpected adverse human health consequences. However, prior to the Food Quality Protection Act (FQPA 1996) regulatory decisions regarding exposure to chemical mixtures often assumed additivity, i.e. zero interaction (see FQPA). Regulations that were based on toxicity of these pesticides one at a time may not adequately protect human health from the adverse effects of cumulative exposure to multiple pesticides.

Although previous studies on pesticide interactions have been performed (e.g., Cohen, 1984; DuBois, 1961; McCollister et al., 1959), they have primarily focused on binary chemical combinations. In addition, few studies have addressed interactions among environmentally relevant organophosphorus (OP) pesticides, which are the most widely used pesticides in the U.S. (Aspelin, 1994). Some of these OPs have been listed as priority chemicals for study under the Safe Drinking Water Act amendments. Agricultural uses include applications on a variety of food and commercial crops; household uses include pet, garden, and home applications. Therefore, there is high potential for aggregate exposure, or multiple exposures from multiple routes. Of particular importance is the detection of interactions, with reasonable power, among combinations of multiple pesticides.

Traditionally, chemical mixtures have been studied using response surface methodology (RSM), which is often supported by factorial designs. Although factorial designs adequately allow for the detection and characterization of interactions, the number of experimental groups and, thus, the number of observations required becomes infeasible as the number of compounds under study increases. In an effort to reduce the amount of experimental effort associated with the study of chemical mixtures, tests for departure from additivity using relevant fixed-ratio ray designs have been proposed by Gennings et al. (2002), Meadows et al. (2002a), and Casey (2003). In this case we are only interested in making inference along the specific rays of interest, as opposed to methods which use designs that require more experimental effort to support the estimation of a response surface over a larger region of interest.

Fixed-ratio ray designs were chosen to study interactions among combinations of multiple pesticides. The pesticides chosen for these studies, based on usage patterns (i.e., pesticides used on the same or similar crops) and market share (i.e., highest volume pesticides), were acephate, diazinon, chlorpyrifos, dimethoate, and malathion. Motor activity, a count of the number of passes made across a central area, was chosen to assess the toxicity of these pesticides in healthy adult rats. The fixed-ratio ray under study was chosen based on the relative dietary exposure estimates of each chemical as projected by the U.S. EPA Dietary Exposure Evaluation Model (DEEM) and is given by (0.040:0.002:0.031:0.102:0.825) for acephate, diazinon, chlorpyrifos, dimethoate, and malathion respectively.

Single chemical data indicate that malathion does not appear to be dose responsive with respect to motor activity (see Table 1). This lack of activity along the dose-response curve and evidence of interactions along the full fixed-ratio ray (described in Section 4) provided motivation for examining a subset ray. This second fixed-ratio ray permits the study of the effect of malathion on the mixture (Casey, 2003). Although malathion does not appear to be dose responsive, it is of interest to investigate whether it interacts with the active pesticides. Following the logic of Casey (2003), a comparison of the interactions observed along the reduced fixed-ratio ray to those observed along the full ray permits the detection and characterization of interactions between malathion and the remaining four pesticides.

The reduced ray is given by (0.2286:0.0114:0.1767:0.5833) for (acephate, diazinon, chlorpyrifos, dimethoate), where malathion was removed from the mixture and the remaining four chemicals are at the same relative proportions as those considered in the full fixed-ratio ray. For example, the ratio of acephate to diazinon along the full fixed-ratio ray is (0.040:0.002) which is a (20:1) ratio. Similarly, the ratio of acephate to diazinon along the reduced fixed-ratio ray is (0.2286:0.0114) which is also a (20:1) ratio.

The objective of this paper is to describe the power and sample size calculations, which are a function of dose location and allocation of subjects per dose group, associated with testing the hypothesis that malathion is involved in interactions with the four active pesticides. These methods can readily be applied to tests for departure from additivity as well. The details of the tests for departure from additivity and tests for interactions due to subsets of compounds are summarized below in section 2 and further details are provided by Gennings et al. (2002), Meadows et al. (2002a), and Casey (2003).

2. Testing for Addivity

Meadows et al. (2002a) and Casey (2003) describe an interaction-model-based method of analysis where assumptions are made about the form of the underlying response surface. In this case, the significance of higher-order terms in the polynomial approximation of the dose-response relationship, expressed as a function of the total dose, indicates departure from additivity. Meadows et al. (2002a) showed that, with this approach, only mixture data along a fixed-ratio ray are necessary for detecting departure from additivity. Casey (2003) extended these results to detect departure from additivity across multiple fixed-ratio rays in the presence or absence of single chemical data.

In the quasi-likelihood framework, proposed by Wedderburn (1974), where the data are assumed to have mean μ and variance τV(μ), the generalized linear model relates the doses of the chemicals under study to the mean through a link function, g(μ). The interaction model for c chemicals can be expressed as

$$\begin{matrix}g ( {μ}_{mix} ) = {β}_{0} + {\sum }_{i = 1}^{c} {β}_{i} {x}_{i} + {{\sum }_{i = 1}^{c} {\sum }_{j = 1}^{c}}_{i < j} {β}_{ij} {x}_{i} {x}_{j} + \\ {{\sum }_{i = 1}^{c} {\sum }_{j = 1}^{c} {\sum }_{l = 1}^{c}}_{i < j < l} {β}_{ijl} {x}_{i} {x}_{j} {x}_{l} + … + {β}_{123 … c} {x}_{1} {x}_{2} … {x}_{c} .\end{matrix} \qquad ( 1 )$$

Let K be the number of fixed-ratio rays under consideration for a mixture of c chemicals and a₍ₖ₎=[a₁₍ₖ₎, a₂₍ₖ₎, . . . , a_{c(k)}] define the mixing ratio along the k^{th} fixed-ratio ray, such that

$${\sum }_{i = 1}^{c} {a}_{i ( k )} = 1.$$

Let x₍ₖ₎=[x₁₍ₖ₎, x₂₍ₖ₎, . . . ,x_{c(k)}] define a vector of doses at a given mixture point along the k^{th} ray and

$$t = {\sum }_{i = 1}^{c} {x}_{i ( k )}$$

define total dose. Given x₍ₖ₎=a₍ₖ₎t, the interaction model along the k^{th} fixed-ratio ray can be expressed as

g(μₘᵢₓ₍ₖ₎)=β₀+θ*₁₍ₖ₎t+θ*₂₍ₖ₎t²+θ*₃₍ₖ₎t³+ . . . +θ*_{c}_{ₖ}₍ₖ₎t^{c}^{ₖ} (2)

where:

$${θ}_{1 ( k )}^{*} = {\sum }_{i = 1}^{{c}_{k}} {β}_{i} {a}_{i ( k )} ; {θ}_{2 ( k )}^{*} = {{\sum }_{i = 1}^{{c}_{k}} {\sum }_{j = 1}^{{c}_{k}}}_{i < j} {β}_{ij} {a}_{i ( k )} {a}_{j ( k )} ;$$

$${θ}_{3 ( k )}^{*} = {{\sum }_{i = 1}^{{c}_{k}} {\sum }_{j = 1}^{{c}_{k}} {\sum }_{l = 1}^{{c}_{k}}}_{i < j <} {β}_{ijl} {a}_{i ( k )} {a}_{j ( k )} {a}_{l ( k )} ; etc . ,$$

g(μₘᵢₓ₍ₖ₎) is the link function specified by the user (see McCullagh and Nelder, 1989),

β₀ is the unknown parameter associated with the intercept,

θ*₁₍ₖ₎ is the unknown parameter associated with the first-order term,

θ*ᵢ₍ₖ₎ for i=2 . . . cₖ is the unknown parameter associated with the i^{th} way interaction,

t is total dose, and

cₖ is the number of chemicals under study along the k^{th} fixed-ratio ray.

When single chemical data are available, the parameters associated with the slopes of the individual chemicals are estimable. Thus, the model fit along the k^{th} fixed-ratio ray is given by g(μₘᵢₓ₍ₖ₎)=β₀+β₁a₁₍ₖ₎t+ . . . +β_{c}_{ₖ}a_{c}_{ₖ}t+θ*₂₍ₖ₎t²+θ*₃₍ₖ₎t³+ . . . +θ*_{c}_{ₖ}₍ₖ₎t^{c}^{ₖ}. (3)

The K fixed-ratio ray models are generally fit simultaneously assuming a common intercept. If multiple vehicle control groups are experimentally evaluated, the assumption of a common intercept should be verified by comparing the means of the control groups. When single chemical data are available, they are used in combination with the mixture data to estimate the intercept and first-order coefficients. In the absence of single chemical data, all of the model parameters are estimated using mixture data. Parameter estimates are found by maximizing the quasi-likelihood criterion (McCullagh and Nelder, 1989).

Following the logic of Carter et al. (1988), which illustrates the relationship between the interaction index, proposed by Berenbaum (1981), and the interaction parameters in a statistical model, the additivity model, based on the definition of zero interaction, can be expressed as

$$\begin{matrix}g ( {μ}_{add ( k )} ) = {β}_{0} + {\sum }_{i = 1}^{c} {β}_{i} {x}_{i} \\ = {β}_{0} + {θ}_{1 ( k )}^{*} t .\end{matrix} \qquad ( 4 )$$

Based on this additivity model, the parameters associated with interaction along the K fixed-ratio rays, namely (θ*₂₍₁₎, θ*₃₍₁₎, . . . , θ*_{c}_{₁}₍₁₎, θ*₂₍₂₎, θ*₃₍₂₎, . . . , θ*_{c}_{₂}₍₂₎, . . . , θ*_{2(K)}, θ*_{3(K)}, . . . , θ*_{c}_{_{K}}_{(K)}), are zero under the hypothesis of additivity. Define the px1 vector γ=[β₀, θ*₁₍₁₎, θ*₂₍₁₎, . . . , θ*_{c}_{₁}₍₁₎, . . . , θ*_{1(K)}, θ*_{2(K)}, . . . , θ*_{c}_{_{K}}_{(K)}]′ as a vector of model parameters and define b_{add} as a matrix of zeros and ones such that

b_{add} γ=[θ*₂₍₁₎, θ*₃₍₁₎, . . . , θ*_{c}_{₁}₍₁₎, . . . , θ*_{2(K)}, . . . , θ*_{c}_{ₖ}_{(K)}]′.

An overall test of additivity, based on the significance of higher-order terms, is given by

H₀: bγ=0. (5)

A Wald-type test for detecting departure from additivity is given by

$$W = \frac{{{( b \hat{γ} )}^{′} [ b {Ω b}^{′} ]}^{- 1} ( b \hat{γ} )}{Mr} , \qquad ( 6 )$$

where τΩ is the variance-covariance matrix of \hat{γ} and b is any matrix of contrasts (e.g. b_{add}). Since \hat{γ} is asymptotically normally distributed (McCullagh and Nelder, 1989) with mean γ and variance τΩ, it follows that W is approximately distributed chi-square with

$$M = {\sum }_{i = 1}^{K} ( {c}_{i} - 1 )$$

degrees of freedom. The moment estimate for t is expressed as

$$\hat{τ} = \frac{1}{( N - p )} {\sum }_{i , j} \frac{{( {y}_{ij} - {\hat{μ}}_{i} )}^{2}}{V ( {\hat{μ}}_{i} )} = \frac{{X}^{2}}{( N - p )} , \qquad ( 7 )$$

where X² is the generalized Pearson statistic (McCullagh and Nelder, 1989), which is asymptotically distributed chi-square with N−p degrees of freedom. In the quasi-likelihood framework, McCullagh (1983) defines the large sample variance-covariance matrix for for \hat{γ} as τ[I(γ)]⁻¹, where I(g) is the expected quasi-information matrix. Replacing γ with \hat{γ}, \hat{Ω}=[J(\hat{γ})]⁻¹ is a consistent estimate for W (McCullagh, 1983). Replacing τ with \hat{τ} and W with \hat{Ω} in (6), W is approximately distributed F with

$$M = {\sum }_{i = 1}^{K} ( {c}_{i} - 1 )$$

numerator degrees of freedom and N−p denominator degrees of freedom, where p=M+K+1 for the hypothesis given in (5).

In addition to the hypothesis described above, Casey (2003) developed hypotheses for detecting interactions among subsets of chemicals. The hypothesis that a chemical or subset of chemicals is not involved in interactions with the remaining components of the mixture is given by

$${H}_{0} : {b}_{interact} γ = [ \begin{matrix}\frac{{θ}_{2 ( full )}^{*}}{{( {a}_{1 ( full )} )}^{2}} - \frac{{θ}_{2 ( reduced )}^{*}}{{( {a}_{1 ( reduced )} )}^{2}} \\ \frac{{θ}_{3 ( full )}^{*}}{{( {a}_{1 ( full )} )}^{3}} - \frac{{θ}_{3 ( reduced )}^{*}}{{( {a}_{1 ( reduced )} )}^{3}} \\ ⋮ \\ \frac{{θ}_{m ( full )}^{*}}{{( {a}_{1 ( full )} )}^{m}} - \frac{{θ}_{m ( reduced )}^{*}}{{( {a}_{1 ( reduced )} )}^{m}}\end{matrix} ] = 0 \qquad ( 8 )$$

where the reduced ray (parameters denoted with subscript ‘reduced’) represents the mixture study where the chemical or subset of chemicals of interest is removed from the mixture and the remaining components are studied as the same relative ratios as given in the full ray. These hypotheses compare interaction parameters along the reduced rays (e.g. the no malathion ray) to interaction parameters along the full ray. Parameter associated with the full ray (i.e. the ratios associated with each of the chemicals are non zero) are denoted with the subscript ‘full’.

For example, consider a mixture study with three chemicals. Let (a_{1(full)}:a_{2(full)}:a_{3(full)}) denote the mixing ratio. The model along the fixed-ratio ray is given by,

g(μ_{(full)})=β₀+θ*_{1(full)}t+θ*_{2(full)}t²+θ*_{3(full)}t³

where:

θ*_{1(full)}=β₁a_{1(full)}+β₂a_{2(full)}+β₃a_{3(full)},

θ*_{2(full)}=β₁₂a_{1(full)}a_{2(full)}+β₁₃a_{1(full)}a_{3(full)}+β₂₃a_{2(full)}a_{3(full)}, and

θ*_{3(full)}=β₁₂₃a_{1(full)}a_{2(full)}a_{3(full)}.

Suppose the third-order term is not significant and it is of interest to determine if the third chemical is involved in interactions with the remaining components of the mixture. Data are collected along a second fixed-ratio ray given by (a_{1(reduced)}:a_{2(reduced)}) where

$$\frac{{a}_{i ( full )}}{{a}_{j ( full )}} = \frac{{a}_{i ( reduced )}}{{a}_{j ( reduced )}} .$$

The model fit along this reduced ray is given by,

g(μ_{(reduced)})=β₀+θ*_{1(reduced)}t+θ*_{2(reduced)}t²

where:

θ*_{1(reduced)}=β₁a_{1(reduced)}+β₂a_{2(reduced)} and

θ*_{2(reduced)}=β₁₂a_{1(reduced)}a_{2(reduced)}.

Since the reduced experiment is performed at the same relative ratios as those in the original ray,

$${β}_{12} \frac{{a}_{1 ( full )} {a}_{2 ( full )}}{{( {a}_{1 ( full )} )}^{2}} = {β}_{12} \frac{{a}_{1 ( reduced )} {a}_{2 ( reduced )}}{{( {a}_{1 ( reduced )} )}^{2}} = \frac{{θ}_{2 ( reduced )}^{*}}{{( {a}_{1 ( reduced )} )}^{2}}$$

and

$$\frac{{θ}_{2 ( full )}^{*}}{{( {a}_{1 ( full )} )}^{2}}$$

becomes

$$\frac{{θ}_{2 ( full )}^{*}}{{( {a}_{1 ( full )} )}^{2}} = \frac{{θ}_{2 ( reduced )}^{*}}{{( {a}_{1 ( reduced )} )}^{2}} + {β}_{13} \frac{( {a}_{1 ( full )} ) {a}_{3 ( full )}}{{( {a}_{1 ( full )} )}^{2}} + {β}_{23} \frac{( {a}_{2 ( full )} ) {a}_{3 ( full )}}{{( {a}_{1 ( full )} )}^{2}} ⇒ \\ \frac{{θ}_{2 ( full )}^{*}}{{( {a}_{1 ( full )} )}^{2}} - \frac{{θ}_{2 ( reduced )}^{*}}{{( {a}_{1 ( reduced )} )}^{2}} = {β}_{13} \frac{( {a}_{1 ( full )} ) {a}_{3 ( full )}}{{( {a}_{1 ( full )} )}^{2}} + {β}_{23} \frac{( {a}_{2 ( full )} ) {a}_{3 ( full )}}{{( {a}_{1 ( full )} )}^{2}} .$$

The hypothesis given by,

$${H}_{0} \text{:} [ \frac{{θ}_{2 ( full )}^{*}}{{( {a}_{1 ( full )} )}^{2}} - \frac{{θ}_{2 ( reduced )}^{*}}{{( {a}_{1 ( reduced )} )}^{2}} ] = 0 ,$$

tests for the effect of the third chemical on the mixture in a pair wise manner (i.e., the significance of β₁₃ and β₂₃) If there is sufficient evidence to reject this hypothesis, we conclude that the third chemical is involved in at least one two-way interaction. Further experimentation would be necessary to determine specifically which chemicals are involved in these interactions. If we fail to reject the hypothesis and the study is reasonably powered, we can conclude that the third chemical is not involved in interactions with the other two chemicals in the mixture. The objective of this paper is to provide methodology to power such studies so that it is reasonable to ‘accept’ the null hypothesis if we fail to reject it.

3. Power and Sample Size Estimation

Sample size and power calculations are developed for the tests of additivity based on parameter estimates. Under the null hypothesis, the test statistic W, given in (6), has an approximate central F-distribution. Under the alternative hypothesis, Hₐ: bγ=(bγ)* ((bγ)* ≠0) where b is an appropriate matrix of contrast (e.g. b_{add}; b_{interact}), W follows an approximate non-central F-distribution with the same degrees of freedom and non-centrality parameter, 1, where

$$λ = \frac{1}{2 τ} {{( {( b γ )}^{*} )}^{′} [ b Ω {b}^{′} ]}^{- 1} ( {( b γ )}^{*} ) . \qquad ( 9 )$$

The power of the test is given by,

Π=P[F(M, N−p, λ)≧Fₐ(M, N−p, λ=0)], (10)

where Fₐ is the critical value of the central F-distribution with M and N−p degrees of freedom. Therefore, in order to calculate power, the non-centrality parameter and the total sample size must be specified.

Power and sample size methods condition on specified model parameters necessary to calculate the non-centrality parameter. For the interaction-model-based approach described in Section 2, single chemical data (when available) are used to estimate the intercept and first-order coefficients. Similarly, in the case where data along specific fixed-ratio rays are available, they are used to estimate higher-order interaction terms along their respective rays. Parameter values for the higher-order interaction terms associated with fixed-ratio rays where data are not available are specified based on interactions the researcher defines as biologically meaningful or from previous experience of the investigator. The value of τ is specified based on the variation researchers expect to see in the data or from the variation that is observed in the available data.

Given τ and the vector of expected model parameters, γ, McCullagh (1983) defines the large sample variance-covariance matrix as τΩ=τ[I(γ)]⁻¹. I(γ) is the expected quasi-information matrix given by

I(γ)=D′(V(μ))⁻¹D (11)

where

$$D = {[ \frac{\partial {μ}_{i}}{\partial {γ}_{j}^{′}} ]}_{\begin{matrix}i = 1 , 2 , … , N \\ j = 1 , 2 , … , P\end{matrix}} and V ( μ ) = [ \begin{matrix}V ( {μ}_{1} ) & 0 & ⋯ & 0 \\ 0 & V ( {μ}_{2} ) & ⋯ & 0 \\ ⋮ & ⋮ & ⋰ & 0 \\ 0 & 0 & ⋯ & V ( {μ}_{N} )\end{matrix} ] .$$

Recall N is the total sample size and p is the number of parameters. Notice that each row of the matrix D, given in (11), corresponds to an observation. Therefore, the variance-covariance matrix depends on the sample size allocation. The Nelder-Mead Simplex algorithm (Nelder and Mead, 1965), in combination with a bi-section algorithm, can be used to maximize the power by optimally allocating the mixture observations to the specified dose locations.

In order to demonstrate the steps used to calculate power and sample size, define power as

Π=f(q, N, Ω; τ, γ, t, α) (12)

where:

Πₑₓₚ is the desired level of power given in (10),

τ is the variation parameter,

α is the significance level (probability of rejecting the null hypothesis when it is true)

γ is a vector of model parameters,

t is a vector of total dose locations,

q is a vector of dose allocations such that Σqᵢ=1,

N is the total sample size,

W is the expected quasi-information matrix, and

Nqᵢ is the number of subjects allocated to the ith dose group.

Thus, power is a function of the model parameters, the variance-covariance matrix, the dose locations, the allocation of subjects, and the total sample size. The following steps define the process used to make power and sample size determinations:

1) Pre-specify dose locations (t), model parameters (t and g), desired level of power (Πₑₓₚ), significance level (a), maximum sample size (Nₘₐₓ), and starting values for dose allocation (q₀).

2) In the initial run of the algorithm let N₀=number of dose groups and let Nₗₐₛₜ=0, where Nₗₐₛₜ is the sample size considered in the previous run of the bi-section algorithm.

3) Use the Nelder-Mead Algorithm to determine the optimal allocation that maximizes power

a) Calculate W₀ (I(γ) given in equation (11))

b) Calculate the non-centrality parameter, 1₀, given in equation (9)

c) Calculate Π₀ using the expression given in equation (10)

d) Using the process defined by Nelder and Mead (1965), determine a new value of q and repeat steps 3(a)-(c) until q maximizes P for N₀

4) Let Pₘₐₓ represent the maximum power determined in step 3

5) Use a bi-section algorithm to increase or decrease N₀

a) If Pₘₐₓ>Πₑₓₚ+ε, where ε is a suitably small positive number, then

N=N₀

$${N}_{0} = N - \frac{( N - {N}_{last} )}{2}$$

Nₗₐₛₜ=N

b) If Pₘₐₓ<Πₑₓₚ−ε then

N=N₀

$${N}_{0} = N + \frac{( N - {N}_{last} )}{2}$$

Nₗₐₛₜ=N

6) Continue steps (2)-(4) until Πₘₐₓ∈(Πₑₓₚ−ε, Πₑₓₚ+ε) or N₀>Nₘₐₓ.

4. Application

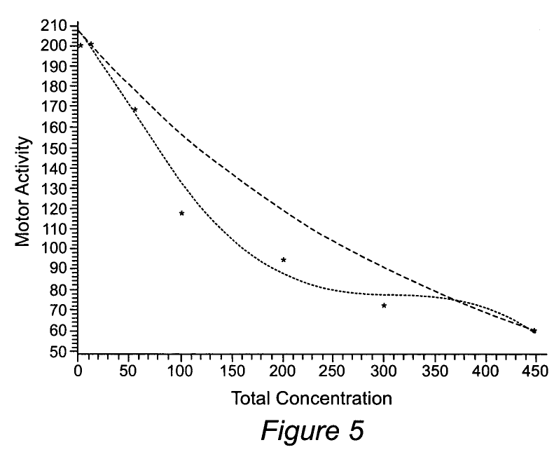

The five-pesticide study described in the introduction is used to illustrate the sample size and power methods developed in Section 3. Due to the high potential of aggregate exposure to OP pesticides, researchers were initially interested in testing the hypothesis of additivity, given in (5), along the full five-pesticide fixed-ratio ray, given by (0.040:0.002:0.031:0.102:0.825) for (acephate:diazinon:chloryprifos:malathon:dimethoate), that represents relative dietary exposure estimates. Single chemical data were collected and used to estimate an additivity model along the ray (analysis not shown). Since, the motor activity response is a count variable it was assumed that V(m)=m and the log link function (McCullagh and Nelder, 1989) was used to fit the generalized linear additivity model described in Section 2. A plot of this additivity model, seen in FIG. 5, was useful in specifying the active dose range of 0 mg/kg to 450 mg/kg along the ray. Prior to the sample size and power calculations developed here, an equally spaced design with equal allocation and extra dose points in the low dose region was chosen to study interactions along the full ray. Eighty-six animals were considered. Fourteen animals were evaluated in the control group. Twelve animals each were evaluated at 10, 55, 100, 200, 300, and 450 mg/kg. Summary statistics for the single chemical and mixture data are provided in the appendix.

Since the mixture contains five chemicals, the single chemical and mixture data were fit to the fifth-order generalized linear model given in (3). Maximum quasi-likelihood estimates were found using PROC GENMOD in SAS® (version 8.2) and are provided in Table 1. A plot of the interaction model is provided in FIG. 5. The hypothesis given by

$${H}_{0} \text{:} {b}_{add} γ = [ \begin{matrix}{θ}_{2 ( full )}^{*} \\ {θ}_{3 ( full )}^{*} \\ {θ}_{4 ( full )}^{*} \\ {θ}_{5 ( full )}^{*}\end{matrix} ] = 0 ,$$

where γ=[β₀, β₁, β₂, β₃, β₄, β₅, θ*_{2(full)}, θ*_{3(full)}, θ*_{4(full)}, θ*_{5(full)}]′ and

$${b}_{add} = [ \begin{matrix}0 & 0 & 0 & 0 & 0 & 0 & 1 & 0 & 0 & 0 \\ 0 & 0 & 0 & 0 & 0 & 0 & 0 & 1 & 0 & 0 \\ 0 & 0 & 0 & 0 & 0 & 0 & 0 & 0 & 1 & 0 \\ 0 & 0 & 0 & 0 & 0 & 0 & 0 & 0 & 0 & 1\end{matrix} ] ,$$

was used to test for departure from additivity. With a p-value of <0.001, there was sufficient evidence to reject this hypothesis and conclude departure from additivity exists along the full fixed-ratio ray. The fifth-order interaction term was not significant (p-value, 0.22); thus, it was removed from the model. In addition, the parameter associated with malathion, b₅, was removed from the model due to lack of significance (p-value, 0.85) which indicates the lack of activity of malathion. The fourth-order interaction term was marginally significant with a p-value of 0.07. Although marginal, we may conclude fourth-order interactions exist along the full ray; however, without further experimentation, we cannot determine which chemicals are involved in these interactions.

TABLE 1
Estimated model parameters where the single chemical and mixture
data along the full fixed-ratio ray are fit to the model
given in (3).

| Parameter | Estimate | SE | p-value |
|---|---|---|---|
| β₀ | 5.326 | 0.020 | <0.0001 |
| β₁ (Acephate) | −0.018 | 0.001 | <0.0001 |
| β₂ Diazinon) | −0.004 | 0.0004 | <0.0001 |
| β₃ (Chlorpyrifos) | −0.025 | 0.002 | <0.0001 |
| β₄ (Dimethoate) | −0.0123 | 0.001 | <0.0001 |
| ${θ}_{2}^{*} ( {2}^{nd} Order Interactions )$ | −3E−5 | 1E−5 | 0.0097 |
| ${θ}_{3}^{*} ( {3}^{rd} Order Interactions )$ | 1.5E−7 | 7.2E−8 | 0.0345 |
| ${θ}_{4}^{*} ( {4}^{th} Order Interactions )$ | −1.9E−10 | 1E−10 | 0.0714 |
| τ | 3.503 | | |

NOTE:
${\sum }_{i = 1}^{5} {β}_{i} {a}_{i ( full )} = {θ}_{1 ( full )}^{*} = - 0.0028 .$
The fifth order interaction term was removed from the model due to
lack of significance (p-value, 0.2203). Similarly, the parameter
associated with the slope of malathion was removed from the model
(p-value, 0.8485).

The existence of fourth-order interactions along the full fixed-ratio ray and the lack of activity of malathion provide motivation for studying interactions between malathion and the four active pesticides. That is, it is of interest to determine if malathion interacts with the other four pesticides even though it is not active alone. This can be achieved through studying a reduced ray, given by (0.2286:0.0114:0.1767:0.5833) for (acephate:diazinon:chlorpyrifos:dimethoate) where malathion is removed from the mixture and the remaining pesticides are at the same relative ratios as given in the full ray. Thus, it is of interest to determine the sample size along the reduced ray necessary to test, with reasonable power, the hypothesis that malathion does not interact with the four active pesticides. This hypothesis is given by

$${H}_{0} \text{:} {b}_{interact} γ = [ \begin{matrix}\frac{{θ}_{2 ( full )}^{*}}{{( {a}_{1 ( full )} )}^{2}} - \frac{{θ}_{2 ( reduced )}^{*}}{{( {a}_{1 ( reduced )} )}^{2}} \\ \frac{{θ}_{3 ( full )}^{*}}{{( {a}_{1 ( full )} )}^{3}} - \frac{{θ}_{3 ( reduced )}^{*}}{{( {a}_{1 ( reduced )} )}^{3}} \\ \frac{{θ}_{4 ( full )}^{*}}{{( {a}_{1 ( full )} )}^{4}} - \frac{{θ}_{4 ( reduced )}^{*}}{{( {a}_{1 ( reduced )} )}^{4}}\end{matrix} ] = 0 \qquad ( 14 )$$

where γ=[β₀, β₁, β₂, β₃, β₄, θ*_{2(full)}, θ*_{3(full)}, θ*_{4(full)}, θ*_{2(reduced)}, θ*_{3(reduced)}, θ*_{4(reduced)}]′ and

$${b}_{interact} = [ \begin{matrix}0 & 0 & 0 & 0 & 0 & \frac{1}{{( 0.04 )}^{2}} & 0 & 0 & - \frac{1}{{( 0.2286 )}^{2}} & 0 & 0 \\ 0 & 0 & 0 & 0 & 0 & 0 & \frac{1}{{( 0.04 )}^{3}} & 0 & 0 & - \frac{1}{{( 0.2286 )}^{3}} & 0 \\ 0 & 0 & 0 & 0 & 0 & 0 & 0 & \frac{1}{{( 0.04 )}^{4}} & 0 & 0 & - \frac{1}{{( 0.2286 )}^{4}}\end{matrix} ]$$

As specified in Section 3, the maximum sample size, significance level, target power, model parameter values, dose locations, and starting values for dose allocation must be specified in order to calculate power and sample size. Let alpha be 0.05, the target power be 75%, and the maximum sample size be 80 animals. Estimates for the intercept (β₀), parameters associated with the single chemical slopes (β₁, β₂, β₃, β₄), interaction parameters along the full ray (θ*_{2(full)}, θ*_{3(full)}, θ*_{4(full)}) and the variation parameter (τ) are provided from the analysis performed on the full ray (Table 1). Preliminary mixture data along the reduced fixed-ratio ray would be ideal for specifying the additional higher-order interaction terms (θ*_{2(reduced)}, θ*_{3(reduced)}, θ*_{4(reduced)}). However, since these data are not available the higher-order interaction parameters along the full ray are used as a guide to specify similar parameters along the reduced ray under the alternative hypothesis that malathion is involved in interactions with the four active pesticides. Since θ*_{2(full)}, θ*_{3(full)}, θ*_{4(full)}, a_{1(full)}, and a_{1(reduced)}, have been specified we can define a model along the reduced ray under the null hypothesis (i.e., under the assumption that malathion does not interact with the remaining pesticides). For example, consider the case where malathion is not involved in any two-way interactions. Under this assumption

$$\begin{matrix}\frac{{θ}_{2 ( full )}^{*}}{{( {a}_{1 ( full )} )}^{2}} - \frac{{θ}_{2 ( reduced )}^{*}}{{( {a}_{1 ( reduced )} )}^{2}} = 0 ⇒ \\ \frac{{θ}_{2 ( full )}^{*}}{{( {a}_{1 ( full )} )}^{2}} - \frac{{θ}_{2 ( reduced )}^{*}}{{( {a}_{1 ( reduced )} )}^{2}} ⇒ \\ \frac{{θ}_{2 ( full )}^{*}}{{( {a}_{1 ( full )} )}^{2}} * {( {a}_{1 ( reduced )} )}^{2} ) = {θ}_{2 ( reduced )}^{*} .\end{matrix} \qquad ( 15 )$$

Parameter values along the reduced ray under the null hypothesis that malathion does not interact with the active pesticides are provided in Table 2.

TABLE 2
Model parameters along the reduced fixed-ratio ray under the null hypothesis
that malathion does not interact with the remaining pesticides and the alternative
hypotheses that (a) malathion is involved in two-way interactions, (b) malathion
is involved in two and three-way interactions, and (c) malathion is involved in
two, three, and four-way interactions.

| | No | | | Two, Three |
|---|---|---|---|---|
| | Malathion | Two-way | Two and | and Four- |
| Parameter | Interactions | Only | Three-way | way |
| β₀ | 5.326 | 5.326 | 5.326 | 5.326 |
| β₁ (Acephate) | −0.018 | −0.018 | −0.018 | −0.018 |
| β₂ (Diazinon) | −0.004 | −0.004 | −0.004 | −0.004 |
| β₃ (Chlorpyrifos) | −0.025 | −0.025 | −0.025 | −0.025 |
| β₄ (Dimethoate) | −0.012 | −0.012 | −0.012 | −0.012 |
| ${θ}_{2}^{*} ( {2}^{nd} Order Interactions )$ | −9.8E−4 | −9.5E−4 | −7.84E−4 | −6.664E−4 |
| ${θ}_{3}^{*} ( {3}^{rd} Order Interactions )$ | 2.8E−5 | 2.8E−5 | 2.52E−5 | 1.96E−5 |
| ${θ}_{4}^{*} ( {4}^{th} Order Interactions )$ | −2.0E−7 | −2.0E−7 | −2.0E−7 | −1.4E−7 |
| τ | 3.503 | | | |

NOTE:
${\sum }_{i = 1}^{4} {β}_{i} {a}_{i ( nomal )} = {θ}_{1 ( nomal )}^{*} = - 0.0157 .$

Using the no malathion interaction case as a guide, we can specify model parameter values under the alternative hypothesis based on cases that are of interest to investigators. First, we consider the case that malathion is involved in two-way interactions. In this case the third and fourth-order interaction terms represent the no malathion interaction case (calculated following the process defined in (15)) and the second-order interaction term is specified based on changes in the mean values that researchers define as biologically meaningful. We also consider the case where malathion is involved in two and three-way interactions and the case where malathion is involved in two, three, and four-way interactions. The interaction model parameter values along the reduced ray for these three cases are provided in Table 2.

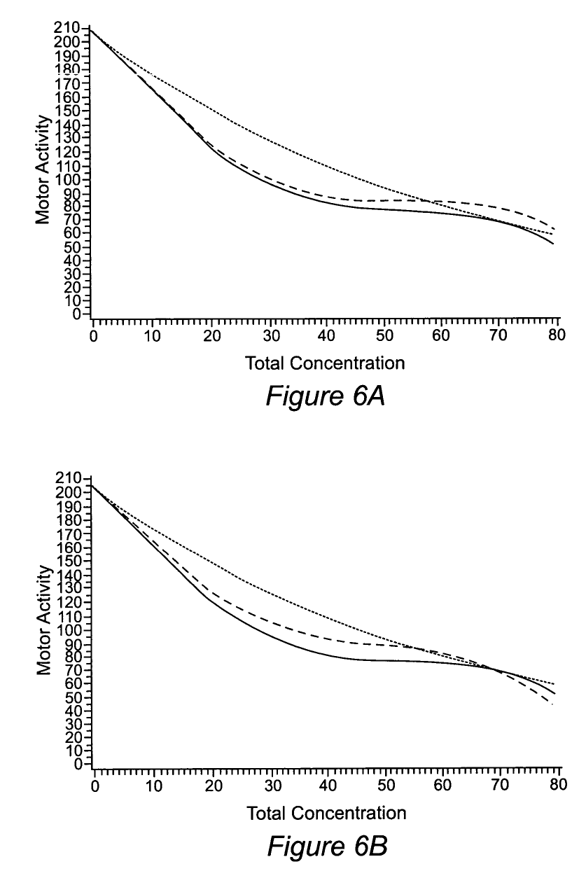

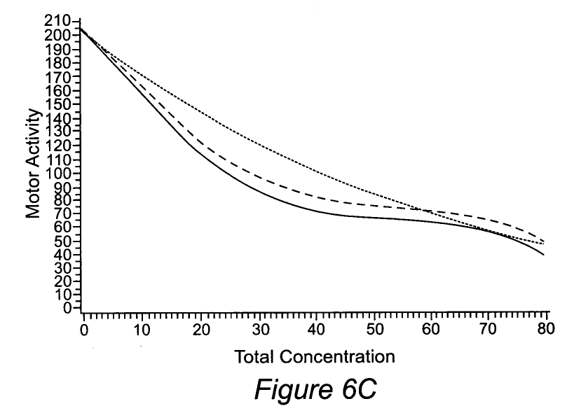

In addition to using the parameter estimates under the null hypothesis or no malathion interaction case, plots of the interaction models under the alternative hypotheses and tables of total dose values where a given percent change in the mean value occurs between the no malathion interaction case and the specified alternative cases are useful in defining biologically meaningful interactions. The plots are provided in FIGS. 6(a-c). The additivity model along the reduced ray is also provided to aid in the interpretation of the interaction model specified under the alternative hypothesis. Table 3 provides the doses where a given percent change in the mean response is observed between the no malathion interaction case and the models specified under the alternative hypotheses. Since the generalized linear model is nonlinear, the differences in the curves are not constant. For example, if we are interested in detecting at least a 5% change in the mean for the two-way interaction case, the minimum total dose value that is associated with such a change is 40.33 mg/kg.

TABLE 3
Lowest total dose values along the reduced fixed-ratio ray
that result in 5%, 10%, 15%, and 20% changes in mean
responses between the model under the null hypothesis and
the model that assumes (a) malathion is involved in 2-way interactions,
(b) malathion is involved in 2 and 3-way interactions, and (c)
malathion is involved in 2, 3, and 4-way interactions. Assumed
parameter values for each of the models are given in Table 2.

| | | | Two, Three, and |
|---|---|---|---|
| Change in | Two-way | Two and Three-Way | Four-Way |
| Mean | Interactions | Interactions | Interactions |
| 5% | 40.33 | 18.37 | 15.78 |
| 10% | 56.36 | 28.71 | 27.04 |
| 15% | 68.25 | 42.98 | 77.69 |
| 20% | 77.96 | 81.88 | 81.46 |

Thus far, we have analyzed available single chemical data and mixture data along the full fixed-ratio ray to develop a hypothesis of interest and to provide some of the parameter estimates necessary to calculate power and sample size. We have used the available information provided by the analysis, in combination with plots, to specify additional model parameter values associated with the alternative hypotheses of interest. In order to determine the optimal allocation of the 80 available animals to detect interactions involving malathion with 75% power at a significance level of 0.05, we need to specify dose locations and starting values for dose allocation. FIGS. 2(a-c) are helpful in specifying the dose range and dose locations along the reduced fixed-ratio rays. The design considered along the reduced ray is similar to the design considered along the full ray where the doses are equally space with extra dose groups in the low dose region. The total dose values along the reduced fixed-ratio ray are given by 2, 10, 20, 35, 50, and 80 mg/kg. Eight control observations were pre-specified along the reduced ray. Initially we assume equal allocation across the remaining dose groups. The Nelder-Mead search algorithm (Nelder and Mead, 1965) is used to determine the optimal allocation to the six total dose groups.

The results of the power and sample size calculations for the three cases under consideration are provided in Table 4. In the case where we assume that malathion is involved in two and three way interactions, 80 animals are not sufficient to provide the desired level of power. In the case where we assume that malathion is only involved in two-way interactions, 77 animals and provide 87% power. However, notice that most of the animals are allocated to the 50 mg/kg and 80 mg/kg dose groups. These dose groups are located where the largest differences between the model under the alternative hypothesis (i.e., malathion involved in second order interactions) and the model under the null hypothesis (i.e., no interactions due to malathion) occur (see FIG. 6(a)).

TABLE 4
Power and sample size results for the hypothesis given in (14) where
parameter estimates along the full fixed-ratio ray are given in Table 1
and assumed parameter values along the reduced fixed-ratio ray
under the alterative hypotheses are given in Table 2.

| | | | Two, Three, and |
|---|---|---|---|
| | Two-Way | Two and Three- | Four-way |
| | Interaction | way Interactions | Interactions |
| Power | 87% | 58% | 76% |

Sample Size Allocation

| | | | |
|---|---|---|---|
| Control Group | 8 | 8 | 8 |
| 2 | 0 | 12 | 8 |
| 10 | 1 | 12 | 7 |
| 20 | 1 | 12 | 8 |
| 35 | 1 | 13 | 9 |
| 50 | 33 | 13 | 9 |
| 80 | 33 | 11 | 9 |
| Total Sample Size | 77 | 81 | 58 |

It is not likely that allocating one or two animals to particular dose groups will be appropriate in real-world situations. Thus, we suggest using these results as a guide and adjusting the sample size and allocation based on experience of the investigator. For example, consider the two-way interaction case presented in Table 4. No animals were allocated to the 2 mg/kg dose group and only one animal was allocated to the 10, 20, and 35 mg/kg dose groups. Consider reducing the sample size at 50 and 80 mg/kg and increasing the number of observations at the other dose locations. For example, suppose instead of allocating 8, 0, 1, 1, 1, 33, and 33 and animals respectively to the 0, 2, 10, 20, 35, 50, and 80 mg/kg dose groups we consider allocating 8, 6, 6, 6, 6, 22, and 23 animals respectively. This modified allocation results in 83% power, as compared to 87% power with original allocation, for testing the hypothesis that malathion interacts with the four active pesticides. Modifying the original allocation resulted in reduced power; however, the decrease in power was not significant (i.e., adjusted sample size allocation results still provided reasonable power to test the hypothesis of interest). Alternatively, when possible, extra animals can be added to the dose groups with low allocation leaving the allocation to the remaining dose groups unchanged. Adding these extra animals will result in increased power since the total sample size increased. In either case, before running an experiment with adjusted sample size allocations it is important to determine the power associated with the hypothesis of interest to ensure the new allocations are appropriate.

5. Discussion

Power and sample size are important issues when designing experiments to test particular hypotheses of interest. Since humans are exposed to hundreds of chemicals though a variety of sources, it is of particular importance to have sufficient power to test the null hypothesis of zero interaction. Without sufficient power we may fail to reject the hypothesis when it is false. In this case, the claim of additivity is weak and decisions based on this weak claim may result in adverse effects.

Meadows et al. (2002b) discussed sample size and power issues for testing departure from additivity at specific mixture points where the test for departure from additivity is based on a comparison of the predicted mean response under additivity to the true mean response. The methods proposed here permit sample size and power determination for detecting departure from additivity along multiple fixed-ratio rays simultaneously and for testing for interactions involving a particular compound or subset of compounds on interactions in the presence or absence of single chemical data. These parametric based power and sample size methods are appropriate for any hypothesis involving linear combinations of the model parameters. In order to use these methods the investigator must supply the maximum sample size, the target power, the significance level, specified total dose locations, and model parameter values under the alternative hypothesis.

The examples determine the sample size allocation necessary to test, with reasonable power, the effect of malathion on the four active pesticides. For ease of notation, the methods in this paper were developed for the generalized linear model. In evaluating the risk associated with exposure to mixtures, it is often of interest to detect a threshold (Schwartz et al., 1995). The methods outlined in this paper are readily extended to the threshold model (Casey, 2003). Observations are heavily allocated to dose groups where larger differences occur, as was demonstrated in the generalized linear model example where it is assumed that malathion is involved in two-way interactions. The examples also indicate that equal allocation is not always optimal and larger differences between the models specified under the null and alternative hypotheses result in increased power.

References

Aspelin, A. L. (1994), Pesticide Industry Sales and Usage: 1992 and 1993 Market Estimates, Office of Pesticides Programs, U.S. Environmental Protection Agency, EPA 733-K-94-001, Washington, D.C.

Berenbaum, M. C. (1981), “Criteria for Analyzing Interaction Between Biologically Active Agents,” Journal of the American Statistical Association, 78, 90-98.

Carter, W. H., Jr., Gennings, C., Staniswalis, J., Campbell, E., and White, K. (1988), “A Statistical Approach to the Construction and Analysis of Isobolograms,” Journal of the American College of Toxicology, 7, 963-973.

Casey, M. A. (2003), Statistical Methodology for Exploiting the Use of Ray Designs in Studies of Polychemical Mixtures, Unpublished Ph.D. Dissertation, Virginia Commonwealth University, Department of Biostatistics.

Cohen, S. D. (1984), “Mechanisms of Toxicological Interactions Involving Organophosphate Insecticides,” Fundamental and Applied Toxicology, 4, 315-324.

DuBois, K. P., (1961), “Potentiation of the Toxicity of Organophosphorus Compounds,” Advances in Pest Control Research, 4, 117-151.

[EPA] U.S. Environmental Protection Agency (1999), Guidance for Conducting Health Risk Assessment of Chemical Mixtures, NCEA-C-0148, External Scientific Peer Review Draft, April 1999, EPA, Washington, D.C.

Gennings, C., Carter, W. H., Jr., Campain, J., Bae, D, Yang, R. (2002), “Statistical Analysis of Interactive Cytotoxicity in Human Epidermal Keratinocytes Following Exposure to a Mixture of Four Metals,” Journal of Agricultural, Biological, and Environmental Statistics, 17, 58-73.

McCollister, D. D., Oyen, F., and Row, V. K. (1959), “Toxicological Studies of O, O-dimethyl-0-(2,4,5-trichlorophenyl) phosphorothionate (Ronnel) in Laboratory Animals,” Journal of Agricultural and Food Chemistry, 7, 689.

McCullagh, P. (1983), “Quasi-likelihood Functions,” The Annals of Statistics, 11, 59-67.

McCullagh, P., Nelder, J. A. (1989), Generalized Linear Models (2^{nd} ed.), New York: Campman and Hall, 511pp.

Meadows, S. L., Gennings, C., and Carter, W. H., Jr. (2002a), “Experimental Designs for Mixtures of Chemicals along Fixed-Ratio Rays,” Environmental Health Perspective, 110, 979-983.

Meadows, S. L., Gennings, C., and Carter, W. H., Jr. (2002b), “Sample Size and Power Determination for Detecting Interactions in Mixtures of Chemicals,” The Journal of Agricultural, Biological, and Environmental Statistics, in review.

Nelder, J. A. and Mead, R. (1965), “A Simplex Method for Function Minimization,” The Computer Journal, 7, 308-313.

Schwartz, P. F., Gennings, C., and Chinchilli, V. M., (1995), “Threshold Models for Combination Data From Reproductive and Developmental Experiments,” Journal of the American Statistical Association, 90, 862-870.

Wedderburn, R. W. M. (1974), “Quasi-Likelihood Functions, Generalized Linear Models, and the Gauss-Newton Method,” Biometrika, 61, 439-447.

APPENDIX
Summary statistics for motor activity response associated
with the single chemical data.

| | | Mean Motor | | |
|---|---|---|---|---|
| | Dose | Activity | Standard | |
| Chemical | (mg/kg) | Response | Deviation | Sample Size |
| Acephate | 0 | 217.88 | 35.77 | 8 |
| | 3 | 200.13 | 34.13 | 8 |
| | 10 | 165.88 | 25.02 | 8 |
| | 30 | 108.75 | 62.51 | 8 |
| | 60 | 58.25 | 24.23 | 8 |
| | 120 | 33.25 | 27.41 | 8 |
| Diazinon | 0 | 206.69 | 34.77 | 16 |
| | 5 | 190.88 | 28.49 | 16 |
| | 25 | 215.56 | 24.02 | 16 |
| | 50 | 183.13 | 24.44 | 8 |
| | 75 | 165.69 | 33.05 | 16 |
| | 125 | 152.00 | 38.65 | 8 |
| | 150 | 76.5 | 35.4 | 8 |
| | 250 | 61.25 | 47.07 | 8 |
| Chlorpyrifos | 0 | 190.00 | 14.36 | 8 |
| | 2 | 192.75 | 38.61 | 8 |
| | 10 | 172.13 | 17.55 | 8 |
| | 20 | 157.13 | 28.31 | 8 |
| | 30 | 80.13 | 34.85 | 8 |
| | 50 | 56.38 | 29.98 | 8 |
| Malathion | 0 | 195.86 | 19.06 | 7 |
| | 100 | 201.5 | 28.38 | 8 |
| | 500 | 203.75 | 28.34 | 8 |
| Dimethoate | 0 | 195.75 | 33.12 | 8 |
| | 5 | 188.25 | 24.21 | 8 |
| | 10 | 188.63 | 53.05 | 8 |
| | 25 | 107.75 | 37.23 | 8 |
| | 50 | 103.75 | 51.59 | 8 |
| | 75 | 101.50 | 59.57 | 8 |

Summary statistics for motor activity response associated with mixture data along the full fixed-ratio ray.

Summary statistics for motor activity associated with mixture data
along the full fixed-ratio ray

| Total | Mean Motor | | |
|---|---|---|---|
| Concentration | Activity | Standard | |
| Dose (mg/kg) | Response | Deviation | Sample Size |
| 0 | 199.43 | 20.77 | 14 |
| 10 | 200.92 | 27.10 | 12 |
| 55 | 167.92 | 37.55 | 12 |
| 100 | 117.08 | 47.34 | 12 |
| 200 | 95.17 | 34.03 | 12 |
| 300 | 72.25 | 40.93 | 12 |
| 450 | 60.08 | 46.36 | 12 |

### Example 3

### Analysis of Functional Effects of a Mixture of Five Pesticides using a Ray Design

Introduction

With support from government agencies, industry, and scientific societies (including the National Institute of Environmental Health Sciences, the American Chemistry Council, the U.S. Environmental Protection Agency, the Society for Environmental Toxicology and Chemistry, and the Chlorine Chemistry Council) the Society of Toxicology recently spearheaded a series of activities intended to advance the scientific understanding of environmental mixtures. An expert Working Group was charged with evaluating the state of the science on environmental mixtures, providing a conceptual framework for future mixtures research, and suggesting potential areas for empirical and mechanistic experimentation. A resulting white paper was published (Teuschler et al, 2002) which outlined three key ideas with extended discussion. The first key idea stated that “toxicology experiments on whole mixtures or mixtures components should include doses at or below the no-observed-effect levels [NOAELs/NOELs] for individual mixture components. The mixture components that are tested and their relative proportions in the mixture also should reflect those seen in environmental samples. In addition, the impact of the unidentified materials in the mixtures should be considered.”

Existing methods for conducting chemical mixture health risk assessments were developed to use available experimental animal data as well as the human health effects data in the toxicological and epidemiological literature (Teuschler et al, 2002). These methods generally rely on default (e.g., dose addition) assumptions whose validity is unknown (ATSDR, 2000a; 2000b; 2000c; U.S. EPA, 2000). Recent congressional acts mandate regulatory evaluations to be based on the toxicities of the mixtures, not just toxicities of the components. Recent congressional acts include a focus on mixtures. For example, the Food Quality Protection Act of 1996 directs that assessments of pesticide safety include consideration of the risk(s) associated with the cumulative effects of chemicals that have a common mode of action while the Safe Drinking Water Act Amendments, also of 1996, requests the development of new approaches for studying complex mixtures. Chemical mixtures risk assessment methods fall into the two general categories of whole mixture approaches (in which complex mixtures are evaluated as though they are single entities) and component-based approaches (in which the interaction of certain individual components in a mixture are considered to estimate toxicity of the mixture) (Teuschler et al, 2002).

The toxicity of a mixture depends on the toxicity of the components and how the components interact with each other in a dose-dependent way. In some cases the toxicity of a mixture may be adjusted by selecting/changing industrial or environmental processes that produce the mixture. For example, a chlorination process and an ozonation-chloramination process in disinfecting drinking water may result in different levels of disinfectant by-products in drinking water. Usage and application rates of fungicides, insecticides and herbicides depend on many factors. The selection of particular pesticides and/or their application limits could be based on knowledge of which chemicals combine synergistically. In general, for industrial/regulatory decision-makers to select/change these processes, it is important to identify whether or not the components of the mixture, including the unidentified fraction, are acting additively.

Practical methods for assessing additivity in mixtures with many components and, in particular the impact of the unidentified materials, have only recently been developed (Casey et al, 2003a, b) and are not widely available to decision makers. Such methods must accommodate economical and practical designs for more than binary and tertiary mixtures. The methods must be useful for low-dose exposures and reflect the toxicities associated with the relative proportions of the mixture as seen in environmental samples including the unidentified fraction. An experimental design that satisfies these requirements is the ‘ray design.’ A ray is defined by a fixed mixing ratio of the components in a specified mixture. The dose-responsiveness of the mixture is evaluated in terms of the total dose/concentration of the mixture with the ratio of the components fixed. A statistical model that allows for the evaluation of the low-dose region is a threshold model (Cox, 1987). If the researcher is willing to assume the possibility of the existence of a threshold, then such a model is useful for estimating the threshold dose, below which responses are assumed to be not different from background. When used with a ray design, the analyst evaluates the dose threshold in terms of total dose for the exposure relevant mixture. Based on information/data from single components of the mixture, the predicted dose-response relationship under the assumption of additivity can be compared to that observed from the mixture. Such a strategy for evaluating mixtures has been previously described (Gennings et al, 1997, 2002; Meadows et al, 2002; and Casey et al, 2003a,b).

The objective of this manuscript is to demonstrate this strategy with a mixture of five pesticides (acephate (ACE), diazinon (DIA), chlorpyrifos (CPF), malathion (MAL) and dimethoate (DIM)). The endpoint of interest is neurotoxicity in rats as measured by a gait score dichotomized to indicate presence or absence of a gait abnormality (i.e., incoordination, loss of balance, etc.). The fixed-ratio ray under study was chosen based on the relative dietary exposure estimates of each chemical as projected by the U.S. EPA Dietary Exposure Evaluation Model (DEEM) and is given by (0.040:0.002:0.031:0.825:0.102) for ACE, DIA, CPF, MAL, DIM, respectively. The data from the five chemical mixture study are referred to as ‘full ray’ data. In order to evaluate the effect of one pesticide (MAL) on the dose-response relationship of the other four pesticides, a ‘reduced ray’ was experimentally evaluated where the remaining four pesticides are fixed at the same relative proportions as considered in the full ray, i.e., (0.229:0.011:0.177:0:0.583) for (ACE:DIA:CPF:MAL:DIM). (Note: Such a strategy can be extended for identifying the impact of the unidentified fraction in a complex mixture.)

Additivity Model

The definition of additivity we use is given by Berenbaum (e.g., 1985) and is based on the classical isobolograms for the combination of two chemicals (e.g., Loewe and Muischnek, 1926; Loewe, 1953). That is, in a combination of c chemicals, let Eᵢ represent the dose of the i^{th} component alone that yields a fixed response, and let xᵢ represent the concentration/dose of the i^{th} component in combination with the c agents that yields the same response. According to this definition of additivity if the substances combine additively, i.e., with zero interaction, then

$${\sum }_{i = 1}^{c} \frac{{x}_{i}}{{E}_{i}} = 1. \qquad ( 1 )$$

If the left-hand side of (1) is less than 1, then a synergism can be claimed at the combination of interest. If the left-hand side of (1) is greater than 1, then an antagonism can be claimed at the combination. As (1) is the equation of a plane in c dimensions, this definition of additivity implies that under additivity contours of constant response are planar. In what follows, the additivity models satisfy both the definition given in (1) and the fundamental notion of ‘no interaction’ (Gennings et al, 2003), i.e., that the rate of change (slope) in the response as a function of the i^{th} chemical does not change in the presence of other chemicals.

Response surface methodology, often supported by factorial designs, is the classical statistical experimental approach for testing for departure from additivity. Alternatively, fixed-ratio ray designs have been proposed (e.g., Gennings et al, 2002, Meadows et al, 2002) to reduce the amount of experimental effort when the exposure region of interest is restricted to relevant mixing ratios. Two analysis strategies are demonstrated here and result in similar conclusions. The first approach is similar to that described by Gennings et al (2002) applied to a threshold additivity model, and is termed the ‘single agents required’ (SAR) method; the second approach (Meadows et al, 2002 and Casey et al, 2003a) is termed the ‘single agents not required’ (SANR) method.

The general strategy begins by using the single chemical data to fit a threshold additivity model. The threshold additivity model is used to estimate the dose-response relationship along the fixed-ratio ray(s) of interest (in terms of total dose) under the hypothesis of additivity. This additivity model is used to provide power/sample size calculations to design the mixture study with adequate power to detect biologically meaningful interactions. The mixture data are then experimentally generated and fit to a threshold model in terms of total dose. For the SAR method, the mixture model is statistically compared to the predicted model under additivity. If the models are determined to be different, then evidence of departure from additivity is inferred. Otherwise, no departure from additivity is inferred. When the studies have the power to detect a biologically meaningful departure from additivity and there is not significant evidence of departure from additivity, additivity can be claimed.

The SANR method assumes a general parameterization of the underlying multidimensional response surface (in this case 6 dimensions). The result is that the terms in a polynomial model along a fixed ratio ray are associated with interaction terms in the underlying model (Meadows et al, 2002; Casey et al, 2003a). For example, a significant cubic term in the mixture model is an indication of a three-way interaction among the chemicals in the mixture.

The threshold additivity model (e.g., Gennings et al, 1997) is of the form

$$g ( {μ}_{A} ) = \{ \begin{matrix}\{ \begin{matrix}{β}_{0} & if {\sum }_{i = 1}^{5} {β}_{i} {x}_{i} < δ \\ {β}_{0} + {\sum }_{i = 1}^{5} {β}_{i} {x}_{i} - δ & if {\sum }_{i = 1}^{5} {β}_{i} {x}_{i} \geq δ\end{matrix} \} , if {β}_{i} \geq 0 , ∀ i \\ \{ \begin{matrix}{β}_{0} & if {\sum }_{i = 1}^{5} {β}_{i} {x}_{i} \geq δ \\ {β}_{0} + {\sum }_{i = 1}^{5} {β}_{i} {x}_{i} - δ & if {\sum }_{i = 1}^{5} {β}_{i} {x}_{i} < δ\end{matrix} \} , if {β}_{i} < 0 , ∀ i\end{matrix} \} \qquad ( 2 )$$

where

g(μ_{A}) is the specified link function (McCullagh and Nelder, 1989) of the response of interest,

xᵢ is the dose of the i^{th} single chemical,

β₀ is an unknown parameter associated with the overall intercept,

βᵢ is an unknown parameter associated with the slope of the i^{th} pesticide dose response,

δ is the unknown parameter associated with the threshold for the additivity model.

Using this model, the parameter associated with the dose of the threshold for the i^{th} chemical is given by

$${δ}_{i}^{*} = \frac{δ}{{β}_{i}} , i = 1 , … , 5.$$

If the model fits a threshold outside the experimental range (resulting in an over-parameterized model), then the corresponding generalized linear model is used, i.e.,

$$g ( {μ}_{add} ) = {β}_{0} {\sum }_{i = 1}^{5} {β}_{i} {x}_{i} . \qquad ( 3 )$$

Let the mixing ratio of chemicals of interest be denoted as (a₁:a₂:a₃:a₄:a₅) such that

$${\sum }_{i = 1}^{c = 5} {a}_{i} = 1.$$

Following Gennings et al (2002) and using the definition of additivity given in (1) and the additivity models in either (2) or (3), the slope along the fixed-ratio ray design under additivity is given by

$${\sum }_{i = 1}^{c} {a}_{i} {β}_{i} .$$

The biological endpoint of interest is an indicator of neurotoxicity based on evidence of the presence or absence of a gait abnormality (Moser, 1995). In order to appropriately constrain the probability of a response to be between 0 and 1, a logit link function was used, i.e., g(μ)=log(μ/(1−μ)). It was assumed throughout that the variance changes as a binomial random variable such that Var(Y)=τμ(1−μ) (e.g., McCullagh and Nelder, 1989).

Parameter estimates for the threshold model in (2) are found using the maximum quasi-likelihood criterion (e.g., McCullagh and Nelder, 1989) in a Nelder Mead algorithm (Nelder and Mead, 1965). Parameter estimates for the generalized linear model given in (3) were found using the maximum quasi-likelihood criterion using a Fisher scoring algorithm in Proc GENMOD in SAS (version 8.2). A moment estimate for τ (McCullagh and Nelder, 1989) was used. Adequacy of the fit of the model to the data was assessed graphically and by comparing the scaled deviance to a χ²_{N-p} distribution where N is the total sample size and p is the number of model parameters.

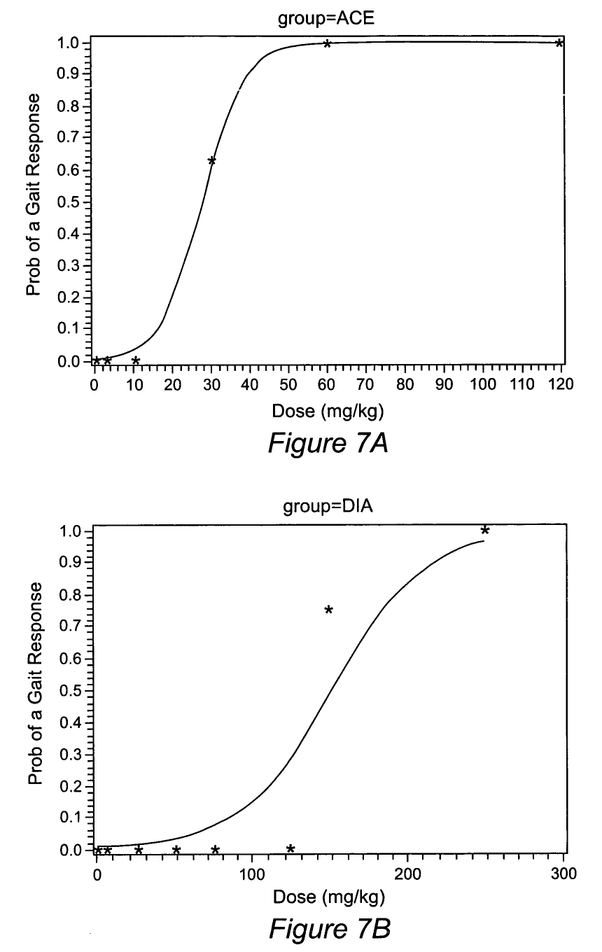

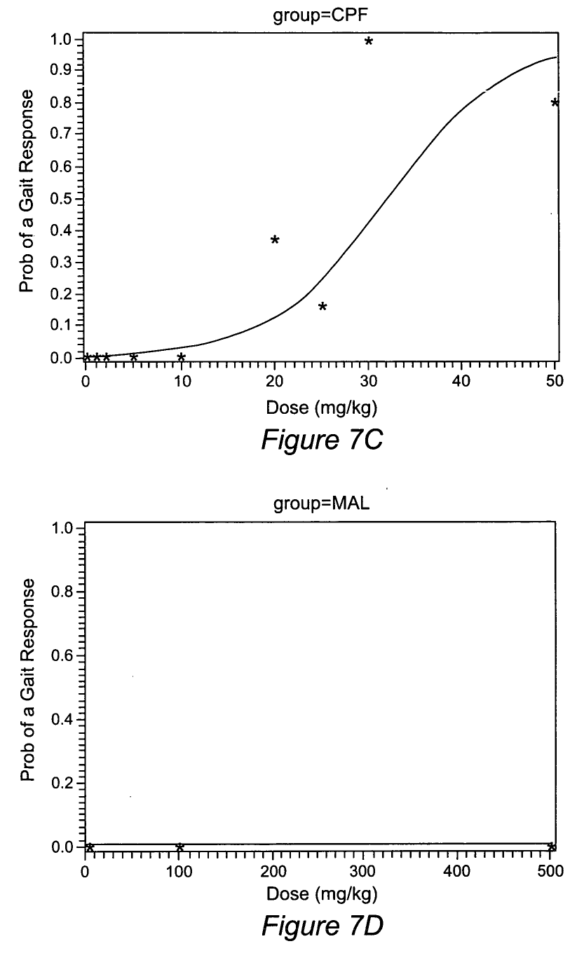

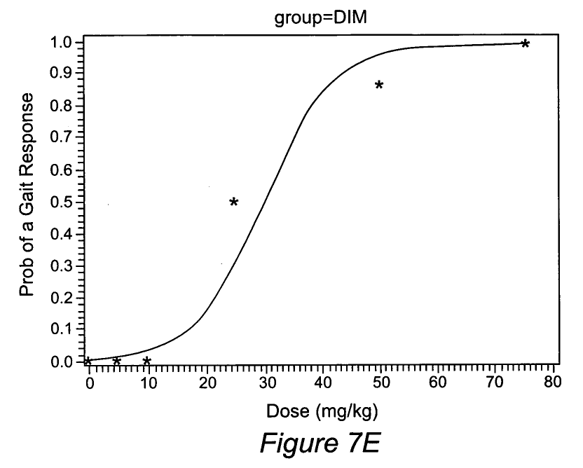

Initially the threshold model given in (2) was fit to the data. The dose threshold estimates were all outside of the experimental region; thus the corresponding generalized linear model given in (3) was used as the additivity model. Parameter estimates and associated p values are provided in Table 1. Plots of the observed and model predicted responses are provided in FIG. 7. The single chemical data are adequately represented by the additivity model (p=0.341, using scaled deviance as an assessment of fit).

TABLE 1
Parameter estimates and associated p values from the additivity
model given in (3). The slope for MAL was not included as no
gait abnormalities were observed in the experimental range for MAL.
The estimate for the scale parameter was \hat{τ} = 1.187.

| Parameter | Estimate | Standard Error | P value |
|---|---|---|---|
| β₀ | −5.130 | 0.7061 | <0.001 |
| β₁ (ACE) | 0.1868 | 0.0368 | <0.001 |
| β₂ (DIA) | 0.0338 | 0.0063 | <0.001 |
| β₃ (CPF) | 0.1605 | 0.0268 | <0.001 |
| β₅ (DIM) | 0.1711 | 0.0373 | <0.001 |

In addition to gait score, other biological and neurochemical endpoints were taken. Sample size estimates (n=12/mixture group) were calculated for motor activity data to detect a 25% decrease (i.e., more negative) in the slope of the dose-response curve along the fixed-ratio ray from that under additivity with 70% power using a Wald-type test (as described in Casey et al, 2003c) with a two-sided test with 5% significance. When the decrease in the slope was 30%, the resulting power was 84%.

As the mixture studies were not run concurrently with the single chemical studies, it is important to demonstrate that the single chemical dose-response curves do not shift across the studies (mixture and single chemical). ‘Positive control’ values of the single chemicals were included in the mixture studies for this purpose. The resulting mixture experiment consisted of a vehicle control (n=14), ‘positive controls’ for ACE alone (6 and 30 mg/kg; n=6, 14, respectively), CPF alone (10, 20, 30 mg/kg; n=6, 8, 6, respectively), DIAZ alone (50 and 125 mg/kg; n=6, 14, respectively), MAL alone (350 mg/kg; n=14), DIM alone (10, 25, 50 mg/kg; n=6, 8, 6, respectively), and six total dose mixture concentrations (10, 55, 100, 200, 300 and 450 mg/kg; n=12 rats per dose group for a total of 72 rats exposed to a mixture of the chemicals) at a fixed mixing ratio ray of (0.040:0.002:0.031:0.825:0.102) for (ACE:DIA:CPF:MAL:DIM). Similarly, the design for a second fixed-ratio ray was based on a reduced number of the pesticides (omitting MAL) with the remaining pesticides at the same relative proportions as in the ‘full’ mixture study. The experiment consisted of a vehicle control (n=8), positive controls (n=8 per group) for ACE (30 mg/kg), CPF (20 mg/kg), DIA (125 mg/kg), and DIM (25 mg/kg), and six total dose mixture concentrations (1.75, 9.6, 17.5, 35, 52.5, and 78.8 mg/kg; n=12 rats per dose group) at a fixed mixing ratio ray of (0.229:0.011:0.177:0.583) for (ACE:DIA:CPF:DIM). Casey et al (2003a,b) describe the motor activity data in the mixture of these five pesticides.

‘Single Agents Required’ Method

Following the logic of Gennings et al (2002), for comparison to the additivity model along the fixed-ratio rays given by (3), the mixture data were fit to a ‘mixture model’ along each ray in terms of total dose.

g(μₘᵢₓ)=β₀+θ*₁t. (4)

In order to achieve adequate fit to the data, higher order terms in total dose are added to (4) when necessary.

The five vehicle control groups for the single chemical data and the vehicle control groups for the two mixture studies resulted in no gait abnormalities. Therefore, since the background rate is similar across the studies, the additivity model in (3) and the mixture model in (4) for both the full and reduced rays were fit simultaneously in an overall model with a common background parameter, β₀. In addition, the two mixture studies included at least one ‘positive control’ group for each of the single chemicals alone. Preliminary analyses (not shown) of all of the data combined did not find evidence of a shift in the dose response curves from the original single chemical studies using the positive control data (p=0.515). Therefore, the overall model was based on the single chemical data and the mixture data combined.

The overall model included a common intercept term, linear terms for each of the single chemicals (excluding MAL), a linear and quadratic term in total dose for the full ray, and a linear term in total dose for the reduced ray (described above), which adequately represented the data (p=0.672, i.e., no indication of lack of fit). The resulting parameter estimates and associated p values are provided in Table 2. As the linear parameters associated with total dose along both the full and reduced rays are significant, there is evidence that as the total dose of the mixture increases, the probability of a gait abnormality also increases.

TABLE 2
Parameter estimates and associated p values from the full
SAR analysis. The estimate for the scale parameter
was \hat{τ} = 1.44. The overall hypothesis of additivity was
rejected (p = 0.040, with 3 degrees of freedom (df)).
The hypothesis of additivity along the full ray was rejected
(p = 0.046, with 2 df) but was not rejected along the reduced
ray (p = 0.486, 1 df). The hypothesis of no malathion
effect was rejected (p = 0.016, 2 df).

| Parameter | Estimate | Standard Error | P value |
|---|---|---|---|
| β₀ | −3.9663 | 0.4905 | <0.001 |
| β₁ ACE | 0.1474 | 0.0364 | <0.001 |
| β₂ DIA | 0.0256 | 0.0054 | <0.001 |
| β₃ CPF | 0.1250 | 0.0217 | <0.001 |
| β₅ DIM | 0.1335 | 0.0328 | <0.001 |
| θ₁₍₁₎ full ray linear | 0.0472 | 0.0101 | <0.001 |
| θ₂₍₁₎ full ray quadratic | −0.0001 | <0.0001 | 0.007 |
| θ₁₍₂₎ reduced ray linear | 0.1166 | 0.0209 | <0.001 |

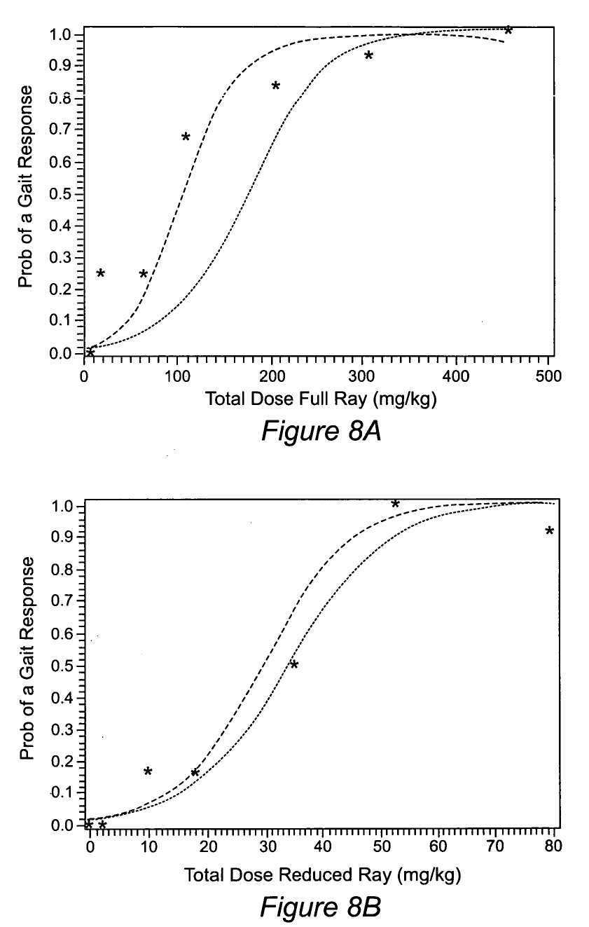

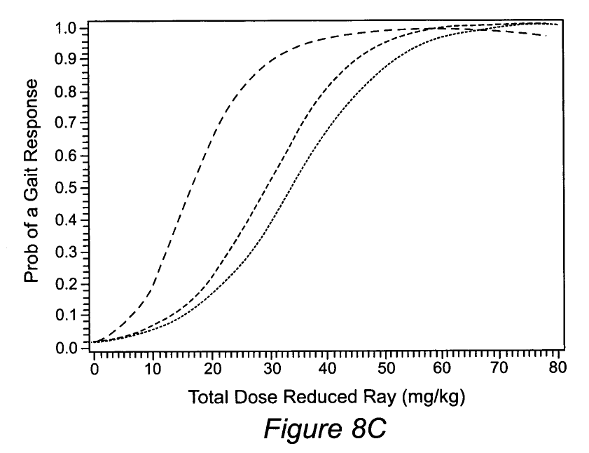

From the parameter estimates given in Table 2, plots of observed and predicted responses along both fixed-ratio mixture rays are provided (FIG. 8) based on the mixture model and under the assumption of additivity. Following the approach in Gennings et al (2002), as the curve predicted using the mixture model for the full mixture ray falls significantly above the predicted dose response curve under the assumption of additivity (FIG. 8A) (p=0.046), it can be inferred that the overall effect of the specified fixed-ratio of the five pesticides is associated with a greater than additive, or synergistic, relationship. Further, there is not a significant difference (FIG. 8B) in the dose response curves from the mixture model and that predicted under the assumption of additivity for the mixture (omitting MAL) along the reduced ray (p=0.486). Following the logic of Casey et al (2003b), this indicates that the interaction (i.e., synergy) in the full ray may be associated with the presence of MAL. Casey et al (2003b) developed a method for combining the results from multiple rays with the same relative ratios (like the full and reduced rays here) in the same figure. If the adjusted dose-response curve from the full ray is identical to the dose-response curve on the reduced ray, then it indicates the chemical or subset of chemicals that were removed in the reduced ray do not interact with the remaining chemicals. For these data, testing for the difference in the corrected and corresponding parameters from the full and reduced rays (Casey et al, 2003b) indicates that the presence of MAL significantly (p=0.016) changes the shape of the dose response curve in the full ray. This is elucidated in FIG. 2C where the dashed curve corresponds to the adjusted dose-response curve from the five-pesticide mixture plotted with the dose response curve without MAL (solid curve). These dose-response curves are significantly different due to the presence of MAL. The total dose that is associated with a 50% response (ED₅₀) for the four pesticides in the absence of malathion is about 34 mg/kg. In the presence of malathion it is roughly 19 mg/kg. This nearly two-fold difference indicates the magnitude of the effect of the synergism at a 50% response level. It is apparent from FIG. 8C that the magnitude of the synergism is dependent on the level of the effect (i.e., 10%, 50%, etc.).

‘Single Agents Not Required’ Method

Following the methods of Meadows et al (2003) and Casey et al (2003a), a comparison analysis strategy to the SAR method is based on an assumption of a general parameterization of the underlying six-dimensional (five chemicals and one response dimension) response surface. Meadows et al (2003) showed that polynomial terms of degree two or greater for the model along a fixed-ratio ray are associated with interactions among the chemicals in a mixture. Casey et al (2003a) generalized this result to the case of multiple mixture rays and termed this approach the ‘single agents not required’ (SANR) method. As the name suggests, the method is applicable to the case where single agent data are not available for estimation of the additivity relationship. This information is ‘replaced’ with the assumption of the parametric form of the underlying response surface. However, if single agent data are available, they can be used to support the estimation of the corresponding parameters in the model.

In comparison to the mixture model in (3), here we allow for higher degree terms, which are interpreted as being associated with interactions. The interaction model for a mixture of c chemicals is given by

$$g ( {μ}_{mix} ) = {β}_{0} + {\sum }_{i = 1}^{c} {β}_{i} {t}^{i} \qquad ( 5 )$$

For example, for data from the full ray with five pesticides, a polynomial model with up to a fifth degree term was considered; for the data from the reduced ray with four pesticides in the mixture, a polynomial model with up to a fourth degree term was considered. The significance of the i^{th}-degree term is interpreted as evidence of an i^{th}-way interaction (i=2, . . . , c), but is not suggestive of which i components are interacting. For example, in the mixture analysis of five pesticides, (for ease of notation denoted as A, B, C, D, E) there are five possible four-way interactions: ABCD, ABCE, ABDE, ACDE, and BCDE. The significance of the 4^{th} degree term in the model given in (5) indicates that one or more of these four-way interactions are present. Further experimentation is needed in order to infer which components are interacting (Meadows, 2002; Casey et al, 2003a,b). Estimation of model parameters follows similarly to that described in the previous section.

The initial model fit to the gait score data had a common intercept term across the studies (5 single chemical and two mixture studies), linear terms for each single chemical study for estimating the additivity response, a fifth-degree polynomial for the full ray data, and a fourth-degree polynomial for the reduced ray data. All of the data are used to estimate the additive part of the model, but only the mixture data were used to estimate the corresponding higher-degree terms. From this model, the simultaneous test for the significance of the higher-degree terms is equivalent to a test of additivity. For these binary gait score data, there was an indication of departure from additivity (p=0.049, with 7 df). In order to make the model more parsimonious, we used a backward elimination approach to delete terms that were not statistically significant. We reduced the model for the full ray first while keeping the reduced ray fully parameterized. Once the model for the full ray was reduced to having only significant terms, then the model for the reduced ray was simplified. None of the higher-order terms for the reduced ray were significant; however, we kept the pure quadratic term for flexibility in the model.

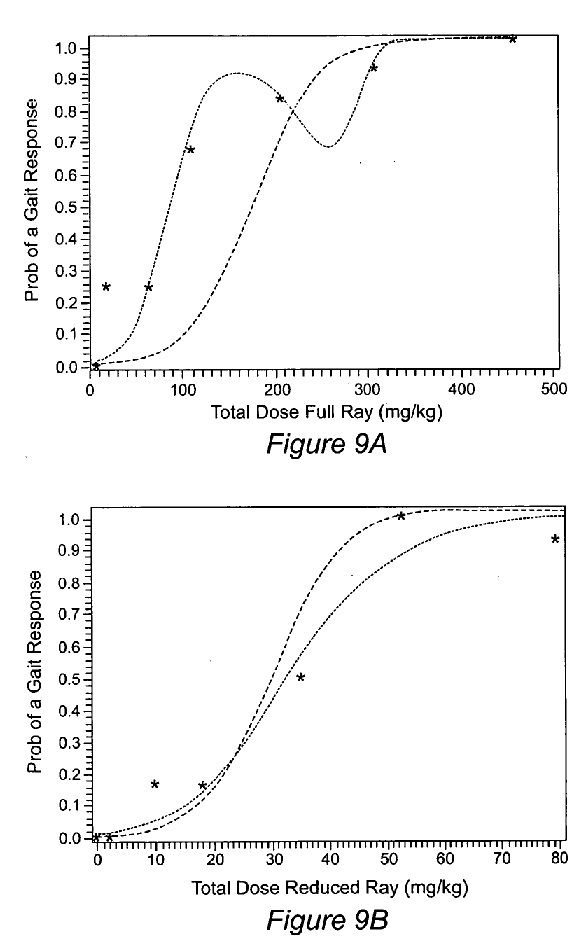

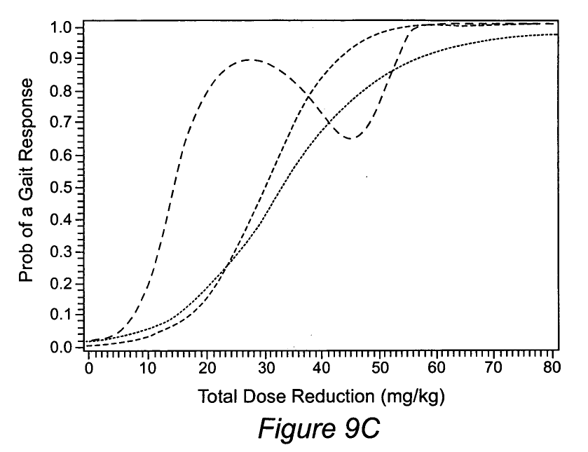

The resulting parameter estimates for the ‘final’ model, standard errors, and p values are provided in Table 3. As all of the linear terms are positive and significant, we conclude that as any of the doses of the chemicals increase, the probability of a gait abnormality also increases. The overall test of additivity was rejected indicating the significance of at least one higher degree term (p=0.041, 3 df). FIG. 9A presents a plot of the dose-response curve in terms of total dose for the predicted model compared to what it would be under additivity. Starting with the highest degree term, since the fourth degree term is significant for the full ray, we conclude that at least one four-way interaction exists. Without further information, it is not evident which four chemicals are involved.

TABLE 3
Parameter estimates and associated p values from the final
SANR analysis. The estimate for the scale parameter
was \hat{τ} = 1.42. The overall hypothesis of additivity was
rejected (p = 0.021, with 4 df). The hypothesis of additivity
along the full ray was rejected (p = 0.041, with 3 df)
but was not rejected along the reduced ray (p = 0.175, 1 df).
The hypothesis of no malathion effect was
rejected (p = 0.014, 3 df).

| Parameter | Estimate | Standard Error | P value |
|---|---|---|---|
| β₀ | −4.244 | 0.5486 | <0.001 |
| β₁ ACE | 0.1615 | 0.0384 | <0.001 |
| β₂ DIA | 0.0276 | 0.0057 | <0.001 |
| β₃ CPF | 0.1343 | 0.0235 | <0.001 |
| β₅ DIM | 0.1531 | 0.0370 | <0.001 |
| θ₂₍₁₎ full ray quadratic | 0.000699 | 0.000280 | 0.013 |
| θ₃₍₁₎ full ray cubic | −0.00000553 | 0.00000245 | 0.024 |
| θ₄₍₁₎ full ray quartic | 0.0000000105 | .00000000517 | 0.042 |
| θ₂₍₂₎ reduced ray quadratic | −0.0000659 | 0.000456 | 0.148 |

By comparison, none of the higher degree terms are significant along the reduced ray (p=0.175). Therefore, there was no evidence of departure from additivity among the four pesticides (ACE, DIA, CPF, and DIM; see FIG. 9B). Recall the relative ratios of these pesticides are equivalent to those used in the full ray. Since there is an indication of at least one four-way interaction on the full ray where MAL is present, and no indication of departure from additivity on the reduced ray where MAL is absent, there is evidence to suggest that MAL interacts with at least some or all of the other four pesticides. Following the work of Casey et al (2003a), the hypothesis of no MAL interaction with the other pesticides was rejected p=0.014, 3 df). FIG. 9C depicts the same two curves as in FIG. 3B with the additional curve (dotted) obtained from the full ray, corrected for the proportion of the pesticides that were included in the reduced ray (here 1-0.825 since MAL was 82.5% of the mixture). The difference in the dotted and solid curves indicates the effect MAL has on the mixture.

Discussion

In summary, both analysis strategies resulted in similar conclusions, namely that (1) ACE, DIA, CPF and DIM when given alone had a significant effect on a gait abnormality and MAL was not dose responsive, (2) there is a significant interaction among the five pesticides along the fixed-ratio mixture ray which is associated with a synergistic effect, (3) there is not a significant departure from additivity among the four pesticides (omitting MAL) along the reduced mixture ray, and (4) adjusted comparisons across the full and reduced rays indicate that MAL interacts with the other pesticides. Casey et al, (2003a,b) describe in more detail the SAR and SANR methods in the analysis of motor activity in the same rats that were used here for the gait score response. Their conclusions for motor activity are similar to those reported here for a gait abnormality.

More generally, the methods described here can be readily generalized to other types of chemicals, different numbers of components in a mixture, and to different types of endpoints. For example, the gait score endpoint used here resulted in proportional data; motor activity described by Casey et al (2003a,b) is a count endpoint; continuous endpoints or time to response endpoints could also be used. The methods based on exposure relevant fixed-ratio ray designs allow for dramatic decreases in the required experimental effort for studying mixtures of many chemicals as compared to the classical factorial designs. The design for the study of the mixture of five pesticides essentially required adequate support for seven dose-response curves (five single chemicals alone and two total dose mixture rays). Positive controls were added in order to demonstrate the comparability of the studies not run concurrently. By comparison a full factorial design for five chemicals with reasonable support of the shape of the dose response curve (i.e., not just two dose points per chemical) would have required more experimental effort. For example, a full factorial design for a mixture of five chemicals each at three levels has 243 dose groups. Of course, fractionated factorial designs are available. But, as the number of chemicals in the mixture increases, the experimental effort for even these designs quickly becomes impractical.

Meadows et al (2002) describe an example where the single chemical data were not appropriate for comparison to the mixture data. In such cases, the interaction model based methods may be used to estimate departure from additivity with only mixture data along a ray to support the estimation of the model parameters. In screening methods for mixtures of many chemicals, it may not be feasible to supply dose-response curves for each component in the mixture. By making the assumption of a parameterization for the underlying response surface, analysis of data along a fixed-ratio ray may result in hypothesis testing for departure from additivity.

An important feature to the analysis strategies is the power and sample size calculations for the mixture study. The single chemical data were initially evaluated using an additivity model. Power and sample size methods (Meadows et al, 2003; and Casey et al, 2003c) were used to determine dose locations and sample sizes to yield an acceptable level of power to detect departure from additivity to a biologically important degree. Here a change in the parameter associated with the slope of at least 25% from that predicted under additivity was considered biologically meaningful. If the study is adequately powered and no evidence of departure from additivity is found, then additivity can be claimed. By comparison, if the study is not adequately powered, then lack of evidence of departure from additivity may be a power problem and not an indication of additivity.

Using both the SAR and SANR methods departures from additivity were found for the given mixture of the five pesticides. This claim of interaction applies to the specified mixing ratio and may not be true for other mixing ratios. The characterization of the interaction may also change along a fixed-ratio ray. For example, Gennings et al (2002) demonstrated in a mixture of four metals that the relationship among the chemicals changed from synergistic, to additive, to antagonistic along the specified ray. Casey et al (2003b) developed methods of determining the location of interaction for a fixed ratio of chemicals through use of simultaneous confidence regions.

When studying motor activity with this same combination of pesticides, Casey et al (2003a,b) concluded that malathion interacted with the remaining four pesticides. Interestingly, the effect did not occur until total doses (of the four pesticides omitting malathion) exceeded about 45 or 50 mg/kg. In the analysis of gait score described here, FIGS. 8C and 9C suggest a malathion effect at much lower total doses. An interaction with malathion was not totally unexpected, since a frequently-cited example of OP mixtures is the potentiation of malathion toxicity by other OPs, which inhibit the carboxylesterase-mediated hydrolysis of malathion (e.g., Murphy and DuBois, 1957). Given the large amount of carboxylesterases in the body, such a kinetic interaction would be expected more at higher dose levels than were observed in the present study.

The risk assessment process is complicated by the fact that environmental exposures frequently may involve mixtures of chemicals rather than a single compound. Public concern about such mixtures led to new requirements under the Food Quality Protection Act (1996) to assess risk of pesticide mixtures that have a common mode of toxicity. The methods described here may be useful in providing an experimentally feasible way of studying exposure-relevant mixtures instead of regulating chemicals based on default assumptions of additivity. In addition, if departure from additivity is concluded, the impact of important components of the mixture can be assessed by comparison of ‘full’ and judiciously chosen ‘reduced’ rays of interest.

References

ATSDR (Agency for Toxic Substances and Disease Registry) (2000a). Guidance Manual for the Assessment of Joint Toxic Action of Chemical Mixtures.

ATSDR (Agency for Toxic Substances and Disease Registry) (2000b). Interaction Profile for: Chlorinated Dibenzo-p-Dioxins, Hexachlorobenzene, p,p′-DDE, and Methylmercury.

ATSDR (Agency for Toxic Substances and Disease Registry) (2000c). Guidance for the Preparation of an Interaction Profile.

Berenbaum, M. C. (1985) The expected effect of a combination of agents: The general solution Journal Theoretical Biology, 114, 413-431.

Casey, M., Carter, W. H., Jr., Gennings, C., Moser, V., Simmons, J. E. (2003a) A single agent not required (SANR) approach for detecting interaction(s) and assessing the impact of component subsets in a chemical mixture using a fixed-ratio ray design, Journal of Agricultural, Biological, and Environmental Statistics, under review.

Casey, M., Gennings, C., Carter, W. H., Jr., Moser, V., Simmons, J. E. (2003b) A single agent required (SAR) approach for detecting interaction(s) and assessing the impact of component subsets in a chemical mixture using a fixed-ratio ray design, Journal of Agricultural, Biological, and Environmental Statistics, under review.

Casey, M., Gennings, C., Carter, W. H., Jr., Moser, V., Simmons, J. E. (2003c) Power and sample size determination for testing the effect of subsets of compounds on mixtures along fixed-ratio rays, Journal of Agricultural, Biological, and Environmental Statistics, under review.

Cox, C. (1987) Threshold dose-response models in toxicology, Biometrics 43: 511-523.

Gennings, C., Schwartz, P., Carter, W. H., Jr., Simmons, J. E. (1997) Detection of departures from additivity in mixtures of many chemical with a threshold model, Journal of Agricultural, Biological, and Environmental Statistics 2: 198-211.

(2000) Erratum: Detection of departures from additivity in mixtures of many chemical with a threshold model, Journal of Agricultural, Biological, and Environmental Statistics 5: 257-259

Gennings, C., Carter, W. H., Jr., Campain, J. A., Bae, D., Yang, R. S. H. (2002) Statistical analysis of interactive cytotoxicity in human epidermal heratinocytes following exposure to a mixture of four metals, Journal of Agricultural, Biological, and Environmental Statistics 7:58-73.

Gennings, C., Carter, W. H., Jr., Simmons, J. E., Carchman, R., Carney, E. (2003) An attempt to unify the concepts of zero interaction in toxicology and statistics, Pharmacology and Toxicology, under review.

Loewe, S. and Muischnek, H. (1926) Uber kombinationswirkunger. I. Mitteilung: Hiltsmittel der gragstellung. Naunyn-Schmiedebergs, Arch. Pharmacol, 114, 313-326.

Loewe, S. (1953) The problem of synergism and antagonism of combined drugs, Arzneimittle forshung, 3, 285-290.

McCullagh, P. and Nelder, J. A. (1989) Generalized Linear Models (2nd ed.), New York: Chapman and Hall.

Meadows, S. L., Gennings, C., Carter, W. H., Jr., Bae, D.-S. (2002) Experimental Designs for Mixtures of Chemicals along Fixed Ratio Rays. Environmental Health Perspectives 110(6):979-983.

Moser, V. C. (1995) Comparisons of the acute effects of cholinesterase inhibitors using a neurobehavioral screening battery in rats. Neurotoxicol. Teratol. 17, 617-625.

Murphy, S. D. and DuBois, K. P. Quantitative measurement of inhibition of the enzymatic detoxification of malathion by EPN (ethyl p-nitrophenyl thionobenzene phosphate). Proc. Soc. Exp. Biol. Med. 96:813-818, 1957.

Nelder, J. A. and Mead, R. (1965). A Simplex Method for Function Minimization, The Computer Journal 7, 308-313.

SAS Institute Inc, Version 8.2, Cary, N.C.

Teuschler, L., Klaunig, J., Carney, E., Chambers, J., Connolly, R., Gennings, C., Giesy, J., Hertzberg, R., Klaassen, C., Kodell, R., Paustenbach, D., Yang, R. (authors listed as Committee Chair, Co-Chair then alphabetically): Support of science-based decisions concerning the evaluation of the toxicology of mixtures: A new beginning. Regulatory Toxicology, 36:34-39, 2002.

U.S. EPA (United States Environmental Protection Agency) (2000). Supplementary Guidance for Conducting Health Risk Assessment of Chemical Mixtures. EPA/630/R-00/002

APPENDIX
Summary Statistics from Single Chemical
and Mixture Experiments:
The number of responders (r) represent the number of
rats with gait scores >1 within each dose group.

| | | | |
|---|---|---|---|
| | Dose | | |
| Group | (mg/kg) | r | N |

Single Chemical Data

| | | | |
|---|---|---|---|
| ACE | 0 | 0 | 8 |
| ACE | 3 | 0 | 8 |
| ACE | 10 | 0 | 8 |
| ACE | 30 | 5 | 8 |
| ACE | 60 | 8 | 8 |
| ACE | 120 | 8 | 8 |
| CPF | 0 | 0 | 20 |
| CPF | 1 | 0 | 12 |
| CPF | 2 | 0 | 8 |
| CPF | 5 | 0 | 12 |
| CPF | 10 | 0 | 20 |
| CPF | 20 | 3 | 8 |
| CPF | 25 | 2 | 12 |
| CPF | 30 | 8 | 8 |
| CPF | 50 | 16 | 20 |
| DIA | 0 | 0 | 16 |
| DIA | 5 | 0 | 16 |
| DIA | 25 | 0 | 16 |
| DIA | 50 | 0 | 8 |
| DIA | 75 | 0 | 16 |
| DIA | 125 | 0 | 8 |
| DIA | 150 | 6 | 8 |
| DIA | 250 | 8 | 8 |
| DIM | 0 | 0 | 8 |
| DIM | 5 | 0 | 8 |
| DIM | 10 | 0 | 8 |
| DIM | 25 | 4 | 8 |
| DIM | 50 | 7 | 8 |
| DIM | 75 | .8 | 8 |
| MAL | 0 | 0 | 8 |
| MAL | 100 | 0 | 8 |
| MAL | 500 | 0 | 8 |

Mixture data

| | | | |
|---|---|---|---|
| | Total | | |
| | Dose | | |
| Group | (mg/kg) | r | N |

1^{st} Mixture Ray (‘Full’ Ray)^{a}
Positive Control data

| | | | |
|---|---|---|---|
| ACE | 6 | 0 | 6 |
| ACE | 30 | 3 | 14 |
| CPF | 10 | 0 | 6 |
| CPF | 20 | 1 | 8 |
| CPF | 30 | 0 | 6 |
| DIA | 50 | 0 | 6 |
| DIA | 125 | 1 | 14 |
| DIM | 10 | 0 | 6 |
| DIM | 25 | 1 | 8 |
| DIM | 50 | 6 | 6 |
| MAL | 350 | 0 | 14 |

Mixture data

| | | | |
|---|---|---|---|
| CON | 0 | 0 | 14 |
| MIX | 10 | 3 | 12 |
| MIX | 55 | 3 | 12 |
| MIX | 100 | 8 | 12 |
| MIX | 200 | 10 | 12 |
| MIX | 300 | 11 | 12 |
| MIX | 450 | 12 | 12 |

2^{nd} Mixture Ray (‘Reduced’ Ray)^{b}
Positive Control data

| | | | |
|---|---|---|---|
| ACE | 30 | 3 | 8 |
| CPF | 20 | 0 | 8 |
| DIA | 125 | 0 | 8 |
| DIM | 25 | 3 | 8 |

Mixture data

| | | | |
|---|---|---|---|
| CON | 0 | 0 | 8 |
| MIX | 1.75 | 0 | 12 |
| MIX | 9.6 | 2 | 12 |
| MIX | 17.5 | 2 | 12 |
| MIX | 35 | 6 | 12 |
| MIX | 52.5 | 12 | 12 |
| MIX | 78.8 | 11 | 12 |

^{a}The total doses for the mixture studies are based on a fixed-ratio of the five pesticides. For the ‘full’ ray where all five pesticides are included the mixing ratio is (0.040:0.002: 0.031:0.825:0.102) for (ACE:DIA:CPF:MAL:DIM), respectively.
^{b}For the ‘reduced’ ray the mixing ratio is (0.229:0.011:0.177:0.000:0.583) for (ACE: DIA:CPF:MAL:DIM), respectively.

### Example 4

### Dₛ-Optimal Designs for Testing Linear Hypotheses of Interest when Studying Combinations of Chemicals Using Multiple Fixed-Ratio Ray Experiments

Introduction

Organophosphorus (OP) pesticides are the most widely used pesticides in the Unites States (Aspelin, 1994). Colosio et al. (1999), Ma et al. (2002), and others have considered the effects of human exposure to pesticides. Due to the variety of agricultural, household, pet, and garden uses, there is high potential for multiple exposures from multiple routes. Thus, regulations that were based on the toxicity of these pesticides alone many not adequately protect humans from adverse health effects. The need for knowledge of how these compounds interact was highlighted in the 1996 Food Quality Protection Act (FQPA), which directed the EPA to consider cumulative and aggregate exposures in the risk assessment process.

The class of OP pesticides includes acephate, diazinon, chlorpyrifos, dimethoate, and malathion. These pesticides were chosen for study based on usage patterns (i.e., pesticides used on the same or similar crops) and market share (i.e., highest volume pesticides). Of the pesticides under study, malathion accounts for 82.5% of the relative dietary exposure to humans as projected by the U.S. EPA Dietary Exposure Evaluation Model (DEEM). In addition, preliminary analysis on available single chemical data indicated that malathion is not dose responsive (see Table 1) with respect to motor activity, a count of the number of passes made across a central area, which was the endpoint chosen to assess toxicity after exposure in rats. Since malathion does not appear to be dose responsive and it accounts for the largest portion of OP pesticides to which humans are exposed, it is of primary interest to study the effect of malathion on the remaining OP pesticides under consideration. Traditionally, to study interactions between malathion and the four active pesticides, researchers would consider factorial designs to study binary or tertiary chemical combinations. However, such studies that consider the effects of exposure to combinations of all five pesticides are not practical.

As an alternative to studying chemical combinations using factorial designs, ray designs have been proposed to study polychemical mixtures. Brunden and Vidmar (1989) and others suggest the use of ray designs to support the estimation of a response surface. Alternatively, Gennings et al. (2002) and Meadows et al. (2002a) propose restricting inference to relevant fixed-ratio ray(s). Focusing inference to relevant fixed-ratio rays reduces the dimensionality and the amount of experimental effort associated with the study of chemical mixtures. Gennings et al. (2002) and Meadows et al. (2002a) develop tests for departure from additivity using these fixed-ratio ray designs. Casey (2003) extended the work of Gennings et al. (2002) and Meadows et al. (2002a) to include hypotheses that test for interactions involving subsets of chemicals. Such hypotheses, described in Section 2, require the collection of data along a full fixed-ratio ray and a reduced ray where the chemical or subset of chemicals of interest (e.g. malathion) is removed from the mixture and the remaining chemicals are at the same relative ratios considered in the full mixture.

The fixed-ratio rays used to study interactions between malathion and the four active pesticides were chosen based on relative dietary exposure estimates of each chemical as projected by the U.S. EPA Dietary Exposure Evaluation Model (DEEM). Consideration was given to a full ray given by (0.040:0.002:0.031:0.102:0.825) for (acephate:diazinon:chlorpyrifos:dimethoate:malathion) and a reduced ray given by (0.2286:0.0114:0.1767:0.5833) for (acephate:diazinon:chlorpyrifos:dimethoate). Notice that the ratio of acephate to diazinon along the full fixed-ratio ray is (0.040:0.002) which is a (20:1) ratio. The ratio of acephate to diazinon along the second fixed-ratio ray is (0.2286:0.0114) which is also a (20:1) ratio. Similar relationships hold for the other chemicals in the mixture; thus, the chemicals along the full and reduced rays are at the same relative ratios to one another.

It is important to develop experimental designs for detecting and characterizing interactions among the pesticides. Assuming no interaction, it is of interest to determine dose locations and sample size allocation that provide precise parameter estimates and enough power to detect departure from additivity. In what follows we extend the work of Meadows (2001) and Meadows et al. (2002b) to develop designs for testing for the effect of subsets of chemicals on the mixture (i.e., to test for interactions involving subsets of chemicals) and for detecting departure from additivity across multiple fixed-ratio rays simultaneously. The criterion we consider aims to minimize the generalized variance of the parameters associated with the hypothesis of interest. While this criterion cannot claim to maximize the power of the hypothesis of interest, it should be related to an increase in power since it reduces the variance of the estimates involved. In order to determine experimental designs, appropriate models and hypotheses must be defined. The designs illustrated in this paper are based on the methods for detecting departure from additivity presented by Gennings et al. (2002), Meadows et al. (2002a), and Casey (2003) and are summarized in Section 2.

2. Model and Hypotheses Development

Additivity Model:

A generalized linear model is used to describe the relationship among the pesticides along the two fixed-ratio rays. In the quasi-likelihood framework, proposed by Wedderburn (1974), the generalized linear model relates the doses of the chemicals to the mean through a link function, g(m). Further it assumes that the variance of the response is of the form tV(m), where V(m) is a known function of m.

Let K be the number of fixed-ratio rays under consideration for a mixture of c chemicals and a₍ₖ₎=[a₁₍ₖ₎, a₂₍ₖ₎, . . . ,a_{c(k)}], define the mixing ratio along the k^{th} fixed-ratio ray, such that

$${\sum }_{i = 1}^{c} {a}_{i ( k )} = 1.$$

Let x₍ₖ₎=x₁₍ₖ₎, x₂₍ₖ₎, x₃₍ₖ₎, . . . ,x_{c(k)}] define a vector of doses at a given mixture point along the k^{th} ray and

$$t = {\sum }_{i = 1}^{c} {x}_{i ( k )}$$

define total dose. When ray designs are considered, total dose is the independent variable along the mixing rays and the amount of the i^{th} compound in the mixture along the k^{th} ray is given by aᵢ₍ₖ₎t. Following Meadows et al. (2002a), the additivity, i.e. no interaction, model along the k^{th} fixed-ratio ray can be expressed as

$$\begin{matrix}g ( {μ}_{add ( k )} ) = {β}_{0} + {β}_{1} {a}_{1 ( k )} t + {β}_{2} {a}_{2 ( k )} t + … + {β}_{c} {a}_{c ( k )} t \\ = {β}_{0} + ( {β}_{1} {a}_{1 ( k )} t + {β}_{2} {a}_{2 ( k )} + … + {β}_{c} {a}_{c ( k )} ) t \\ = {β}_{0} + {θ}_{1 ( k )}^{*} t , & ( 1 )\end{matrix}$$

where:

g(μ_{add(k)}) is the specified link function (see McCullagh and Nelder, 1989),

β₀ is the unknown parameter associated with the intercept, and

$${θ}_{1 ( k )}^{*} = {\sum }_{i = 1}^{c} {β}_{i} {a}_{i ( k )}$$

is the unknown parameter associated with the slope along the k^{th} ray.

Interaction-Model-Based Method of Analysis:

Meadows et al. (2002a) and Casey (2003) describe an interaction-model-based method of analysis where assumptions are made about the form of the underlying response surface. The significance of higher-order terms in the polynomial approximation of the dose-response relationship, expressed as a function of the total dose, indicates departure from additivity. Meadows et al. (2002a) showed that with this approach, only mixture data along a fixed-ratio ray are necessary for detecting departure from additivity. Casey (2003) extended these results to detect departure from additivity across multiple fixed-ratio rays in the presence or absence of single chemical data.

Using the quasi-likelihood framework, the interaction model along the k^{th} ray can be expressed as,

g(μₘᵢₓ₍ₖ₎)=β₀+θ*₁₍ₖ₎t+θ*₂₍ₖ₎t²+θ*₃₍ₖ₎t³+ . . . +θ*_{c}_{ₖ}₍ₖ₎t^{c}^{ₖ} (2)

where:

$${θ}_{1 ( k )}^{*} = {\sum }_{i = 1}^{{c}_{k}} {β}_{i} {a}_{i ( k )} , {θ}_{2 ( k )}^{*} = {{\sum }_{i = 1}^{{c}_{k}} {\sum }_{j = 1}^{{c}_{k}}}_{i < j} {β}_{ij} {a}_{i ( k )} {a}_{j ( k )} , {θ}_{3 ( k )}^{*} = {{\sum }_{i = 1}^{{c}_{k}} {\sum }_{j = 1}^{{c}_{k}} {\sum }_{l = 1}^{{c}_{k}}}_{i < j < l} {β}_{ijl} {a}_{i ( k )} {a}_{j ( k )} {a}_{l ( k )} , etc . ,$$

g(μₘᵢₓ₍ₖ₎) is the specified link function (see McCullagh and Nelder, 1989),

θ*₁₍ₖ₎ is the unknown parameter associated with the first-order term,

θ*ᵢ₍ₖ₎ for i=2 . . . cₖ is the unknown parameter associated with the i^{th} way interaction, and

cₖ is the number of chemicals under study along the k^{th} fixed-ratio ray.

When single chemical data are available, the slope associated with each of the single chemicals are estimable. Thus, the model fit along the k^{th} fixed-ratio ray is given by

g(μₘᵢₓ₍ₖ₎)=β₀+β₁a₁₍ₖ₎t+ . . . +β_{c}_{ₖ}a_{c}_{ₖ}₍ₖ₎t+θ*₂₍ₖ₎t²+θ*₃₍ₖ₎t³+ . . . +θ*_{c}_{ₖ}₍ₖ₎t^{c}^{ₖ}. (3)

The K fixed-ratio rays are generally fit simultaneously assuming a common intercept. If multiple control groups are experimentally evaluated, the assumption of a common intercept should be verified by comparing the means of the control groups. When single chemical data are available they are used in combination with mixture data to estimate the intercept and first-order terms and the higher-order terms are estimated using only the mixture data. In the absence of single chemical data, all of the model parameters are estimated using the mixture data. Parameter estimates are found by maximizing the quasi-likelihood (e.g., McCullagh and Nelder, 1989).

Under the hypothesis of additivity, the parameters associated with interaction along the K fixed-ratio rays, namely (θ*₂₍₁₎, θ*₃₍₁₎, . . . , θ*_{c}_{₁}₍₁₎, θ*₂₍₂₎, θ*₃₍₂₎, . . . , θ*_{c}_{₂}₍₂₎, . . . , θ*_{2(K)}, θ*_{3(K)}, . . . , θ*_{c}_{ₖ}_{(K)}), are zero. Define the px1 vector γ=[β₀, θ*₁₍₁₎, θ*₂₍₁₎, . . . , θ*_{c}_{₁}₍₁₎, . . . , θ*_{1(K)}, θ*_{2(K)}, . . . , θ*_{c}_{ₖ}_{(K)}]′ as a vector of model parameters and define b_{add} as a matrix of contrasts (zeros and ones) such that

b_{add} γ=[θ*₂₍₁₎, θ*₃₍₁₎, . . . , θ*_{c}_{₁}₍₁₎, . . . , θ*_{2(K)}, . . . , θ*_{c}_{ₖ}_{(K)}]′

An overall hypothesis of additivity, based on the significance of higher-order terms, is given by

H₀: :b_{add} γ=0 (4)

In addition to the hypothesis described above, Casey (2003) developed hypotheses for detecting and characterizing interactions due to subsets of chemicals. The hypothesis that a chemical or subset of chemicals is not involved in interactions with the remaining components of the mixture is given by

$${H}_{0} \text{:} {b}_{interact} γ = [ \begin{matrix}\frac{{θ}_{2 ( full )}^{*}}{{( {a}_{1 ( full )} )}^{2}} - \frac{{θ}_{2 ( reduced )}^{*}}{{( {a}_{1 ( reduced )} )}^{2}} \\ \frac{{θ}_{3 ( full )}^{*}}{{( {a}_{1 ( full )} )}^{3}} - \frac{{θ}_{3 ( reduced )}^{*}}{{( {a}_{1 ( reduced )} )}^{3}} \\ ⋮ \\ \frac{{θ}_{m ( full )}^{*}}{{( {a}_{1 ( full )} )}^{m}} - \frac{{θ}_{m ( reduced )}^{*}}{{( {a}_{1 ( reduced )} )}^{m}}\end{matrix} ] = 0 \qquad ( 5 )$$

where the reduced ray (parameters denoted with subscript ‘reduced’) represents the mixture study where the chemical or subset of chemicals of interest is removed from the mixture and the remaining components are studied at the same relative ratios as given in the full ray. Parameters along the full ray, where all of the chemicals are considered in the mixture, are denoted with subscript ‘full’. This hypothesis compares interaction parameters along the reduced ray (e.g. the no malathion ray) to interaction parameters along the full ray.

For example, consider a mixture study with three chemicals. Let (a_{1(full)}: a_{2(full)}: a_{3(full)}) denote the mixing ratio. The model along the fixed-ratio ray is given by,

g(μ_{(full)})=β₀+θ*_{1(full)}t+θ*_{2(full)}t²+θ*_{3(full)}t³

where:

θ*_{1(full)}=β₁a_{1(full)}+β₂a_{2(full)}+β₃a_{3(full)},

θ*_{2(full)}=β₁₂a_{1(full)}a_{2(full)}+β₁₃a_{1(full)}a_{3(full)}+β₂₃a_{2(full)}a_{3(full)}, and

θ*_{3(full)}=β₁₂₃a_{1(full)}a_{2(full)}a_{3(full)}.

Suppose the third-order term is not significant and it is of interest to determine the effect of the third chemical on the mixture. Thus, data are collected along a second fixed-ratio ray given by (a_{1(reduced)}:a_{2(reduced)}) where the third chemical is removed from the mixture and

$$\frac{{a}_{i ( full )}}{{a}_{j ( full )}} = \frac{{a}_{i ( reduced )}}{{a}_{j ( reduced )}} .$$

The model fit along this reduced ray is given by,

g(μ_{(reduced)})=β₀+θ*_{1(reduced)}t+θ*_{2(reduced)}t²

where:

θ*_{1(reduced)}=β₁a_{1(reduced)}+β₂a_{2(reduced)} and

θ*_{2(reduced)}=β₁₂a_{1(reduced)}a_{2(reduced)}.

Since the reduced experiment is performed at the same relative ratios as those in the original or full ray,

$${β}_{12} \frac{{a}_{1 ( full )} {a}_{2 ( full )}}{{( {a}_{1 ( full )} )}^{2}} = {β}_{12} \frac{{a}_{1 ( reduced )} {a}_{2 ( reduced )}}{{( {a}_{1 ( reduced )} )}^{2}} = \frac{{θ}_{2 ( reduced )}^{*}}{{( {a}_{1 ( reduced )} )}^{2}}$$

and

$$\frac{{θ}_{2 ( full )}^{*}}{{( {a}_{1 ( full )} )}^{2}}$$

becomes

$$\frac{{θ}_{2 ( full )}^{*}}{{( {a}_{1 ( full )} )}^{2}} = \frac{{θ}_{2 ( reduced )}^{*}}{{( {a}_{1 ( reduced )} )}^{2}} + {β}_{13} \frac{{a}_{1 ( full )} {a}_{2 ( full )}}{{( {a}_{1 ( full )} )}^{2}} + {β}_{23} \frac{{a}_{2 ( full )} {a}_{3 ( full )}}{{( {a}_{1 ( full )} )}^{2}} ⇒ \\ \frac{{θ}_{2 ( full )}^{*}}{{( {a}_{1 ( full )} )}^{2}} - \frac{{θ}_{2 ( reduced )}^{*}}{{( {a}_{1 ( reduced )} )}^{2}} = {β}_{13} \frac{{a}_{1 ( full )} {a}_{3 ( full )}}{{( {a}_{1 ( full )} )}^{2}} + {β}_{23} \frac{{a}_{2 ( full )} {a}_{3 ( full )}}{{( {a}_{1 ( full )} )}^{2}} .$$

The hypothesis, given by

$${H}_{0} \text{:} [ \frac{{θ}_{2 ( full )}^{*}}{{( {a}_{1 ( full )} )}^{2}} - \frac{{θ}_{2 ( reduced )}^{*}}{{( {a}_{1 ( reduced )} )}^{2}} ] = 0 ,$$

tests for the effect of the third chemical on the mixture (i.e. the significance off β₁₃ and/or β₂₃) If there is sufficient evidence to reject this hypothesis, we conclude that the third chemical is involved in at least one two-way interaction. Further experimentation would be necessary to determine specifically which chemicals are involved in these interactions. If we fail to reject the hypothesis and the study is reasonably powered, we can conclude that the third chemical does not interact with the remaining components of the mixture.

A Wald-type test for testing the hypotheses given in (4) and (5), is given by

$$W = \frac{{{( b \hat{γ} )}^{′} [ b Ω {b}^{′} ]}^{- 1} ( b \hat{γ} )}{M τ} , \qquad ( 6 )$$

where τΩ is the variance-covariance matrix of \hat{γ} and b is any contrast matrix (e.g. b_{add}; b_{interact}). Since \hat{γ} is distributed asymptotically normal (McCullagh and Nelder, 1989) with mean γ and variance τΩ, it follows that W is approximately distributed chi-square with M degrees of freedom (M is the number of tests considered simultaneously or the number of rows in b). The moment estimate for t is expressed as

$$\hat{τ} = \frac{1}{( N - p )} {\sum }_{i , j}^{} \frac{{( {y}_{ij} - {\hat{μ}}_{i} )}^{2}}{V ( {\hat{μ}}_{i} )} = \frac{{X}^{2}}{( N - p )} , \qquad ( 7 )$$

where X² is the generalized Pearson statistic (McCullagh and Nelder, 1989), which is asymptotically distributed chi-square with N−p degrees of freedom. In the quasi-likelihood framework, McCullagh (1983) defines the large sample variance-covariance matrix for \hat{γ} as τ[I(γ)]⁻¹, where I(g) is the expected quasi-information matrix. Let N be the number of observations. McCullagh (1983) expressed the expected quasi-information as

I(γ)=D′(V(μ))⁻¹D (8)

where

$$D = {[ \frac{\partial {μ}_{i}}{\partial {γ}_{j}^{′}} ]}_{{i = 1 , 2 , … , N}_{j = 1 , 2 , … , p}} and V ( μ ) = [ \begin{matrix}V ( {μ}_{1} ) & 0 & ⋯ & 0 \\ 0 & V ( {μ}_{2} ) & ⋯ & 0 \\ ⋮ & ⋮ & ⋰ & 0 \\ 0 & 0 & ⋯ & V ( {μ}_{N} )\end{matrix} ] .$$

Replacing γwith \hat{γ} in (8), \hat{Ω}=[I(\hat{γ})]⁻¹ is a consistent estimate for W (McCullagh, 1983). Replacing τ with \hat{τ} and W with \hat{Ω} in (6), W is approximately distributed F with M numerator degrees of freedom and N−p denominator degrees of freedom, where p is the number of parameters.

3. Data Description

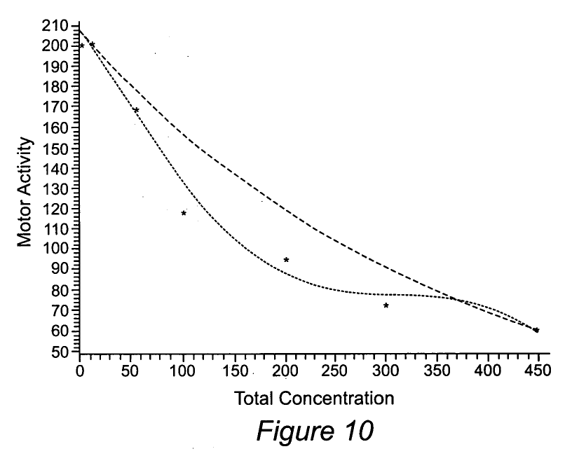

The five-pesticide study described in the introduction is used to illustrate the design methodology developed in the following sections. Due to the high potential for aggregate exposure to OP pesticides, researchers were initially interested in testing the hypothesis of additivity, given in (4), along the full five-pesticide fixed-ratio ray, given by (0.040:0.002:0.031:0.102:0.825) for (acephate:diazinon:chlorpyrifos:dimethoate:malathion). Single chemical data were collected and used to estimate an additivity model along the ray (results shown in Table 1). Since motor activity response is a count variable, it was assumed that V(μ)=μ and the log link function (McCullagh and Nelder, 1989) was used to fit the generalized linear additivity model given in (1). A plot of this additivity model, seen in FIG. 10, was useful in specifying the active dose range of 0 mg/kg to 450 mg/kg along the ray. Prior to the design methods developed here, an equally spaced design with equal allocation and extra dose points in the low dose region was chosen to study interactions along the full ray. Eighty-six animals were considered. Fourteen animals were evaluated in the control group. Twelve animals each were evaluated at 10, 55, 100, 200, 300, and 450 mg/kg. Summary statistics for the single chemical and mixture data are provided in the appendix.

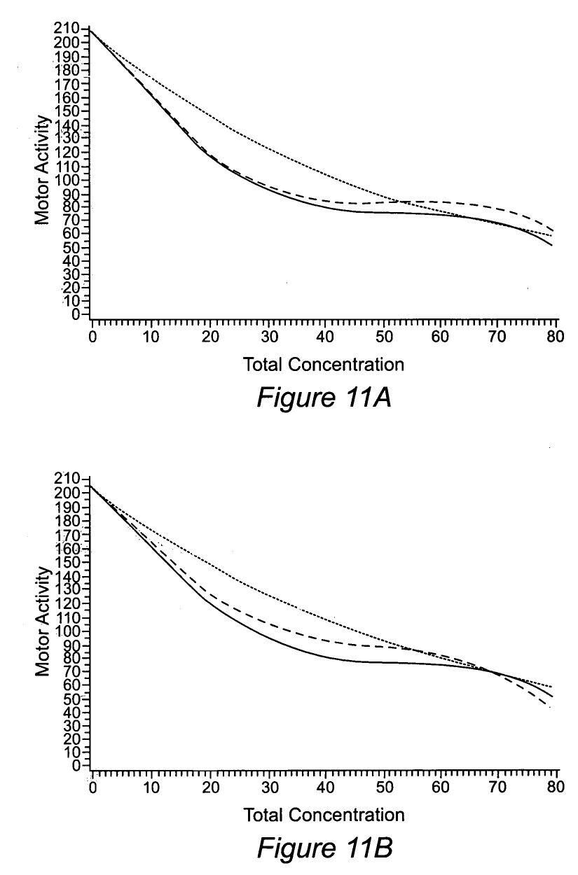

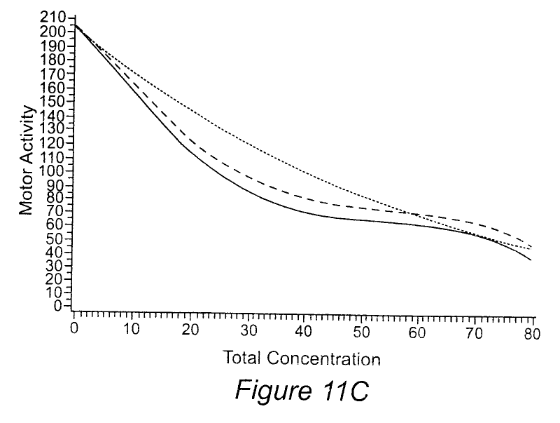

Since the mixture contains five chemicals the single chemical and mixture data were fit to the fifth-order generalized linear model given in (3). Maximum quasi-likelihood estimates were found using PROC GENMOD with DIST=POISSON and LINK=LOG in SAS® (version 8.2) and are provided in Table 1. A plot of the interaction model is provided in FIG. 11. The hypothesis given by

$${H}_{0} : {b}_{add} γ = [ \begin{matrix}{θ}_{2 ( full )}^{*} \\ {θ}_{3 ( full )}^{*} \\ {θ}_{4 ( full )}^{*} \\ {θ}_{5 ( full )}^{*}\end{matrix} ] = 0 , \qquad ( 9 )$$

where γ=[β₀, β₁, β₂, β₃, β₄, β₅, θ*_{2(full)}, θ*_{3(full)}, θ*_{4(full)}, θ*_{5(full)}]′ and

$${b}_{add} = [ \begin{matrix}0 & 0 & 0 & 0 & 0 & 0 & 1 & 0 & 0 & 0 \\ 0 & 0 & 0 & 0 & 0 & 0 & 0 & 1 & 0 & 0 \\ 0 & 0 & 0 & 0 & 0 & 0 & 0 & 0 & 1 & 0 \\ 0 & 0 & 0 & 0 & 0 & 0 & 0 & 0 & 0 & 1\end{matrix} ] ,$$

was used to test the hypothesis of additivity. With a p-value of 0.007, there was sufficient evidence to reject this hypothesis and conclude departure from additivity exists along the full five pesticide fixed-ratio ray. The fifth-order interaction term was not significant (p-value, 0.22); thus, it was removed from the model. In addition, the parameter associated with malathion was removed from the model due to lack of significance (p-value, 0.85) which indicates the lack of activity of malathion. The fourth-order interaction term was marginally significant with a p-value of 0.07. Although marginal, we may conclude that up to fourth-order interactions exist along the full ray; however, without further experimentation, we cannot determine which chemicals are involved in these interactions.

TABLE 1
Estimated model parameters where the single chemical and mixture
data along the full fixed-ratio ray are fit to the model given
in (3) with the log link (allowing V(m) = m).

| Parameter | Estimate | SE | p-value |
|---|---|---|---|
| β₀ | 5.326 | 0.020 | <0.0001 |
| β₁ (Acephate) | −0.018 | 0.001 | <0.0001 |
| β₂ (Diazinon) | −0.004 | 0.0004 | <0.0001 |
| β₃ (Chlorpyrifos) | −0.025 | 0.002 | <0.0001 |
| β₄ (Dimethoate) | −0.0123 | 0.001 | <0.0001 |
| ${θ}_{2}^{*} ( {2}^{nd} Order Interactions )$ | −3E−5 | 1E−5 | 0.0097 |
| ${θ}_{3}^{*} ( {3}^{rd} Order Interactions )$ | 1.5E−7 | 7.2E−8 | 0.0345 |
| ${θ}_{4}^{*} ( {4}^{th} Order Interactions )$ | −1.9E−10 | 1E−10 | 0.0714 |
| τ | 3.503 | | |

NOTE:
${\sum }_{i = 1}^{5} {β}_{i} {a}_{i ( full )} = {θ}_{1 ( full )}^{*} = - 0.0028 .$
The fifth order interaction term was removed from the model due to
lack of significance (p-value, 0.2203). Similarly, the slope for
malathion was removed from the model (p-value, 0.8485).

The existence of fourth-order interactions along the full fixed-ratio ray and the lack of activity of malathion provided motivation for studying the effect of malathion on the four active pesticides. That is, it is of interest to determine if malathion interacts with the other four pesticides even though it is not active alone. This can be achieved through studying a reduced ray, where the mixing ratios are given by (0.2286: 0.0114: 0.1767: 0.5833) for acephate, diazinon, chlorpyrifos, and dimethoate. In this mixture, malathion was and the remaining pesticides are at the same relative ratios as in the full ray. Thus, it is of interest to determine a design along the reduced ray associated with the hypothesis that malathion does not interact with the four active pesticides. This hypothesis is given by

$${H}_{0} : {b}_{interact} γ = [ \begin{matrix}\frac{{θ}_{2 ( full )}^{*}}{{( {a}_{1 ( full )} )}^{2}} - \frac{{θ}_{2 ( reduced )}^{*}}{{( {a}_{1 ( reduced )} )}^{2}} \\ \frac{{θ}_{3 ( full )}^{*}}{{( {a}_{1 ( full )} )}^{3}} - \frac{{θ}_{3 ( reduced )}^{*}}{{( {a}_{1 ( reduced )} )}^{3}} \\ \frac{{θ}_{4 ( full )}^{*}}{{( {a}_{1 ( full )} )}^{4}} - \frac{{θ}_{4 ( reduced )}^{*}}{{( {a}_{1 ( reduced )} )}^{4}}\end{matrix} ] = 0 \qquad ( 10 )$$

where γ=[β₀, β₁, β₂, β₃, β₄, θ*_{2(full)}, θ*_{3(full)}, θ*_{4(full)}, θ*_{2(reduced)}, θ*_{3(reduced)}, θ*_{4(reduced)}]′ and

$${b}_{interact} = [ \begin{matrix}0 & 0 & 0 & 0 & 0 & \frac{1}{{( 0.04 )}^{2}} & 0 & 0 & - \frac{1}{{( 0.2286 )}^{2}} & 0 & 0 \\ 0 & 0 & 0 & 0 & 0 & 0 & \frac{1}{{( 0.04 )}^{3}} & 0 & 0 & - \frac{1}{{( 0.2286 )}^{3}} & 0 \\ 0 & 0 & 0 & 0 & 0 & 0 & 0 & \frac{1}{{( 0.04 )}^{4}} & 0 & 0 & - \frac{1}{{( 0.2286 )}^{4}}\end{matrix} ] .$$

The objective of this paper is to provide methodology to determine at what dose levels and in what proportion of the total sample size observations should be taken.

4. Experimental Designs

Dₛ-optimality is a special case of D-optimality, defined by Kiefer and Wolfowitz (1959). D-optimal designs minimize the generalized variance of the model parameters, where the generalized variance is defined as the determinant of the variance-covariance matrix. While this criterion is not directly related to optimal hypothesis test power, use of such designs should result in increased power since the parameters of interest are estimated more precisely. Dₛ-optimality minimizes the generalized variance for a subset of model parameters. We have seen in (4) and (5) that certain hypotheses of interest in chemical mixture problems can be expressed in terms of subsets of the parameter vector. Dₛ-optimality is appropriate when the precision of a subset of parameters is of interest (Atkinson and Donev, 1992).

In the quasi-likelihood framework, the determinant of the variance-covariance matrix is given by |τΩ⁻¹|, where W is the expected quasi-information matrix given in (8). When the hypothesis of interest is given by a subset of parameters (e.g. the hypothesis of additivity given in (4)) or is based on linear combinations of model parameters (e.g. the hypothesis given in (5)), the variance covariance matrix is given by τ(bΩb′)⁻¹, where b is an appropriate matrix of contrasts (e.g. b_{add}; b_{interact}). The expected quasi-information matrix depends on parameter values, total dose values, and the allocation of observation to the dose groups. Given expected parameter values, the total sample size, and the form of the hypothesis of interest, the Nelder Mead algorithm (Nelder and Mead, 1965) can be used to determine the total dose levels and the allocation of observations that minimizes the generalized variance, |τ(bΩb′)⁻¹|, for the model parameters of interest.

Using the methods described above, it is of interest to determine the design along the reduced ray which minimizes the generalized variance associated with the parameters involved in the hypothesis, given in (10), that malathion dose not interact with the four active pesticides. The Dₛ-optimal design methods condition on the total sample size, the model parameters, and the number of dose groups of interest. Thus, these values must be specified prior to implementing the methods developed here.

Values for the intercept (β₀), single chemical Slopes (β₁, β₂, β₃, β₄) interaction parameters along the full ray (θ*_{2(full)}, θ*_{3(full)}, θ*_{4(full)}), and the variation parameter (τ) are provided from the analysis performed on the full ray (Table 1). Preliminary mixture data along the reduced fixed-ratio ray would be ideal for specifying the additional higher-order interaction terms (θ*_{2(reduced)}, θ*_{3(reduced)}, θ*_{4(reduced)}) However, since these data are not available the higher-order interaction parameters along the full ray are used as a guide to specify similar parameters along the reduced ray under the alterative hypothesis that malathion is involved in interactions with the four active pesticides. Since θ*_{2(full)}, θ*_{3(full)}, θ*_{4(full)}, α_{1(full)}, and α_{1(reduced)}, have been specified we can define a model along the reduced ray under the null hypothesis (i.e., under the assumption that malathion does not interact with the remaining pesticides). For example, consider the case where malathion is not involved in any three-way interactions. Under this assumption

$$\begin{matrix}\frac{{θ}_{3 ( full )}^{*}}{{( {a}_{1 ( full )} )}^{3}} - \frac{{θ}_{3 ( reduced )}^{*}}{{( {a}_{1 ( reduced )} )}^{3}} = 0 ⇒ \\ \frac{{θ}_{3 ( full )}^{*}}{{( {a}_{1 ( full )} )}^{3}} = \frac{{θ}_{3 ( reduced )}^{*}}{{( {a}_{1 ( reduced )} )}^{3}} ⇒ . \\ \frac{{θ}_{3 ( full )}^{*}}{{( {a}_{1 ( full )} )}^{3}} * {( {a}_{1 ( reduced )} )}^{3} ) = {θ}_{3 ( reduced )}^{*}\end{matrix} \qquad ( 11 )$$

Parameters values along the reduced ray under the assumption that malathion does not interact with the active pesticides are provided in Table 2.

TABLE 2
Model parameters along the reduced fixed-ratio ray under the null hypothesis (i.e.
malathion does not interact with the remaining pesticides) and the alternative
hypotheses that (a) malathion is involved in two-way interactions, (b) malathion
is involved in two and three-way interactions, and (c) malathion is involved in
two, three, and four-way interactions.

| | No Malathion | Two-way | Two and | Two, Three and |
|---|---|---|---|---|
| Parameter | Interactions | Only | Three-way | Four-way |
| β₀ | 5.326 | 5.326 | 5.326 | 5.326 |
| β₁ (Acephate) | −0.018 | −0.018 | −0.018 | −0.018 |
| β₂ (Diazinon) | −0.004 | −0.004 | −0.004 | −0.004 |
| β₃ (Chlorpyrifos) | −0.025 | −0.025 | −0.025 | −0.025 |
| β₄ (Dimethoate) | −0.012 | −0.012 | −0.012 | −0.012 |
| ${θ}_{2}^{*} ( {2}^{nd} Order Interactions )$ | −9.8E−4 | −9.5E−4 | −7.84E−4 | −6.664E−4 |
| ${θ}_{3}^{*} ( {3}^{rd} Order Interactions )$ | 2.8E−5 | 2.8E−5 | 2.52E−5 | 1.96E−5 |
| ${θ}_{4}^{*} ( {4}^{th} Order Interactions )$ | −2.0E−7 | −2.0E−7 | −2.0E−7 | 1.4E−7 |
| t | 3.503 | | | |

NOTE:
${\sum }_{i = 1}^{4} {β}_{i} {a}_{i ( reduced )} = {θ}_{1 ( reduced )}^{*} = - 0.01$

Using the no malathion interaction case as a guide, we can specify values of model parameters under the alternative hypothesis based on cases that are of interest to investigators. First, we consider the case that malathion is involved in two-way interactions. In this case the third and fourth-order interaction terms are determined following the process defined in (11) and the second-order term is defined based on changes in the mean values that researchers define as biologically meaningful. We also consider the case where malathion is involved in two and three-way interactions and the case where malathion is involved in two, three, and four-way interactions. The interaction model parameters along the reduced ray for these three cases are provided in Table 2.

In addition to using the parameter values under the null hypothesis or no malathion interaction case, plots of the interaction models under the alternative hypothesis and tables of total dose values where a given percent change in the mean value occurs between the no malathion interaction case and the specified alternative cases are useful in defining biologically meaningful interactions. The plots are provided in FIGS. 2(a-c). The additivity model along the reduced ray is also provided to aid in the interpretation of the interaction model specified under the alternative hypothesis. Table 3 provides the doses where a given percent change in the mean response is observed between the no malathion interaction case and the model specified under the alternative hypothesis. Since the generalized linear model is nonlinear, the differences in the curves are not constant. For example, if we are interested in detecting at least a 5% change in the mean for the two-way interaction case, the minimum total dose value that is associated with such a change in the mean is 40.33 mg/kg.

TABLE 3
Lowest total dose values along the reduced fixed-ratio ray
that result in 5%, 10%, 15%, and 20% changes in mean
responses between the model under the null hypothesis
and the model under the alternative hypotheses that
(a) malathion is involved in 2-way interactions,
(b) malathion is involved in 2 and 3-way interactions, and
(c) malathion is involved in 2, 3, and 4-way interactions.

| | | | Two, Three, and |
|---|---|---|---|
| Change in | Two-way | Two and Three-Way | Four-Way |
| Mean | Interactions | Interactions | Interactions |
| 5% | 40.33 | 18.37 | 15.78 |
| 10% | 56.36 | 28.71 | 27.04 |
| 15% | 68.25 | 42.98 | 77.69 |
| 20% | 77.96 | 81.88 | 81.46 |

Thus far, we have used available information provided by the analysis on single chemical and mixture data along the full ray, in combination with plots, to specify model parameters associated with the alternative hypotheses of interest. Now we must specify the size of the design and the available sample size. Suppose researchers indicate that a maximum sample size of 80 animals is possible for the mixture study along the reduced ray. For a mixture of c chemicals, (c+1) is the minimum number of dose group necessary to detect departure from additivity along a fixed-ratio ray. Thus, the minimum design along the reduced ray is a five-point design.

The Nelder-Mead algorithm (Nelder and Mead, 1965) is used to determine the optimal allocation of the 80 available animals to five total dose groups that minimizes the generalized variance associated with the parameter values related to the hypothesis that malathion is not involved in interactions with the remaining four pesticides. The Nelder-Mead algorithm requires starting values for the dose levels and the sample size allocations. For each of the three cases considered we force the design to include a control group and a range of starting values (0 to 80 by 5) for the remaining total dose values were considered. Initially, equal allocation across the dose groups was assumed. The Dₛ-optimal designs are provided in Table 4. Notice that the design for the case where it is assumed that malathion is involved in two-way interactions is the same as the design for the case where malathion is assumed to be involved in two, three, and four-way interactions. Also, notice that in each of the three cases the allocation of the total sample is relatively equal across the dose groups. Finally, if we look at the plots of the models under the alternative hypotheses, provided in FIGS. 2(a-c), we see that the total dose levels determined by the Dₛ-optimal designs are located where the curvature exists along the model considered under the alternative hypothesis and where the largest differences occur between the no malathion interaction model and the model under the alternative hypothesis.

TABLE 4
Five point Dₛ-optimal designs for the hypothesis, given in (10),
that malathion does not interact with the four active pesticides. The
top row corresponds to the total dose locations and the bottom row of
the design corresponds to the sample size allocation. Parameter
estimates along the full fixed-ratio ray are provided in Table 1.
Assumed model parameters under the alternative hypothesis along the
reduced ray for each of the three cases considered are provided in
Table 2.

| | Dₛ-Optimal Design |
|---|---|
| Two-way Interaction Case | $Ψ = \{ \begin{matrix}0 & 33 & 35 & 65 & 80 \\ 16 & 16 & 16 & 16 & 16\end{matrix} \}$ |
| Two and Three-way Interaction Case | $Ψ = \{ \begin{matrix}0 & 30 & 35 & 61 & 80 \\ 16 & 16 & 16 & 16 & 16\end{matrix} \}$ |
| Two, Three, and Four-way Interaction Case | $Ψ = \{ \begin{matrix}0 & 33 & 35 & 65 & 80 \\ 16 & 16 & 16 & 16 & 16\end{matrix} \}$ |

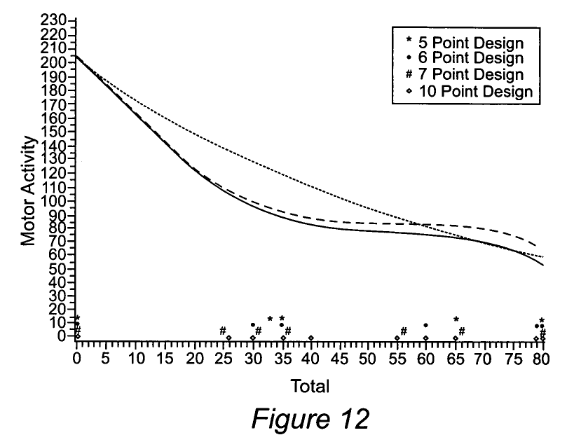

For each of the three cases considered above, we found the Dₛ-optimal design with the minimum number of design points, c+1. It is of interest to examine the effect of adding additional dose groups. For example, consider the six, seven and ten point Dₛ-optimal designs, provided in Table 5, for the alternative hypothesis that malathion is involved in two-way interactions only. Recall that each of the designs forces a control group. Notice that the five-point design places two dose groups in the middle of the dose region at the first curve in the model and two doses in the high dose region where there is additional curvature and the largest difference between the null and alternative models occurs. The six-point design continues to follow this pattern. In fact the six-point design is not much different from the five-point design as 79 mg/kg is not much different from 80 mg/kg. As more design points are added, the doses are added to the middle and high dose regions and are relatively equally spaced in these dose regions. FIG. 12 illustrates the placement of dose points for the five, six, seven, and ten-point designs given in Table 5.

TABLE 5
Six, seven, and ten point Dₛ-optimal designs for the hypothesis, given
in (10), that malathion does not interact with the four active pesticides
and the alternative hypothesis that malathion is involved in two-way
interactions. The top row of the design corresponds to the total dose
locations and the bottom row corresponds to the sample size allocation.
Parameter estimates along the full fixed-ratio ray are provided in Table
1. Assumed model parameters under the alternative hypothesis along the
reduced ray are provided in Table 2.

| Two-Way | |
|---|---|
| Interaction Case | Dₛ-Optimal Design |
| Six Point Design | $Ψ = \{ \begin{matrix}0 & 30 & 35 & 60 & 79 & 80 \\ 13 & 13 & 13 & 14 & 13 & 13\end{matrix} \}$ |
| Seven Point Design | $Ψ = \{ \begin{matrix}0 & 25 & 31 & 36 & 56 & 66 & 80 \\ 10 & 12 & 12 & 12 & 12 & 12 & 12\end{matrix} \}$ |
| Ten Point Design | $Ψ = \{ \begin{matrix}0 & 26 & 30 & 35 & 40 & 55 & 60 & 65 & 79 & 80 \\ 8 & 8 & 8 & 8 & 8 & 8 & 8 & 8 & 8 & 8\end{matrix} \}$ |

5. Efficiency

When it is of interest to detect and characterize interactions among chemicals in a mixture, multiple hypotheses are often considered. Different hypotheses can result in different designs. In choosing the appropriate design, consideration can be given to the primary hypothesis of interest. Given the design corresponding to the primary hypothesis of interest (Ψ) and the design corresponding to the secondary hypothesis (Ψ*), efficiency, described by Atkinson and Donev (1992) and given by

$$Eff = {\{ \frac{\vert M ( ψ ) \vert}{\vert M ( {ψ}^{*} ) \vert} \}}^{\frac{1}{p}} ,$$

can be used to determine how efficient Ψ is relative to Ψ* for testing the secondary hypotheses (p is the number of model parameters). For example, we are primarily interested in testing for interactions between malathion and the four active pesticides. However, in order to ensure appropriate conclusions are made with respect to the effect of malathion, it is important to consider the hypothesis for additivity, given in (4), along the reduced ray. If the design chosen to study interactions between malathion and the remaining components of the mixture does not adequately allow for the detection of higher-order terms along the reduced ray, conclusions about the effect of malathion may be misleading. Thus, it is important to consider the efficiency of the designs given in Table 4 for testing the hypothesis of additivity given in (4).

Let ψ_{interact} represent the design associated with the hypothesis, given in (10), that malathion is not involved in any interactions and let ψ_{add} represent the design for the overall hypothesis of additivity along the reduced ray, given in (4). Following Atkinson and Donev (1992), the Dₛ-efficiency of ψ_{interact} for testing the hypothesis of additivity along the reduced ray can be expressed as

$${D}_{s - eff} = {\{ \frac{\vert M ( {ψ}_{interact} ) \vert}{\vert M ( {ψ}_{add} ) \vert} \}}^{\frac{1}{p}} \qquad ( 12 )$$

where |M(ψ_{interact})| is the determinant of the variance-covariance matrix associated with the hypothesis of additivity when the ψ_{interact} design is considered, |M(ψ_{add})| is the determinant of the variance-covariance matrix associated with the hypothesis of additivity when the ψ_{add} design is considered, and p is the number of parameters. If D_{s-eff} equals one, ψ_{interact} is fully efficient for testing hypothesis of additivity. The smaller D_{s-eff} the less efficient ψ_{interact} is for testing the hypothesis of additivity.

Consider the Dₛ-optimal design (ψ_{interact}), given in Table 4, for the case where it is assumed that malathion is involved in two, three, and four-way interactions. We are interested in determining the efficiency of this design for testing the overall hypothesis of additivity. The Dₛ-optimal design for testing for departure from additivity along the reduced ray is given by

$${Ψ}_{add} = \{ \begin{matrix}0 & 30 & 35 & 65 & 80 \\ 16 & 16 & 16 & 16 & 16\end{matrix} \} .$$

The efficiency of ψ_{interact} for testing for the presence of the higher-order terms along the reduced ray is given by

$${D}_{s eff} = {\{ \frac{\vert M ( {ψ}_{interact} ) \vert}{\vert M ( {ψ}_{add} ) \vert} \}}^{1 / 11} = .99 .$$

Thus, the Dₛ-optimal design associated with testing interactions between malathion and the four active pesticides under the assumption that malathion is involved in two, three, and four-way interactions is efficient for testing for the presence of higher-order terms along the reduced ray. Notice that these two designs are similar to one another, thus we would expect high efficiency.

6. Discussion

The goal of this paper was to develop methodology for determining dose locations and sample size allocation that provide precise parameter estimation and enough power to detect departure from additivity and interactions due to subsets of chemicals along fixed-ratio rays. The precision of parameter estimates is an important issue as it is associated with increased power. Consideration has been given to Dₛ-optimal designs which are concerned with minimizing the generalized variance associated with the hypothesis of interest.

The hypotheses developed in Section 2 require the fit of higher-order polynomial models. Working with such models can cause numerical problems, particularly as the order of the polynomial increases. For example consider the model parameters that results from fitting the generalized linear model with the log link to the single chemical data and to the data along the full fixed-ratio ray (estimates provided in Table 1). Notice that the parameter associated with the fourth-order term is ˜1.9E-10 with a standard error of 1.0E-10. We are considering a dose range of 0 mg/kg to 450 mg/kg along the full ray and 0 mg/kg to 80 mg/kg along the reduced ray. Raising such dose values to powers of greater than or equal to two results in relatively large numbers; thus, parameters estimates associated with higher-order terms become smaller as the order of the polynomial term increases. In some situations such small numbers cause calculation problems. It should be noted that the degree of the polynomial model chosen follows directly from the number of components in the mixture (Meadows et al., 2002a; Casey (2003)). Therefore, these higher-order polynomial terms are important in detecting and characterizing interactions. One proposed solution to ease numerical problems is to consider scaling the dose range. For example we could divide the doses by 10 or 100 and work with either centigrams or decigrams instead of milligrams. Although the results are not presented here we examined the effect of scaling the dose on the Dₛ-optimal designs. For the examples we considered the designs reported here were equivalent to the designs along the scaled dose region.

Since the hypotheses of interest involve only a subset of the model parameters, Dₛ-optimal designs were developed for fixed-ratio rays. The Dₛ-optimal examples presented here considered the design along a single fixed-ray ray. These methods can be extended to simultaneously consider dose location and sample size allocation for multiple rays. Although the examples presented here resulted in relatively equal allocation it is important to note that equal allocation is not always optimal. Dₛ-optimal designs condition on model parameter values specified under the alternative hypothesis. In the case where competing hypotheses are of interest, methods for determine the Dₛ-efficiency of one design relative to another were also developed.

The designs presented here were developed for the generalized linear model. In evaluating the risk associated with exposure to mixtures it is often of interest to detect a threshold (Schwartz et al., 1995). The methods for detecting overall departure from additivity and for detecting interactions between subsets of chemicals and the remaining components of a mixture are readily extended to the threshold model (Casey, 2003). The methodology for determining Dₛ-optimal designs can readily be applied when threshold models are of interest.

References

Aspelin, A. L. 1994. Pesticide Industry Sales and Usage: 1992 and 1993 Market Estimates, Office of Pesticides Programs, U.S. Environmental Protection Agency, EPA 733-L-94-001, Washington, D.C.

Atkinson, A. C. and Donev A. N. 1992. Optimum Experimental Designs, New York: Oxford University Press.

Brunden, M; and Vidmar, T. 1989. Optimal 3×3 Factorial and 3-ray Designs for Drug Interaction Experiments with Dichotomous Responses. Communications in Statistics, 18, 2835-2859.

Casey M. A. 2003. Statistical methodology for Exploiting the Use of Ray Designs in Studies of Polychemical Mixtures, Unpublished Ph.D. Dissertation, Virginia Commonwealth University, Department of Biostatistics.

Colosio, C., Corsini, E., Barcellini, W., Maroni, M.1999. Immune Parameters in Biological Monitoring of Pesticide Exposure: Current Knowledge and Perspectives. Toxicology Letters, 108, 285-295.

Gennings, C., Carter, W. H., Jr., Campain, J., Bae, D., Yang, R. S. H. 2002. Statistical Analysis of Interactive Cytotoxicity in Human Epidermal Keratinocytes Following Exposure to a Mixture of Four Medals. Journal of Agricultural, Biological, and Environmental Statistics, 17, 58-73.

Kiefer, J., and Wolfowitz, J. 1959. Optimum Designs in Regression Problems. The Annals of Mathematical Statistics, 30, 271-294.

Ma, X., Buffler, P. A., Gunier, R. B., Dahl, G., Smith, M. T., Reinier, K., and Reynolds, P. 2002. Critical Windows of Exposure to Household Pesticides and Risk of Childhood Leukemia. Environmental Health Perspectives, 110, 955-960.

McCullagh, P. 1983. Quasi-likelihood Functions. The Annals of Statistics, 11, 59-67.

McCullagh, P., Nelder, J. A. 1989. Generalized Linear Models (2^{nd} ed), New York: Campman and Hall, 511 pp.

Meadows, S. L. 2001. Optimal Experimental Designs for Detecting Departures from Additivity in Drug Chemical Mixtures, Unpublished Ph.D. Dissertation, Virginia Commonwealth University, Department of Biostatistics.

Meadows, S. L., Gennings, C. and Carter, W. H., Jr. 2002a. Experimental Designs for Mixtures of Chemicals along Fixed-Ratio Rays. Environmental HealtPerspective, 110, 979-983.

Meadows, S. L., Gennings, C., Carter, W. H., Jr., and Simmons, J. E. 2002b. Analysis of Mixtures of Drugs/Chemicals along a Fixed Ratio Ray without Single Chemical Data to Support an Additivity Model. The Journal of Agricultural, Biological, and Environmental Statistics, in review.

Nelder, J. A. and Mead, R. 1965. A Simplex Method for Function Minimization. The Computer Journal, 7, 308-313.

Schwartz, P. F., Gennings, C., and Chinchilli, V. M., 1995. Threshold Models for Combination Data From Reproductive and Developmental Experiments. Journal of the American Statistical Association, 90, 862-870.

Wedderburn R. W. M. 1974. Quasi-Likelihood Functions, Generalized Linear Model and the Gauss-Newton Method. Biometrika, 61, 439-447.

Appendix

Summary statistics for activity response associated with the single chemical data.

APPENDIX
Summary statistics for motor activity response
associated with the single chemical data.

| | | Mean Motor | | |
|---|---|---|---|---|
| | Dose | Activity | Standard | |
| Chemical | mg/kg | Response | Deviation | Sample Size |
| Acephate | 0 | 217.88 | 35.77 | 8 |
| | 3 | 200.13 | 34.13 | 8 |
| | 10 | 165.88 | 25.02 | 8 |
| | 30 | 108.75 | 62.51 | 8 |
| | 60 | 58.25 | 24.23 | 8 |
| | 120 | 33.25 | 27.41 | 8 |
| Diazinon | 0 | 206.69 | 34.77 | 16 |
| | 5 | 190.88 | 28.49 | 16 |
| | 25 | 215.56 | 24.02 | 16 |
| | 50 | 183.13 | 24.44 | 8 |
| | 75 | 165.69 | 33.05 | 16 |
| | 125 | 152.00 | 38.65 | 8 |
| | 150 | 76.5 | 35.4 | 8 |
| | 250 | 61.25 | 47.07 | 8 |
| Chlorpyrifos | 0 | 190.00 | 14.36 | 8 |
| | 2 | 192.75 | 38.61 | 8 |
| | 10 | 172.13 | 17.55 | 8 |
| | 20 | 157.13 | 28.31 | 8 |
| | 30 | 80.13 | 34.85 | 8 |
| | 50 | 56.38 | 29.98 | 8 |
| Malathion | 0 | 195.86 | 19.06 | 7 |
| | 100 | 201.5 | 28.38 | 8 |
| | 500 | 203.75 | 28.34 | 8 |
| Dimethoate | 0 | 195.75 | 33.12 | 8 |
| | 5 | 188.25 | 24.21 | 8 |
| | 10 | 188.63 | 53.05 | 8 |
| | 25 | 107.75 | 37.23 | 8 |
| | 50 | 103.75 | 51.59 | 8 |
| | 75 | 101.50 | 59.57 | 8 |

Summary statistics for motor activity response associated
with mixture data along the full fixed-ratio ray.

| Total | Mean Motor | | |
|---|---|---|---|
| Concentration | Activity | Standard | |
| Dose (mg/kg) | Response | Deviation | Sample Size |
| 0 | 199.43 | 20.77 | 14 |
| 10 | 200.92 | 27.10 | 12 |
| 55 | 167.92 | 37.55 | 12 |
| 100 | 117.08 | 47.34 | 12 |
| 200 | 95.17 | 34.03 | 12 |
| 300 | 72.25 | 40.93 | 12 |
| 450 | 60.08 | 46.36 | 12 |

### Example 5

### Statistical Analysis of Interactive Cytotoxicity in Human Epidermal Keratinocytes Following Exposure to a Mixture of Four Metals

Introduction

Both occupational and environmental exposures to hazardous metals are significant toxicological concerns. Not only do metals such as arsenic (As), cadmium (Cd), chromium (Cr), lead (Pb) and nickel (Ni) lead to toxicity in exposed individuals, but epidemiological evidence suggests that some, if not all, of these metals are human carcinogens. Many laboratories, using a variety of experimental systems and techniques, have invested substantial resources into mechanistic studies of metal toxicity. We are, however, still a long way from understanding the relationship between these observed cellular effects and the toxicity of metals in exposed populations. To further complicate the picture, individuals are rarely exposed to single metals. Rather, they are exposed to metals in combination with one another or with other environmental contaminants such as those prevalent at hazardous waste sites. In fact, 100 or more different chemicals can be found at a single hazardous waste site in varying combinations in water, soil, and air (De Rosa et al, 1996). Like most chemical mixtures, however, the toxicity of these metal-containing mixtures has not yet been studied. It is anticipated that many of the toxic effects of metals, including carcinogenicity, can be modified by concurrent exposure to other metals. We are interested in understanding the biological processes that drive metal-mediated cytotoxicity and carcinogenesis, particularly with respect to metals in environmentally relevant chemical mixtures. The metals chosen for these studies were As, Cd, Cr, and Pb, which are among the top contaminants in site frequency count by the ATSDR Completed Exposure Pathway Site Count Report (ATSDR, 1997); three of these, As, Pb, and Cd are among the Superfund Top 10 Priority Hazardous Substances (De Rosa et al, 1996), i.e. those considered to pose the greatest hazard to human health. In addition, as demonstrated by ATSDR using the HazDat database, these metals are present in eight (five) of the Top 10 Binary Combinations of Contaminants in soil (water) (Fay and Mumtaz, 1996). Mechanistic studies have demonstrated that these four metals affect multiple intracellular targets, (including both nucleic acids and proteins) and exert a variety of diverse effects on cells in culture (including DNA damage and mutagenesis, enzyme inactivation and altered metabolism, and aberrant signal transduction). The role played by these intracellular alterations in either metal-mediated acute toxicity or carcinogenicity is currently uncertain.

Epidermal keratinocytes, both in culture and in vivo, have been used extensively to study the effects of chemical exposure at the cellular level, particularly with regards to malignant transformation. These types of studies have defined phenotypic and genotypic alterations that occur during transformation of normal skin cells (Pietenpol, Holt, Stein, and Moses, 1990; Gaido, Maness, Leonard, and Greenlee, 1992; Glick, Spom, and Yuspa, 1991; Glick, Lee, Darwiche, Kulkami, et al, 1994; Choi, Toscano, Ryan, Riedel, et al, 1991; Punnonen, Denning, Rhee, and Yuspa, 1994). In addition, for As at least, the skin is a critical target organ for metal-mediated carcinogenesis and other proliferative disorders such as hyperkeratosis. Due to high As concentrations in many drinking water supplies, this has become a health problem of global proportions. Arsenic has substantial effects on epidermal keratinocytes in vitro, altering expression of several growth regulatory factors such as TGFa and TGFb, and inhibiting the normal process of differentiation (Germolec, Yoshida, Gaido, Wilmer, et al, 1996; Yen, Chiang, Chang, Tsai, et al, 1996; Germolec, Spalding, Boorman, Wilmer. et al, 1997; Kachinskas, Qin, Phillips, and Rice, 1997). This latter effect is also seen in keratinocytes with Cr administration, a well known skin sensitizer (Cohen, Kargacin, Klein, and Costa, 1993; Ye, Zhang, Young, Mao, and Shi, 1995). We have, therefore, chosen human keratinocytes for our toxicological studies of metal mixtures. These studies have two distinct phases and are being carried out in both primary human epidermal keratinocytes and virally or spontaneously immortalized keratinocyte cell lines: 1) evaluation of the acute cytotoxicity of As, Cd, Cr, and Pb in this cell type, both individually and in combination in a four-metal mixture, and 2) determination of the carcinogenic potential of the metals and metal mixture in low-dose long-term chronic exposure scenarios. In both phases of our work a great deal of emphasis is being placed on identifying toxicological interactions among the metals, whether synergistic or antagonistic. Subsequent mechanistic studies will increase our understanding of these interactions and aid in development of more realistic risk assessment strategies for metal-containing chemical mixtures. As part of this larger study, we present here a detailed statistical analysis of the cytotoxic interactions of As, Cd, Cr, and Pb in normal primary human keratinocytes.

Of primary importance in studying these four metals is the determination and characterization of their interactions when present in a mixture. For example, it is of interest to determine if the metals interact in such a way as to increase the toxic effect above what one would expect to observe from any single chemical. If the metals do not interact, it is said that they may either be functionally independent or may act in a dose-additive fashion. One definition of additivity is given by Berenbaum (e.g., 1985) and is based on the classical isobolograms for the combination of two chemicals (e.g., Loewe and Muischnek, 1926; Loewe, 1953). That is, in a combination of c chemicals, let Xᵢ represent the concentration/dose of the i^{th} component alone that yields a fixed response, y₀, and let xᵢ represent the concentration/dose of the i^{th} component in combination with the c agents that yields the same response. According to this definition of additivity if the substances combine with zero interaction, then

$${\sum }_{i = 1}^{c} \frac{{x}_{i}}{{X}_{i}} = 1.$$

The additivity surface can be used to test the null hypothesis that the chemicals act in an additive fashion. The experimental data necessary and sufficient to support the estimation of the additivity surface are single chemical dose-response data (e.g., Gennings, et al., 1997). The experimental design considered herein also includes a fixed ratio of the four metals at varying total dose levels. It is of interest to determine if the observed mean responses from these mixture points coincide with the predicted response under the assumption of additivity. This general approach is described in detail by many authors, including Berenbaum (1985), Kelly and Rice (1990), Gennings and Carter (1995), Gennings et al (1997). However, these authors do not address the issue of simultaneous testing at multiple mixture points.

In what follows, two simultaneous tests for departure from additivity are developed. If the overall test of additivity is rejected, then corrected single degree of freedom tests can be used to determine at which mixture point(s) an interaction exists. The correction is based on Hochberg's (1990) sequentially rejective approach. Prediction intervals are then used to characterize the interaction as synergistic or antagonistic. In addition, a simultaneous confidence band on the difference in the predicted response and that predicted under additivity is compared to a zero reference level to identify concentration ranges of departure from additivity.

Materials and Methods

Chemicals. Sodium metaarsenite (NaAsO₂), cadmium chloride (CdCl₂), chromium oxide (CrO₃), chromium chloride (CrCl₃), lead acetate [(C₂H₃O₂)₂Pb.3H₂O], and 3-[4,5-Dimethylthiazol-2-yl]-2,5-diphenyltetrazolium bromide (MTT) were purchased from Sigma Chemical Co. (St. Louis, Mo.).

Cells and culture conditions. Cryopreserved, pooled normal human epidermal keratinocytes (NHEK) were purchased from the Clonetics Corp. (San Diego, Calif.). NHEK cells were grown in defined Keratinocyte Growth Medium-KGM™ (Clonetics).

Cytotoxicity analyses. For toxicity studies, cells were plated at a density of 2,500 cells/cm² in 6-well plastic tissue culture plates and grown for 24 hr before metal treatment. Triplicate wells of cells were treated with increasing concentrations of As, Cr, Cd, Pb, or a mixture of the four metals for 24 hr. Concentrations used for As and Cr were 0.3, 1, 3, 10 , and 100 mM. The Cr stock was made by mixing a 1:1 ratio of trivalent and hexavalent chromium. Cd and Pb were administered at 3, 10, 30, 100, and 300 mM. To prepare the four metal mixture, a 50× stock solution was made which, when diluted to its final 1× concentration in cell culture, contained the levels of each As, Cr, and Cd giving 50% cell killing in individual cytotoxicity assays (LD₅₀). The concentrations of these three metals in the 1× mixture solution was 7.7 mM As, 4.9 mM Cr, 6.1 mM Cd. The lead acetate concentration in the 1× solution was 100 mM, as we were unable to get complete killing at any dose tested. This 1× solution was serially diluted at a 1:3 ratio to get 0.333, 0.111, 0.037, 0.0123, 0.004, and 0.0014 dilution groups. Double deionized water was used as the vehicle control in all cases. After exposure to the individual metals or metal mixture, cells were refed with fresh metal-free KGM medium and incubated for 3 days prior to viability analysis by the MTT assay.

MTT assay. The MTT assay was carried out using a modification of the method of Mosmann (1983). MTT was dissolved at 5 mg/ml in 1× PBS [phosphate-buffered saline]. This stock solution was filtered through a 0.2 mM filter and stored at 4° C. Immediately before use, the stock solution was diluted to 0.5 mg/ml with serum-free KGM to make a working solution. Working solution (1 ml) was added to each well of cells after aspiration of medium. Cells were incubated at 37° C. for 3 hr, after which time, the MTT was removed by aspiration. Cells were subsequently lysed by addition of 0.5 ml of dimethyl sulfoxide (DMSO). The absorbence at 550 nm of samples as well as a DMSO blank was read on a Microplate Autoreader (Bio-Tek Instruments, Inc, Winooski, Vt.). The absorbance of the DMSO blank was subtracted from all values. All absorbance values were standardized to the water vehicle control.

Additivity model. The nonlinear additivity model selected for fitting the single chemical data was based on a Gompertz function.

y=α+γ[exp(−exp(−(β₀+β₁x₁+β₂x₂+β₃x₃+β₄x₄)))]+ε (1)

where

y is the observed response (% viability),

x₁ is the dose of arsenic (mM),

x₂ is the dose of chromium (mM),

x₃ is the dose of cadmium (mM),

x₄ is the dose of lead (mM),

α is an unknown parameter associated with the minimum response,

γ is an unknown parameter associated with the maximum response

β₀ is an unknown parameter associated with the intercept on the complementary log log scale,

β₁ is an unknown parameter associated with the slope of arsenic,

β₂ is an unknown parameter associated with the slope of chromium,

β₃ is an unknown parameter associated with the slope of cadmium,

β₄ is an unknown parameter associated with the slope of lead, and

ε is an unobserved random error term assumed to have mean 0 and constant variance.

The Gauss-Newton iterative algorithm was used in PROC NLIN in SAS (version 6.12) to find parameter estimates under the assumption of a constant variance across the dose range of all four compounds. Upon consideration of the range of sample variances for the single chemical data, a weighted least-squares criterion was initially considered where the weight of each observation is set to the inverse of the sample variance. For convenience in calculating the prediction intervals an unweighted analysis is given here. The predicted responses in the two models were very similar.

To compare the observed response at Xₘ to that predicted under the hypothesis of additivity, a prediction interval was used at each of the m=1, . . . ,M(=7) mixture points where M is the total number of mixture points. Let \overline{y}_{X}_{ₘ} be the observed sample mean response at the combination Xₘ with sample variance Var(\overline{y}_{X}_{ₘ}). Denote the estimated predicted response using the model given in (1) by ŷ_{X}_{ₘ} with estimated variance Var(ŷ_{X}_{ₘ}). Using the approach taken by Gennings et al. (1997), a 100(1-a)% prediction interval for the sample mean response at Xₘ under the assumption of additivity is given by

ŷ_{X}_{ₘ}±t_{(1-α/2;N-7)}{square root over (Var(ŷ)}_{X}_{ₘ})+Var(\overline{y}_{X}_{ₘ}), (2)

where N is the total number of observations. If the observed sample mean, \overline{y}_{X}_{ₘ}, is not included in the prediction interval, then it is reasonable to conclude that the data do not support the assumption of additivity. For decreasing dose response curves, if the observed sample mean is less than the lower bound of the prediction interval, then synergism can be claimed at Xₘ, i.e., lower viability than expected under additivity. If the observed sample mean exceeds the upper bound of the prediction interval, then antagonism can be claimed at Xₘ, i.e., greater viability than expected under additivity. It is important to note that these prediction intervals are piecewise intervals without correction for multiple testing.

Overall Test of Additivity:

An overall test for additivity can be based on testing the hypothesis that the mean response under the hypothesis of additivity is the true mean response. The estimated response under the hypothesis of additivity is provided by the model given in (1). The estimated response for the true mean is provided by the sample means at each mixture group. Define the M-dimensional vector d=E(Y_{add,X})-E(Y_{X}), which is estimated as \hat{δ}=ŷ_{add,X}−\overline{y}_{X}. Let θ₁ be the vector of model parameters associated with the model given in (1), i.e., θ₁=[α γ β₀ β₁ β₂ β₃ β₄]′. Let θ=[θ′₁ μ₁ μ₂ . . . μ_{M}]′ be the combined vector of model parameters and mixture point means. Let

$$Ω = [ \begin{matrix}Σ & 0 \\ 0 & D\end{matrix} ] ,$$

where s²S is the pxp variance covariance matrix of the model parameters given in q₁ and s²D=diag[Var(\overline{y}(x₁)) . . . Var(\overline{y}(x_{M}))]. Using the multivariate delta method, an approximate large sample estimate for the variance of \hat{δ} is given by s²GWG′, where

$$G = {( ( \frac{\partial {δ}_{s}}{\partial {θ}_{r}} ) )}_{\hat{θ} ; s = 1 , … , M ; r = 1 , … , p + M } .$$

For large samples, \hat{δ}′[G\hat{Ω}G′]⁻¹\hat{δ}/σ² follows a chi square distribution with M degrees of freedom. Then a Wald-type test for testing if the observed mixture points agree with the assumption of additivity simultaneously is given by

$${W}_{M} ( δ ) = \frac{{{\hat{δ}}^{′} [ G \hat{ Ω} {G}^{′} ]}^{- 1} \hat{δ}}{MSE} \qquad ( 3 )$$

which follows an F distribution with M and N−p degrees of freedom for large samples.

Once the overall test for additivity is rejected, it is of interest to detect and characterize departure from additivity at each of the M mixture points. If M>1 then individual tests for departure from additivity and/or multiple 95% prediction intervals suffer from an inflated significance level for the family of tests. Hochberg (1990) proposed a refinement of Bonferroni's correction to adjust for multiple tests while maintaining an overall significance level. His approach is a step-down sequentially rejective procedure which rejects the hypothesis (here, of additivity) associated with the m^{th} statistic and all other hypotheses corresponding to smaller p-values when

$$p \text{-} {value}_{( m )} \leq \frac{α}{M - m + 1} ,$$

for m=1, . . . ,M.

Our approach is to use Hochberg's correction on the M single degree of freedom tests of (3) when M=1. If the m^{th} p-value associated with a mixture point is less than a/(M−m+1) then departure from additivity is claimed at all mixture points with smaller p values. The prediction intervals given in (2) are used to characterize the type of interaction detected for the points where departure from additivity is detected using Hochberg's correction for multiple testing.

Comparison of Fitted Curves:

When the M mixture points are on a fixed ratio ray, these mixture points can be used to estimate a dose response curve along the fixed ratio ray using total dose as the measure of total exposure. In this case, an extension to the approach above can be made. Of interest is to compare the predicted response along a fixed ratio-mixing ray from two sources. Under the hypothesis of additivity, the single chemical data are used to estimate an additivity surface. The slice of the fitted surface that corresponds to the fixed ratio ray is denoted f_{A}(x; \hat{θ}_{1 px1}). Suppose that enough mixture points are experimentally considered along the fixed ratio ray so that an independent fit of the mixture data yields an estimate f_{M}(x; \hat{θ}_{2 qx1}). Further, assume that under additivity g(q₁)=q₂. Thus, the additivity hypothesis is equivalent to testing 1=g(q₁)−q₂=0.

$$Define {q}^{*} = {[ {q}_{1}^{′} \vert {q}_{2}^{′} ]}^{′} and {Ω}^{*} = [ \begin{matrix}{Σ}_{1} & 0 \\ 0 & {Σ}_{2}\end{matrix} ] ,$$

where s²W* is the variance-covariance matrix of q*. Define \hat{λ}=g(\hat{θ}₁)−\hat{θ}₂. A large sample approximate variance covariance matrix of \hat{λ} is given by s²HW*H′, where

$$H = {( ( \frac{\partial λ}{\partial {θ}_{j}^{*}} ) )}_{j = 1 , … , p + q} .$$

Then under the hypothesis of additivity for large samples

$$\frac{{{\hat{λ}}^{′} [ H {Ω}^{*} {H}^{′} ]}^{- 1} \hat{λ}}{MSE} is approximately {F}_{q , N - ( p + q )} . \qquad ( 4 )$$

Here, the model given in (1) provides f_{A}(x;q₁) and

f_{M}(x; q₂)=a*+g*[exp(−exp(−(b₀*+b₁*x+b₁₁*x²)))], (5)

where x is the total dose along the fixed ratio ray. Then, under additivity, 1=g(q₁)−q₂=

$$[ \begin{matrix}α - {α}^{*} \\ γ - {γ}^{*} \\ {β}_{0} - {β}_{0}^{*} \\ {\sum }_{i = 1}^{c} {β}_{i} {a}_{i} - {β}_{1}^{*} \\ {β}_{11}^{*}\end{matrix} ] = 0.$$

Simultaneous confidence band of f_{A}(x;q₁)−f_{M}(x; q₂) along the fixed ratio ray:

Define d(x;q*)=f_{A}(x;q₁)−f_{M}(x; q₂) as the difference, as a function of dose, between the model for the curve under additivity and using only the mixture data. Then

Var(d(x; \hat{θ}*))≈\hat{σ}²BΩ*B′,

where

$$B = {( ( \frac{\partial d ( x ; {θ}^{*} )}{\partial {θ}_{j}^{*}} ) )}_{j = 1 , … p + q} .$$

Following Miller(1981) and Seber and Wild (1989, pg 246), a 100(1−a)% confidence band for d(x;q*) is approximately for all x

d(x;q*)∈ d(x;\hat{θ}*)±\sqrt{(p+q)F_{α;p+q,N-(p+q)}}{square root over (Diag(Var(d(x)};\hat{θ}*)).

Noting when zero is not included in this confidence band allows one to determine total dose levels that depart from additivity.

Results

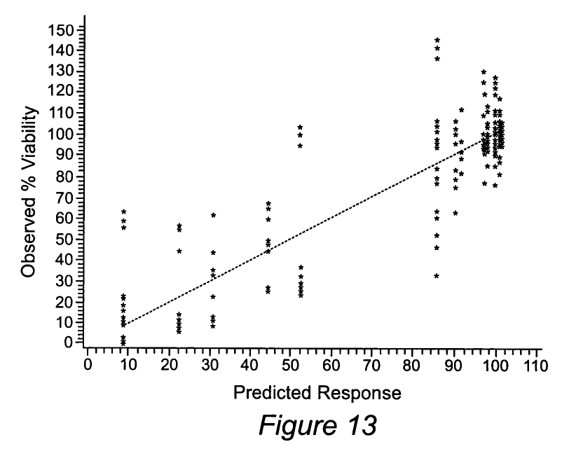

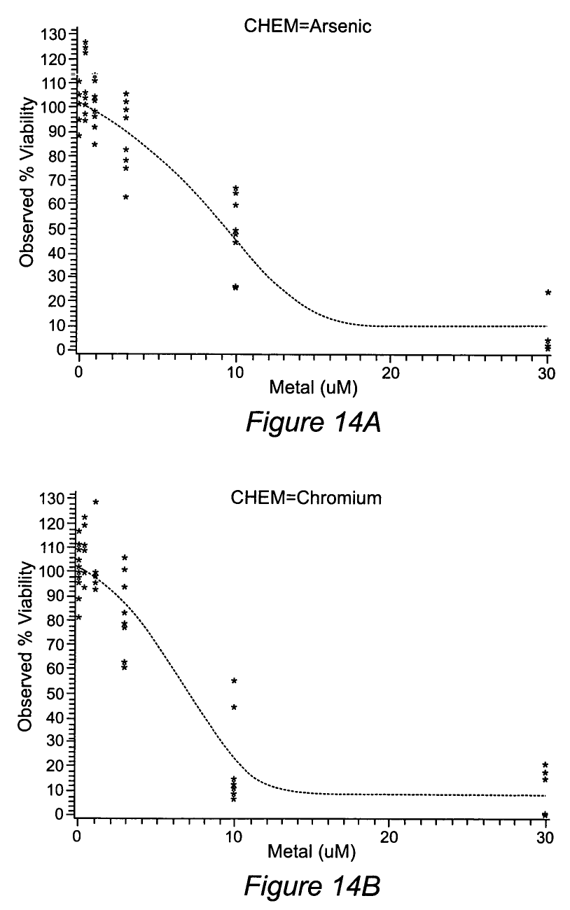

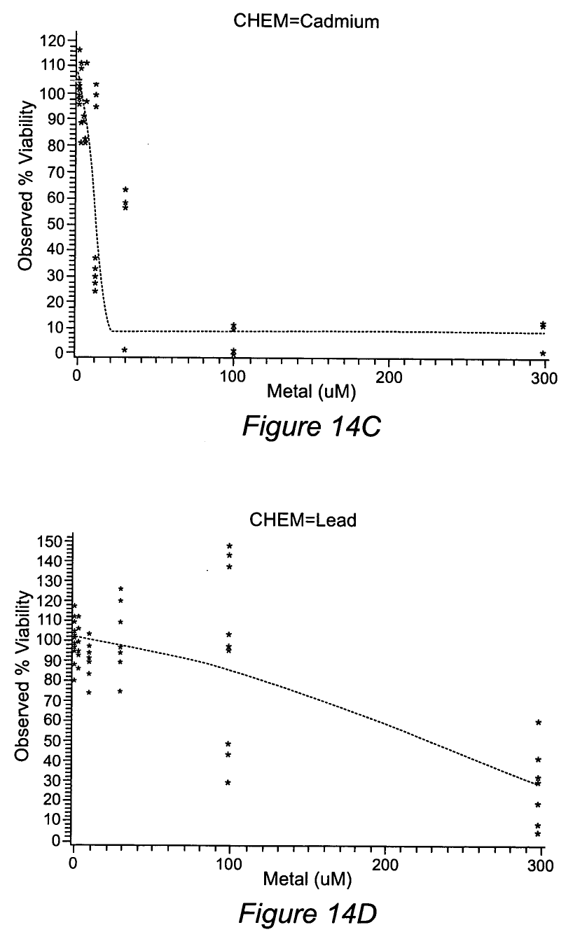

Summary statistics for the single chemical data and the mixture data are provided in the Appendix. The additivity model given in (1) was fit to the single chemical data. A plot of the observed and predicted responses is given in FIG. 13. The observed and model predicted responses for the individual metals are graphically provided in FIG. 14. Overall, the fit of the single chemical data seems adequate. The estimated model parameters and their associated large sample standard errors and p values are provided in Table 1. All of the model parameters were significantly different from zero as the p values are all <0.005. The slope parameters associated with each of the four metals are negative and significant, indicating that as the dose of the metal increases, the % viability decreases significantly.

TABLE 1
Estimated model parameters for the additivity
model given in (1) using NHEK cell line.

| | | Asymptotic | |
|---|---|---|---|
| Parameter | Estimate | Standard Error | P value |
| α | 8.76 | 2.58 | <0.001 |
| γ | 107.7 | 13.0 | <0.001 |
| β₀ | 1.87 | 0.658 | 0.005 |
| β₁ | −0.197 | 0.058 | <0.001 |
| β₂ | −0.259 | 0.0669 | <0.001 |
| β₃ | −0.177 | 0.0557 | 0.001 |
| β₄ | −0.0078 | 0.0021 | <0.001 |

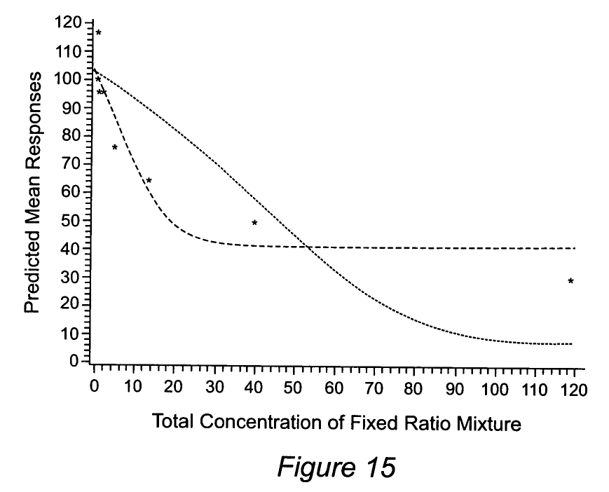

FIG. 15 presents the predicted concentration effect curve under additivity for total concentrations of the four metals along the ray associated with the LD₅₀ mixing ratio. This curve is based on the fit of the single chemical data and the definition of additivity. The asterisks indicate the observed sample means at the seven dilution points. From this figure, there is evidence of departure from additivity at some of the mixture points. In fact, the general trend does not seem to agree with the responses predicted under additivity.

The observed responses at the seven mixture points are provided in Table 2. This table also provides the predicted responses under the hypothesis of additivity. Table 3 presents the overall test for departure from additivity given in equation (3). The hypothesis of additivity at all seven of the mixture points considered is rejected with a p value <0.001. Table 3 also includes the single degree of freedom tests associated with each mixture point. Using Hochberg's (1990) correction for multiple comparisons, the three groups with the smallest p values are significantly different from that predicted under additivity as p<a/k for k=5,6,7, when the overall significance level is set at 5% (or at 1%).

TABLE 2
Observed mean % viability responses and predicted responses under the
hypothesis of additivity using the NHEK cell line. The sample size was 9 in
each mixture group. An * indicates a greater than additive relationship;
a # indicates a less than additive relationship; a ‘?’ indicates
a possible hormesis effect. The symbols are only included for mixture points
that are associated with significant departure from additivity using
Hochberg's correction in Table 3.

| | Total | | | | | 99% |
|---|---|---|---|---|---|---|
| | Concentration | Observed | | Predicted | | Prediction |
| | Of the | Mean | Variance Of | Response | 95% Prediction | Intervals |
| Mixture | Mixtures* | Response | Observed | Under | Intervals Under | Under |
| Dilution | (mM) | (% Viability) | Mean | Additivity | Additivity | Additivity |
| 0.0014 | 0.163 | 116.6 | 35.0 | 100.9 | [88.5, 113.3]? | [84.6, 117.2] |
| 0.004 | 0.475 | 95.7 | 12.1 | 100.7 | [92.8, 108.7] | [90.2, 111.2] |
| 0.0123 | 1.465 | 96.0 | 24.0 | 100.2 | [89.8, 110.5] | [86.5, 113.8] |
| 0.037 | 4.39 | 76.5 | 10.2 | 98.4 | [91.3, 105.4]* | [89.0, 107.7]* |
| 0.111 | 13.18 | 64.3 | 1.56 | 91.8 | [87.0, 96.7]* | [85.5, 98.2 ]* |
| 0.333 | 39.56 | 50.1 | 29.1 | 60.8 | [47.9, 73.6] | [43.8, 77.8] |
| 1 | 118.7 | 31.1 | 23.0 | 8.76 | [0, 19.5]# | [0, 22.9]# |

*The predetermined LD₅₀s were 7.7, 4.9, 6.1, 100 mM for arsenic, chromium, cadmium, and lead, respectively which were used to determine the mixing ratios of the metals.

TABLE 3
Test results for testing the hypothesis that the
mean of the mixture group is equal to that
predicted under additivity model.

| | |
|---|---|
| Statistic | P value* |

Overall F test ((7,200) df)

| | |
|---|---|
| 179.1 | <0.001 |

Individual F tests ((1,200) df)

| Dilution | Statistic | |
|---|---|---|
| 0.0014 | 6.27 | 0.013 |
| 0.004 | 1.53 | 0.217 |
| 0.0123 | 0.62 | 0.432 |
| 0.037 | 37.2 | <0.001** |
| 0.111 | 127.6 | <0.001** |
| 0.333 | 2.70 | 0.102 |
| 1 | 16.8 | <0.001** |

Using Hochberg's correction for multiple comparisons, these groups are associated with a significant interaction using an overall 5% test. Those marked with ** are significant with an overall significance level of 1%.

The direction of departure from additivity can be assessed through consideration of the prediction intervals in Table 2 for mixture points associated with significant departure from additivity using Hochberg's correction in Table 3. The 95% and 99% prediction intervals fall below the observed response for the lowest concentration of 0.0014 dilution. This indicates that there is a greater than expected response at very low concentrations. Perhaps this is due to an hormesis (i.e., growth stimulating) effect. Further, for the dilutions of 0.037 and 0.111, the observed sample means fall below the 95% prediction intervals. That is, the observed responses show more cytotoxicity than predicted under additivity. This may be associated with an overall conclusion of a cytotoxic synergism at these concentrations. By comparison, the mixture of the four LD50s (i.e., dilution is 1.0) show evidence of a less than additivity association in terms of cytotoxicity, as the observed mean response was less cytotoxic than predicted under additivity. This may be associated with an overall comclusion of a cytotoxic antagonism at this mixture.

With seven mixture points experimentally evaluated there are enough data to actually fit a concentration effect curve to these data and compare the fitted function to that predicted under additivity. Preliminary evaluation of the mixture data indicated that the relationship was more quadratic than linear on the complementary log-log scale. For this reason, the model given in (5) was used to fit the mixture data which includes a quadratic term in concentration. FIG. 15 presents the fitted mixture data concentration effect curve (dashed line) plotted with the predicted response curve under the hypothesis of additivity (solid line) and the observed mixture points (asterisks). The overall test for a difference between the fitted curve from the mixture data and the curve predicted under additivity as given in (4) was rejected (p<0.001).

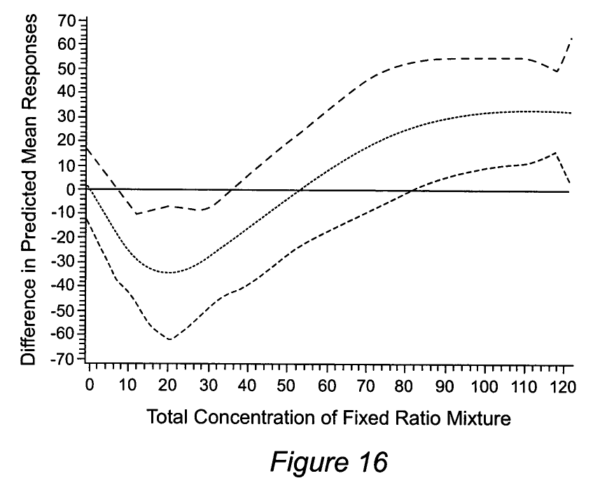

From FIG. 15, there seems to be an increasing departure of the two curves in the concentration range of roughly 10 to 40 total concentration units. This is depicted in FIG. 16 as the difference between the predicted response of the mixture data and that predicted under additivity. The 95% simultaneous confidence band on the difference between the curves (FIG. 16) does not include zero in the range from 8 to 36 mM of the mixture. In this range, the difference is significantly negative indicating the response of the mixture was associated with an increase in cytotoxicity as compared to that predicted under additivity, i.e., synergism. In addition, the difference is positive in the range from 80 to 120 mM indicating a decrease in cytotoxicity as compared to that predicted under additivity, i.e., antagonism. Thus, from this example, we have evidence of different characterizations of interaction along the same fixed ratio mixture of the four metals.

Discussion

The overall seven degree of freedom test for departure from additivity indicated that for at least one of the seven mixture groups there is a difference between the mean response as estimated by the additivity model and the unrestricted mean. The former is estimated by the model given in (1) and the latter by the sample means. Similar to the post hoc tests used in analysis of variance, Hochberg's step-down sequentially rejective procedure results in at least three concentration groups being associated with a significant difference from additivity.

The fit of the additivity model assumed a common estimate for a, g, and b₀. This restricts the maximum and minimum values for the range of the response to be the same: a minimum value of percent viability of 8.8% and a maximum value of 101.3%. The lowest mixture combination had a mean response of 116.6. This is clearly above that observed in the single chemical data. It is likely that this enhancement of cell viability at the lowest mixture level is indicative of the presence of “hormesis.” Hormesis, defined by Stebbing (1982) as the stimulatory effects caused by low levels of toxic agents, was originally developed under different terminologies over a century ago. Its origin, scientific development, historical perspectives, and modern implications have been ably reviewed by a number of contemporary scientists (Stebbing, 1982; Calabrese, 1997; Calabrese and Baldwin, 1997a,b; Stebbing, 1997). Since we are observing growth stimulatory effects at the lowest level of the metal mixture, this might be the first observation that a mixture of As, Cd, Cr, and Pb caused a hormesis effect. The interactive effect changes from additive cytotoxicity to synergistic cytotoxicity in the range of about 8 to 36 mM of the metal mixture (FIG. 4). It should be noted that when we talk about synergism or antagonism here we are referring to cytotoxicity; it is completely opposite if we refer to cell viability. Thus, we observe hormesis at the lowest mixture level and synergistic cytotoxicity at higher levels (roughly 8 to 36 mM). What we are seeing is a typical b-curve (or J- or U-shaped curve) for the growth hormesis (Calabrese, 1997). As Stebbing (1997) proposed, hormesis may be the cumulative consequence of transient and sustained over-corrections by feedback growth regulatory mechanisms to low levels of inhibitory challenge. When the concentration level increases, toxicity becomes more and more prevalent and the growth regulatory mechanisms are overwhelmed. Growth recovery to control level is thus impossible. At this stage, a number of mechanisms of toxicity for the different metals may work in concert, antagonism toward cell viability (or synergistic cytotoxicity) is therefore observed (FIGS. 15 and 16). Interestingly, at the highest mixture concentration tested in NHEK (119 mM), we again observed antagonistic cytotoxicity. We have also seen this same trend in immortalized keratinocyte cell lines when treated with a similar metal mixture (Bae et al., 2001). One hypothesis for why this is occurring is that at very high metal concentrations, cell protective mechanisms are induced. We are currently exploring this possibility by quantitation of the molecules glutathione and metallothionein; both of which have been shown to confer protection against metal-mediated cytotoxicity.

References

ATSDR (1997) 1997 CERCLA Priority List of Hazardous Substances That Will be the Subjects of Toxicological Profiles & Support Document, Agency for Toxic Substances and Disease Registry, U. S. Department of Health and Human Services, November, 1997.

Bae, D-S, Gennings, C., Carter, Jr., W. H., Yang, R. S. H., Campain, J. A. (2001), “Toxicological Interactions among Arsenic, Cadmium, Chromium, and Lead in Human Keratinocytes,” Toxicological Sciences, under review.

Berenbaum, M. C. (1985), “The expected effect of a combination of agents: the general solution,” Journal Theoretical Biology, 114:413-431.

Berenbaum, M. C. (1989), “What is synergy?” Pharmacological Reviews, 41, 93-141.

Calabrese, E. J. (1997), “Hormesis revisited: New insights concerning the biological effects of low-dose exposures to toxins,” Environmental Law Reporter, 27, 10526-19532.

Calabrese, E. J. and Baldwin, L. A. (1997a), “The dose determines the stimulation (and poison): Development of a chemical hormesis database,” International Journal of Toxicology, 16, 545-559.

Calabrese, E. J. and Baldwin, L. A. (1997b), “A quantitatively-based methodology for the evaluation of chemical hormesis,” Human Ecological Risk Assessment, 3, 545-554.

Choi, E. J., Toscano, D. G., Ryan, J. A., Riedel, N., and Toscano, W. A. ( 1991), “Dioxin induces transforming growth factor-a in human keratinocytes,” Journal Biol. Chem., 266, 9591-9597.

Cohen, M. D., Kargacin, C. B., Klein, C. B., and Costa, M. (1993), “Mechanisms of chromium carcinogenicity and toxicity,” Critical Reviews in Toxicology, 23, 255-281.

De Rosa, C. T., Johnson, B. L., Fay, M., Hansen, H., and Mumtaz, M. M. (1996), “Public health implications of hazardous waste sites: findings, assessment and research,” Food and Chemical Toxicology, 34, 1131-1138.

Fay, R. M. and Mumtaz, M. M. (1996), “Development of a priority list of chemical mixtures occurring at 1188 hazardous waste sites, using the HazDat database,” Food and Chemical Toxicology, 34, 1163-1165.

Finney, D. J. (1964), Statistical Methods in Biological Assay ₂nd edition. Charles Griffin & Co.: London.

Gaido, K. W., Maness S. C., Leonard, L. S., and Greenlee W. F. (1992), “2,3,7,8-Tetrachlorodibenzo-p-dioxin-dependent regulation of transforming growth factors-a and b2 expression in a human keratinocyte cell line involves both transcriptional and posttranscriptional control,” Journal Biol. Chem., 267(34), 245591-24595.

Gennings, C. and Carter, Jr., W. H. (1995), “Utilizing Concentration-Response data from individual components to detect statistically significant departures from additivity in chemical mixtures,” Biometrics, 51, 1264-1277.

Gennings, C., Schwartz, P., Carter, Jr., W. H., and Simmons, J. E. (1997), “Detection of departures from additivity in mixtures of many chemicals with a threshold model,” Journal of Agricultural, Biological, and Environmental Statistics, 2, 198-211.

Germolec, D. R., Yoshida, T., Gaido, K., Wilmer, J. L., Simeonova, P. P., Kayama, F., Burleson, F., Dong, W., Lange, R. W., and Luster, M. I. (1996), “Arsenic induces overexpression of growth factors in human keratinocytes,” Toxicology Applied Pharmacology, 141, 308-318.

Germolec, D. R., Spalding, J., Boorman, G. A., Wilmer, J. L., Yoshida, T., Simeonova, P. P., Bruccoleri, A., Kayama, F., Gaido, K., Tennant, R., Burleson, F., Dong, W., Lang, R. W., and Luster, M. I. (1997), “Arsenic can mediate skin neoplasia by chronic stimulation of keratinocyte-derived growth factors,” Mutation Research, 386, 209-218.

Glick, A. B., Sporn, M. B., and Yuspa, S. H. (1991), “TGF-b1 and TGF-a in primary keratinocytes and papillomas expressing v-Ha-ras,” Molecular Carcinogenicity, 4, 210-219.

Glick, A. B., Lee, M. M., Darwiche, N., Kulkarni, A. B., Karlsson, S., and Yuspa, S. H. (1994), “Targeted deletion of the TGFb1 gene causes rapid progression to squamous cell carcinoma,” Genes Devel., 8, 2429-2440.

Hochberg, Y. (1990), “A sharper Bonferroni procedure for multiple tests of significance,” Biometrika, 75, 800-802.

Kachinskas, D. J., Qin, Q., Phillips, M. A., and Rice, R. H. (1997), “Arsenic suppression of human keratinocyte programming,” Mutation Research, 386, 253-261.

Kelly, C. and Rice, J. (1990), “Monotone smoothing with application to dose-response curves and the assessment of synergism,” Biometrics, 46,1071-1085.

Loewe, S. and Muischnek, H. (1926), “Uber kombinationswirkunger. I. Mitteilung: Hiltsmittel der gragstellung. Naunyn-Schmiedebergs,” Arch. Pharmacol, 114, 313-326.

Loewe, S. (1953), “The problem of synergism and antagonism of combined drugs,” Arzneimittle forshung, 3, 285-290.

Miller, R. J., Jr. (1981), Simultaneous Statistical Inference, ₂nd ed. McGraw-Hill: New York.

Mosmann, T. (1983), “Rapid colorimetric assay for cellular growth and survivals: application to proliferation and cytotoxicity assays,” Journal of Immunological Methods, 65, 55-63.

Pietenpol, J. A., Holt, J. T., Stein, R. W., and Moses, H. L. (1990), “Transforming growth factor b1-suppression of c-myc gene transcription: Role in inhibition of keratinocyte proliferation,” Proceedings National Academy Science USA, 87, 53-65.

Punnonen, K., Denning, M. F., Rhee, S. G., and Yuspa, S. H. (1994), “Differences in the regulation of phosphatidylinositol-specific phospholipase C in normal and neoplastic keratinocytes,” Molecular Carcinogenicity, 10, 216-225.

Seber, G. A. and Wild, C. J. (1989), Nonlinear Regression, John Wiley and Sons: New York.

Stebbing, A. R. D. (1982), “Hormesis-the stimulation of growth by low levels of inhibitors.” Sci. Total Environ., 22, 213-234.

Stebbing, A. R. D. (1997), “A theory for growth hormesis,” BELLE Newsletter, 6, 1-11.

Ye, J., Zhang, X., Young, H. A., Mao, Y., and Shi, X. (1995), “Chromium(VI)-induced nuclear factor-kb activation in intact cells via free radical reactions,” Carcinogenesis, 16, 2401-2405.

Yen, H-T., Chiang, L-C., Wen, K-H., Chang, S-F., Tsai, C-C., Yu, C-L., and Yu, H-S. (1996), “Arsenic induces interleukin-8 expression in cultured keratinocytes,” Archives Dermatological Research, 288, 716-717.

APPENDIX
NHEK Cell line

| | | | Sample | Sample |
|---|---|---|---|---|
| Chemical | Dose | Sample Mean | Variance | Size |
| Arsenic | 0 | 100.0 | 45.7 | 9 |
| | 0.3 | 108.9 | 146.6 | 9 |
| | 1.0 | 99.6 | 78.1 | 9 |
| | 3.0 | 84.1 | 279 | 9 |
| | 10.0 | 45.1 | 268 | 9 |
| | 30.0 | 8.4 | 108 | 9 |
| Chromium | 0 | 100.0 | 137 | 6 |
| | 0.3 | 105.1 | 119 | 9 |
| | 1.0 | 99.7 | 124 | 9 |
| | 3.0 | 79.8 | 304 | 9 |
| | 10.0 | 23.9 | 446 | 9 |
| | 30.0 | 6.6 | 78 | 9 |
| Cadmium | 0 | 100.0 | 27 | 6 |
| | 3 | 92.6 | 130 | 9 |
| | 10 | 51.9 | 1236 | 9 |
| | 30 | 20.2 | 829 | 9 |
| | 100 | 3.8 | 23 | 9 |
| | 300 | 4.6 | 28 | 9 |
| Lead | 0 | 100.0 | 8.4 | 6 |
| | 3 | 95.5 | 79 | 9 |
| | 10 | 91.0 | 63 | 9 |
| | 30 | 98.8 | 236 | 9 |
| | 100 | 93.7 | 1838 | 9 |
| | 300 | 28.9 | 297 | 9 |
| LD₅₀ Mixture* | Total | | | |
| (dilution) | Concentration | | | |
| 0.0014 | 0.16 | 116.6 | 315 | 9 |
| 0.004 | 0.48 | 95.7 | 1.9 | 9 |
| 0.0123 | 1.46 | 96.0 | 216 | 9 |
| 0.037 | 4.39 | 76.5 | 92 | 9 |
| 0.11 | 13.2 | 64.3 | 14 | 9 |
| 0.33 | 39.6 | 50.1 | 262 | 9 |
| 1.0 | 118.7 | 31.1 | 207 | 9 |

*The predetermined LD₅₀s were 7.7, 4.9, 6.1, 100 mM for arsenic, chromium, cadmium, and lead, respectively.

### Example 6

### Experimental Designs for Mixtures of Chemical s Along Fixed Ratio Rays

Abbreviations:

As: Arsenic

ATSDR: Agency for Toxic Substances and Disease Registry

Cd: Cadmium

CHEM: Chemical

Cr: Chromium

ED₅₀: Dose/concentration associated with 50% response

GLM: General linear model procedure in SAS

LD₅₀: Dose/concentration associated with 50% lethality

Pb: Lead

RSM: Response Surface Methodology

Introduction

Determining and characterizing the nature of interactions among components of a combination of c drugs or chemicals is a problem of current interest (where c is the number of drugs/chemicals in a mixture). Although assessments based on single drug/chemical exposure enable us to acquire fundamental knowledge about individual drugs or chemicals under carefully controlled conditions, they do not reflect real-world exposures. Thus, it is often of interest to study the effects of exposure to multiple drugs/chemicals. Of ultimate interest in such studies is the determination and characterization of interactions among the components in a mixture. For example, Gennings et al. (1) report on a study of the nature of the interaction involving the mixture of four metals. The four metals chosen for the study were arsenic (As), cadmium (Cd), chromium (Cr), and lead (Pb), which are among the top contaminants in site frequency count by the Agency for Toxic Substances and Disease Registry (ATSDR) Completed Exposure Pathway Site Count Report (2). In addition, human health risk assessment associated with exposure to disinfection by-products (DBPs) in drinking water is of concern because of the wide spread exposure of persons who receive disinfected water. Other examples of human exposure to combinations of agents can be found in the treatment of numerous diseases including cancer, AIDS, diabetes and asthma. These examples illustrate the importance of studying mixtures/combinations of drugs or chemicals. Determining departures from additivity for a combination of drugs or chemicals is a problem that has been considered by many authors (3-7).

Classical Methodology for Detecting and Characterizing Departures from Additivity

2.1 Isobolograms

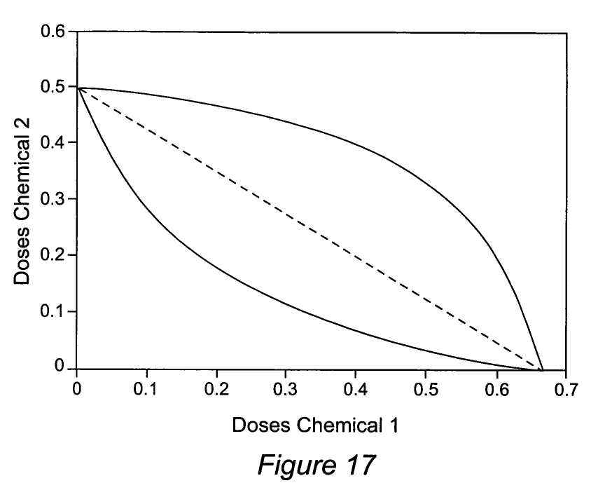

The classical method for detecting and characterizing departures from additivity between combinations of drugs or chemicals is the isobologram. The isobologram, introduced as a graphical tool by Fraser (8,9), is a plot of a contour of constant response of the dose-response surface associated with the combination superimposed on a plot of the same contour under the assumption of additivity. Their use was extended by Loewe and Muischnek (10), Loewe (11), and Berenbaum (12) and reviewed by Gessner (13), Wessinger (14), and Berenbaum (15). For a two-component mixture, the analysis of an isobologram compares the observed isobol (e.g., combination ED₅₀) to the line of additivity. The line of additivity is formed by joining the ED₅₀ associated with each of the individual components calculated from the dose response data for the individual components. FIG. 17 presents illustrations of possible isobolograms for a combination of two drugs/chemicals. As indicated, if the isobol is below the line of additivity, a synergism is claimed. On the other hand, if the isobol is above the line of additivity, an antagonism is claimed. However, there are shortcomings associated with the use of isobolograms. For instance, the method used in the construction of an isobologram typically does not take data variability into account. Additionally, since it is a graphical method, isobolograms effectively are limited to the study of combinations of two or three drugs or chemicals.

2.2 Interaction Index

The interaction index, introduced by Berenbaum (12), provides a convenient method to determine and characterize departures from additivity for a combination of c>2 or 3 components. The interaction index, II, is defined by

$$II = \frac{{X}_{1}}{{ED}_{100 μ} ( {CHEM}_{1} )} + \frac{{X}_{2}}{{ED}_{100 μ} ( {CHEM}_{2} )} + … + \frac{{X}_{c}}{{ED}_{100 μ} ( {CHEM}_{c} )} \qquad ( 1 )$$

where c is the number of components, X₁, X₂, . . . ,X_{c} are the doses in combination associated with a desired effect, and ED_{100μ}(CHEMᵢ), i=1, . . . ,c is the dose of the ith component that, when administered alone, produces the same effect. When the interaction index, defined in equation (1), is equal to 1 the c components interact additively; when II is greater than 1 the components interact antagonistically; and when II is less than 1 the components interact synergistically. Again, it should be noted that the individual component dose-response information is required to calculate the interaction index. As described by Berenbaum (12), the interaction index is directly related to the isobologram, i.e., when II<1, the isobol is coincident with the line of additivity; when II>1, the isobol bows above the line of additivity; and when II<1, the isobol bows below the line of additivity. An advantage of using the interaction index over the isobologram is that the interaction index is not limited to combinations/mixtures of just two or three components. However, as developed by Berenbaum (12), the biological variability associated with the data is not taken into account by the interaction index.

2.3 Statistical Models

Statisticians frequently use models of the form

$$Y = {β}_{0} + {\sum }_{i = 1}^{c} {β}_{i} {x}_{i} + {{\sum }_{i = 1}^{c} {\sum }_{j = 1}^{c}}_{i < j} {β}_{ij} {x}_{i} {x}_{j} + {{\sum }_{i = 1}^{c} {\sum }_{j = 1}^{c}}_{i < j} {\sum }_{k = 1}^{c} {β}_{ijk} {x}_{i} {x}_{j} {x}_{k} + … + {β}_{12 … c} {x}_{1} {x}_{2} … {x}_{c}$$

to approximate the relationship between a response of interest, Y, and concentrations of c chemicals (x₁,x₂, . . . ,x_{c}).

Carter et al. (4) showed that a relationship exists between the interaction index proposed by Berenbaum (12) and the parameter in a statistical model that is associated with the interaction of the components of the combination. Without loss of generality, consider that the combination/mixture of interest involves two chemicals and that the response is continuous. Therefore, following the logic of Carter et al. (4), for the linear models case, the relationship between the response and the doses or concentrations of the components in combination can be expressed as

μ=β₀+β₁x₁+β₂x₂+β₁₂x₁₂, (2)

where

μ=is the mean response, E(Y),

β₀ is the unknown intercept,

β₁ is the unknown slope parameter associated with the first component,

β₂ is the unknown slope parameter associated with the second component,

β₁₂ is the unknown parameter associated with the interaction of the two components,

and x₁ and x₂ are the doses of the respective chemicals.

From the model defined in equation (2), the ED_{100μ}(CHEMᵢ) for the respective components can be derived to be

$${ED}_{100 μ} ( {CHEM}_{1} ) = \frac{μ - {β}_{0}}{{β}_{1}}$$

Thus, after algebraic manipulation, the model defined in equation (2) becomes

$$\begin{matrix}\frac{{β}_{1} {x}_{1}}{μ - {β}_{0}} + \frac{{β}_{2} {x}_{2}}{μ - {β}_{0}} + \frac{{β}_{12} {x}_{12}}{μ - {β}_{0}} = 1 \\ or \\ 1 - \frac{{β}_{12} {x}_{12}}{μ - {β}_{0}} = \frac{{x}_{1}}{\frac{( μ - {β}_{0} )}{{β}_{1}}} + \frac{{x}_{2}}{\frac{( μ - {β}_{0} )}{{β}_{2}}} .\end{matrix}$$

Therefore, it follows that when β₁₂=0, the combination of components 1 and 2 is additive, i.e., the isobologram is coincident with the line of additivity and the interaction index equals 1. Similarly, when β₁₂>0, the combination of components 1 and 2 is synergistic, i.e., the isobologram bows below the line of additivity and the interaction index is less than 1; and when β₁₂<0, an antagonism is present, i.e., the isobologram bows above the line of additivity and the interaction index is greater than 1. This demonstrates the algebraic equivalence between the statistical model and the interaction index. Gennings et al (16) demonstrated the experimental convergence of the statistical modeling approach and the interaction index. The number of components that can be considered in the statistical model can be generalized to c, and data variability is appropriately accounted for in the resulting inference.

The various methods used to determine and classify departures from additivity described above utilize both single-compound data as well as combination data. Consider the situation in which the single-compound dose-response data are not available. The approach discussed in the following sections of this paper allows one to test the null hypothesis of additivity using only combination/mixture data collected along a fixed ratio ray. Thus, single-compound dose-response data are not needed.

New Methodology

Problems with statistical modeling are associated with the size of the experiment required to generate data to support the model. Factorial experiments, e.g. 2^{c} or 3^{c} are often considered. When c is large such experiments may not be feasible, so, in a sense, this approach is limited to combinations of relatively few drugs or chemicals. An alternative to the traditional factorial design for studying interactions, and the design to be considered here, is the ray design. Ray designs, described by Martin (17), Mantel (18), Finney (19), Bruden and Vidmar (20), and others, are used to study mixtures of c drugs or chemicals at a fixed mixing ratio, [a₁:a₂: . . . :a_{c}], where

$${\sum }_{i = 1}^{c} {a}_{i} = 1 ,$$

with the total “dose”, t, varying. The fraction of the total “dose” represented by the ith drug or chemical is aᵢ and the amount of the ith drug or chemical in the mixture is aᵢt. This approach is appealing since the dimensionality of the study is reduced along each ray, i.e., each ray can be considered as an individual drug or chemical with only the total “dose” varying. For example, in a study involving c drugs or chemicals the fitted model based on a response surface approach is a (c+1)-dimensional surface. In contrast, the fitted model based on a ray design defines a set of 2-dimensional dose response curves.

What can be stated about departures from additivity in the mixture? Meadows (21) showed that when mixture data are collected along a fixed ratio ray, the additivity model reduces to a simple linear regression model. In addition, the interaction model reduces to a higher order polynomial model. Thus, the test for additivity is equivalent to the test of the adequacy of the simple linear regression model. Consider that the combination/mixture of interest involves c drugs or chemicals and that the response of interest is continuous. The underlying additivity model, i.e., the model with no cross-product terms is defined by

Y=β₀+β₁x₁+ . . . +β_{c}_{^{x}}_{c}, (3)

where

Y is the observed response,

xᵢ is the dose of the ith drug or chemical,

β₀ is an unknown parameter associated with the intercept, and

βᵢ is an unknown parameter associated with the slope of the ith drug or chemical.

When the mixing ratios are invoked, the dose of the ith drug or chemical is xᵢ=aᵢt, where aᵢ is the mixture fraction for the ith drug or chemical and t is the total dose. As a result, the additivity model becomes

$$\begin{matrix}Y = {β}_{0} + {β}_{1} {a}_{1} t + {β}_{2} {a}_{2} t + … + {β}_{c} {a}_{c} t \\ = {β}_{0} + ( {β}_{1} {a}_{i} + {β}_{2} {a}_{2} + … + {β}_{c} {a}_{c} ) t \\ = {β}_{0} + {β}_{1}^{*} t ,\end{matrix} \qquad ( 4 )$$

where

$${β}_{1}^{*} = {\sum }_{i = 1}^{c} {β}_{i} {a}_{i} .$$

For convenience, we assume the experimental region along the fixed ratio ray in terms of total dose is transformed to the region −1≦t≦1. Thus, under additivity, the dose response relationship along the ray can be described with a simple linear regression on total dose.

It also follows that when the slope of the regression line for total dose is

β₁a₁+β₂a₂+ . . . +β_{c}a_{c},

the interaction index, defined in equation (1) equals 1. This would suggest that the single-component dose response data would be required. In the absence of single chemical data, the slope bᵢ for each drug/chemical alone is unknown so that the hypothesis H₀:

$${β}_{1}^{*} = {\sum }_{i = 1}^{c} {β}_{i} {a}_{i}$$

can not be directly tested. However, consider the following model

$$\begin{matrix}Y = {β}_{0} + {\sum }_{i = 1}^{c} {β}_{i} {x}_{i} + {{\sum }_{i = 1}^{c} {\sum }_{j = 1}^{c}}_{i < j} {β}_{ij} {x}_{i} {x}_{j} + \\ {{\sum }_{i = 1}^{c} {\sum }_{j = 1}^{c} {\sum }_{k = 1}^{c}}_{i < j < k} {β}_{ijk} {x}_{i} {x}_{j} {x}_{k} + … + {β}_{12 … c} {x}_{1} {x}_{2} … {x}_{c}\end{matrix}$$

Notice that this model is the model that would be supported by a factorial experiment and the βᵢⱼ,βᵢⱼₖ, . . . β₁₂. . . c terms are coefficients associated with the various two, three-factor and higher order interactions. The ray design will not support this model; however, invoking the mixing ratio associated with the ray design results in

$$\begin{matrix}Y = {β}_{0} + ( {\sum }_{i = 1}^{c} {a}_{i} {β}_{i} ) t + ( {{\sum }_{i = 1}^{c} {\sum }_{j = 1}^{c}}_{i < j} {a}_{i} {a}_{j} {β}_{ij} ) {t}^{2} + \\ ( {{\sum }_{i = 1}^{c} {\sum }_{j = 1}^{c} {\sum }_{k = 1}^{c}}_{i < j < k} {a}_{i} {a}_{j} {a}_{k} {β}_{ijk} ) {t}^{3} + … + ( {a}_{1} {a}_{2} … {a}_{c} {β}_{12 … c} ) {t}^{c} \\ = {β}_{0} + {β}_{1}^{*} t + {β}_{2}^{*} {t}^{2} + {β}_{3}^{*} {t}^{3} + … + {β}_{c}^{*} {t}^{c}\end{matrix} \qquad ( 5 )$$

It follows that interactions among pairs of chemical components are associated with second-degree terms, interactions among three chemicals are associated with third degree terms, etc.

Of ultimate interest is the determination of departure from additivity among a particular combination/mixture of drugs or chemicals. When comparing the model under additivity to the interaction model, defined in equations (4) and (5), respectively, evidence of curvature indicates departure from additivity; i.e., there is interaction among the compounds if at least one β*ᵢ≠0, i=1, . . . ,c. Thus, any polynomial lack of fit associated with the additive model

Y=β₀+β*₁t

would be associated with a lack of additivity. Meadows (21) showed that the test statistic for the null hypothesis of additivity,

$${H}_{0} \text{:} \qquad [ \begin{matrix}{β}_{2}^{*} \\ {β}_{3}^{*} \\ ⋮ \\ {β}_{c}^{*}\end{matrix} ] = 0 ,$$

is given by

$$F = \frac{R ( {θ}_{2} \vert {θ}_{1} ) / ( c - 1 )}{{s}^{2}} . \qquad ( 6 )$$

4. Experimental Design

Experimental design implications for studying a c component mixture include the following:

(1) Place a minimum of c+1 points on the ray of interest so as to maximize the power of the test for lack of fit of the additivity model, i.e., Y=β₀+β*₁t.

(2) Replicate the experiment at these points to make the lack of fit test possible.

When the response variable is continuous and the method of least squares has been used to estimate the model parameters, Meadows (21) showed that we can incorporate the statistical results of Jones and Mitchell (22) to determine values of total dose that maximize the design's ability to detect lack of fit or departure from additivity.

The overall lack of fit answers the question as to whether or not there is a departure from additivity. Rejection of his hypothesis that simultaneously tests that the interaction parameters are equal to zero, i.e., H₀: β₂=β₃= . . . =β_{c}=0, implies that interaction is present among the chemicals globally. Thus, if the overall test for additivity is rejected, tests of the form

H₀: β*ⱼ=0

H₁: β*ⱼ=0

using Hochberg's (23) correction for multiple testing, can be used to answer the question of whether or not a j-factor interaction exists. If such an interaction is detected recall that

$${β}_{2}^{*} = {{\sum }_{i = 1}^{c} {\sum }_{j = 1}^{c}}_{i < j} {a}_{i} {a}_{j} {β}_{ij} , \qquad {β}_{3}^{*} = {\sum }_{i = 1}^{c} {\sum }_{j = 1}^{c} {\sum }_{k = 1}^{c} {a}_{i} {a}_{j} {a}_{k} {β}_{ijk} , \qquad etc .$$

Here interest will be focused on which of the j-factor interactions are present. This can be determined by performing

$$( \begin{matrix}c \\ j\end{matrix} )$$

additional ray experiments at the same ratio as were present on the original ray.

5. Illustration

The methodology introduced in this paper is illustrated with cytotoxicity data obtained from assessing interactions among arsenic (As), cadmium (Cd), chromium (Cr), and lead (Pb) in human keratinocytes. The experimental data were obtained from Ray Yang and colleagues at Colorado State University. The endpoint of interest is the percent viability of treated NHEK cells using the MTT assay. The mixture point of interest for As, Cr, Cd, and Pb contained the estimated LD₅₀s of 7.7 μM, 4.9 μM, 6.1 μM, and 100 μM, respectively. This 1× solution was serially diluted at a 1:3 ratio to get 0.333, 0.111, 0.037, 0.0123, 0.004, and 0.0014 dilution groups. Double deionized water was used as the vehicle control in all cases.

After exposure to individual metals or metal exposure, cells were refed with fresh metal-free KGM medium and incubated for 3 days prior to viability analysis by the MTT assay. Details of the experimental protocol and methods are described elsewhere (24, 1) and are not included here. The summary statistics for the LD₅₀ mixture data presented in Table 1 are linearized cytotoxicity response data from Gennings et al. (1).

TABLE 1
Summary Staistics for the LD₅₀ Mixture Data Based on the
Linearized Cytotoxicity Response Data From Gennings et al. (2002) -
NHEK Cells

| Mixture | Total Dose^{a} | | Sample | |
|---|---|---|---|---|
| Dilution | (μM) | Sample Mean | Variance | Sample size |
| 0 | 0 | 1.81 | 0.23 | 9 |
| 0.0014 | 0.2 | 2.24 | 0.20 | 6^{b} |
| 0.004 | 0.5 | 1.65 | 0.55 | 9 |
| 0.0123 | 1.5 | 1.58 | 1.07 | 8^{b} |
| 0.037 | 4.4 | 0.77 | 0.11 | 9 |
| 0.111 | 13.2 | 0.40 | 0.01 | 9 |
| 0.333 | 39.6 | 0.02 | 0.18 | 9 |
| 1 | 118.7 | −0.55 | 0.27 | 9 |

^{a}LD₅₀ mixing ratio (7.7 μM, 4.9 μM, 6.1 μM, and 100 μM) for As, Cr, Cd and Pb, respectively.
^{b}Overall, four data values are missing due to the transformation on the response.

The nonlinear additivity model selected for fitting the single compound data by Gennings et al. (1) was based on a Gompertz function where the mean viability was modeled as

$$μ = α + γ exp ( - exp ( - ( {β}_{0} + {\sum }_{i = 1}^{4} {β}_{i} {x}_{i} ) ) ) .$$

From this model, a is the parameter associated with the minimum mean response and g is the range of mean response values. Therefore, for this example, it is reasonable to assume that a transformation on the response, conditioning on the values of α=8.76 and γ=109 obtained by Gennings et al. (1), will induce linearity in the additivity model. As a result, the additivity model becomes

$$- log ( - log ( \frac{μ - α}{γ} ) ) = {β}_{0} + {β}_{1} {x}_{1} + {β}_{2} {x}_{2} + {β}_{3} {x}_{3} + {β}_{4} {x}_{4} .$$

As shown in Section 3, since the mixture data were collected along a fixed ratio ray, the additivity model can be re-written as

$${μ}_{m , add} = - log ( - log ( \frac{y - α}{γ} ) ) = {β}_{0} + {β}_{1}^{*} t . \qquad ( 7 )$$

Additionally, the interaction model along the same fixed ratio ray becomes

$$\begin{matrix}{μ}_{m , interaction} = - log ( - log ( \frac{y - α}{γ} ) ) \\ = {β}_{0} + {β}_{1}^{*} t + {β}_{2}^{*} {t}^{2} + {β}_{3}^{*} {t}^{3} + {β}_{4}^{*} {t}^{4} .\end{matrix} \qquad ( 8 )$$

Therefore, conditioning on the values of α=8.76 and γ=109, the transformation

$$- log ( - log ( \frac{y - 8.76}{109} ) )$$

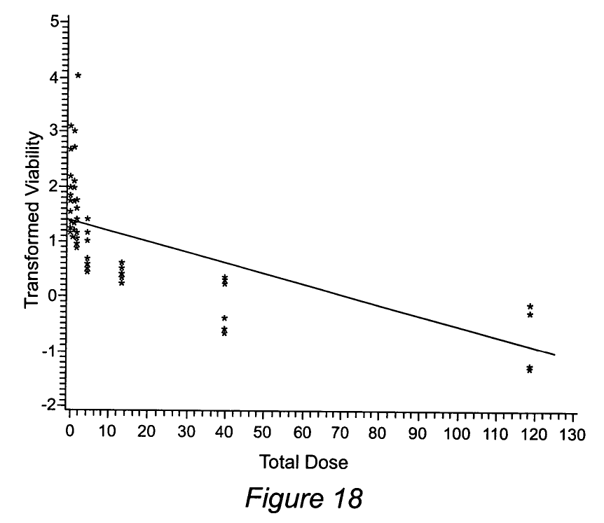

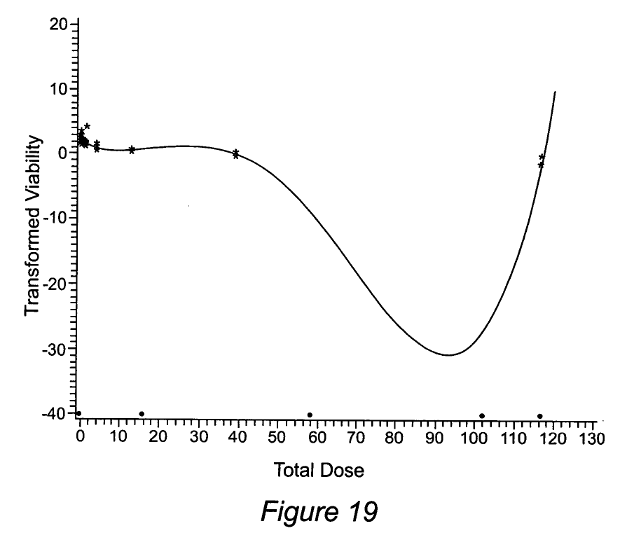

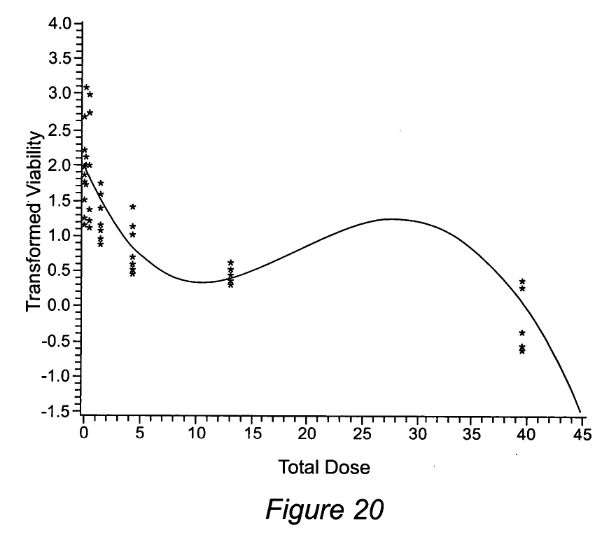

on the observed responses for the mixture data was performed. The additivity model given in equation (7) and the interaction model given in equation (8) was fit to the mixture data using the method of least squares. The GLM procedure of SAS® was used to estimate the unknown parameters in equations (7) and (8). Parameter estimates and their p values are provided in Table 2. FIG. 18 presents the fitted concentration effect curve under additivity for total concentrations of the four metals along the ray associated with the LD₅₀ mixing ratio. The asterisks (*) indicate the observed transformed responses at the seven dilution points. From this figure, there is some question as to whether the data fall along the line of additivity. In comparison, FIG. 19 presents the observed mixture data and the fitted interaction (higher order polynomial) model. The dots (•) indicate the design locations of the total dose values selected by the Λ₁-optimal design, which are presented by total doses of 0, 16, 59.4, 102.7, and 118.7 μM. Notice that the values selected as the Λ₁-optimal design are symmetrically spread out throughout the total dose region, whereas the majority of the points used in the current study are directed toward the lower total dose region. An enlarged version of the lower total dose region of the plot of the fitted interaction model is presented in FIG. 20.

TABLE 2
Estimated Model Parameters for the Additivity Model Given in
Equation (7) and the Interaction Model Given in Equation (8)

| Parameter | Estimate | S.E. | P value |
|---|---|---|---|
| Additivity Model: | | | |
| β₀ | 1.36 | .12 | <.001 |
| β*₁ (t) | −0.02 | 2.34 × 10⁻³ | <.001 |

SS_{RES} = 38.04, df_{RES} = 66

| Interaction Model: | | | |
|---|---|---|---|
| β₀ | 1.96 | .12 | <.001 |
| β₁ (t) | −0.36 | .09 | <.001 |
| β₂ (t²) | 0.03 | .01 | .010 |
| β₃ (t³) | −0.0006 | 2.44 × 10⁻⁴ | .024 |
| β₄ (t⁴) | 0.00000319 | 1.43 × 10⁻⁶ | .030 |

SS_{RES} = 20.49, df_{RES} = 63

The test statistic for the null hypothesis of additivity,

$${H}_{0} \text{:} \qquad [ \begin{matrix}{β}_{2} \\ {β}_{3} \\ {β}_{4}\end{matrix} ] = 0 ,$$

is given by

$$\begin{matrix}F = \frac{R ( {θ}_{2} \vert {θ}_{1} ) / ( c - 1 )}{{s}^{2}} = \frac{( {SS}_{Res , reduced} - {SS}_{Res , full} ) / 3}{{s}^{2}} \\ = \frac{( 38.04 - 20.49 ) / 3}{0.3252} \\ = 17.99\end{matrix}$$

Table 3 presents the overall test for departure from additivity given in equation (6).

TABLE 3
Test results for testing the hypothesis of additivity, as well as the
hypotheses that the j-factor interactions do not exist, j = 2, . . ., 4.

| Hypothesis | F | P value |
|---|---|---|
| Overall test for Additivity: | | |
| H₀: β₂ = β₃ = β₄ = 0 | 17.99 (3, 63) | <0.001 |
| Individual tests: | | |
| H_{0A}: β₂ = 0 | 23.95 (1, 65) | <0.001** |
| H_{0B}: β₃ = 0 | 16.54 (1, 64) | <0.001** |
| H_{0C}: β₄ = 0 | 4.92 (1, 63) | 0.0302* |

*Using Hochberg's correction for multiple comparisons, these tests are associated with a significant j-factor interaction using an overall 5% test. Those marked with ** are significant with an overall significance level of 1%.

Based on this test, we reject the null hypothesis of additivity (p-value<0.001) and conclude that at least one of the j-factor interactions exists, j=2, . . . 4. Since the overall test for additivity is rejected, it is of interest to determine whether two, three, or four-factor interactions are present. Therefore, we want to test the following hypotheses using Hochberg's (23) correction for multiple testing:

H_{0A}: β*₂=0 vs. H_{1A}: β*₂≠0

H_{0B}: β*₃=0 vs. H_{1B}: β*₃≠0

H_{0C}: β*₄=0 vs. H_{1C}: β*₄≠0

Table 3 also presents the single parameter tests associated with each of the j-factor interactions, j=2, . . . 4. Using Hochberg's (23) correction for multiple comparisons, all three parameters are significantly different from zero, when the overall significance level is set at 5%. However, if we consider the case where an overall significance level of 1% is used, only the two smallest p-values are significant using Hochberg's correction. Therefore, we conclude that a 3-factor -interaction exists implying that the 2-factor interactions are not constant. Now it is of interest to determine which three metals are interacting with one another. This can be accomplished by performing

$$( \begin{matrix}4 \\ 3\end{matrix} ) = 4$$

additional experiments at the same ratios of metals that were used in the original ray. Table 4 gives the ratios of compounds, along with the corresponding total dose, to be used for the four additional experiments. This approach limits the inferences of the original experiment, as well as the four additional experiments, to be made about the particular mixing ratio used in the experiment.

TABLE 4
Ratios of compounds to be used for the four additional
experiments, which are based on the LD₅₀ mixing
ratio (7.7 μM, 4.9 μM, 6.1 μM, and 100 μM).

| | As | Cr | Cd | Pb | Total dose |
|---|---|---|---|---|---|
| 4-factor combination: | | | | | |
| Original Experiment | 6.5% | 4.1% | 5.1% | 84.3% | 118.7 μM |
| 3-factor combination: | | | | | |
| Experiment #1 | 41.2% | 26.2% | 32.6% | — | 18.7 μM |
| Experiment #2 | 6.8% | 4.4% | — | 88.8% | 112.6 μM |
| Experiment #3 | 6.8% | — | 5.3% | 87.9% | 113.8 μM |
| Experiment #4 | — | 4.4% | 5.5% | 90.1% | 111.0 μM |

Conclusion

It was shown that the classical methodology used in evaluating an interaction requires single drug/chemical data. In Section 3 it was shown that the evaluation of interactions could be accomplished with a ray design that did not generate single drug/chemical data. When a ray design is used, departure from additivity is associated with higher order polynomial terms in a linear model. Additivity, or absence of interaction, is described by a simple linear model in terms of total dose. As a result, we have shown that we can obtain information about departures from additivity from data collected along a fixed ratio ray. This result is important in that it permits a reduction in the total experimental effort for studying a combination when compared to that associated with a traditional factorial design. Additionally, by incorporating the approach taken by Jones and Mitchell (22), we have presented methodology for determining optimal levels along the fixed ratio ray (total dose) to be considered in the experiment for detecting model inadequacy.

References

1. Gennings C, Carter W H Jr., Campain J, Bae D-S, Yang R S H. Statistical Analysis of Interactive Cytotoxicity in Human Epidermal Keratinocytes Following Exposure to a Mixture of Four Metals. Journal of Agricultural, Biological, and Environmental Statistics 7(1):58-73 (2002).

2. ATSDR. 1997 CERCLA Priority List of Hazardous Substances That Will be the Subjects of Toxicological Profiles & Support Document. Agency for Toxic Substances and Disease Registry, U.S. Department of Health and Human Services, November, 1997.

3. Gessner P K and Cabana B E. A Study of the Interaction of the Hypnotic Effects and of the Toxic Effects of Chloral Hydrate and Ethanol. Journal of Pharmacology and Experimental Therapeutics 174: 247-259 (1970).

4. Carter W H Jr, Gennings C, Staniswalis J, Campbell E, and White K. A Statistical Approach to the Construction and Analysis of Isobolograms. Journal of the American College of Toxicology 7: 963-973 (1988).

5. Kelly C and Rice J. Monotone Smoothing With Application to Dose-Response Curves and the Assessment of Synergism. Biometrics 46: 1071-1085 (1990).

6. Gennings C, Carter W H Jr. Utilizing Concentration-Response Data From Individual Components to Detect Statistically Significant Departures From Additivity in Chemical Mixtures. Biometrics 51:1264-1277 (1995).

7. Dawson K S, Carter W H Jr., and Gennings C. A Statistical Test for Detecting and Characterizing Departures from Additivity in Drug/Chemical Combinations. Journal of the Agricultural, Biological, and Environmental Statistics 5: 342-359 (2000).

8. Fraser T R. An Experimental Research on the Antagonism Between the Actions of Physostigma and Atropia. Proc. R. Soc. Edinburg 7: 506-511 (1870-1871).

9. Fraser T R. The Antagonism Between the Actions of Active Substances. British Medical Journal ii: 485-487 (1872).

10. Loewe S and Muischnek H. Über Kombinations-Wirkungen. 1. Mitteilung: Hilfsmittle der Fragestel-lung. Archives of Experimental Pathology and Pharmacology 114: 313-326 (1926).

11. Loewe S. The Problem of Synergism and Antagonism of Combined Drugs. Arzneimittle forshung 3: 285-290 (1953).

12. Berenbaum M C. Criteria for Analyzing Interactions Between Biologically Active Agents. Journal of the American Statistical Association 78: 90-98 (1981).

13. Gessner P K. The Isobolographic Method Applied to Drug Interactions. In: Drug Interactions (Morselli P L, Garattini S and Cohen S, ed). New York: Raven Press, 1974; 349-362.

14. Wessinger W D. Approaches to the Study of Drug Interaction in Behavioral Pharmacology. Neurosci. Behav. Rev. 10: 103-113 (1976).

15. Berenbaum M C. What is Synergy? Pharmacol. Rev. 41: 93-141 (1989).

16. Gennings, C., Carter, W. H., Jr., Campbell, E. D., Staniswalis, J. G., Martin, T. J., Martin, B. R., White, K. L. Jr.: Isobolographic Characterization of Drug Interactions Incorporating Biological Variability. Journal Pharmacology and Experimental Therapeutics, 252:208-217 (1990).

17. Martin J T. The Problem of the Evaluation of Rotenone-Containing Plants. VI. The Toxicity of 1-elliptone and of Poisons Applied Jointly, with Further Observations on the Retonone Equivalent Method of Assessing the Toxicity of Derris Root. Annals of Applied Biology 29: 69-81 (1942).

18. Mantel N. An Experimental Design in Combination Chemotherapy. Annals of the New York Academy of Sciences 76: 909 (1958).

19. Finney D J. Probit Analysis. London: Cambridge University Press, 1964,1971.

20. Bruden M and Vidmar T. Optimal 3×3 Factorial and 3-ray Designs for Drug Interaction Experiments with Dichotomous Responses. Communications in Statistics 18(8): 2835-2859 (1989).

21. Meadows S L. Design Optimality And Sample Size Planning For Mixtures Studies [PhD Thesis]. Richmond, Va.: Virginia Commonwealth University, 2001.

22. Jones E R and Mitchell T J. Design Criteria for Detecting Model Inadequacy. Biometrika 65: 541-551 (1978).

23. Hochberg Y. A Sharper Bonferroni Procedure for Multiple Tests of Significance. Biometrika 75: 800-802 (1988).

24. Yang R S H, ed. Toxicology of Chemical Mixtures: Case Studies, Mechanisms, and Novel Approaches. San Diego:Academic Press, 1999.

### Example 7

### Analysis of Mixtures of Drugs/Chemicals Along a Fixed Ratio Ray Without Single Chemical Data to Support an Additivity Model

1. Introduction

The determination and characterization of departures from additivity among drugs or chemicals in mixtures/combinations is often of importance. The definition of additivity assumed throughout is given by Berenbaum (e.g., 1985) and is equivalent to that based on the classical isobologram for the combination of two chemicals (e.g., Loewe and Muischnek, 1926; Loewe, 1953). That is, in a combination of c chemicals, let Eᵢ represent the concentration/dose of the i^{th} component alone that yields a fixed response, m₀, and let xᵢ represent the concentration/dose of the i^{th} component in combination with the c agents that yields the same response. According to this definition of additivity, if the substances combine with zero interaction, then

$${\sum }_{i = 1}^{c} \frac{{x}_{i}}{{E}_{i}} = 1 ,$$

which is the interaction index considered by Dawson et al. (2000). A response surface that satisfies this definition of additivity is termed an ‘additivity surface’. The additivity surface can be used to test the null hypothesis that the chemicals combine in an additive fashion. The experimental data necessary and sufficient to support the estimation of the additivity surface are single chemical dose-response data (e.g., Gennings, et al., 1997; 2000).

Also of importance is the consideration of the experimental design used when studying mixtures/combinations of drugs or chemicals. Factorial experiments involving c drugs/chemicals, such as 2^{c} or 3^{c}, are often considered. However, when c is large, such experiments may not be feasible. Thus, use of such factorial designs is limited to combinations of relatively few drugs or chemicals. Alternatively, ray designs, described by Martin (1942), Mantel (1958), Finney (1964), Bruden and Vidmar (1989), and others, are used to study mixtures of c drugs or chemicals at several levels of a fixed mixing ratio

$$[ {a}_{1} : {a}_{2} : … : {a}_{c} ] , such that {\sum }_{i = 1}^{c} {a}_{i} = 1.$$

The proportion of the total “dose” represented by the ith chemical (i=1,2, . . . ,c) is denoted by aᵢ and the amount of the ith drug or chemical in the mixture is aᵢt, where t is the total dose. The mixture can then be experimentally observed at several dilutions, creating a fixed-ratio ray. Ray designs can be used to support the estimation of a response surface (e.g., Bruden and Vidmar, 1989).

Alternatively, inference may be focused to a particular relevant fixed-ratio ray. A mixing ratio may be considered relevant, for example, if the mixture under study is observed environmentally. This approach is appealing since the dimensionality of the study is reduced along the ray of interest. The drug/chemical combination along the ray can be considered as an individual drug/chemical with only the total “dose” varying. For example, in a study involving c drugs or chemicals the dose-response relationship is described by a (c+1)-dimensional surface. In contrast, the dose-response relationship on a given fixed ratio ray can be described by a 2-dimensional dose-response curve in the total dose, t. The methodology developed in this paper assumes that the mixture data are collected along a fixed ratio ray.

In the data considered here, there are three mixture points along a fixed ratio ray. Following the approach described in Gennings et al. (2002), a generalized linear model is fitted to the mixture data and then the estimated dose-response curve (over the total dose range) is statistically compared to a dose-response curve fit using the additivity model. If the two curves are significantly different, then departure from additivity can be claimed along the fixed-ratio ray. Otherwise, evidence of departure from additivity cannot be claimed, providing evidence that additivity is a reasonable assumption for risk assessment. This general approach is described in detail by many authors, including Berenbaum (1985), Kelly and Rice (1990), Gennings and Carter (1995), Gennings et al. (1997; 2000).

However, for the study considered herein, comparing the positive control values from the mixture studies to that predicted at the same dose levels from the original single chemical studies indicated that the dose-response curves shifted. Thus, the single chemical data and hence the additivity surface cannot be used to compare to the mixture data. Differences between the two curves may be due to changes in the experimental environment and not due to a true interaction among the test chemicals. The purpose of this paper is to develop an approach that can be used to test for interaction among c chemicals when single chemical data are either unreliable or are not available.

The mixture selected for the study used to illustrate the methodology proposed here is that of four trihalomethanes formed as disinfection by-products (DBPs) when water is chlorinated. The four components are bromodichloromethane (BDCM), chlorodibromomethane (CDBM), chloroform (CHCl₃), and bromoform (CHBr₃). The endpoint of interest is liver damage, as measured by serum sorbitol dehydrogenase (SDH) levels in female CD-1 mice after 14 days of exposure by oral gavage. Seven separate experiments were conducted: four single chemical studies and three mixture studies. A more complete description of the experimental methods is provided in Gennings, et al. (1997; 2000). The mixture studies were all conducted with a fixed ratio of the four chemicals (a ratio of (0.34: 0.29:0.32:0.05) for (BDCM:CDBM:CHCl₃:CHBr₃)) with three different total dose values (0.05, 1.5, 3.0 mM/kg) and appropriate positive controls (a fixed dose of each chemical alone for quality control purposes). The fixed mixing ratio of interest is associated with the chlorination process of disinfection (McDonald et al., 1999). The purpose of this study was to determine if the four DBPs combine additively, i.e., with no interaction.

In Section 2, we provide further details about the DBP study and results. Section 3 develops the model along a fixed ratio ray in the generalized linear model framework using quasi-likelihood estimation. In addition, tests for the null hypothesis of additivity are developed and described. Experimental designs involving mixtures of drugs/chemicals along fixed ratio rays using D-optimality and Dₛ-optimality criteria are presented in Section 4. Two-stage designs are also described in Section 4. We apply the methodology developed throughout Sections 3 and 4 to the DBP data and present the results in Section 5. Finally, in Section 6 we conclude with a brief discussion.

2. Example Description

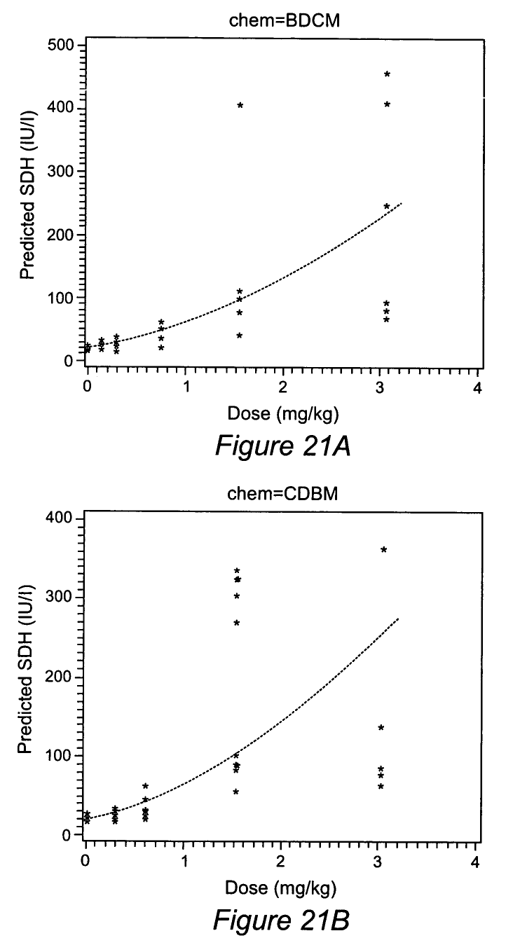

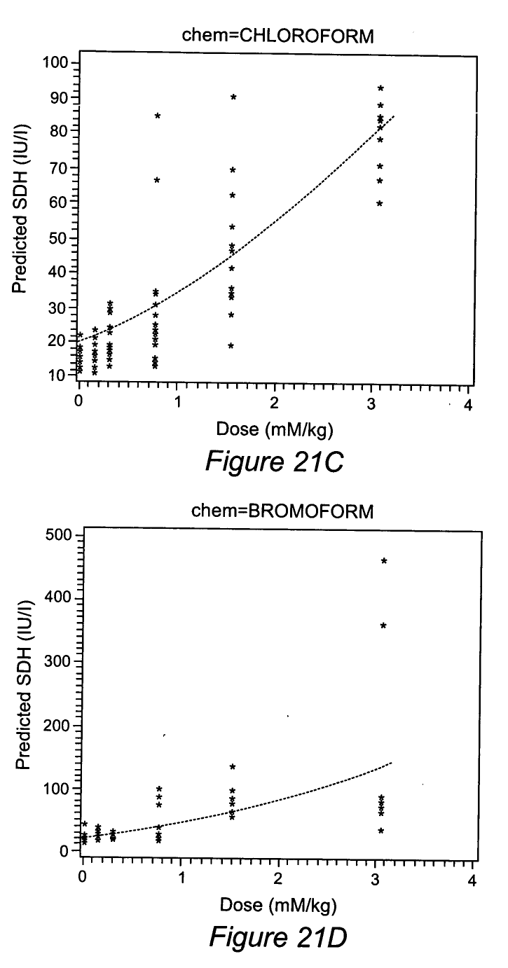

The data used to illustrate the methodology developed in the following sections involves the combination of four chemicals, which are disinfection by-products in drinking water. Summary statistics for the single chemical data are provided in Gennings et al. (1997, 2000). A generalized linear model with a power link function,

$$g ( {μ}_{m , add} ) = {μ}_{add}^{λ} = {β}_{0} + {\sum }_{i = 1}^{c} {γ}_{i} {x}_{i} , \qquad ( 1 )$$

where c=4 is the number of chemicals, xᵢ is the dose of the i^{th} chemical, β₀ is the unknown intercept, γᵢ is the unknown slope parameter for the i^{th} chemical, was fit to the single chemical data to produce an additivity model for the SDH response. Following Gennings et al. (1997; 2000) the variance of SDH was assumed to be related to the mean (i.e., tm for t a dispersion parameter), and the transformation parameter in the power link was set to 0.5 for the analysis of these data. The resulting parameter estimates (using a quasi-likelihood estimation criterion) and associated p-values are provided in Table 1. All four chemicals are associated with an increase in SDH as the dose of the chemical increases (FIG. 21). In addition, the additivity model seems to adequately represent the single chemical data as evidenced in FIG. 21.

TABLE 1
Predicted model parameters for the additivity model given in (1)
using the single chemical data only. The transformation parameter,
λ, was set to 0.5 as used in Gennings et al. (1997).

| Parameter | Estimate | Standard Error | P-value |
|---|---|---|---|
| β₀ | 4.402 | 0.213 | <0.001 |
| γ₁ (BDCM) | 3.567 | 0.282 | <0.001 |
| γ₂ (CDBM) | 3.833 | 0.316 | <0.001 |
| γ₃ (CHCl₃) | 1.538 | 0.239 | <0.001 |
| γ₄ (CHBr₃) | 2.441 | 0.231 | <0.001 |
| τ (dispersion parameter) | 5.293 | | |

After the single chemical studies were completed, three mixture studies were conducted. These consisted of mixture points, vehicle controls, and positive controls (each chemical alone at 1.52 mM/kg for BDCM, CHCl₃, and CHBr₃; 0.76 mM/kg for CDBM). In order to verify that the dose-response relationship was consistent across the different studies, the additivity model given in (1) was used to predict the response for each of the positive control groups. Table 2 provides comparisons of the observed sample means at each of the positive control groups and the predicted response using the additivity model in (1). The p-value is associated with the Wald-type test for equivalence of the two means. Using Hochberg's correction for multiple comparisons, six of the twelve comparisons resulted in the conclusion that there was a significant shift in the dose-response relationship between the original single chemical dose-response studies and the mixture studies. Therefore, it was concluded that the single chemical data should not be used to describe the additive or ‘zero interaction’ case along the mixture ray of interest.

TABLE 2
Analysis of Positive Control values: Observed sample means from
the positive controls in the mixture study and predicted mean responses
from the single chemical data in the additivity model as defined
in Table 1.

| | Dose | | Predicted from | |
|---|---|---|---|---|
| | (mM/ | Mean SDH | Single Chemical | |
| Chemical | kg) | (STD) | Data (SE) | P-value |
| mixture | | | | |
| study = 0.05 | | | | |
| total dose | | | | |
| BDCM (n = 9) | 1.52 | 107.3 (97.5) | 96.5 (7.80) | 0.747 |
| CDBM (n = 9) | 0.76 | 38.0 (11.2) | 53.5 (3.57) | 0.004* |
| CHCl₃ (n = 8) | 1.52 | 63.1 (34.9) | 45.4 (4.46) | 0.182 |
| CHBr₃ (n = 7) | 1.52 | 64.0 (27.8) | 65.8 (5.20) | 0.878 |
| mixture | | | | |
| study = 1.5 total | | | | |
| dose | | | | |
| BDCM (n = 9) | 1.52 | 56.0 (17.4) | 96.5 (7.80) | <0.001* |
| CDBM (n = 8) | 0.76 | 28.1 (6.7) | 53.5 (3.57) | <0.001* |
| CHCl₃ (n = 6) | 1.52 | 46.6 (21.5) | 45.4 (4.46) | 0.905 |
| CHBr₃ (n = 8) | 1.52 | 56.0 (24.8) | 65.8 (5.20) | 0.340 |
| mixture | | | | |
| study = 3.0 total | | | | |
| dose | | | | |
| BDCM (n = 6) | 1.52 | 48.8 (23.3) | 96.5 (7.80) | 0.0002* |
| CDBM (n = 7) | 0.76 | 19.3 (3.6) | 53.5 (3.57) | <0.001* |
| CHCl₃ (n = 8) | 1.52 | 24.3 (5.8) | 45.4 (4.46) | <0.001* |
| CHBr₃ (n = 8) | 1.52 | 86.4 (89.2) | 65.8 (5.20) | 0.521 |

*Significant at the 5% level using Hocherg's correction for multiple testing.

The objective of this paper is to develop a method for testing for departure from additivity when the single chemical data cannot be used to describe the no interaction case. The mixture data of interest are assumed to result from a fixed-ratio ray design. Table 3 provides summary statistics for the DBP mixture data described above. The three ‘total dose’ groups represent the mixture of the four chemicals at a fixed ratio of (0.34: 0.29: 0.32: 0.05) for (BDCM: CDBM: CHCl3: CHBr₃), but with total dose values of 0.5, 1.5, and 3.0 mM/kg.

TABLE 3
Summary statistics for the mixture data.

| Mixture group | Total dose | Mean SDH | STD SDH | Sample size |
|---|---|---|---|---|
| Control | 0 | 17.42 | 3.43 | 27 |
| Chlorination* | 0.05 | 19.61 | 4.36 | 17 |
| Chlorination* | 1.5 | 46.29 | 19.26 | 17 |
| Chlorination* | 3.0 | 76.22 | 12.10 | 16 |

*Mixing ratio of (BDCM:CDBM:CHCl₃:CHBr₃) was (0.34:0.29:0.32:0.05).

3. Model and Estimation

Suppose we are interested in studying the interaction among c drugs/chemicals in combination at a fixed ratio. Let yᵢⱼₖ be the kth observation of the jth dose of the ith chemical; 1≦i≦c, 1≦j≦dᵢ, 1≦k≦nᵢⱼ; and N=Σ_{i,j}nᵢⱼ. Denote the mean of Y as E(Y)=μ, and the variance of Y as Var(Y)=τV(μ), where V(μ) is an assumed known function of the mean and τ is an unknown scale parameter. Using a generalized linear model, the mean of Y is associated with the doses of the c chemicals through a link function (McCullagh and Nelder, 1989). With the assumption of the form for the mean and variance of Y, quasi-likelihood methods can be used to estimate the model (mean) parameters (e.g., McCullagh, 1983), i.e.,

$$Q ( μ , τ ; y ) = {\int }_{y}^{μ} \frac{y - w}{τ V ( w )} ⅆ w$$

is maximized across the N observations in the study using an iterative algorithm. A method of moments one-step estimator is used for τ (e.g., McCullagh and Nelder, 1989).

3.1 Model Along a Fixed Ratio Ray

For a combination of c drugs/chemicals with mixing ratio [a₁: a₂: . . . :a_{c}], the additivity model can be expressed as given in (1) with the additional assumption that var(Y)=τV(μ). If the model is parameterized to include the terms associated with all 2, 3, . . . ,c-drug/chemical interactions, then the interaction model assumes the following form

$$\begin{matrix}g ( {μ}_{m , interaction} ) = {β}_{0} + {\sum }_{i = 1}^{c} {γ}_{i} {x}_{i} + {{\sum }_{i = 1}^{c} {\sum }_{j = 1}^{c}}_{i < j} {γ}_{ij} {x}_{i} {x}_{j} + {{\sum }_{i = 1}^{c} {\sum }_{j = 1}^{c} {\sum }_{k = 1}^{c}}_{i < j < k} {γ}_{ijk} {x}_{i} {x}_{j} {x}_{k} + \\ {{\sum }_{i = 1}^{c} {\sum }_{j = 1}^{c} {\sum }_{k = 1}^{c} {\sum }_{l = 1}^{c}}_{i < j < k < l} {γ}_{ijkl} {x}_{i} {x}_{j} {x}_{k} {x}_{l} + … + {γ}_{12 … c} {x}_{1} {x}_{2} … {x}_{c}\end{matrix} \qquad ( 2 )$$

where xᵢ is the dose of the ith drug/chemical, β₀ is the unknown intercept and γᵢ is the unknown slope parameter for the ith drug/chemical, γᵢⱼ is the unknown parameter associated with the interaction between drugs/chemicals i and j, γᵢⱼₖ is the unknown parameter associated with the interaction between drugs/chemicals i,j and k, and γ_{12 . . . c} is the unknown parameter associated with the c-factor interaction among the drugs/chemicals. Pure higher order terms and associated cross-product terms are not included in (2) as such terms do not allow the corresponding additivity model (i.e., the model in (2) where all cross product terms are zero) to satisfy Berenbaum's definition of additivity.

When the combination data are collected along a fixed ratio ray with mixing ratio (a₁:a₂: . . . :a_{c}), then a mixture point [x₁, x₂, ,x_{c}] is uniquely defined by [a₁t, a₂t, . . . a_{c}t] where t is the total dose. The model of no interaction defined in equation (1) reduces to the linear predictor being in the form of a simple linear model in terms of total dose, i.e.,

g(μ_{m,add})=β₀+β*₁t, (3)

where

$${β}_{1}^{*} = {\sum }_{i = 1}^{c} {γ}_{i} {a}_{i} .$$

Additionally, the model that allows for interaction, defined in equation (2), can be expressed with the linear predictor portion of the model being a higher order polynomial in terms of the total dose, defined by

$$g ( {μ}_{m , interaction} ) = {β}_{0} + {β}_{1} t + {\sum }_{i = 2}^{c} {β}_{i} {t}^{i} , \\ where \\ {β}_{1} = {\sum }_{i = 1}^{c} {γ}_{i} {a}_{i} , {β}_{2} = {{\sum }_{i = 1}^{c} {\sum }_{j = 1}^{c}}_{i < j} {γ}_{ij} {a}_{i} {a}_{j} , {β}_{3} = {{\sum }_{i = 1}^{c} {\sum }_{j = 1}^{c} {\sum }_{k = 1}^{c}}_{i < j < k} {γ}_{ijk} {a}_{i} {a}_{j} {a}_{k} , etc . \qquad ( 4 )$$

the unknown parameter associated with all two-factor interactions, β₃ is the unknown parameter associated with all three-factor interactions, . . . , and β_{c} is the unknown parameter associated with the c-factor interaction. With mixture data only along a fixed-ratio ray, the entire response surface cannot be adequately (if at all) estimated. Thus, the g parameters in (2) are not estimated. Instead, the design supports the estimation of the polynomial parameters in (4).

3.1 Inference

Let θ=[β₀, β₁, β₂, . . . ,β_{c}]′, where \hat{θ} is found by replacing unknown parameters with quasi-likelihood parameter estimates. Following McCullagh (1983), the large sample covariance matrix of \hat{θ} is var(\hat{θ})=[I(\hat{θ})]⁻¹, where the expected quasi-information matrix evaluated at \hat{θ} is written as

I(\hat{θ})=D′(τV(μ))⁻¹D|_{\hat{θ}} (5)

where

$$D = [ \begin{matrix}\frac{\partial {μ}_{1}}{\partial {β}_{0}} & \frac{\partial {μ}_{1}}{\partial {β}_{1}} & ⋯ & \frac{\partial {μ}_{1}}{\partial {β}_{c}} \\ \frac{\partial {μ}_{2}}{\partial {β}_{0}} & \frac{\partial {μ}_{2}}{\partial {β}_{1}} & ⋯ & \frac{\partial {μ}_{2}}{\partial {β}_{c}} \\ ⋮ & ⋮ & & ⋮ \\ \frac{\partial {μ}_{d}}{\partial {β}_{0}} & \frac{\partial {μ}_{d}}{\partial {β}_{1}} & ⋯ & \frac{\partial {μ}_{d}}{\partial {β}_{c}}\end{matrix} ] \qquad and$$

$$V ( μ ) = [ \begin{matrix}V ( {μ}_{1} ) & 0 & ⋯ & 0 \\ 0 & V ( {μ}_{2} ) & ⋯ & 0 \\ ⋮ & ⋮ & ⋰ & ⋮ \\ 0 & 0 & ⋯ & V ( {μ}_{d} )\end{matrix} ] .$$

It is important to note that the information matrix in (5) depends on the design of the study (in terms of dose location and subject allocation) through the rows of D. This is exploited in section 4 to determine optimal experimental designs.

Of ultimate interest is the determination and classification of departures from additivity among a particular combination/mixture of chemicals. When comparing the additivity model to the interaction model, defined in (3) and (4) respectively, evidence of curvature on the link scale indicates departure from additivity; i.e., there is interaction among the chemicals if at least one βᵢ≠0, i=2, . . . ,c. When θ=[θ₁: θ₂]′, where θ₁=[β₀, β₁]′ and θ₂=[β₂, . . . , β_{c}]′, the test for departure from additivity can be written as

H₀: θ₂=0 vs. H₁: θ₂≠0. (6)

In testing such an hypothesis, the analyst generally selects from three large sample tests: the quasi-likelihood ratio test (McCullagh, 1983), the score test, and the Wald test (e.g., McCullagh and Nelder, 1989).

4. Experimental Designs

We have shown that when a ray design is used the hypothesis of additivity is equivalent to the hypothesis of the adequacy of the model where the linear predictor is in the form of a simple linear model. In other words, the test for additivity is testing that the parameters associated with the higher order polynomial terms in the linear predictor are equal to zero. The tests of the hypothesis in (6) either implicitly or explicitly involve the significance of \hat{θ}₂ terms relative to Var(\hat{θ}₂). Thus, designs which lead to precise estimation of \hat{θ}₂ are preferred. Hence, a reasonable criterion for use when designing mixture studies to detect interactions requires optimizing the precision of the estimates of the model parameters. Such designs are associated with an increase in the power of the test of additivity.

4.1 D-Optimal and Dₛ-Optimal Designs

Define t=[t₁ t₂ . . . t_{c+r}] as the (c+r)x1 vector of total dose design points where the number of total dose levels is fixed. The minimum number of levels needed to test the hypothesis of additivity is (c+1). Define q=[q₁ q₂ . . . q_{c+r}] as the vector of sample size allocations where Σqᵢ=1 and the number of observations in the i^{th} dose group is nᵢ=Nqᵢ. The D-optimal design is the design that minimizes with respect to t and q the generalized variance of the estimated model coefficients (Kiefer and Wolfowitz, 1959), where the generalized variance is defined as the determinant of the variance-covariance matrix. In the present context, the D-optimal design would maximize the determinant of the Fisher's quasi-information matrix; i.e.,

$$\begin{matrix}max \\ t , q\end{matrix} \vert \frac{1}{τ} I ( β ) \vert , \qquad ( 7 )$$

where I(β) is the Fisher's quasi-information matrix defined in equation (5). Maximization of the determinant of the information matrix is accomplished by adjusting the rows in D in (5) for the total dose values and the number of observations associated with each dose group at each step in a direct search algorithm.

In Section 3 we introduced methodology for testing the hypothesis of additivity given a generalized linear model framework, using quasi-likelihood estimation. We showed that the hypothesis of additivity is rejected when higher order polynomial terms are required in the total dose-response model. Thus, it is important that we have precise parameter estimates for these higher order polynomial terms in the linear predictor. We will develop methodology for finding a D_{S}-optimal design based on this subset of terms in the linear predictor.

The Dₛ-optimal design is used to select design points that minimize with respect to t the generalized variance of the parameters associated with the higher order polynomial parameter terms in the linear predictor; that is,

$${min}_{t , q} Var ( {\hat{θ}}_{2} ) , \qquad ( 8 )$$

where Var(\hat{θ}₂) is the appropriate subset of the inverse of I(θ₁, θ₁), defined in (5), and is evaluated at specified values of θ₁ and θ₂. In practice, situations may arise where the search needs to be constrained to a particular region of interest. In either case, the Nelder-Mead direct search algorithm (Nelder and Mead, 1965) can be used to accomplish the minimization procedure.

The approach discussed above results in a Dₛ-optimal design. However, the practical use of a Dₛ-optimal design may be questioned since the design is dependent upon unknown parameters. Thus, the scientist who employs the optimal design may need to “guess” the parameter values. The “guess” may be based on preliminary studies or information found in the literature. Another approach is to develop two-stage designs that provide good statistical properties, as suggested by several researchers, including Abdelbasit and Plackett (1983), Minkin (1987) and Myers et al. (1996).

4.2 Two-Stage Designs

A two-stage design may be employed when there is only scant information on which to base a reasonable “guess” of parameter values and when the researcher believes the experimental conditions in two studies are reproducible. A two-stage procedure uses the second stage to complement the first stage.

Following the approach taken by Minkin (1987), the total quasi-information matrix of the entire experiment can be expressed as the sum of the information matrices of the first stage and the second stage given the first stage, i.e.,

$${I}_{total} = \frac{1}{{τ}_{f}} {I}_{f} ( {β}_{0} , {β}_{1} , {β}_{2} , … , {β}_{c} ) + \frac{1}{{τ}_{s \vert f}} {I}_{s \vert f} ( {β}_{0} , {β}_{1} , {β}_{2} , … , {β}_{c} ) . \qquad ( 9 )$$

Minkin (1987) based this result on conditional likelihood theory; i.e., the fact that the log likelihood of a two-stage design can be expressed as the sum of the log likelihood of the first stage and the log likelihood of the second stage given the first stage.

The following steps outline the two-stage design.

(1) Provide initial parameter estimates based on previous experimentation, a pilot experiment conducted specifically for this purpose, or a guess by the scientist (β_{0f}, β_{1f}, β_{2f}, . . . , β_{cf}).

(2) Choose the total sample size for the entire experiment, N=N_{f}+N_{S}. (N_{f} is the number of experimental units allotted for the first stage and Nₛ is the number of experimental units allotted for the second stage).

(3) Based on N_{f}, β_{0f}, β_{1f}, β_{2f}, . . . , β_{cf}, apply, for example, the D-optimality criterion defined in equation (9) to obtain the values of total dose and sample size allocation (i.e., q) that maximize the determinant of the quasi-information matrix. This is accomplished by using the Nelder-Mead direct search algorithm.

(4) Perform the first stage of the experiment at the first stage D-optimal total dose values (t_{1f}, t_{2f}, . . . ,t_{(c+r1)f}) with N₁(q_{1f},q_{2f}, . . . ,q_{(c+r1)f}) observations at each dose group and obtain maximum quasi-likelihood estimates for the model parameters (\hat{β}_{0f}, \hat{β}_{1f}, \hat{β}_{2f}, . . . , \hat{β}_{cf}). Equal allocation in the first stage may be considered reasonable.

(5) Based on the first stage parameter estimates (\hat{β}_{0f}, \hat{β}_{1f}, \hat{β}_{2f}, . . . , \hat{β}_{cf}), \hat{τ}_{f}, τ_{S}, N_{S}, apply the D_{S}-optimality criterion defined in equation (8), where Var(\hat{θ}₂) is replaced with the appropriate subset of the inverse of the total conditional information for the two-stages, Iₜₒₜₐₗ, given in equation (9), to obtain the second stage total dose values (t_{1s|f}, t_{2s|f}, . . . , t_{(c+r2)s|f}).

(6) Conduct the second stage experiment at the second stage D_{S}-optimal total dose values (t_{1s|f}, t_{2s|f}, . . . , t_{(c+r2)s|f}) with nᵢ=N₂qᵢ observations at the i^{th} dose group, i=1, . . . ,c+r2.

(7) Based on the observed responses, yᵢⱼₖ, at t_{1f}, t_{2f}, . . . , t_{(c+r1)f}, t_{1s|f}, t_{2s|f}, . . . , t_{(c+r2)s|f}, estimate the final model parameters \hat{θ}₁ and \hat{θ}₂ using maximum quasi-likelihood estimation. In addition, the estimate of τ_{S|f} is found by using moment estimation.

This will result in a two-stage D-D_{S}-optimal design consisting of 2*c+r1+r2 design points.

5. Example

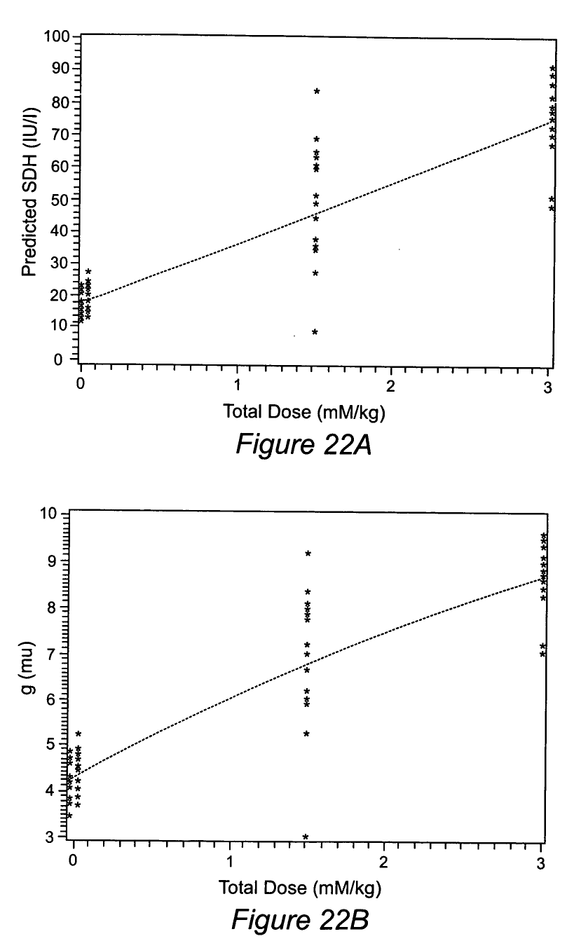

Descriptive statistics for the mixture of the four DBPs described in Section 2 are provided in Table 3. Clearly, as the total dose increases there appears to be an increase in the mean SDH. In addition, the standard deviation appears larger for the total dose groups associated with a higher mean response. Thus a quasi-likelihood criterion for parameter estimation with Var(Y)=τμ seems reasonable for these data. Using the same link function as considered in the additivity model (i.e., g(μ)=μ^{λ} where λ=0.5), a quadratic model was initially fit to the data (Table 4a, FIG. 22). From (3), the additivity model along the fixed-ratio ray includes an intercept and slope parameter. Assuming the underlying dose-response surface associated with the four chemicals is as described in (4), the test for the significance of the quadratic term along the fixed-ratio ray is analogous to the simultaneous test of all pairwise interaction terms. The p-value associated with the significance of β₂ (Table 4a) is 0.152. Although not significant at the usual 5% significance level, the p-value is compelling enough to motivate further investigations of the mixture. With a larger design, it would be possible to again test for the significance of all higher order terms, which is associated with the test of additivity.

TABLE 4a
Estimated model parameters using the mixture model given in (2) for a
quadratic generalized linear model with power link with the
transformation parameter λ = 0.5

| Parameter | Estimate | Standard Error | P-value |
|---|---|---|---|
| β₀ | 4.234 | 0.124 | <0.001 |
| β₁ | 1.938 | 0.300 | <0.001 |
| β₂ | −0.146 | 0.102 | 0.152 |
| τ | 2.58 | | |

TABLE 4b
Estimated model parameters using the mixture model given in (2)
for a cubic generalized linear model with power link.

| Parameter | Estimate | Standard Error | P-value |
|---|---|---|---|
| β₀ | 4.174 | 0.155 | <0.001 |
| β₁ | 5.246 | 5.250 | 0.318 |
| β₂ | −3.415 | 5.179 | 0.510 |
| β₃ | 0.724 | 1.147 | 0.528 |
| τ | 2.60 | | |

* The likelihood ratio simultaneous test for the significance of β₂ and β₃ was not rejected
(p = 0.294).

The design used for the mixture data (Table 3) was selected to include a small dose value, a large dose value and somewhat of a midpoint value. It was not based on a formal design strategy. Therefore, it is of interest to propose a design that might be useful in further investigations of the mixture. Two options are available for consideration. First, the observed data to date could be considered preliminary data and a full new study could be conducted. The parameter estimates found in the observed data could be used in a one-stage Dₛ-optimal design. In this approach, the new data would be analyzed separately from the original mixture data. Another approach is to consider the observed data as a first-stage and patch these data with additional dose groups so that a fourth degree model could be fit to the combined data. A fourth degree model is of interest as the mixture includes four DBPs and such a model allows for a test of up to a four-way interaction among the chemicals along the fixed-ratio ray of interest. Of concern is that the dose-response relationship shifted from the initial single chemical studies to the mixture studies. If another shift occurs between the first and second stages, then the data could not be combined for a full analysis. Both approaches are considered in more detail below.

One-Stage Design

A Dₛ-optimal design associated with the test for interaction is a design that minimizes the volume of the confidence ellipsoid about the higher order parameters. In constructing this design, the mixture data were refit with a cubic model with the same power link function (Table 4b). Assuming an underlying dose-response surface as given in (4), the test for interaction would be based on the significance of β₂ and β₃ (i.e., the quadratic and cubic terms which are associated with all pairwise and three-way interactions). The design algorithm resulted in values for the total dose groups and sample size allocations associated with minimizing the determinant of the 2×2 covariance matrix associated with the higher order terms. A region constraint was added to the Nelder-Mead algorithm that required the largest total-dose group to be no larger than 3.0 mM/kg. This was selected based on the range of the single chemical data and because the investigator is more interested in the low-dose region than a high-dose region. The resulting design is provided in Table 5.

TABLE 5
One and two-stage designs associated with testing for interaction among the
four DBPs using the model parameters in Table 4b to describe the assumed shape of the
mixture dose-response curve in total dose.

| | |
|---|---|
| Design | $\{ \begin{matrix}{d}_{0} & {d}_{1} & {d}_{2} & {d}_{3} & {d}_{4} \\ {q}_{0} & {q}_{1} & {q}_{2} & {q}_{3} & {q}_{4}\end{matrix} \}$ |
| One stage design (assuming vehicle +four points) | $\{ \begin{matrix}0 & 0.9 & 1.8 & 2.5 & 3.0 \\ 0.26 & 0.14 & 0.16 & 0.21 & 0.23\end{matrix} \} for N obervations$ |
| Two-stage design (assuming observed data is first stage and adding new vehicle + 2 points; N = N₁ + N₂) | $\begin{matrix}First stage \text{:} \{ \begin{matrix}0 & 0.05 & 1.5 & 3.0 \\ 0.35 & 0.22 & 0.22 & 0.21\end{matrix} \} for {N}_{1} observations \\ Second stage \text{:} \{ \begin{matrix}0 & 1.0 & 1.9 \\ 0.57 & 0.28 & 0.15\end{matrix} \} for {N}_{2} observations\end{matrix}$ |

Two-Stage Design

A two-stage design assumed the observed mixture data was the first stage. The idea is to ‘patch’ this design with two additional points, so that a quartic model could be estimated. With four chemicals in the mixture it is of interest to test for the significance of up to a four-way interaction. Assuming the underlying dose-response surface as defined in (2), a four-way interaction is associated with a fourth degree term along the fixed-ratio ray.

The two-stage design is based on the conditional information matrix given in (9). The first stage information is added to the conditional second stage information matrix. This was accomplished assuming the underlying parameters are as given in Table 4b and the first stage information was the inverse of the covariance matrix of the model parameters. Again, a region constraint was included in the Nelder Mead algorithm requiring the largest total dose was no greater than 3.0 mM.kg. The resulting second-stage design is provided in Table 5. In a two-stage design, both the first and second-stage data are combined in the final analysis. Of course, preliminary checks for the equality of corresponding positive control group means would be conducted.

6. Discussion

A goal of this paper is the development of methodology for detecting departures from additivity among mixtures of drugs/chemicals taken along a fixed mixing ratio when a generalized linear model using quasi-likelihood estimation is used. This approach is useful when interest is focused on a fixed ratio ray, when resources are limited, and when only the first two moments of the distribution of the response variable can be specified. Importantly, the methodology developed in this paper does not require single-drug/chemical data to test for departures from additivity along the fixed ratio ray of the drugs/chemicals. The present example illustrates a situation where single chemical data were available but were unusable due to a shift in the dose-response curves. While single chemical data would be desired they are not necessary. The number of datapoints necessary to test for interaction along a fixed-ratio ray depends on the degree of the polynomial assumed. With c chemicals in the mixture, one may be interested in fitting a c-degree polynomial. The minimum number of dose points would be c+1. However, as the number of chemicals in the mixture increases, the analyst may be willing to assume that any higher-order interaction greater than say of degree k is negligible. In this case the minimum number of data points is k+1. Of course, additional data points can be added to further support the shape of the dose-response relationship.

An alternative approach to test for chemical interactions along a fixed ratio when single drug/chemical data are available is described in Gennings et al. (2002). These authors compared the estimated slope of an additivity model along a fixed mixing ratio of interest to the estimated slope based on combination data along the ray. Here, the single chemical dose-response data are experimentally observed to support the estimation of an additivity surface. However, as the number of drugs/chemicals increases, the likelihood that the single drug/chemical data are available decreases.

References

Abdelbasit, K. M. and Plackett, R. L. (1983) “Experimental Design for Binary Data,” Advanced Cancer Research, 35, 269-335.

Atkinson, A. and Donev, A. (1992) Optimum Experimental Designs. Oxford: Oxford University Press.

Berenbaum, M. C. (1985) The expected effect of a combination of agents: The general solution Journal Theoretical Biology, 114, 413-431.

Bruden, M. and Vidmar, T. (1989), “Optimal 3×3 Factorial and 3-ray Designs for Drug Interaction Experiments with Dichotomous Responses,” Communications in Statistics, 18, No. 8, 2835-2859.

Dawson, K. S., Carter, Jr., W. H., Gennings, C. A Statistical Test for Detecting and Characterizing Departures from Additivity in Drug/Chemical Combinations. Journal of Agricultural, Biological, and Environmental Statistics, 5:342-359, 2000.

Finney, D. J. (1964) Statistical Methods in Biological Assay (2nd ed.), London: Charles Griffin & Co.

Gennings, C., Carter, W. H., Jr. (1995). “Utilizing Concentration-Response Data from Individual Components to Detect Statistically Significant Departures from Additivity in Chemical Mixtures” Biometrics, 51:1264-1277.

Gennings, C., Schwartz, P., Carter, W. H., Jr., Simmons, J. E.(1997) “Detection of departures from additivity in mixtures of many chemicals with a threshold model” Journal of Agricultural, Biological, and Environmental Statistics, 2:198-211.

Gennings (2000) “ERRATUM: Detection of Departures From Additivity in Mixtures of Many Chemicals With a Threshold Model,” Journal of Agricultural, Biological, and Environmental Statistics, 5, 257-259.

Gennings, C., Carter, W. H., Jr., Campain, J., Bae, D, Yang, R. (2002) “Statistical Analysis of Interactive Cytotoxicity in Human Epidermal Keratinocytes Following Exposure to a Mixture of Four Metals,” Journal of Agricultural, Biological, and Environmental Statistics, 7(1):58-73.

Kelly, C., and Rice, J. (1990) Monotone smoothing with application to dose-response curves and the assessment of synergism, Biometrics, 46, 1071-1085.

Kiefer, J., and Wolfowitz, J. (1959) “Optimum Designs In Regression Problems,” The Annals of Mathematical Statistics, 30, 271-294.

Loewe, S. and Muischnek, H. (1926), “Uber kombinationswirkunger. I. Mitteilung: Hiltsmittel der gragstellung. Naunyn-Schmiedebergs,” Arch. Pharmacol, 114, 313-326.

Loewe, S. (1953), “The problem of synergism and antagonism of combined drugs,” Arzneimittle forshung, 3, 285-290.

Mantel, N. (1958) “An Experimental Design in Combination Chemotherapy,” Annals of the New York Academy of Sciences, 76, 909.

Martin, J. T. (1942), “The Problem of the Evaluation of Rotenone-containing Plants. VI. The Toxicity of 1-elliptone and of Poisons Applied Jointly, with Further Observations on the Rotenone Equivalent Method of Assessing the Toxicity of Derris Root,” Annals of Applied Biology, 29, 69-81.

McCullagh, P. (1983), “Quasi-likelihood Functions,” The Annals of Statisitcs, 11, 59-67.

McCullagh, P., and Nelder, J. A. (1989), Generalized Linear Models (2nd ed.), New York: Chapman and Hall. 511 pp.

McDonald, A., Gennings, C., Hartley, W., Teuschler, L. K., Thiyagarajah, A., Sey, Y. M., Krasner, S. W. and Simmons, J. E. (1999) “The effect of mixing ratio on the hepatotoxicity of trihalomethane disinfection byproducts,” The Toxicologist, 48, 110.

Minkin, S. (1987), “Optimal Designs for Binary Data,” Journal of the American Statistical Association, 82, 1098-1103.

Myers, W. R., Myers, R. H., Carter, W. H., Jr. and White, K. L., Jr. (1996) “Two-Stage Designs for the Logistic Regression Model in Single-agent Bioassays,” Journal of Biopharmaceutical Statistics, 6, 283-301.

Nelder, J. A., and Mead, R. (1965), “A Simplex Method for Function Minimization,” The Computer Journal, 7, 308-313.

### Example 8

### Analysis of an Interaction Threshold in a Mixture of Drugs and/or Chemicals

1. Introduction

A major task when studying chemical mixtures is to determine whether departures from additivity, i.e. interactions, among the chemicals in the mixture exist. Current methodology (Gessner and Cabana, 1970, Carter, et.al, 1988, Kelly and Rice, 1990, Gennings, 1995, Dawson, Carter, and Gennings, 2000) provides foundations to study and characterize interactions by utilizing concepts involving isobolograms, statistical models, and the interaction index (Berenbaum, 1981). Toxicological data may suggest dose-dependent interactions (e.g. Konemann and Pieters, 1996, Gennings, et.al. 2002) where the existence and nature of the interaction may change with dose. The U.S. EPA (1996, 2000, 2002) and Carpy, Kobel, and Doe (2000) suggested that low-dose regions of mixtures of chemicals should be associated with additivity, while interactions might occur in higher-dose regions.

The definition of additivity used here is consistent with the classical isobologram (Loewe and Muischnek, 1926; Loewe, 1953). For a mixture of two agents, an isobologram is a contour of constant response of the dose-response surface superimposed on the line of additivity defined by the equi-effective levels of the individual components of the mixture. When the observed contour is below the line of additivity, a synergism can be claimed. When the observed contour is above the line of additivity, an antagonism can be claimed. When the observed contour is coincident with the line of additivity, additivity can be claimed. For a mixture of c≧3 chemicals, the production of an isobologram suffers from the difficulties associated with displaying c-dimensional figures.

For a mixture of c chemicals, an additivity model can be written as

g(μ)=β₀+β₁x₁+β₂x₂+ . . . +β_{c}x_{c}

where x₁, x₂, . . . x_{c} are the doses of the c individual chemicals, g(μ) is a user-specified link function (McCullagh and Nelder, 1989), and β₀, β₁, . . . , β_{c} are unknown parameters. At a fixed response, μ₀, g(μ₀)−β₀=β₁x₁+β₂x+. . . +β_{c} and

$$1 = \frac{{x}_{1}}{\frac{g ( {μ}_{0} ) - {β}_{0}}{{β}_{1}}} + ⋯ + \frac{{x}_{c}}{\frac{g ( {μ}_{0} ) - {β}_{0}}{{β}_{c}}} = \frac{{x}_{1}}{{ED}_{{μ}_{0}}^{( 1 )}} + ⋯ + \frac{{x}_{c}}{{ED}_{{μ}_{0}}^{( c )}} = Interaction Index \qquad ( 1.1 )$$

This follows since

$$\frac{g ( {μ}_{0} ) - {β}_{0}}{{β}_{i}} = {ED}_{{μ}_{0}}^{( i )} ,$$

the dose associated with the response μ₀ for the i^{th} component of the mixture. Berenbaum (1981) related the interaction index to the isobologram and showed that when the interaction index is not equal to one, an interaction, i.e. departure from additivity, is present. The interaction index is important since it does not have the graphical limitations associated with producing plots of multi-dimensional isobolograms when the number of chemicals in the mixture is greater than three.

Carter, et.al, (1988) showed that when model parameters associated with interaction in a generalized linear model are different from zero, the interaction index is different from one. For example, consider a two-chemical mixture with interaction, i.e.

g(μ)=β₀+β₁x₁+β₂x₂+β₁₂x₁x₂

From this, it follows that,

$$1 - \frac{{β}_{12} {x}_{1} {x}_{2}}{g ( μ ) - {β}_{0}} = \frac{{x}_{1}}{{ED}_{μ}^{( 1 )}} + \frac{{x}_{2}}{{ED}_{μ}^{( 2 )}} = Interaction Index .$$

When β₁₂=0, the interaction index is equal to one. For g(μ)>β₀, if the estimate of β₁₂>0, the interaction index is less than one which is indicative of a synergism. Similarly, when β₁₂<0, an antagonistic interaction can be claimed.

Gessner and Cabana (1970) studied the mixture of ethanol and chloral hydrate, using the loss of righting reflex in mice as the response. These authors compared confidence interval estimates about experimentally determined ED₅₀'s at nineteen different dose combinations to lines formed by connecting the lower confidence limits of the ED₅₀'s of the individual drugs. They interpreted these latter lines as some form of a confidence bound about the line of additivity formed by connecting the ED₅₀'s determined for each drug. Evidence for a departure from additivity was provided whenever the confidence bounds for the experimentally determined ED₅₀ for a combination did not overlap with the “confidence” region for the line of additivity, as shown in FIG. 1 (taken from FIG. 1 of Gessner and Cabana, 1970).

Although the statistical approach used to analyze their data is crude, their work is important because it provides an empirical estimate of the ED₅₀ contour of the underlying dose response surface associated with these two chemicals. It is noteworthy that the experiment used a total of 1681 animals in 21 treatment groups, the 19 combinations of the two chemicals mentioned previously, and two single chemical groups (Gessner and Cabana, 1967).

The isobologram of Gessner and Cabana (FIG. 1) associated with the empirical ED₅₀'s of ethanol and chloral hydrate is consistent with the existence of an interaction threshold. Note that the mixture appears to be additive at the 50% level of response for chloral hydrate less than 125 mg/kg and ethanol greater than 1200 mg/kg. When chloral hydrate exceeds 125 mg/kg and ethanol is less than 1200 mg/kg, there is a synergistic interaction. This suggests the possibility of an interaction threshold when the drugs are combined.

The boundary that separates the dose space into regions of interaction and additivity is of interest to locate. The development and subsequent analysis of a model that accommodates the elucidation of the boundary of the two regions is the objective of this report. The interaction threshold boundary may take a variety of different shapes, and the shape of this boundary is not likely to be known. Our goal is to develop a general procedure to accommodate various potential shapes for this boundary.

In Section 2, we develop a dose-response model that allows an interaction threshold boundary. In Section 3, we describe parameter estimation procedure and tests of hypotheses of specific interest. An example illustrating these methods using a mixture of ethanol and chloral hydrate is presented in Section 4. A discussion of these methods and some concluding remarks are presented in Section 5.

2. Development of the Interaction Threshold Model on the Response Surface

Suppose that we are interested in estimating an interaction threshold boundary for a mixture of c chemicals where both single chemical and mixture data are observed. Let yᵢⱼₖ be the k^{th} observation of the j^{th} dose of the i^{th} chemical and let the mean of Y be E(Y)=μ. Assume that var(Y)=τV(μ), where V(μ) is assumed to be a known function of the mean and τ is an unknown scale parameter. Given a c-dimensional combination, we assume that the interaction threshold boundary can be defined such that the value of the c^{th} component can be expressed as a function of the remaining c-1 chemicals, i.e.

x_{c}=Q(x₁, x₂, . . . , x_{c-1}).

2.1 The General Interaction Threshold Model

Consider the following generalized linear interaction threshold model describing the relationship between the response and the doses of the c chemicals in combination:

$$g ( μ ) = \{ \begin{matrix}{β}_{0} + {\sum }_{r = 1}^{c} {β}_{r} {x}_{r} & {x}_{c} \leq Q ( {x}_{1 ,} {x}_{2} , … , {x}_{c - 1} ) \\ \begin{matrix}{β}_{0} + {\sum }_{r = 1}^{c} {β}_{r} {x}_{r} + {\sum }_{r = 1}^{c - 1} {\sum }_{s = r + 1}^{c} {β}_{rs} {x}_{r} {x}_{s} + \\ {\sum }_{r = 1}^{c - 2} {\sum }_{s = r + 1}^{c - 1} {\sum }_{t = s + 1}^{c} {β}_{rst} {x}_{r} {x}_{s} {x}_{t} + \\ ⋯ {β}_{12 … c} {x}_{1} {x}_{2} … {x}_{c}\end{matrix} & {x}_{c} > Q ( {x}_{1 , } {x}_{2} , … , {x}_{c - 1} )\end{matrix} \} \qquad ( 2.1 .1 )$$

(2.1.1) where x₁, x₂, . . . , x_{c} are the doses of the individual chemicals, g(μ) is a user-specified link function (McCullagh and Nelder, 1989), and β₀, β₁, . . . β_{c}, β₁₂, . . . , β_{12 . . . c} are unknown parameters. The model can be made continuous by requiring the values of g(μ) at the threshold boundary to be equal, i.e., at the boundary

$$( {\sum }_{r = 1}^{c - 2} {x}_{r} ( ( {\sum }_{s = r + 1}^{c - 1} {β}_{rs} {x}_{s} ) + {β}_{rc} Q ) + {\sum }_{r = 1}^{c - 3} {\sum }_{s = r + 1}^{c - 2} {x}_{r} {x}_{s} ( ( {\sum }_{t = s + 1}^{c - 1} {β}_{rst} {x}_{t} ) + {β}_{rsc} Q ) + ⋯ + {β}_{12 … c} {x}_{1} {x}_{2} … {x}_{c - 1} Q ) = 0 \qquad ( 2.1 .2 )$$

(2.1.2)

For simplicity, consider a mixture of two drugs/chemicals. In this case, the continuity constraint given in (2.1.2) requires that β₁₂xᵢQ(x₁)=0. Thus, for the two-drug/chemical case, (2.1.1) can be written as

g(μ)=β₀+β₁x₁+β₂x₂+[β₁₂(x₁(x₂−Q(x₁)))]I₊(x₂−Q(x₁)) (2.1.3)

where

$${I}_{+} ( {x}_{2} - Q ( {x}_{1} ) ) = \{ \begin{matrix}0 & {x}_{2} \leq Q ( {x}_{1} ) \\ 1 & {x}_{2} > Q ( {x}_{1} )\end{matrix} . \qquad 2.2$$

2.2 Several Formulations of a Threshold Region When c=2

It is unlikely that investigators will know the form of Q(x₁) or, equivalently, the location of interaction thresholds, if they exist. When the form of Q(x₁) is specified in the interaction threshold model, it is possible to estimate the unknown constants that parameterize the interaction threshold boundary. Four different functional relationships are considered here and will be used in the example given in Section 4.

(i) Segmented Line (FIG. 2A)

For this boundary, Q₁(x₁) is given by

$${Q}_{1} ( {x}_{1} ) = \{ \begin{matrix}A + {Bx}_{1} & if {x}_{1} < C \\ D + {Ex}_{1} & if {x}_{1} \geq C\end{matrix} \qquad ( 2.2 .1 )$$

with the continuity constraint that A+BC=D+EC. After application of the method of Gallant and Fuller (1973), (2.2.1) becomes

Q₁(x₁)=A+Bx₁+[(E−B)(x₁−C)]I₊(x₁−C) (2.2.2)

where

$${I}_{+} ( {x}_{1} - C ) = \{ \begin{matrix}0 & {x}_{1} \leq C \\ 1 & {x}_{1} > C\end{matrix} .$$

(ii) Nonlinear Boundaries

(a) Four Parameter Logistic Boundary (FIG. 2B)

Here,

Q₂(x₁)=A+Bf(x₁) (2.2.3)

For this example, we have chosen

$$f ( {x}_{1} ) = \frac{1}{1 + exp ( - C + {Dx}_{1} )} ,$$

the logistic CDF. Any cumulative distribution function would suffice to impose the boundary we envision. This boundary imposes asymptotic boundaries at A and A+B, for the levels of the second drug/chemical associated with the threshold boundary.

(b) Inverse Cubic Boundary (FIG. 2C)

Here,

$${Q}_{3} ( {x}_{1} ) = A + \frac{1}{B ( {x}_{1} - E ) + {C ( {x}_{1} - E )}^{2} + {D ( {x}_{1} - E )}^{3}} \qquad ( 2.2 .4 )$$

This relationship permits asymptotes to minimum values of each of the two drugs/chemicals, E for drug/chemical 1 and A for drug/chemical 2.

(iii) Elliptical Boundary (FIG. 2D)

It may be the case that for a combination of two drugs/chemicals, interaction may be constrained to a region within the dose space. Consider the situation where this region is elliptical. Here, if Ax₁²+Bx₂²+Cx₁+Dx₂+Ex₁x₂+1<0, interaction is present. When Ax₁²+Bx₂²+Cx₁+Dx₂+Ex₁x₂+1≧0, there is no interaction. That is, when the combination of doses, (x₁,x₂), is inside the ellipse, the combination is associated with interaction. When the combination of doses, (x₁,x₂), is outside the ellipse, the combination is associated with no interaction.

The nature of this region of interaction requires that the user modify the general interaction threshold model to preserve continuity. For this situation, we propose the following continuous model

g(μ)=β₀+β₁x₁+β₂x₂+[β₁₂x₁′x₂′]I₋(Q₄(x₁,x₂)) (2.2.5)

where Q₄(x₁,x₂)=Ax₁²+Bx₂²+Cx₁+Dx₂+Ex₁x₂+1 and

$${I}_{-} ( {Q}_{4} ( {x}_{1} , {x}_{2} ) ) = \{ \begin{matrix}0 & {Q}_{4} ( {x}_{1} , {x}_{2} ) \geq 0 \\ 1 & {Q}_{4} ( {x}_{1} , {x}_{2} ) < 0\end{matrix}$$

The values of the variables x₁′ and x₂′ are scaled such that the relationship is continuous on the interaction threshold boundary. There are multiple ways to accomplish this, and we discuss one such method in Section 4.

For the interaction threshold model that has been defined for the various formulations of Q, our objective now is to estimate the model parameters.

3. Estimation and Hypothesis Testing

3.1 Parameter Estimation

For the combination of two chemicals, the interaction threshold models are

g(μ)=β₀+β₁x₁+β₂x₂+[β₁₂(x₁(x₂−Q(x₁)))]I₊(x₂−Q(x₁)) (3.1.1)

for Q(x₁) given by (2.2.2), (2.2.3), and (2.2.4), and

g(μ)=β₀+β₁x₁+β₂x₂+[β₁₂x₁′x₂′]I₋(Q(x₁,x₂)) (3.1.2)

for Q(x₁,x₂) given by (2.2.5).

The methods of maximum quasi-likelihood (Wedderburn, 1974; McCullagh and Nelder, 1989) can be used to estimate the unknown parameters from the interaction threshold model. The log-quasi-likelihood function is

$$q ( μ , τ ; y ) = {\int }_{y}^{μ} \frac{y - t}{τ V ( t )} ⅆ t$$

Assuming independence across observations, the total log quasi-likelihood is

q(μ,τ,y)=Σ_{i,j,k}q(μᵢⱼ,τ;yᵢⱼₖ). (3.1.3)

A direct search algorithm, such as the Nelder-Mead algorithm (1965) can be used to estimate the unknown parameters due to its ease with which it can incorporate the constraints associated with the interaction threshold boundary. We use a closed form estimator for τ suggested by McCullagh and Nelder (1989) shown as

$$\hat{τ} = {\sum }_{i , j , k} \frac{{( {y}_{ijk} - {\hat{μ}}_{ij} )}^{2}}{V ( {\hat{μ}}_{ij} ) ( N - p )} = \frac{{X}^{2}}{N - p} \qquad ( 3.1 .4 )$$

where N is the total number of observations, and p is the total number of parameters estimated in the particular model of interest. X² is the generalized Pearson statistic asymptotically distributed χ² with N−p degrees of freedom (McCullagh and Nelder, 1989). Estimation is performed in SAS, Version 8.2 using Proc NLP specifying maximization of the quasi-likelihood by the Nelder-Mead algorithm, and Proc IML for estimation of \hat{τ} and the appropriate variance-covariance matrix.

3.2 Hypothesis Testing

Separate tests of the hypotheses of overall additivity and the hypothesis of the presence of the interaction threshold boundary are performed. These hypotheses are tested using a log quasi-likelihood ratio test (McCullagh and Nelder, 1989). Denote the maximum values of the log quasi-likelihood under H₀ and H_{A} as Q(y;\tilde{θ},\tilde{τ}) and Q(y;\hat{θ},\hat{τ}), respectively. Then, under H₀, QLR=2{Q(y;\hat{θ})−Q(y;\tilde{θ})} is approximately distributed τχ²ₖ (McCullagh, 1983), where k is the difference in the number of parameters between the restricted and unrestricted models. Following McCullagh and Nelder, 1989, \hat{τ} is a consistent estimator of the unknown parameter τ and is approximately distributed

$$\frac{{χ}_{n - p}^{2}}{n - p} .$$

Hinkley (1969) recommended the use of the likelihood-ratio statistic for inferences about the join point or joint inferences about the join point and model parameters in segmented regression. Feder (1975) noted that the distribution of the likelihood ratio might be better approximated in finite samples by a multiple of an asymptotically equivalent F-distribution (Seber and Wild, 1989, pgs. 451-452). Following this logic, we use

$$\frac{QLR}{k \hat{τ}} ,$$

where \hat{τ} is calculated in the unrestricted model, as a likelihood-ratio test statistic, approximately distributed F_{k,n-p}.

(i) The Test for Additivity

Partition the interaction threshold model parameter vector from (3.1.1 or 3.1.2) as Θ=[Θ₁:Θ₂] where Θ₁=[β₀,β₁]′, Θ₂=[β₁₂,φ], and φₖₓ₁ is the k-vector of model parameters associated with the interaction threshold boundary, Q. With respect to a mixture of two chemicals, the test of departure from additivity is

H₀:Θ₂=0 H₁:Θ₂≠0 (3.2.1)

For the log quasi-likelihood ratio test, the unrestricted model is given by (3.1.1) or (3.1.2) and the restricted model is

g(μ)=β₀+β₁x₁+β₂x₂

If the null hypothesis of additivity is rejected, there is evidence of an interaction somewhere in the experimental region. It is of interest to determine if an interaction threshold exists and lies in the experimental region. Testing this hypothesis is equivalent to testing if any of the unknown parameters in the interaction threshold boundary, Q, are different from zero.

(ii) The Test for the Presence of an Interaction Threshold Boundary

We assume that the estimated boundary is within the experimental region. Partition the interaction threshold model parameter vector as ψ=└Ψ₁:φ┘ where Ψ₁=[β₀,β₁,β₁₂]′. The hypothesis of no interaction threshold is

H₀:φ=0 H_{A}:φ≠0 (3.2.2)

Again, the unrestricted model is given by (3.1.1) or (3.1.2), and the restricted model is

g(μ)=β₀+β₁x₁+β₂X₂+β₁₂x₁x₂

If we fail to reject the null hypothesis, it can be claimed that the interaction exists in the entire dose region. If we reject the null hypothesis, the interaction threshold boundary splits the dose region into areas of additivity and interaction.

4. Ethanol-Chloral Hydrate Example

Carter, et.al. (1988) provides data from the study of the combination of ethanol and chloral hydrate. In their study, the endpoint used was the same as that used by Gessner and Cabana (1970), the loss of righting reflex. These data, given in Table 1, were used to estimate the parameters of the interaction threshold model for each of the four considered interaction threshold boundaries. Estimation of parameters in the interaction threshold models using the original doses of ethanol and chloral hydrate resulted in a wide range of parameter estimates, in some examples, as wide as on the order of 10⁻⁸ to 10³. To avoid the appearance of an information matrix ill-conditioned to handle the wide range of variances and covariances associated with these parameter estimates, the concentrations of ethanol and chloral hydrate are scaled by the conversions

$$\frac{( \frac{mg}{kg} ethanol )}{4300} \text{and} \frac{ ( \frac{mg}{kg} \text{chloral hydrate} )}{425} ,$$

which scales the doses to values between 0 and 1.

TABLE 1
Experimental Groups and Number of Animals Exhibiting Loss of Righting Reflex in an
Ethanol-Chloral Hydrate Experiment; Expected Number Responding Under Assumption
of Additivity in Parentheses with Dose Groups Possibly Associated with Interaction
Inside Enclosed Cells

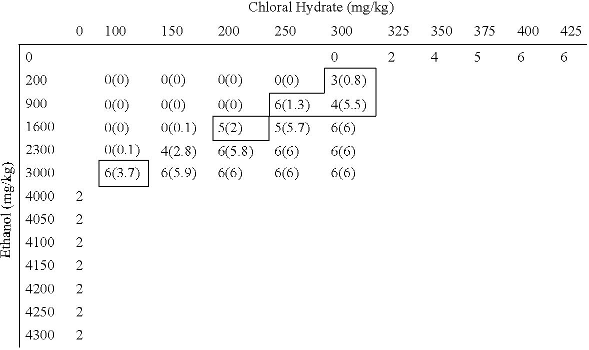

*There are 6 animals in each dose group

Since the response variable is binary,

$$g ( μ ) = ln ( \frac{p}{1 - p} ) ,$$

and the interaction threshold models become

$$ln ( \frac{p}{1 - p} ) = {β}_{0} + {β}_{1} {x}_{1} + {β}_{2} {x}_{2} + [ {β}_{12} ( {x}_{1} ( {x}_{2} - Q ( {x}_{1} ) ) ) ] I ( {x}_{2} > Q ( {x}_{1} ) ) \qquad ( 4.1 )$$

for Q(x₁) given by (2.2.2), (2.2.3), and (2.2.4), and

$$ln ( \frac{p}{1 - p} ) = {β}_{0} + {β}_{1} {x}_{1} + {β}_{2} {x}_{2} + [ {β}_{12} {x}_{1}^{′} {x}_{2}^{′} ] I ( Q ( {x}_{1} , {x}_{2} ) < 0 ) \qquad ( 4.2 )$$

for Q(x₁,x₂) given by (2.2.5).

To preserve continuity in the interaction threshold model given in (4.2), we rescale the doses as

x₁′=min(x₁−h₂(x₂), h₁(x₂)−x₁) (4.3)

x₂′=min(x₂−v₂(x₁), v₁(x₁)−x₂) (4.4)

where

$${x}_{1} = {h}_{1} ( {x}_{2} ) = \frac{- ( {Ex}_{2} + C ) + \sqrt{{( {Ex}_{2} + C )}^{2} - 4 A ( B {x}_{2}^{2} + D {x}_{2} + 1 )}}{2 A}$$

$${x}_{1} = {h}_{2} ( {x}_{2} ) = \frac{- ( E {x}_{2} + C ) - \sqrt{{( E {x}_{2} + C )}^{2} - 4 A ( B {x}_{2}^{2} + D {x}_{2} + 1 )}}{2 A}$$

$${x}_{2} = {v}_{1} ( {x}_{1} ) = \frac{- ( E {x}_{1} + D ) + \sqrt{{( E {x}_{1} + D )}^{2} - 4 B ( A {x}_{1}^{2} + C {x}_{1} + 1 )}}{2 B}$$

$${x}_{2} = {v}_{2} ( {x}_{1} ) = \frac{- ( E {x}_{1} + D ) - \sqrt{{( E {x}_{1} + D )}^{2} - 4 B ( A {x}_{1}^{2} + C {x}_{1} + 1 )}}{2 B}$$

By rescaling the doses in this way, at the interaction threshold boundary (boundary of the ellipse), the point is rescaled to zero and thus its contribution to the interaction is zero and the model is continuous. Within the ellipse, x₁′ and x₂′ take on values that are dependent on the distance from the closest boundary of the ellipse. As the point moves closer to the middle of the ellipse from the closest boundary, its contribution to the interaction increases, and as it moves away from the middle of the ellipse to the closest boundary, its contribution to the interaction decreases.

Each point (x₁,x₂) is considered individually. The process of resealing doses begins by determining whether the given point lies inside the ellipse. If Ax₁²+Bx₂²+Cx₁+Dx₂+Ex₁x₂+1>0, the point (x₁,x₂) is outside the ellipse and is associated with additivity and is not rescaled. If Ax₁²+Bx₂²+Cx₁+Dx₂+Ex₁x₂+1≦0, determines its contribution to interaction. An additional constraint imposed on the model is that the rescaling of either x₁ and/or x₂ cannot exceed the value of x₁ and/or x₂, respectively. This situation occurs if the closest interaction threshold boundary falls in negative dose space.

With several different boundary candidates under consideration, the results of Pearson Chi-square goodness-of-fit tests are helpful in making choices among the candidate threshold boundary forms. Since the p-value associated with the test of fit is adjusted for the degrees of freedom, ranking the various forms of Q through the p-values may be informative. The results of the goodness of fit tests for each model are contained in Table 2.

TABLE 2
Goodness-of-Fit results for the four considered interaction threshold
models

| Interaction Threshold Boundary | Goodness-of-Fit Test | | |
|---|---|---|---|
| Considered in Model | Statistic | df | p-value |
| Segmented Line Boundary | 42.33 | 31 | 0.084 |
| Nonlinear Logistic-Type Boundary | 36.72 | 31 | 0.221 |
| Inverse Cubic Boundary | 44.81 | 30 | 0.040 |
| Elliptical Boundary | 12.15 | 30 | 0.998 |

With respect to the interaction threshold boundaries considered, the results presented in Table 2 suggest that the elliptical boundary is the most appropriate to use in the interaction threshold model. Quasi-likelihood ratio tests given in (3.2.1) and (3.2.2) are used to test the hypotheses of overall additivity and the hypothesis of the existence of the interaction threshold boundary in the experimental region, respectively. These results and the parameter estimates associated with the selected interaction threshold model are shown in Table 3.

TABLE 3
Parameter Estimates and Quasi-Likelihood
Ratio Tests (Elliptical Boundary)

| | Parameter | | Test | | |
|---|---|---|---|---|---|
| Parameter | Estimate | Hypothesis Tested | Statistic | df | p-value |
| β₀ | −21.85 | Additivity | 7.51 | 6, 30 | <0.001 |
| β₁ | 22.95 | Presence of Interaction | 6.78 | 5, 30 | <0.001 |
| | | Threshold Boundary | | | |
| β₂ | 27.05 | | | | |
| β₁₂ | 297.09 | | | | |
| A | 1.20 | | | | |
| B | 2.06 | | | | |
| C | −1.74 | | | | |
| D | −2.86 | | | | |
| E | −2.07 | | | | |

*The value for \hat{τ} is 0.405, and the parameter estimates are associated with scaled doses.

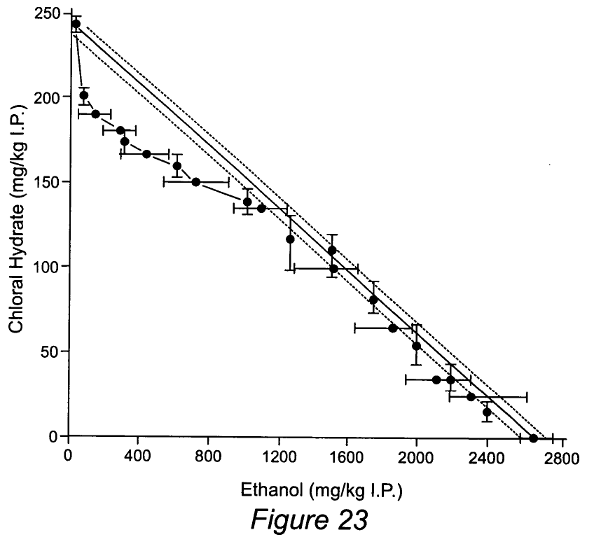

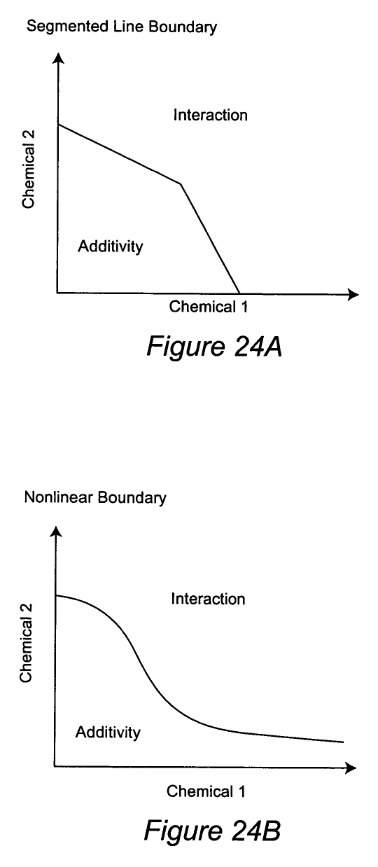

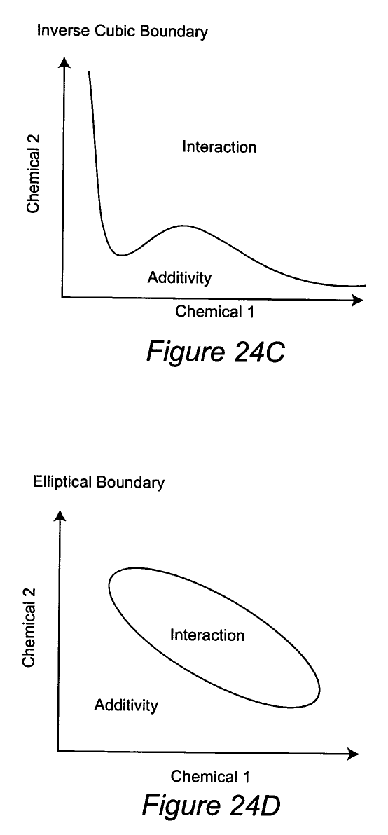

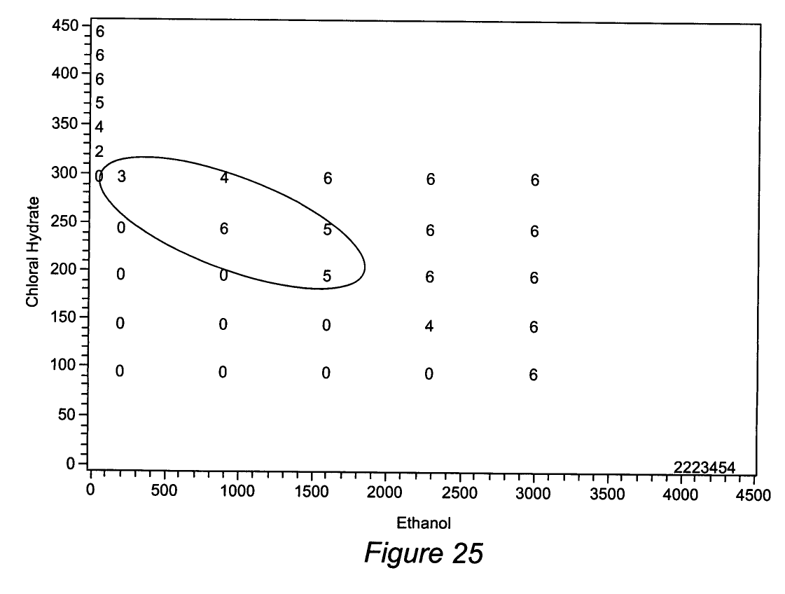

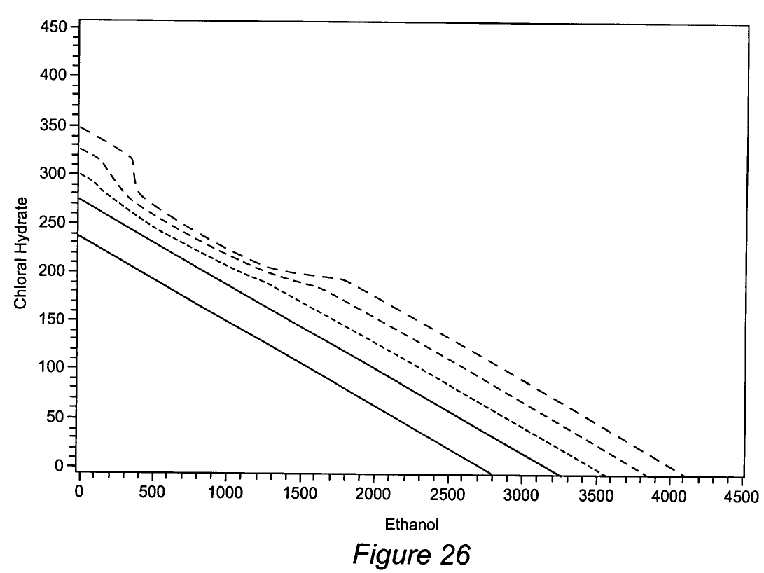

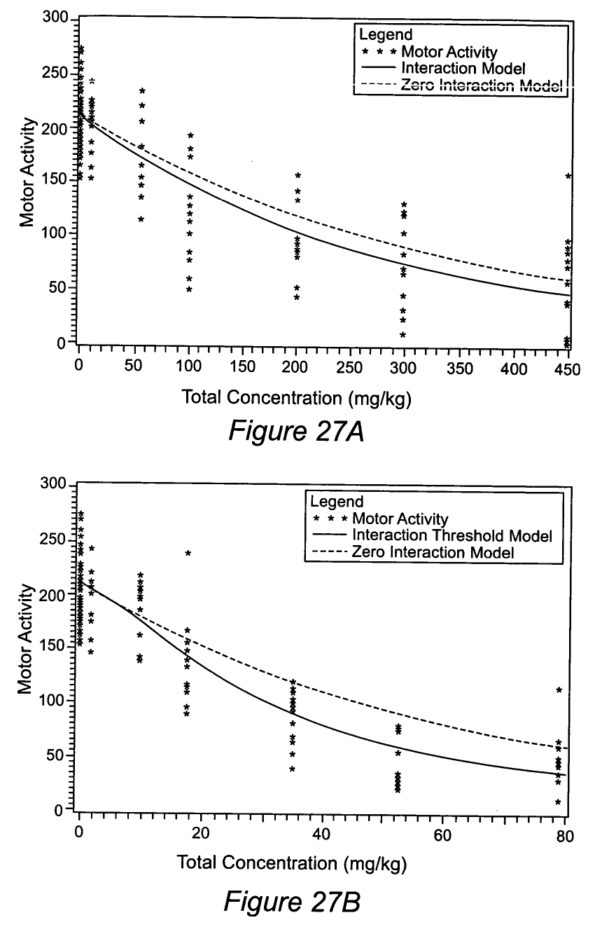

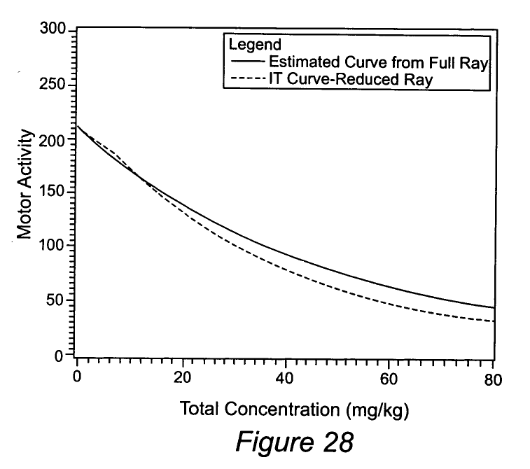

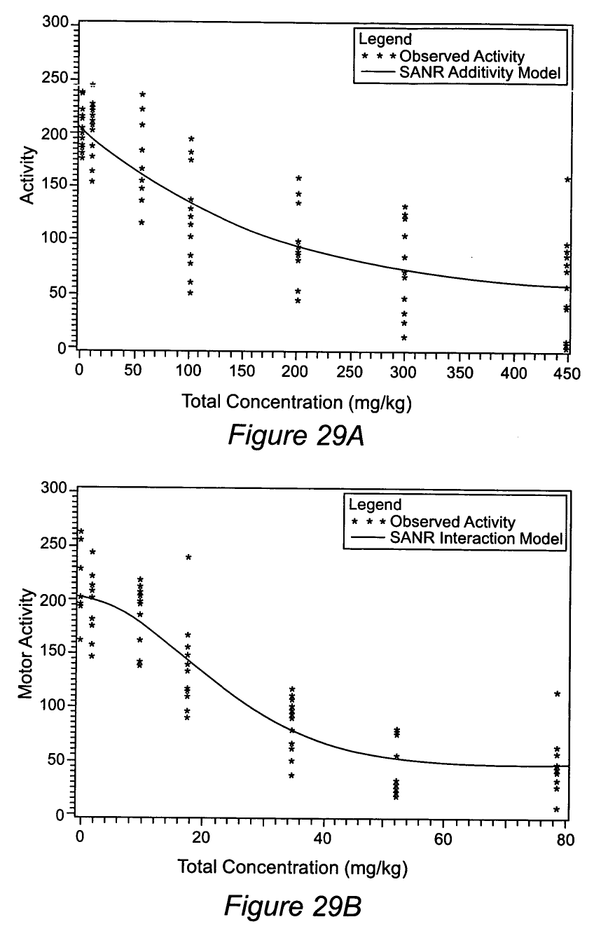

The hypothesis of additivity is rejected and the hypothesis that the interaction threshold does not exist is rejected, with p-values less than 0.001 for each test. It is interesting to consider the contours of the fitted dose response surfaces for this interaction threshold model. Since the isobologram presented by Gessner and Cabana (FIG. 23) is associated with a 50% level of response, a comparison of the ED₅₀ contours estimated from the interaction threshold model with the Gessner and Cabana isobologram is of interest, especially since the data set used in our interaction threshold model is an independently observed and much smaller data set. The estimated interaction threshold boundary plotted with the number of animals responding (out of 6) at each design point is graphically represented in FIG. 25 and the contours associated with various ED₁₀₀ₚ's are found in FIG. 26.

The data set reported by Carter, et.al. (1988) that was used in the example is much smaller than Gessner and Cabana's experiment, and it includes many observations at dose combinations where all or none of the animals responded, as illustrated in FIG. 25. The similarity between Gessner and Cabana's ED₅₀ contour and that estimated by our interaction threshold model lends support to the concept of interaction thresholds.

5. Discussion

Gessner and Cabana's (1970) data suggests the existence of an interaction threshold for the combination of ethanol and chloral hydrate. The model presented here permits the estimation of the location of the interaction threshold boundary, and also supports such a finding. For more than two chemicals, the interaction threshold boundaries become multiple dimensional planes or surfaces, with increasing numbers of parameters needed to describe them. As the number of chemicals in the mixture increases, it becomes less likely that an investigator will be able to perform an experiment large enough to support the estimation of these parameters as well as those associated with the dose-response relationship. For mixtures with many components, it is likely that alternative approaches will need to be considered to account for these complexities with respect to interaction thresholds.

The elliptical interaction threshold boundary raises some interesting points regarding interaction. Here, we rescaled doses for the initial purpose of imposing a continuity constraint in such a way that a point further from the boundary will have greater contribution to the interaction than a point that is near the boundary. There are many ways to accomplish such an effect, and the user has the flexibility to define the interaction effect thought to be most appropriate. As in the example presented, goodness-of-fit tests can be helpful in determining the appropriateness of the various choices considered.

For studies of single agents, much has been written on the existence of dose thresholds (Lutz, 2001; Kroes, et.al, 2000; Sofuni, et.al 2000) and the development of models to accommodate the estimation of the threshold value. Gennings, et.al. (1997) developed additivity threshold models for drug/chemical combinations. We have added to the work on thresholds by introducing the concept of an interaction threshold. From our review of the statistical literature, the concept of an interaction threshold has not been considered. However, more recent studies on complex mixtures (El-Masri, Yushak, and Mumtaz 2002; Dobrev, Andersen, and Yang 2001) have also examined the assessment of an interaction threshold in chemical mixtures through the use of physiologically based pharmacokinetic (PBPK) modeling.

References

Berenbaum, M. C. (1981). Criteria for analyzing interactions between biologically active agents. Advances in Cancer Research 35, 269-335.

Carpy, S. A., Kobel, W., Doe, J. (2000). Health risk of low-dose pesticides mixtures: a review of the 1985-1998 literature on combination toxicology and health risk assessment. Journal of Toxicology and Environmental Health. Part B, Critical Reviews 3, 1-25

Carter, W. H., Jr., Gennings, C., Staniswalis, J. G., Campbell, E. D. and White, K. L. (1988). A statistical approach to the construction and analysis of isobolograms. Journal of the American College of Toxicology 7,963-973.

Dawson, K. S., Carter, W. H., Jr., Gennings, C. (2000). A statistical test for detecting and characterizing departures from additivity in drug/chemical combinations. Journal of Agricultural, Biological, and Environmental Statistics 5, 342-359.

Dobrev, I. D., Andersen, M. E., Yang, R. S. H. (2001). Assessing interaction thresholds for trichloroethylene in combination with tetrachloroethylene and 1,1,1-trichloroethane using gas uptake studies and PBPK modeling. Archives of Toxicology 75,134-44.

El-Masri, H. A., Yushak, M. L., Mumtaz, M. M. Development of a response surface for the toxicological interaction between chlorpyrifos and parathion using physiologically based pharmacokinetic modeling. Poster Presentation, 2002 Society of Toxicology Conference

Feder, P. I. (1975). The log likelihood ratio in segmented regression. The Annals of Statistics 3, 84-97.

Gallant, A. R., and Fuller, W. A. (1973). Fitting segmented polynomial regression models whose join points have to be estimated. Journal of the American Statistical Association 68, 144-147.

Gennings, C. (1995). An efficient experimental design for detecting departure from additivity in mixtures of many chemicals. Toxicology 105, 185-197.

Gennings, C., Schwartz, P., Carter, W. H., Jr., and Simmons J. E. (1997). Detection of departures from additivity in mixtures of many chemicals with a threshold model. Journal of Agricultural, Biological, and Environmental Statistics 2, 198-211.

Gennings, C., Carter, W. H., Jr., Campain, J., Bae, D., Yang, R. (2002). Statistical analysis of interactive cytotoxicity in human epidermal keratinocytes following exposure to a mixture of four metals. Journal of Agricultural, Biological, and Environmental Statistics 17, 58-73

Gessner, P. K., and Cabana, B. E. (1967). Chloral alcoholate: reevaluation of its role in the interaction between the hypnotic effects of chloral hydrate and ethanol. The Journal of Pharmacology and Experimental Therapeutics 156, 602-5.

Gessner, P. K., and Cabana, B. E. (1970). A study of the interaction of the hypnotic effects and of the toxic effects of chloral hydrate and ethanol. The Journal of Pharmacology and Experimental Therapeutics 174, 247-259.

Hinkley, D. V. (1969). Inference about the intersection in two-phase regression. Biometrika 56, 495-504.

Kelly, C., and Rice, J. (1990). Monotone smoothing with application to dose-response curves and the assessment of synergism. Biometrics 46, 1071-1085.

Konemann, W. H., and Pieters, M. N. (1996). Confusion of concepts in mixture toxicology. Food and Chemical Toxicology 34(11-12), 1025-1031.

Kroes, R., Galli, C., Munro, I., Schilter, B., Tran, L., Walker, R., and Wurtzen, G. (2000). Threshold of toxicological concern for chemical substances present in the diet: a practical tool for assessing the need for toxicity testing. Food and Chemical Toxicology 38, 255-312.

Loewe, S. (1953). The Problem of Synergism and Antagonism of Combined Drugs. Arzneimittle Forshung 3, 285-290.

Loewe, S., and Muischnek, H. (1926). Uber Kombinations-Wirkungen. 1. Mitteilung: Hilfsmittle der Fragestel-lung. Archives of Experimental Pathology and Pharmacolog 114, 313-326.

Lutz, W. K. (2001). Susceptibility differences in chemical carcinogenesis linearize the dose-response relationship: threshold doses can be defined only for individuals. Mutation Research 482, 71-6.

McCullagh, P. (1983). Quasi-likelihood functions. The Annals of Statistics, 11, 59-67.

McCullagh, P., Nelder, J. A. (1989). Generalized Linear Models (2^{nd} ed.), New York: Campman and Hall, 511 pp.

Nelder, J. A., and Mead, R. (1965). A Simplex Method for Function Minimization. The Computer Journal 7, 308-313.

Seber, G. A. F. and Wild, C. J. (1989), Nonlinear Regression, New York: John Wiley & Sons, Inc.

Sofuni, T., Hayashi, M., Nohmi, T., Matsuoka, A., Yamada, M., and Kamata, E. (2000). Semi-quantitative evaluation of genotoxic activity of chemical substances and evidence for a biological threshold of genotoxic activity. Mutation Research 464, 97-104.

U.S. Environmental Protection Agency. (1986). Guidelines for the Health Risk Assessment of Chemical Mixtures. EPA/630/R-98/002. National Center for Environmental Assessment, Office of Research and Development, Washington, D.C. 51 FR 34014.

U.S. Environmental Protection Agency. (2000). Supplementary Guidance for Conducting Health Risk Assessment of Chemical Mixtures. USEPA EPA/630/R-00/002. National Center for Environmental Assessment, Office of Research and Development, Washington, D.C. 51 FR 34014.

U.S. Environmental Protection Agency. (2002). Guidance on Cumulative Risk Assessment of Pesticide Chemicals that have a Common Mechanism of Toxicity. USEPA EPA/630/R-00/002?. Office of Pesticide Programs, Washington, D.C. 51 FR 34014.

Wedderburn, R. W. M. (1974), Quasi-likelihood Functions, Generalized Linear Models, and the Gauss-Newton Method. Biometrika 61, 439-447.

We claim:

1. A method of detecting an interaction among agents in a group using a fixed-ratio ray design and determining whether subsets of said agents also interact, comprising the steps of
a. determining an additivity model from single chemical data;
b. fitting a mixture model in terms of total dose to mixture data from fixed-ratio rays;
c. statistically comparing said additivity model to said mixture model, wherein a difference between said additivity model and said mixture model indicates an interaction among said agents in said group;
d. removing at least one subset of agents from said group, wherein relative ratios of remaining agents stay the same as in said fixed-ratio ray design;
e. repeating steps b and c for agents remaining in said group after removal of said subset; and
f. determining whether or not said remaining agents interact with said subset of agents by utilizing statistical methods based on algebraic manipulations relating full and reduced ray mixture models.

2. The method of claim 1 wherein said method is applied to a plurality of full-ray groups.

3. The method of claim 1 further comprising the step of carrying out steps b and c for said subset of agents.

4. The method of claim 1, wherein said additivity model is graphically represented as an additivity curve and said mixture model is graphically represented as a mixture curve in terms of total dose.

5. The method of claim 1, further comprising the step of determining simultaneous confidence bands on the difference between said additivity curve and said mixture curve or between mixture curves on full and reduced rays.

6. A method of detecting, in a group of agents, using a fixed-ratio ray design, the number of agents that interact, and determining whether subsets of said agents also interact, comprising the steps of
a. fitting a suitable polynomial in total dose to experimental data obtained with a combination of said agents;
b. statistically identifying higher order terms of said polynomial that are not equal to zero, wherein the number of agents that interact in said group of agents is equal to the degree of said higher order terms that are not equal to zero;
c. removing at least one subset of agents from said group, wherein relative ratios of remaining agents stay the same as in said fixed-ratio ray design;
d. repeating steps a and b for agents remaining in said group after removal of said subset;
e. determining whether or not said remaining agents interact with said subset of agents by utilizing statistical methods based on algebraic manipulations relating full and reduced ray mixture models.

7. The method of claim 6 wherein said method is applied to a plurality of full-ray groups.

8. The method of claim 6 further comprising the step of carrying out steps a and b for said subset of agents.

9. The method of claim 6, wherein single chemical data are used to estimate an additivity model which is linked to a linear term in said polynomial model.

10. The method of claim 9, wherein an additivity model is graphically represented as an additivity curve and said polynomial model is graphically represented as a mixture curve in terms of total dose.

11. The method of claim 6, wherein said polynomial is embedded in a generalized linear model.

12. The method of claim 6, wherein said polynomial is embedded in a general non-linear model.

13. The method of claim 6, further comprising the step of generating a graphical representation of said polynomial in total dose.

14. A method of determining an interaction threshold for agents in a group, comprising the step of
generating a generalized linear model or general nonlinear model that permits estimation of the boundaries between a region of additivity of said agents and a region of interaction of said agents, wherein said boundaries define said interaction threshold.

15. The method of claim 14, wherein said region of additivity of said agents and said region of interaction of said agents is determined by the steps of
a. determining an additivity model from single chemical data;
b. fitting an interaction threshold mixture model that incorporates an interaction threshold parameter in terms of total dose to mixture data from fixed-ratio rays; and
c. statistically comparing said additivity model to said interaction threshold mixture model, wherein a region of difference between said additivity model and said interaction threshold mixture model indicates a region of interaction among said agents in said group, and a region of coincidence between said additivity model and said interaction threshold mixture model indicates a region of additivity among said agents in said group.

16. The method of claim 15 wherein said method is applied to a plurality of full-ray groups.

17. The method of claim 15 further comprising the steps of
d. removing at least one subset of agents from said group wherein relative ratios of remaining agents stay the same as in said fixed-ratio ray design;
e. repeating steps b and c for agents remaining in said group after removal of said subset; and
f. determining whether or not said remaining agents interact with said subset of agents by utilizing statistical methods based on algebraic manipulations relating full and reduced ray interaction threshold mixture models.

18. The method of claim 15 further comprising the step of carrying out steps b and c for said subset of agents.

19. The method of claim 14, wherein said region of additivity of said agents and said region of interaction of said agents is determined by the steps of
a. determining an additivity model from single chemical data;
b. fitting an interaction threshold mixture model that incorporates an interaction threshold parameter in terms of total dose to mixture data from fixed-ratio rays, wherein said region of additivity is conditioned on results obtained in step a; and
c. statistically comparing said additivity model to said interaction threshold mixture model, wherein a region of difference between said additivity model and said interaction threshold mixture model indicates a region of interaction among said agents in said group, and a region of coincidence between said additivity model and said interaction threshold mixture model indicates a region of additivity among said agents in said group.

20. The method of claim 19 wherein said method is applied to a plurality of full-ray groups.

21. The method of claim 19 further comprising the steps of
d. removing at least one subset of agents from said group, wherein relative ratios of remaining agents stay the same as in said fixed-ratio ray design;
e. repeating steps b and c for agents remaining in said group after removal of said subset; and
f. determining whether or not said remaining agents interact with said subset of agents by utilizing statistical methods based on algebraic manipulations relating full and reduced ray interaction threshold mixture models.

22. The method of claim 19 further comprising the step of carrying out steps b and c for said subset of agents.

23. The method of claim 14, wherein said region of additivity of said agents and said region of interaction of said agents is determined by the steps of
a. fitting an interaction threshold mixture model parameterized with a polynomial function for regions of interaction to experimental data obtained with a combination of said agents, and
b. statistically testing whether the interaction threshold parameter is different from zero and identifying higher order terms of said polynomial that are not equal to zero.

24. The method of claim 23 wherein said method is applied to a plurality of full-ray groups.

25. The method of claim 23, further comprising the steps of
c. removing at least one subset of agents from said group wherein relative ratios of remaining agents stay the same as in said fixed-ratio ray design;
d. repeating steps a and b for agents remaining in said group after removal of said subset; and
e. determining whether or not said remaining agents interact with said subset of agents by utilizing statistical methods based on algebraic manipulations relating full and reduced ray mixture models.

26. The method of claim 23, wherein single chemical data are also utilized.

27. A method of designing experiments that achieve a target power associated with a test of additivity, comprising the steps of
a. specifying said target power, a significance level, a number of mixture dose groups, and a magnitude of departure from additivity in terms of total dose;
b. setting a candidate total sample size;
c. formulating a design by expressing a design optimality criterion as a function of said target power, said significance level, said number of mixture dose groups, said magnitude of departure from additivity in terms of total dose, and said candidate total sample size, wherein optimal locations of total dose groups and optimal allocations of subjects to said total dose groups are determined using a direct search algorithm;
d. calculating a calculated power associated with said design;
e. comparing said calculated power to said target power; and
f. repeating steps a-e until said step of comparing shows that said calculated power is equal to said target power.

28. The method of claim 27 further comprising the step of increasing said total sample size used during said step of repeating if said step of comparing shows that said calculated power is less than said target power.

29. The method of claim 27 further comprising the step of decreasing said total sample size used during said step of repeating if said step of comparing shows that said calculated power is greater than said target power.

30. Software for causing a computer to carry out a method of detecting an interaction among agents in a group using a fixed-ratio ray design and determining whether subsets of said agents also interact, wherein said method comprises the steps of
a. determining an additivity model from single chemical data;
b. fitting a mixture model in terms of total dose to mixture data from fixed-ratio rays;
c. statistically comparing said additivity model to said mixture model, wherein a difference between said additivity model and said mixture model indicates an interaction among said agents in said group;
d. removing at least one subset of agents from said group, wherein relative ratios of remaining agents stay the same as in said fixed-ratio ray design;
e. repeating steps b and c for agents remaining in said group after removal of said subset; and
f. determining whether or not said remaining agents interact with said subset of agents by utilizing statistical methods based on algebraic manipulations relating full and reduced ray mixture models.

31. Software for causing a computer to carry out a method of detecting, in a group of agents, using a fixed-ratio ray design, the number of agents that interact, and determining whether subsets of said agents also interact, wherein said method comprises the steps of
a. fitting a suitable polynomial in total dose to experimental data obtained with a combination of said agents;
b. statistically identifying higher order terms of said polynomial that are not equal to zero, wherein the number of agents that interact in said group of agents is equal to the degree of said higher order terms that are not equal to zero;
c. removing at least one subset of agents from said group, wherein relative ratios of remaining agents stay the same as in said fixed-ratio ray design;
d. repeating steps a and b for agents remaining in said group after removal of said subset;
e. determining whether or not said remaining agents interact with said subset of agents by utilizing statistical methods based on algebraic manipulations relating full and reduced ray mixture models.

32. Software for causing a computer to carry out a method of determining an interaction threshold for agents in a group, wherein said method comprises the step of
generating a generalized linear model or general nonlinear model that permits estimation of the boundaries between a region of additivity of said agents and a region of interaction of said agents, wherein said boundaries define said interaction threshold.

33. Software for causing a computer to carry out a method of designing experiments that achieve a target power associated with a test of additivity, wherein said method comprises the steps of
a. specifying said target power, a significance level, a number of mixture dose groups, and a magnitude of departure from additivity in terms of total dose;
b. setting a candidate total sample size;
c. formulating a design by expressing a design optimality criterion as a function of said target power, said significance level, said number of mixture dose groups, said magnitude of departure from additivity in terms of total dose, and said candidate total sample size, wherein optimal locations of total dose groups and optimal allocations of subjects to said total dose groups are determined using a direct search algorithm;
d. calculating a calculated power associated with said design;
e. comparing said calculated power to said target power; and
f. repeating steps a-e until said step of comparing shows that said calculated power is equal to said target power.
